(19) United States
(12) Patent Application Publication
(10) Pub. No.: US 2026/0108335 A1
(43) Pub. Date: Apr. 23, 2026

(54) ORAL APPLIANCES, THEIR COMPONENTS, AND METHODS OF USE FOR ORAL MAPPING AND HYGIENE

(71) Applicant: Daniel X Foz, El Cerrito, CA (US)

(72) Inventor: Daniel X Foz, El Cerrito, CA (US)

(21) Appl. No.: 19/116,339

(22) PCT Filed: Sep. 28, 2023
(86) PCT No.: PCT/US2023/075452

§ 371 Date: Mar. 27, 2025

Related U.S. Application Data
(60) Provisional application No. 63/377,375, filed on Sep. 28, 2022.
(60) Provisional application No. 63/377,380, filed on Sep. 28, 2022.
(60) Provisional application No. 63/377,722, filed on Sep. 29, 2022.
(60) Provisional application No. 63/385,993, filed on Dec. 4, 2022.
(60) Provisional application No. 63/503,165, filed on May 19, 2023.
(60) Provisional application No. 63/503,166, filed on May 19, 2023.
(60) Provisional application No. 63/503,167, filed on May 19, 2023.
(60) Provisional application No. 63/503,168, filed on May 19, 2023.

(51) Int. Cl. A61C 17/34; A61C 5/90; A61C 15/04; A61C 19/06

(52) U.S. Cl. CPC A61C 17/34; A61C 5/90; A61C 15/047; A61C 19/06

(57) ABSTRACT

Oral appliances, their components, and methods of their use for oral mapping and hygiene are disclosed. One method of using an oral appliance, comprises using a tool while the tool is at least partially within the oral cavity of a living creature; moving the tool, with a motion generator comprised of at least one linear and/or rotary motion-producing device; retrieving a map from machine-readable memory; and processing, with nonhuman processing circuitry, the map to generate control signals for controlling movement of the motion generator; and the processing circuitry using the map to control the motion generator to move the tool within the oral cavity so that the tool performs one of the functions of: cleaning, inspecting, scanning, imaging, dispensing, repairing, and surgery of anatomical features of the oral cavity.

### CROSS-REFERENCE TO RELATED APPLICATIONS

This application claims the benefit of U.S. patent application 63/377,375, filed Sep. 28, 2022, entitled ‘ORAL MAPPING’, U.S. patent application 63/377,380, filed Sep. 28, 2022, entitled ‘ORAL HYGIENE APPARATUSES’, U.S. patent application 63/377,722, filed Sep. 29, 2022, entitled ‘ORAL APPLIANCES’, U.S. patent application 63/385,993, filed Dec. 4, 2022, entitled ‘ORAL HYGIENE APPARATUS CARTRIDGES AND TOOLS’, U.S. patent application 63/503,165, filed May 19, 2023, entitled ‘ORAL POSITIONING APPARATUSES’, U.S. patent application 63/503,166, filed May 19, 2023, entitled ‘ORAL POSITIONING APPARATUSES’, United States patent application 63/503,167, filed May 19, 2023, entitled ‘ORAL APPLIANCES’, and United States patent application 63/503,168, filed May 19, 2023, entitled ‘ORAL APPLIANCES’, all of which are hereby incorporated by reference in their entireties.

### BACKGROUND OF THE DISCLOSURE

### Field of the Disclosure

This disclosure relates to oral appliances, their components, and methods of their use for oral mapping and hygiene.

### SUMMARY OF THE DISCLOSURE

Disclosed are oral appliances; oral hygiene apparatuses; cartridges; oral positioning apparatus; method for performing oral hygiene tasks and generating and using oral maps and at least one sensor.

One oral appliance comprises a motion generator comprising a tool arm and an assembly, at least one sensor, machine-readable and/or readable and writable memory, and non-human processing circuitry. The tool arm has a distal end. The assembly comprises a mechanism to rotate the tool arm and structure allowing the tool arm to move linearly. The distal end of the tool arm is configured to mechanically attach to an oral cavity tool. A sensor is configured to output a signal indicating locations of surfaces of an oral cavity. The non-human processing circuitry is coupled to the memory and the at least one sensor. The processing circuitry is configured to read from and/or write to the memory. The processing circuitry is configured to receive signals from the at least one sensor. The processing circuitry is configured to generate control signals to control the motion generator to move the tool arm.

One method of using an oral appliance, comprises using a tool while the tool is at least partially within the oral cavity of a living creature; moving the tool, with a motion generator comprised of at least one linear and/or rotary motion-producing device; retrieving a map from machine-readable memory; and processing, with non-human processing circuitry, the map to generate control signals for controlling movement of the motion generator; and the processing circuitry using the map to control the motion generator to move the tool within the oral cavity so that the tool performs one of the functions of: cleaning, inspecting, scanning, imaging, dispensing, repairing, and surgery of anatomical features of the oral cavity.

One method for automatically generating an oral map of features within an oral cavity of a living animal, comprises: moving a tool relative to a reference point that is fixed relative to oral cavity; detecting, using a sensor, positions of the tool, indicating that either the tool or an object mechanically connected to the tool, has hit an obstruction; and storing oral mapping data, in computer writable memory, based upon the detected positions.

One oral hygiene apparatus comprises: an oral hygiene tool; a member connected to the oral hygiene tool; a connector configured to connect to an actuator; wherein the connector is mechanically coupled to the member so that motion of the connector causes the member to move; and a retention feature which is configured to retain the connector to an actuator and enable the actuator to rotate the connector.

One cartridge, comprises: an oral hygiene tool; a member connected to the oral hygiene tool; a connector configured to connect to an actuator; wherein the connector is mechanically coupled to the member so that motion of the connector causes the member to move; and
a retention feature which is configured to retain the connector to an actuator and enable the actuator to rotate the connector.

One oral positioning apparatus, comprises: one or more members configured so that the one or more members hold an upper jaw spaced from a lower jaw of a vertebrate, when the one or more members are positioned relative to anatomical features of the vertebrate; a cam follower connected to one or more of said locating members either directly or through intermediate members; and a cam having a plurality of positions which constrain the motion of said cam follower.

One automated oral hygiene apparatus, for automatically performing an oral hygiene task within a mouth of an individual, comprises: a probe; wherein the probe comprises a tool; wherein the oral hygiene apparatus is configured to automatically move and orient the probe within the mouth; and wherein the oral hygiene apparatus is configured to automatically operate the tool to perform an oral hygiene task.

One method for automatically performing an oral hygiene task within a mouth of an individual, comprising: providing an automated oral hygiene apparatus comprising probe, wherein the probe comprises a tool; the automated oral hygiene apparatus automatically moving and orienting the probe within the mouth; and the oral hygiene apparatus automatically operating the tool to perform an oral hygiene task.

Each apparatus and/or method may include one or more of the following. Wherein the assembly is a gimbal assembly that comprises at least one gimbal and a bore through which the tool arm extends; wherein the processing circuitry utilizes the output of one or more sensors to store in the memory a map of oral cavity locations; utilizing locations of a map stored in the memory to control the motion generator to move the tool arm to locations in the oral cavity; an oral cavity tool attached to the tool arm; wherein the processing circuitry uses a map stored in the memory to control the motion generator to move the tool within the oral cavity so that the tool performs at least brushing or flossing of teeth within the oral cavity; wherein the oral cavity tool includes a length of dental floss or plurality of bristles; wherein the oral cavity tool includes one or more cameras; wherein the oral cavity tool includes one or more 2D or 3D scanners; wherein the oral appliance includes a tool holder for the oral cavity tool; wherein the oral cavity tool includes a groove to retain the tool in the tool holder while permitting rotation of the tool; wherein the oral cavity tool includes a flange to retain the tool in the tool holder while permitting rotation of the tool; wherein a portion of the oral cavity tool that mates with the tool holder has an asymmetric shape so that it may be attached in only one orientation relative to the tool holder; wherein the oral appliance includes a clamp to removably attach the oral cavity tool; wherein the motion generator includes one or more motors; wherein the motion generator includes one or more linear actuators; wherein the motion generator includes one or more rotary actuators; wherein the motion generator includes a motor or linear or rotary actuator for rotating the oral cavity tool around a first axis; wherein the motion generator includes a motor or linear or rotary actuator for rotating the oral cavity tool around a second axis; wherein the motion generator includes five motors: one for left-right motion, one for up-down motion, one for in-out motion, one for oral cavity tool rotation along a first axis, and one for oral cavity tool rotation along a second axis; wherein at least a portion of the tool arm has an exterior surface of constant geometry such that it can mate with a seal to reduce ingress of debris or fluids into the oral appliance; wherein the oral appliance includes a seal which mates with the tool arm to reduce ingress of debris or fluids into the oral appliance; wherein the motion generator includes a linear bearing or bushing to permit the tool arm to extend and retract; wherein the motion generator is coupled to the oral cavity tool via a tool arm and one or more gimbals; wherein the motion generator is coupled to the oral cavity tool via nested gimbals; wherein the motion generator is coupled to the oral cavity tool via a tool arm and a ball-and-socket joint; wherein the oral appliance includes a hemispherical shield which mates with a seal to reduce ingress of debris or fluids into the oral appliance; wherein at least one of the sensors comprises either an optical encoder or a magnetic encoder; wherein at least one of the sensors comprises one of a current sensor, a linear potentiometer, a rotary potentiometer, a linear variable-displacement transformer (LVDT), a force-sensitive resistor (FSR), a strain gauge, a magnetometer, and a gyroscope; wherein at least one of the sensors comprises, an accelerometer; wherein the sensor comprising the accelerometer provides detection of a hazardous or damaging orientation in order to stop or prevent the operation of the device and/or communicate a warning; wherein at least one of the sensors comprises one of an ultrasonic transceiver or ranger, a camera, a 2D or 3D scanner, and a capacitive sensor; one or more members configured to constrain one or more oral or facial features of an individual to provide one or more position references; one or more members configured to contact one or more oral or facial features of an individual to constrain the lower jaw relative to the upper jaw of an oral cavity to maintain an opening to the oral cavity; one or more members configured to anchor the oral appliance's position relative to the oral cavity; wherein at least a part of the members fit into the upper and/or lower gum pockets between the front gums and the inner surface of the lip; wherein at least one of the members has a notch which surrounds the upper frenulum; wherein at least part of the members fit between the maxilla and mandible behind the rear molars; wherein the members are configured to constrain at least one facial feature via at least one member external to the oral cavity; wherein at least one facial feature constrained is the mandible; wherein at least one facial feature constrained is the chin; wherein at least one facial feature constrained is the nose; wherein at least one facial feature is the intersection of the nasal septum and the philtrum; wherein at least one facial feature is the mentolabial sulcus; wherein the oral cavity tool includes a cleaning and/or dispensing orifice; wherein the oral appliance includes a cleaning member or cleaning and/or dispensing mechanism for an oral cavity tool; wherein the oral cavity tool comprises an oral cavity tool cleaning mechanism that comprises one or more stationary brushes which the oral cavity tool may be moved to brush against, using the motion generator; wherein the oral cavity tool comprises an oral cavity tool cleaning mechanism that comprises one or more moving or rotating brushes; wherein the oral cavity tool comprises an oral cavity tool cleaning mechanism that comprises one or more stationary or moving wipers; wherein the oral cavity tool comprises an oral cavity tool cleaning mechanism that comprises of one or more stationary or moving sponges; wherein the oral cavity tool comprises an oral cavity tool dispensing mechanism that comprises one or more orifices fed from one or more substance pumps from one or more substance reservoirs; wherein the oral cavity tool comprises an oral cavity tool cleaning mechanism that comprises one or more jets; wherein the one or more jets are configured to use water pressure supplied by the water mains; wherein the one or more jets are configured to be fed from one or more substance pumps from one or more substance reservoirs; wherein the one or more jets are configured as part of the oral cavity tool; wherein the one or more jets are part of the oral appliance, and not part of the oral cavity tool; wherein the memory stores a map that defines a set of coordinates and/or orientations of locations in the oral cavity; wherein the memory stores a map represented by a set of points and/or vectors and/or curves and/or surfaces; wherein processing circuitry computes the mapping data based upon the detected positions, and stores mapping data in the computer writeable memory; wherein processing circuitry generates control signals to control a motion generator to cause the moving of the tool relative to the reference point; wherein the retention feature is or is not, an integral part of said connector; wherein the retention feature is not an integral part of said connector; a set of actuators configured to automatically move parts of the oral probe; wherein the set of actuators comprises one linear actuator and four rotary actuators; wherein each one of the set of actuators comprises a corresponding encoder that provides feedback on position or rotation of the corresponding actuator; wherein the tool comprises a brush or dental floss; computer memory storing data defining a set of locations where the tool is to be moved and/or oriented to perform an oral hygiene task; processing circuitry configured to generate signals to control operation of a set of actuators to move and orient the oral hygiene tool to specified locations within the mouth of the individual where one or more oral hygiene tasks are to be performed; the computer memory storing a set of locations where the tool is to be moved and/or oriented to perform the oral hygiene task; the processing circuitry is configured to read the set of locations from the computer memory and use those locations to the generate signals to control the operation of the set of actuators to move and orient the oral hygiene tool to the specified locations within the mouth of the individual where one or more oral hygiene tasks are to be performed; wherein the tool comprises dental floss, and the oral hygiene apparatus is configured to automatically move the dental floss through a pocket between opposing surface of adjacent teeth in a corkscrew motion; wherein the tool comprises a floss cartridge forming an “U” shape which constrains the dental floss to extend between tips of the “U”.

### BRIEF DESCRIPTION OF THE DRAWINGS

Like reference numerals refer to the same or similar elements throughout the disclosure.

FIG. 1 shows a perspective view of oral appliance 200.

FIG. 2 shows an exploded view of the subsystems of an example oral appliance.

FIG. 3 shows an exploded view of housings, seals, fasteners and a charging station.

FIG. 4 shows an exploded view of a tool arm and an oral cavity tool.

FIGS. 5A and 5B show a procedure for inserting an oral cavity tool into a tool holder.

FIG. 6A shows a right-front perspective view of a gimbal assembly.

FIG. 6B shows a right-rear perspective view of a gimbal assembly.

FIG. 7 shows an exploded view of a gimbal assembly.

FIG. 8A shows a right perspective view of a motor platform assembly.

FIG. 8B shows a left perspective view of a motor platform assembly.

FIG. 9 shows an exploded view of a motor platform assembly.

FIG. 10 shows an exploded view of a substance delivery assembly and oral cavity tool.

FIG. 11A shows a right-front perspective view of a mouth anchoring assembly.

FIG. 11B shows a right-rear perspective view of a mouth anchoring assembly.

FIG. 12 shows an exploded view of a mouth anchoring assembly.

FIG. 13 shows a perspective view of an illuminated switch assembly.

FIG. 14 shows an exploded view of an illuminated switch assembly.

FIG. 15A shows a perspective view of a hatch-hinge assembly.

FIG. 15B shows an exploded view of a hatch-hinge assembly

FIG. 16A shows a top perspective view of a printed circuit board (PCB) assembly.

FIG. 16B shows a bottom perspective view of a printed circuit board (PCB) assembly.

FIG. 17 shows, in a composite image of three different positions, the use of an oral appliance for brushing teeth.

FIG. 18A shows the use of a scanner cartridge to generate 3D maps and/or images of the oral cavity.

FIG. 18B shows the use of a stereo camera cartridge to generate 3D maps and/or images of the oral cavity.

FIG. 19 shows a block diagram of an example oral appliance.

FIG. 20 shows an elevation view of an example oral positioning apparatus.

FIG. 21 shows a perspective view of an example oral positioning apparatus.

FIG. 22 shows an overview of a cycle of an example oral positioning apparatus.

FIG. 23 shows a user closing his or her mouth on the apparatus in the Storage position.

FIG. 24 shows a user biting down to release the apparatus from the Storage position.

FIG. 25 shows a transition from the Storage Released position to the Pre-Activation position.

FIG. 26 shows a transition from the Pre-Activation position to the Active position.

FIG. 27 shows the Active position.

FIG. 28 shows a transition from the Active position to the Post-Activation (Completed or Emergency Stop) position.

FIG. 29 shows a transition from the Post-Activation (Completed or Emergency Stop) position to the Pre-Storage position.

FIG. 30 shows a transition from the Pre-Storage position to the Storage position.

FIG. 31 shows a user removing the stowed apparatus from his or her mouth.

FIG. 32 shows an exploded view of the front side of a cam mechanism.

FIG. 33 shows an exploded view of the rear side of a cam mechanism.

FIG. 34 shows front-side gates which restrict a cam follower to one-way motion.

FIG. 35 shows rear-side gates which restrict a cam follower to one-way motion.

FIG. 36 shows a perspective view of an example cam adjustment mechanism.

FIG. 37 shows an illustration of how the cam range is adjusted.

FIG. 38 shows the extents of the adjustable cam range in the Active position.

FIG. 39 shows an exploded view of an example cam adjustment mechanism.

FIG. 40 shows the use of a microswitch for detection of the Active, Storage or other positions.

FIG. 41A shows the use of conductive section(s) of the cam for detection of the Active, Storage or other positions (Shown not in detected position).

FIG. 41B shows the use of conductive section(s) of the cam for detection of the Active, Storage or other positions (Shown in detected position).

FIG. 42 shows an active positioning mechanism powered by a motor or actuator and capable of measuring the force applied and/or received.

FIG. 43 is a rear perspective view of a mouth including two jaw wedges with saliva-removal tubes and force-detection

FIG. 44 is a front perspective view of a mouth including two jaw wedges with lip displacers

FIG. 45 is an exploded view of a jaw wedge with saliva-removal tubes and force-detection

FIG. 46 is a perspective view showing no current flow when little or no force is applied to the jaw wedge.

FIG. 47 is a perspective view showing current flow when sufficient force is applied to the jaw wedge.

FIG. 48 shows perspective and section views of a flossing cartridge without cleaning jets and/or dispensing orifices.

FIG. 49 shows perspective and section views of a flossing cartridge with cleaning jets and/or dispensing orifices.

FIG. 50A shows a perspective view of a floss insert.

FIG. 50B shows a perspective view of a floss insert holder.

FIG. 50C shows a perspective view of an assembled floss insert in a floss insert holder.

FIG. 50D shows a section view of an assembled floss insert in a floss insert holder.

FIG. 51 shows perspective and section views of a brushing cartridge with radial bristle clusters and cleaning jets and/or dispensing orifices.

FIG. 52 shows perspective and section views of a brushing cartridge with radial bristle clusters without cleaning jets and/or dispensing orifices.

FIG. 53 shows perspective and section views of a brushing cartridge with parallel bristle clusters and cleaning jets and/or dispensing orifices.

FIG. 54 is a block diagram of an oral hygiene apparatus including an oral hygiene apparatus cartridge.

FIG. 55 shows an exploded view of an example actuator and substance delivery system.

FIG. 56 illustrates the insertion of a cartridge into a tool arm.

FIG. 57A illustrates the increased range of motion required for a brush cartridge with bristle clusters perpendicular to the tool arm.

FIG. 57B illustrates the reduced range of motion required for a brush cartridge with bristle clusters parallel to the tool arm.

FIG. 58A shows a brush cartridge with bristle clusters parallel to the tool arm.

FIG. 58B shows a floss cartridge with dental floss parallel to the tool arm.

FIG. 59A shows how a floss cartridge with floss parallel to the tool arm can fully contact the gumline via semi-flexible legs which can bend.

FIG. 59B shows how a floss cartridge with floss parallel to the tool arm can fully contacting the gumline via slack in the floss.

FIG. 59C shows a floss cartridge with floss parallel to the gumline in an open mouth.

FIG. 59D shows how a cartridge with floss parallel to the tool arm has a reduced height requirement.

FIG. 60A shows the use of a groove for cartridge retention while permitting rotation and the transmission of bidirectional forces.

FIG. 60B shows the use of a flange for cartridge retention while permitting rotation and the transmission of bidirectional forces.

FIG. 61 illustrates a locating feature on the cartridge and its complementary locating feature on the cartridge holder.

FIG. 62A is a perspective view of a flossing cartridge with cleaning jets and/or dispensing orifices.

FIG. 62B is a perspective view of a flossing cartridge with cleaning jets and/or dispensing orifices and a tab for scraping biofilms off a tongue.

FIGS. 63A to 63D are perspective, section, plan and elevation views, respectively, of a flossing cartridge without cleaning jets and/or dispensing orifices.

FIGS. 64A to 64D are perspective, section, plan and elevation views, respectively, of a flossing cartridge with one cleaning jet and/or dispensing orifice on the connector side of the cartridge.

FIGS. 65A to 65D are perspective, section, plan and elevation views, respectively, of a flossing cartridge with one cleaning jet and/or dispensing orifice on the non-connector side of the cartridge.

FIGS. 66A to 66D are perspective, section, plan and elevation views, respectively, of a flossing cartridge with two cleaning jets and/or dispensing orifices.

FIGS. 67A to 67D are perspective, section, plan and elevation views, respectively, of a flossing cartridge with two cleaning jets and/or dispensing orifices.

FIGS. 68A to 68D are perspective, section, plan and elevation views, respectively, of a flossing cartridge with two cleaning jets and/or dispensing orifices.

FIGS. 69A to 69D are perspective, section, plan and elevation views, respectively, of a flossing cartridge with two cleaning jets and/or dispensing orifices.

FIGS. 70A to 70D are perspective, section, plan and elevation views, respectively, of a flossing cartridge with two cleaning jets and/or dispensing orifices.

FIGS. 71A to 71D are perspective, section, plan and elevation views, respectively, of a flossing cartridge with two cleaning jets and/or dispensing orifices.

FIG. 72A shows a perspective view of a first example of a floss insert.

FIG. 72B shows a perspective view of a first example of a floss insert holder.

FIG. 72C shows a perspective view of a first example of an assembled floss insert in a floss insert holder.

FIG. 72D shows a section view of a first example of an assembled floss insert in a floss insert holder.

FIG. 73A shows a perspective view of a second example of a floss insert having posts to increase retention and minimize substance leakage.

FIG. 73B shows a perspective view of a second example of a floss insert holder.

FIG. 73C shows a perspective view of a second example of an assembled floss insert in a floss insert holder.

FIG. 73D shows a section view of a second example of an assembled floss insert in a floss insert holder.

FIG. 74 illustrates the process of connecting the floss insert to the floss insert holder to form a complete assembly.

FIG. 75 illustrates enhanced cleaning of the gumline using angled bristle clusters.

FIG. 76A is a perspective view of a brushing cartridge with regular-length flat parallel bristle clusters and cleaning jets and/or dispensing orifices.

FIG. 76B is a perspective view of a brushing cartridge with regular-length flat radial bristle clusters and cleaning jets and/or dispensing orifices.

FIGS. 77A to 77D are perspective, section, plan and elevation views, respectively, of a brushing cartridge with regular-length flat parallel bristle clusters and cleaning jets and/or dispensing orifices.

FIGS. 78A to 78D are perspective, section, plan and elevation views, respectively, of a brushing cartridge with regular-length flat and extended-length angled-down parallel bristle clusters and cleaning jets and/or dispensing orifices.

FIGS. 79A to 79D are perspective, section, plan and elevation views, respectively, of a brushing cartridge with regular-length angled-alternating and extended-length angled-down parallel bristle clusters and cleaning jets and/or dispensing orifices.

FIGS. 80A to 80D are perspective, section, plan and elevation views, respectively, of a brushing cartridge with regular-length flat parallel bristle clusters without cleaning jets and/or dispensing orifices.

FIGS. 81A to 81D are perspective, section, plan and elevation views, respectively, of a brushing cartridge with regular-length flat and extended-length angled-down parallel bristle clusters without cleaning jets and/or dispensing orifices.

FIGS. 82A to 82D are perspective, section, plan and elevation views, respectively, of a brushing cartridge with regular-length rounded parallel bristle clusters without cleaning jets and/or dispensing orifices.

FIGS. 83A to 83D are perspective, section, plan and elevation views, respectively, of a brushing cartridge with regular-length flat radial bristle clusters and cleaning jets and/or dispensing orifices.

FIGS. 84A to 84D are perspective, section, plan and elevation views, respectively, of a brushing cartridge with regular-length flat and extended-length angled-down radial bristle clusters and cleaning jets and/or dispensing orifices.

FIGS. 85A to 85D are perspective, section, plan and elevation views, respectively, of a brushing cartridge with regular-length rounded radial bristle clusters and cleaning jets and/or dispensing orifices.

FIGS. 86A to 86D are perspective, section, plan and elevation views, respectively, of a brushing cartridge with regular-length flat radial bristle clusters without cleaning jets and/or dispensing orifices.

FIGS. 87A to 87D are perspective, section, plan and elevation views, respectively, of a brushing cartridge with regular-length angled-alternating radial bristle clusters without cleaning jets and/or dispensing orifices.

FIGS. 88A to 88D are perspective, section, plan and elevation views, respectively, of a brushing cartridge with regular-length angled-alternating and extended-length angled-down radial bristle clusters without cleaning jets and/or dispensing orifices.

FIG. 89 is a block diagram of an example automated oral appliance.

FIG. 90 is a diagram of example set of actuators that may be included in an automated oral appliance.

FIG. 91 is a diagram of example set of related movements of actuators that may be included in an automated oral appliance.

FIG. 92 is a diagram of an example calibration process that may be performed by an example automated oral appliance.

FIG. 93 is a diagram of an example outer mapping of oral features of an individual by an example automated oral appliance.

FIG. 94 is a diagram of an example inner mapping of oral features of an individual by an example automated oral appliance.

FIG. 95 is a diagram of an example tooth profile mapping and an example pocket profile mapping of oral features of an individual by an example automated oral appliance.

FIG. 96 is a flowchart diagram of a first example method of mapping an oral cavity of an individual.

FIG. 97 is a flowchart diagram of a second example method of mapping an oral cavity of an individual.

FIG. 98 is a component block diagram of an example oral apparatus configured to map an oral cavity of an individual.

FIG. 99 is a diagram of a computer-readable medium storing instructions that, when executed by an oral apparatus, may cause the oral apparatus to map an oral cavity of an individual.

FIG. 100 is a diagram of example uses of an example robotic dental workstation for mapping an oral cavity of an individual.

FIG. 101 is a flowchart diagram of a third example method of mapping an oral cavity of an individual via groove following.

FIG. 102 is a diagram showing an example of a tooth pocket axis and a groove axis.

FIG. 103 is a diagram showing an example of a groove following path.

FIG. 104 is a flowchart diagram of a fourth example method of mapping an oral cavity of an individual via point cloud generation.

FIG. 105 is a diagram showing an example of a point cloud of oral surfaces.

FIG. 106 is a diagram showing example teeth boundaries computed from point cloud scanning of oral surfaces.

FIG. 107 is a component block diagram 812 of oral appliance 813.

FIG. 108 is a diagram of example set of actuators that may be included in an automated oral appliance 827.

FIG. 109 is a diagram of an example calibration process that may be performed by an automated oral appliance 827.

FIG. 110 is a diagram of performing a first oral hygiene task in the mouth of an individual by an automated oral appliance 827.

FIG. 111 is a diagram of performing a second oral hygiene task in the mouth of an individual by an automated oral appliance 827.

FIG. 112 is a flowchart diagram of a first example method of performing an oral hygiene task in a mouth of an individual.

FIG. 113 is a flowchart diagram of a second example method of performing an oral hygiene task in a mouth of an individual.

FIG. 114 is a flowchart diagram of a third example method of performing an oral hygiene task in a mouth of an individual.

FIG. 115 is a component block diagram 877 of an oral appliance 879 configured to perform an oral hygiene task in a mouth of an individual 878.

FIG. 116 is a diagram of a computer-readable medium storing instructions that, when executed by an oral hygiene apparatus, may cause the oral hygiene apparatus to perform an oral hygiene task in a mouth of an individual.

FIG. 117 is a diagram of a fourth example method, a zig-zag maneuver to reduce the force required to penetrate the space between tightly packed teeth.

FIG. 118 is a diagram of a fifth example method, a sawing maneuver to reduce the force required to penetrate the space between tightly packed teeth.

FIG. 119 is a diagram of a sixth example method, a repeatable corkscrew maneuver to sweep food debris out of a tooth pocket.

FIG. 120 is an illustration of an example robotic dental workstation configured to clean the oral cavity of a human or animal subject.

FIG. 121 is a flowchart diagram of a seventh example method of cleaning a mouth of an individual.

### DETAILED DESCRIPTION

### Oral Appliance Detailed Description

Oral appliances include toothbrushes, powered toothbrushes, water jet systems, floss, floss holders, wipes, substance dispensers, polishers, drills, cameras and other devices for cleaning, repairing or inspecting an oral cavity. Such oral appliances are often operated at least in part through manipulation by an individual.

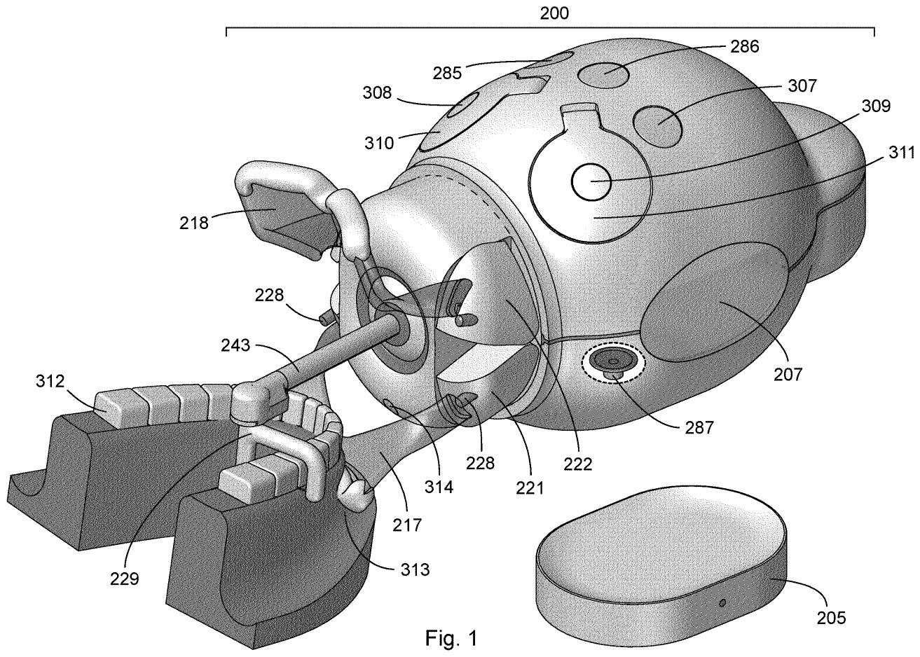

FIG. 1 shows an oral appliance 200 and some of its user interface features. Oral appliance 200 may be positioned on an individual's head in a fixed relationship to the individual's head by a lower mouth anchor 217 and an upper mouth anchor 218 inserted into the oral cavity of the individual. A mouth anchor is a member inserted into the oral cavity to couple to one or more of a user's jaws to hold them apart to permit activities within the oral cavity. In the context of this disclosure, other terms may be used for other structures which provide similar functionality, such as positioning member and [jaw] spacer. Oral appliance 200 may then automatically map the oral cavity of the individual, which may include the position and orientation of gaps between teeth. Oral appliance 200 may then automatically clean, repair and/or inspect the oral cavity of the individual based on a map without any motion required on the part of the individual to move a cleaning, inspecting, dispensing or repairing portion of oral appliance 200. In the context of this disclosure, the terms individual, user, human, patient, subject, vertebrate, animal and living creature may all be interchangeably used to describe the human or animal being treated by the oral appliance. The individual, user, human, patient or subject may be the operator of the device, or they may be a passive recipient of care provided by another person operating the device.

As described hereinabove, oral appliance 200 may be positioned on an individual's head in a relatively fixed relationship. In the context of this disclosure, “relatively fixed” means that once oral appliance 200 is anchored to the individual's head, one or more mouth anchors, described further hereinbelow, and external portions of oral appliance 200 should not be moved during mapping or during cleaning, dispensing, repair and/or inspection of the oral cavity to the extent possible. During operation, a tool arm and/or oral cavity tool and/or cartridge may be movable within the oral cavity to identify positions of teeth and other oral structures or to clean, dispense, repair and/or inspect the oral cavity. In the context of this disclosure, it may be understood that the terms ‘cartridge’ and ‘appliance tool’ refer to types of oral cavity tools.

In some examples, oral appliance 200 may be anchored to the head of the individual. Such anchoring may be on external portions of a head, such as cheeks, chin, nose, mentolabial sulcus, mandible and other such places where an external device may be secured to be relatively motionless with respect to the oral cavity of the individual. In the example of FIG. 1, such anchoring may be via upper mouth anchor 218 held by one or more upper mouth anchor holders 222 and lower mouth anchor 217 held by one or more lower mouth anchor holders 221.

Lower mouth anchor 217 may fit into a lower gum pocket 313 located between the lower front gums and the lower lip. Similarly, upper mouth anchor 218 may fit into an upper gum pocket located between the upper front gums and the upper lip. The mouth anchors may have their positions adjusted or be removed from oral appliance 200 by pressing two corresponding mouth anchor adjustment buttons 228 to release the clamps holding the mouth anchor in place. The mouth anchor may then be moved forward or backwards to adjust for overbite or underbite, or may be removed for cleaning, replacement or swapping for a different size or geometry.

In addition to positioning oral appliance 200 in a relatively fixed relationship to an individual's head, lower mouth anchor 217 and/or upper mouth anchor 218 may also create space for procedures or operations on the individual's teeth or gums by holding back an individual's lips and/or cheeks to reduce the danger of pinching by a portion of oral appliance 200 or oral cavity tool 229.

An adjustment knob 314 may be included in oral appliance 200 to adjust the distance between upper mouth anchor 218 and lower mouth anchor 217 in the active position. This allows oral appliance 200 to accommodate different mouth sizes, such as adults and children. Adjustment knob 314 may be of the ‘push-push’ type, whereby the button is pushed to extend it from a front housing, then rotated to adjust the mouth anchor opening distance, then pushed again to retract and lock it flush with the front housing.

Oral appliance 200 may have a tool arm 243 which may be positioned and/or rotated under control of processing circuitry to a variety of locations within the oral cavity. Tool arm 243 holds an oral cavity tool 229 which may be rotated under processing circuitry control. In the example shown in FIG. 1, the oral cavity tool 229 has a length of dental floss which is temporarily moved into and out of tooth pockets between the base of pairs of teeth 312 to remove debris and plaque from between the teeth 312.

Oral appliance 200 may have a first tank 207 containing a cleaning and/or disinfecting substance or fluid which may be routed to oral cavity tool 229 via tool arm 243. First tank 207 may be refilled by pressing a first tank hatch release button 309 to release a first tank fill hatch 311, thereby exposing a fill port for the first tank 207.

Oral appliance 200 may have a second tank containing a cleaning, flushing and/or disinfecting substance or fluid which may be routed to oral cavity tool 229 via tool arm 243. The second tank may be refilled by pressing a second tank hatch release button 308 to release a second tank fill hatch 310, thereby exposing a fill port for the second tank.

To facilitate user interaction and commands, oral appliance 200 may have an audio speaker 287 which can generate verbal prompts and tones under control of processing circuitry. Oral appliance 200 may have one or more illuminated buttons, such as an illuminated first button 285, an illuminated second button 286 and an illuminated third button 307. These buttons may contain multiple colored light sources such as LEDs and may be driven by variable current sources or digital pulse trains under processing circuitry control such that variations in color, blinking and/or intensity can be produced. These illuminated buttons may indicate various states or button options by being constantly illuminated, blinking or increasing and decreasing in brightness, such as power on or applied, power off or standby, oral cavity mapping, variations in cleaning such as flossing only, cleaning fluid only, and a combination of flossing and cleaning fluid, brushing, state of battery charge and operational fault conditions. For example, charging of batteries may be indicated by a pulsating repeated pattern. Prompting the user to press a button to begin the cleaning sequence may be indicated by an illuminated button blinking green. Since oral appliance 200 may operate other types of tools other than floss and a substance applicator, the illuminated buttons may be configured to indicate operation of such other types of tools. The illuminated buttons may be in a linear or curved pattern and may be animated by sequential operation to display lights that appear to follow each other. In some other examples, lights may alternate with each other and with variations in color.

FIG. 1 also shows a charging station 205 on which oral appliance 200 rests. The charging may transfer power wirelessly, or via electrical contacts or via a connector such as a USB-C connector.

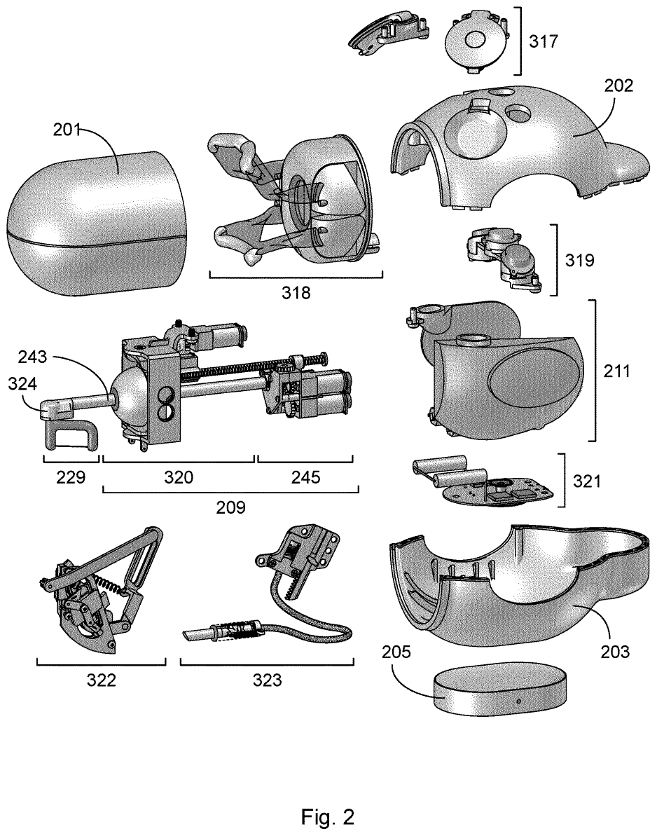

FIG. 2 shows major subsystems and other components which may be part of oral appliance 200.

A mouth anchoring assembly 318 provides for the attachment of the mouth anchors to the oral appliance and may allow for their adjustment. Mouth anchoring assembly 318 may compensate for conditions of overbite or underbite by allowing the position of the mouth anchors to be shifted inward or outward. Mouth anchoring assembly 318 may synchronize the motion of the upper and lower mouth anchors such that when the upper mouth anchor moves up, the lower mouth anchor moves down by the same angle.

Mouth anchoring assembly 318 may be attached to an upper housing 202 and a lower housing 203. Mouth anchoring assembly 318 may be attached to the housings by way of clamping via a groove and flange, fasteners, or engaging features such as interlocking tabs or clasps, adhesives, heat staking, welding, overmolding and the like.

A cover 201 may fit over mouth anchoring assembly 318 to protect the exposed mouth anchors from dust or splashes and/or improve the aesthetics of oral appliance 200 when it is not in use.

One or more hatch-hinge assemblies 317 may be attached to upper housing 202. Hatch-hinge assembly 317 may be attached to the upper housing 202 by way of fasteners, or engaging features such as interlocking tabs or clasps, clamping via a groove and flange, adhesives, heat staking, welding, and the like.

Hatch-hinge assembly 317 protects a fill port 370 for a tank to prevent dust or dirt ingress, and prevents the liquid in the tank from escaping if the oral appliance is inverted. Hatch-hinge assembly 317 may also contain one or more check valves to allow air to enter when the liquid is pumped from the tank in order to avoid creating a partial vacuum.

An illuminated switch assembly 319 may be attached to upper housing 202. Illuminated switch assembly 319 may be attached to the upper housing 202 by way of fasteners, or engaging features such as interlocking tabs or clasps, clamping via a groove and flange, adhesives, heat staking, welding, and the like.

Illuminated switch assembly 319 may have one or more switches to allow the user to control the operation of oral appliance 200. Illuminated switch assembly may also have one or more light sources such as LEDs to indicate the state of oral appliance 200 or available choices that the user can make.

Tool arm 243 may have a tool holder 324 which holds an oral cavity tool 229. Tool holder 324 may convert rotational force transmitted from a driveshaft in tool arm 243 into rotational force transmitted to oral cavity tool 229. Tool holder 324 may also provide a mechanism for retention and removal of oral cavity tool 229. Tool holder 324 may also convey fluids, gels, slurries or substances from, without limitation, a tube, tubing, hollow shaft or pipe in tool arm 243 to oral cavity tool 229.

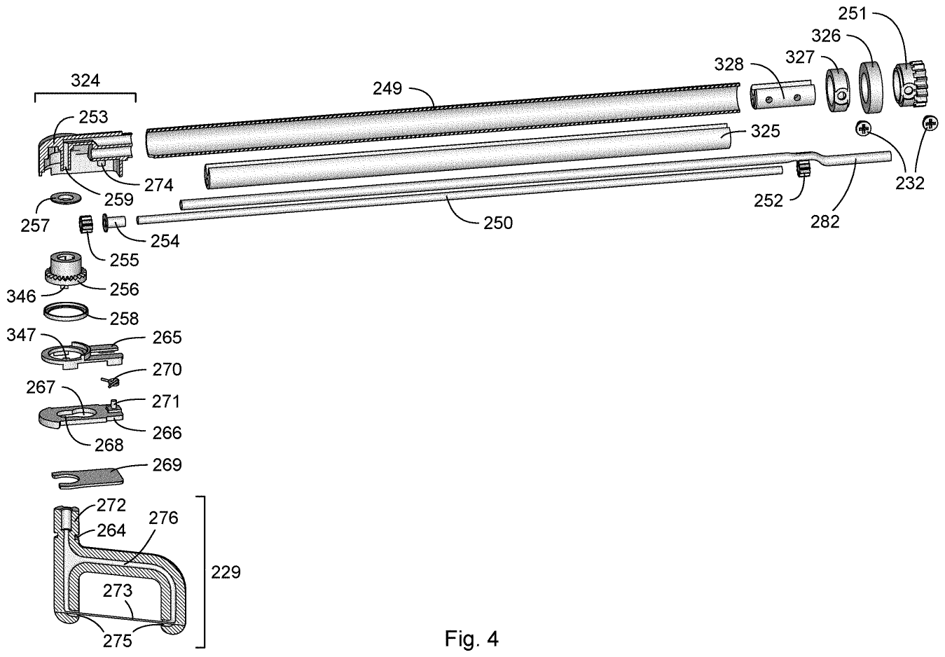

In the example shown in FIG. 4, the oral cavity tool 229 has a length of dental floss. Oral cavity tool 229 may also be other types of oral health tools, such as, without limitation, a toothbrush, pick, interdental brush, fluid jet, drill, polishing cup, mono or stereo camera, or 3D scanner head. Oral cavity tool 229 may or may not have a channel or tube to dispense a fluid, gel, slurry or substance.

Tool arm 243 may be part of a motion generator 209, which may also include a gimbal assembly 320 and a motor platform assembly 245.

Gimbal assembly 320 may be attached to the front housing by way of fasteners, or engaging features such as interlocking tabs or clasps, clamping via a groove and flange, adhesives, heat staking, welding, overmolding and the like.

Gimbal assembly 320 may contain motors or actuators which can rotate tool arm 243 horizontally and/or vertically. Gimbal assembly 320 may also contain a circular counter-torque rack along which motor platform assembly 245 can traverse to create extension/retraction motion of tool arm 243.

The gimbal assembly 320 and associated motors provide a motion generator configured to rotate and linearly move the tool. For example, as shown in FIGS. 2 to 7, gimbal assembly 320 includes gimbals 341 and 233 to rotate tool arm 243 and a bore through which tool arm 243 extends to permit tool arm 243 to be moved linearly.

Motor platform assembly 245 may contain motors or actuators to create extension/retraction motion and/or rotation of tool arm 243. Motor platform assembly 245 may also contain motors or actuators to rotate oral cavity tool 229.

Oral appliance 200 may contain a substance delivery assembly 211 which may comprise one or more tanks containing cleaning, flushing and/or disinfecting substances or fluids and the associated pumps, tubing, pipes, fittings and adaptors required to convey the substance(s) to oral cavity tool 229.

Parts of substance delivery assembly 211 may be clamped between upper housing 202 and lower housing 203 via one or more tank retention ribs 374. Alternatively or additionally, other parts of substance delivery assembly 211 may be attached to the upper and/or lower housings or components attached to the housings by way of one or more fasteners 232, or engaging features such as interlocking tabs or clasps, adhesives, sticky foam tape, heat staking, welding, and the like. It may be understood that fasteners 232 may include threaded fasteners, rivets, weldments, and other devices and mechanisms suitable for attachment of two or more pieces together.

Substance delivery assembly 211 may also contain various seals, gaskets, o-rings, sealants, clamps or hose clamps to prevent leakage or pressure loss of substance and/or ingress of substances into the housings.

Oral appliance 200 may contain a Printed circuit board (PCB) assembly 321. Printed circuit board (PCB) assembly 321 may contain processing circuitry for controlling the operation of oral appliance 200. The processing circuitry may consist of one or more processing units. If there is more than one processing unit, then one or more of the processing units may function as safety coprocessors, checking sensor and/or redundant sensor data, motor position and commanded moves to verify the proper functioning of oral appliance 200. Printed circuit board (PCB) assembly 321 may also contain one or more communication transceivers such as, without limitation, Bluetooth, WiFi, USB or RS-247.

Printed circuit board (PCB) assembly 321 may contain one or more batteries to power the processing circuitry, sensors, motors and audio components of oral appliance 200. The batteries may be non-rechargeable carbon-zinc or alkaline batteries, or rechargeable batteries such as NiCd, NiMH, Li-ion, LiFePO₄ or LiPo. Printed circuit board (PCB) assembly 321 may contain circuitry for charging the batteries, including wired or wireless charging.

Printed circuit board (PCB) assembly 321 may also contain motor driving circuitry for generating the voltage and current to control the speed and direction of one or more motors or pumps. Printed circuit board (PCB) assembly 321 may contain light source driving circuitry for generating the proper voltages and/or currents and/or pulse patterns to control the output of one or more light sources such as LEDs under processing circuitry control. Printed circuit board (PCB) assembly 321 may also contain audio driving circuitry and one or more speakers 287 or audio transducers to generate tones, verbal cues or music to assist in the operation of oral appliance 200.

Printed circuit board (PCB) assembly 321 may also contain circuitry such as linear regulators and/or buck, boost or buck-boost converters to convert the unregulated raw battery voltage into a regulated voltage so that the processing circuitry is not subject to undervoltage or overvoltage conditions, and so that the actuator and/or motor speed and torque do not significantly vary with the state of charge of the batteries.

Printed circuit board (PCB) assembly 321 may also contain circuitry to process and/or condition sensor data such as from, without limitation, magnetic or optical encoders, ultrasonic transducers, capacitive contact/touch sensors, linear variable-displacement transformers (LVDTs), linear or rotary potentiometers, strain gauges or time-of-flight (ToF) distance sensors.

Oral appliance 200 may contain a cam-based oral positioning apparatus comprised of mouth anchoring assembly 318 and cam assembly 322. Cam assembly 322 couples to mouth anchoring assembly 318 and allows the user to expand the mouth anchors from the collapsed storage position to the active position and back down to the collapsed storage position simply by repeatedly biting down on and then releasing the mouth anchors. The operation and structure of cam assembly 322 is described elsewhere in this disclosure.

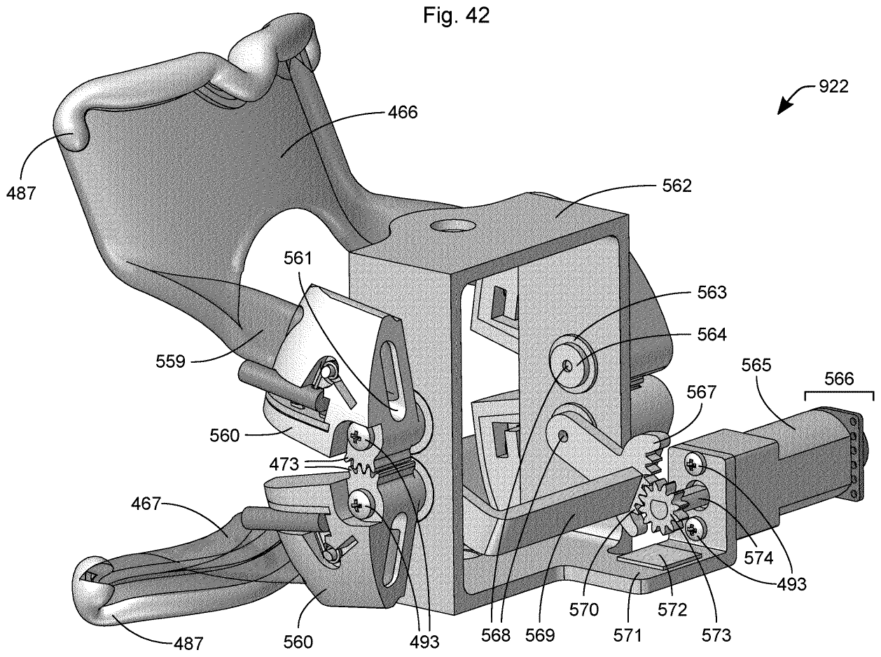

Oral appliance 200 may contain a motor-based or actuator-based oral positioning apparatus 922 comprised of mouth anchoring assembly 318 and one or more motors, rotary actuators or linear actuators as shown in FIG. 42 and described elsewhere in this disclosure.

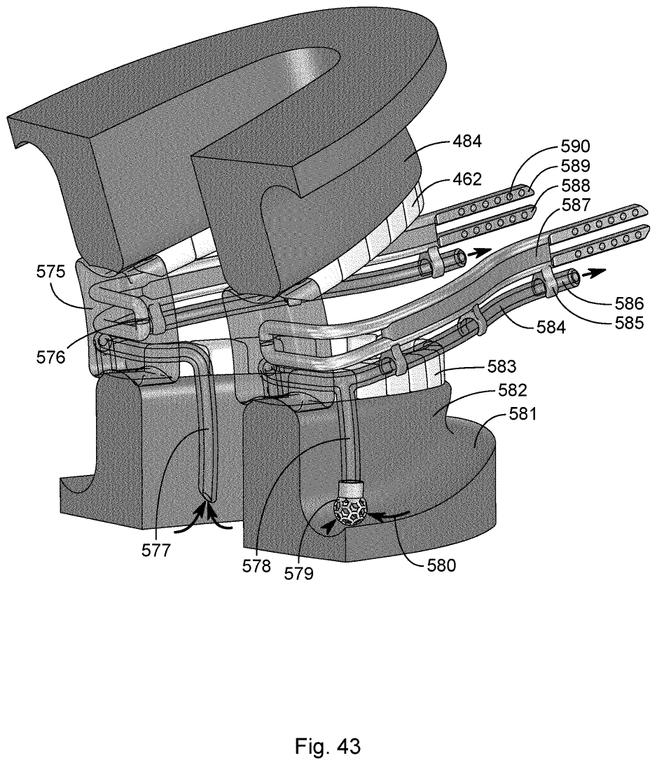

Oral appliance 200 may contain a spacer-based oral positioning apparatus 923 as shown in FIGS. 43 to 47 and described elsewhere in this disclosure.

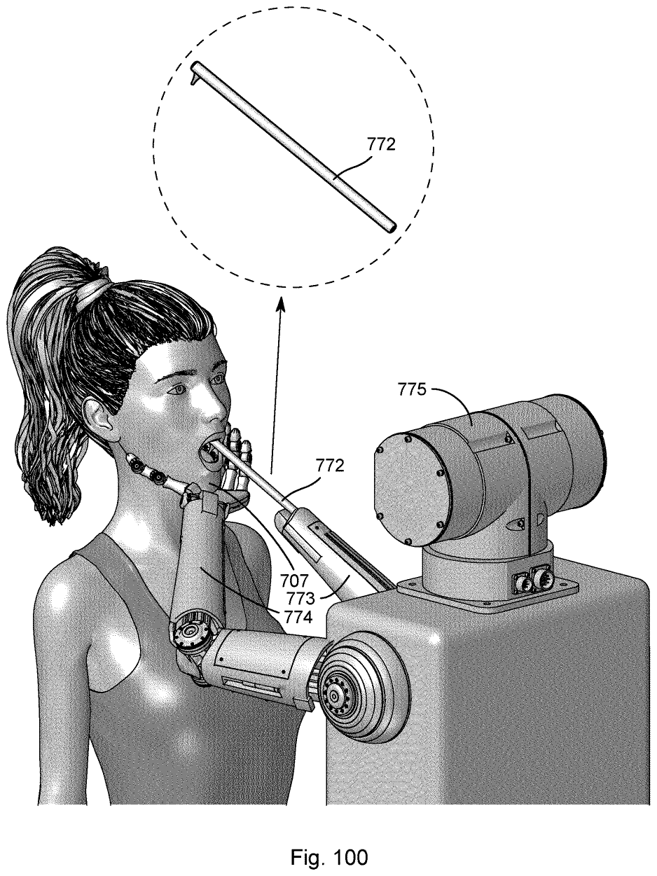

Oral appliance 200 may contain a physically constraining oral positioning apparatus as shown in FIG. 100, wherein oral or facial feature(s) physically connected to the upper and/or lower jaws may be mechanically constrained, for example, by a robotic hand cupping the lower jaw through the user's skin. More than one oral or facial feature may be constrained, for example, a robotic finger may be pressed into the mentolabial sulcus between the chin and the lower lip while simultaneously, another robotic finger may be pressed against the nasal base at the intersection of the nasal septum and the philtrum to hold the user's jaws apart. Any oral or facial feature which is tied to either the upper or lower jaw may be constrained, such as, without limitation, the upper frenulum, the upper and/or lower jaw directly, the nose, cheekbones, ears, hair, mentolabial sulcus and eyesockets. The oral positioning apparatus need not have moving parts. For example, a passive fixture may have a chin cup or divot for constraining the chin connected to a flange that presses against the septal cartilage to hold the jaws apart. The passive fixture may also have a connecting member to attach it to an oral appliance.

Cam assembly 322 may also have sensors such as microswitches or electrical contacts to detect when the mouth anchors are in the collapsed storage position or the active position. These sensors allow for the possibility of activating the cleaning sequence without requiring the user to press a button, simply by biting down, releasing, then biting down again on the mouth anchors to place the cam assembly into the active position. These sensors also permit a hands-free emergency stop function by detecting if the user opens their mouth during the cleaning sequence and terminating or pausing the operation of the device.

Oral appliance 200 may contain a cam adjustment assembly 323. Cam adjustment assembly 323 adjusts the vertical distance between the mouth anchors in the active position by changing the location of the pivot point for cam assembly 322. By changing the mouth anchor opening width, oral appliance 200 can accommodate a variety of mouth sizes, for example children and adults. The operation and structure of cam adjustment assembly 323 is described elsewhere in this disclosure.

Cam adjustment assembly 323 may have an adjustment knob, which may be of the ‘push-push’ type, whereby the button is pushed to extend it from the front housing, then rotated to adjust the mouth anchor opening distance, then pushed again to retract and lock it flush with the front housing. Cam adjustment assembly 323 may also have an overrun clutch so that excessively turning the adjustment knob won't harm the cam or cam adjustment mechanisms. Cam adjustment assembly 323 may also have seals or o-rings to prevent or reduce liquid ingress into the housings.

Oral appliance 200 may also include a charging station 205 on which lower housing 203 rests. The charging may transfer power wirelessly, via electrical contacts or via a connector such as a USB-C connector.

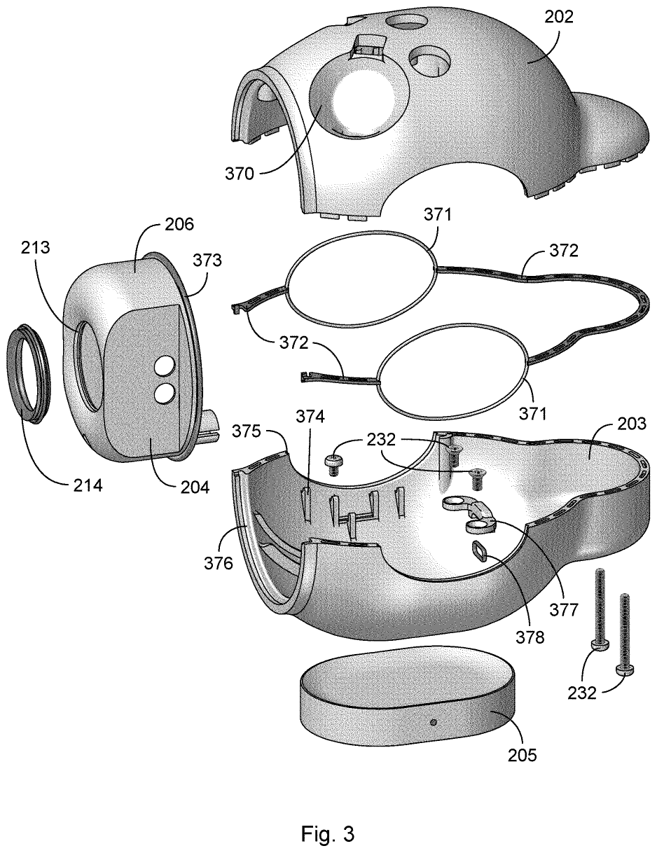

Referring to FIG. 3, oral appliance 200 may include an upper housing 202, a lower housing 203, and a front housing 204. Oral appliance 200 may also include a detachable cover 201 and may include a charging station 205 on which lower housing 203 rests.

Upper housing 202 and lower housing 203 may be attached to each other by way of fasteners 232, or engaging features such as interlocking tabs or clasps, adhesives, heat staking, welding, and the like. Front housing 204 may be clamped between upper housing 202 and lower housing 203. Alternatively or additionally, front housing 204 may be attached to the upper and/or lower housings by way of fasteners 232, or engaging features such as interlocking tabs or clasps, adhesives, heat staking, welding, and the like.

Oral appliance 200 may be sealed to reduce the intrusion of moisture, dirt or other substances. Upper housing 202 and lower housing 203 may have seals or gaskets to prevent or reduce liquid ingress into oral appliance 200, such as one or more side o-rings 371 or one or more housing seals 372. Side o-ring 371 may fit into an side o-ring groove 375 to seal the upper and lower housings against a first tank 207 or a second tank 208. Tanks may be clamped to the upper and/or lower housings via tank retention ribs 374 and/or attached with fasteners 232, adhesives or other methods. Front housing 204 may be sealed to upper housing 202 and lower housing 203 via a front o-ring 373 which may fit into a front o-ring groove 376 in upper housing 202 and lower housing 203. As described further hereinbelow, motion generator 209 may include a tool arm 243 that may protrude through an opening 213 formed in front housing 204. A shield seal 214 may be formed or attached around a periphery of opening 213. Shield seal 214 may be constructed of, without limitation, plastic, rubber or an elastomeric material. A shield 215 may be positioned within front housing 204 in contact with shield seal 214. Shield 215 may be positioned to contact shield seal 214 and may be biased by gimbal assembly 320 to maintain contact with shield seal 214 as the tool arm 243 moves by action of gimbal assembly 320. The contact of shield 215 and shield seal 214 may form a wiping action to reduce the ingress of contaminates into oral appliance 200.

Front housing 204 may include a peripheral surface 206 and, in some examples, a cover which slides over and contains sufficient friction with respect to peripheral surface 206 to maintain engagement with peripheral surface 206. Alternatively, the cover may be fixed to front housing 204 or other portions of the assembled housing by way of fasteners, including integral threads on an interior periphery of the cover.

A PCB assembly may be attached to lower housing 203 by way of fasteners 232, or engaging features such as interlocking tabs or clasps, adhesives, heat staking, welding, and the like.

The PCB assembly may have a power and/or data connector such as USB-C. To prevent or reduce liquid ingress into the housings, the USB-C connector may be sealed with an o-ring 378 and clamped to lower housing 203 via a clamp 377.

FIG. 4 shows an exploded view of tool arm 243. Tool arm 243 may include a rigid tube 249 and may include a tool rotation driveshaft 250 positioned internal to rigid tube 249. Tool rotation driveshaft 250 may be configured to rotate oral cavity tool 229 along a second axis that extends along a direction that may be perpendicular to the rotational axis of tool rotation driveshaft 250.

Rigid tube 249 may enclose a driveshaft guide 325 which may constrain tool rotation driveshaft 250 from twisting due to torque forces applied to tool rotation driveshaft 250. Tool rotation driveshaft 250 may be solid or hollow to transport a substance or fluid either directly or via a pipe, tube or tubing inside the hollow driveshaft.

Positioned on a proximate or near end of rigid tube 249, which is the end nearest to motor platform assembly 245, may be an arm rotation spur gear 251. Arm rotation spur gear 251 may be fixedly attached to rigid tube 249, via one or more fasteners 232 which may protrude through holes in arm rotation spur gear 251 and rigid tube 249 and may engage threads in a driveshaft support 328, such that rotational movement of arm rotation spur gear 251 causes rigid tube 249 to rotate. Rotation of arm rotation spur gear 251 may drive rigid tube 249, which may cause rotation of oral cavity tool 229 about the longitudinal axis of rigid tube 249.

Rigid tube 249 may also be attached to a ball bearing 326 via one or more fasteners 232 which may protrude through holes in a bearing clamp 327 and rigid tube 249 and may engage threads in driveshaft support 328. Ball bearing 326 allows free rotation of rigid tube 249, but constrains axial motion due to being clamped between bearing clamp 327 and arm rotation spur gear 251, which may both fixed to rigid tube 249 via holes in rigid tube 249 and attachment to driveshaft support 328.

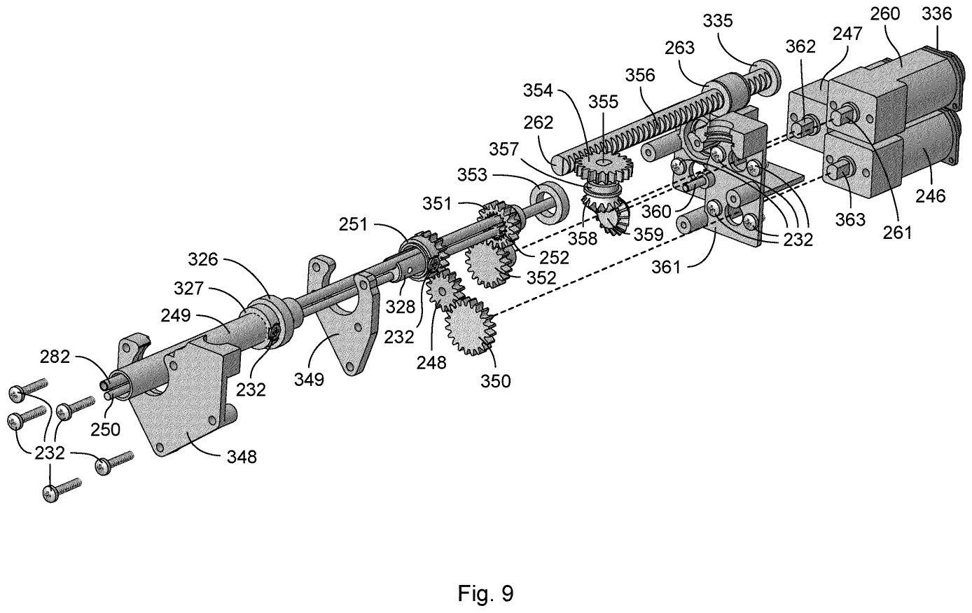

Positioned on a proximate end of tool rotation driveshaft 250 may be a spur gear 252. Spur gear 252 may be fixedly attached to tool rotation driveshaft 250 such that rotational movement of spur gear 252 causes tool rotation driveshaft 250 to rotate. With reference to FIG. 9, a tool rotation motor 247 may include a tool rotation motor output shaft 362 on which may be fixedly positioned a tool rotation motor gear 352. Tool rotation motor gear 352 may mesh with the exterior teeth of a tool rotation ring gear 351, which may be pressed into or otherwise attached to a ball bearing 353 thereby allowing free rotation of tool rotation ring gear 351. When tool rotation ring gear 351 is driven by tool rotation motor gear 352, the internal teeth mesh with and rotate spur gear 252, which rotationally drives tool rotation driveshaft 250.

Tool rotation driveshaft 250 may have a connector, fitting, adapter, coupler or other means to couple to the output of tool rotation motor 247 or may be permanently bonded to the output of tool rotation motor 247, for example by welding or permanent adhesives. Tool rotation driveshaft 250 may be connected to and driven by a tool rotation motor 247, which may have a gearbox to reduce the raw speed of the motor and increase its torque. Tool rotation motor 247 may have an optical or magnetic encoder assembly 336 to monitor the angular position of the motor, which in conjunction with a processing unit controlling the driving voltage and/or current to the motor, may position oral cavity tool 229 to a desired angle. Each of rigid tube 249 and tool rotation driveshaft 250 may rotate independently of each other under the action of an arm rotation motor 246 and a tool rotation motor 247, respectively.

Optical or magnetic encoders, such as optical or magnetic encoder assembly 336 may act as a sensor indicating the tool or probe is at the position of a surface of the oral cavity. It may act as a sensor by indicating the corresponding motor is not moving during a time period when the corresponding motor is being controlled to move. This indicates that the movement of the motor is being opposed, which means that there is a surface of the oral cavity blocking the movement of tool arm 243 in the direction in which the motor is designed to move tool arm 243. The output of the encoders indicating the rotation and linear position of the tool arm 243 when one of the encoders indicates movement of the arm is blocked, defines values indicating the location and orientation of a surface of the oral cavity. Sets of these values may be stored in computer memory as a map of surfaces of an oral cavity. For simplicity, these values for the encoders may be referred to as a location. In practice, the system may be configured to adjust locations stored in memory depending upon variations in the spatial extent of whatever tool or probe, if any, is attached to tool arm 243 to account for the spatial extent of the particular tool or probe attached to tool arm 243, relative to location values obtained using a different tool or probe attached to tool arm 243.

Tool arm 243 may include a tool holder 324. Tool holder 324 may be fixedly attached to rigid tube 249, and rotation of rigid tube 249 may cause rotation of tool holder 324. Rotation of tool holder 324 may be around the central axis of rigid tube 249, or an offset axis of rigid tube 249. Tool holder 324 may include a tool support head 253. Tool rotation driveshaft 250 may extend into tool support head 253. Tool holder 324 may include a driveshaft seal 254 to help prevent liquid ingress into rigid tube 249. Tool rotation driveshaft 250 may extend through and may be supported by driveshaft seal 254 and/or the walls of tool support head 253. Tool rotation driveshaft 250 may include a gear 255 that is fixedly attached to tool rotation driveshaft 250 such that gear 255 is rotationally driven when tool rotation driveshaft 250 is rotated. A rotating tool holder 256 may be positioned within tool holder 324, which may be perpendicular to the longitudinal axis of tool rotation driveshaft 250. Gear 255 may be a spur gear, a bevel gear, a worm gear, a spiral bevel gear, a hypoid gear or other type of gear which permits the off-axis transfer of rotational torque. Rotating tool holder 256 may have an integral crown gear, bevel gear, worm wheel, a spiral bevel gear, a hypoid gear or other type of gear which permits the off-axis transfer of rotational torque. Alternatively, linear motion may be provided down rigid tube 249, for example, by a linear motor, which may be coupled to a pushrod, which then may rotate rotating tool holder 256 via a lever arm or crankshaft. Gear 255 may mesh with and drive the integral gear of rotating tool holder 256. Rotating tool holder 256 may have an upper seal 257 to help prevent substance leaks and loss of substance pressure, which may be positioned on a nipple 259 which may be formed integrally with tool support head 253. Rotating tool holder 256 may also have a lower seal 258, which may fit around rotating tool holder 256 to help prevent substance leaks and loss of substance pressure.

Tool rotation motor 247 may drive tool rotation driveshaft 250, which may then drive gear 255. Gear 255 may then drive rotating tool holder 256. Oral cavity tool 229 may have a connector 272, which may fit into a recess formed in the interior of rotating tool holder 256, and which may contact an upper surface of rotating tool holder 256 and/or the edge of upper seal 257, and may be frictionally engaged with splines formed in the walls of rotating tool holder 256. Accordingly, rotation of rotating tool holder 256 may cause rotation of oral cavity tool 229 at an axis which may be at a perpendicular angle to the central axis of tool arm 243, or an acute or oblique angle as in the case of bevel gears or a variable angle as in the case of an input spur gear driving a face gear which then drives an output spur gear, where the output spur gear orientation is controlled by a fixed or movable holder.

Oral cavity tool 229 may have a connector 272 that extends into tool holder 324 to frictionally engage with rotating tool holder 256 such that rotation of rotating tool holder 256 rotates oral cavity tool 229. Connector 272 may be “keyed” to be oriented in rotating tool holder 256 in only one orientation. Connector 272 may have an asymmetric pattern or design that mates with a complementary pattern or design in rotating tool holder 256.

Connector 272 may have one or more flats, splines, protrusions, grooves, depressions, polygons or other geometrical features for conveying rotational torque configured to connect to an actuator in a direction of an axis and to receive a rotational force around the axis, and a member that extends in a lengthwise direction, the member including or coupled to an oral cavity tool, wherein the rotational force applied to connector 272 causes the member to rotate relative to the axis.

Oral cavity tool 229 may include a retention feature 264 such as, without limitation, a groove, flange snap, clasp or hook, to retain the tool in the rotating tool holder 256 while permitting rotation. Tool holder 324 may include a rotating tool holder retainer 265 that maintains the position of upper seal 257, rotating tool holder 256, and lower seal 258 within tool holder 324. Rotating tool holder 256 may have a calibration feature such as a tang, tab or pin 346, and rotating tool holder retainer 265 may also have a tang, pin, tab or stop 347 serving as a calibration stop such that when the calibration pin 346 of rotating tool holder 256 contacts the calibration stop 347 of rotating tool holder retainer 265, oral cavity tool 229 is at a known rotation angle. Processing circuitry can then use the angle provided by the optical or magnetic encoder assembly 336 in order to position oral cavity tool 229 at a specified angle relative to tool arm 243.

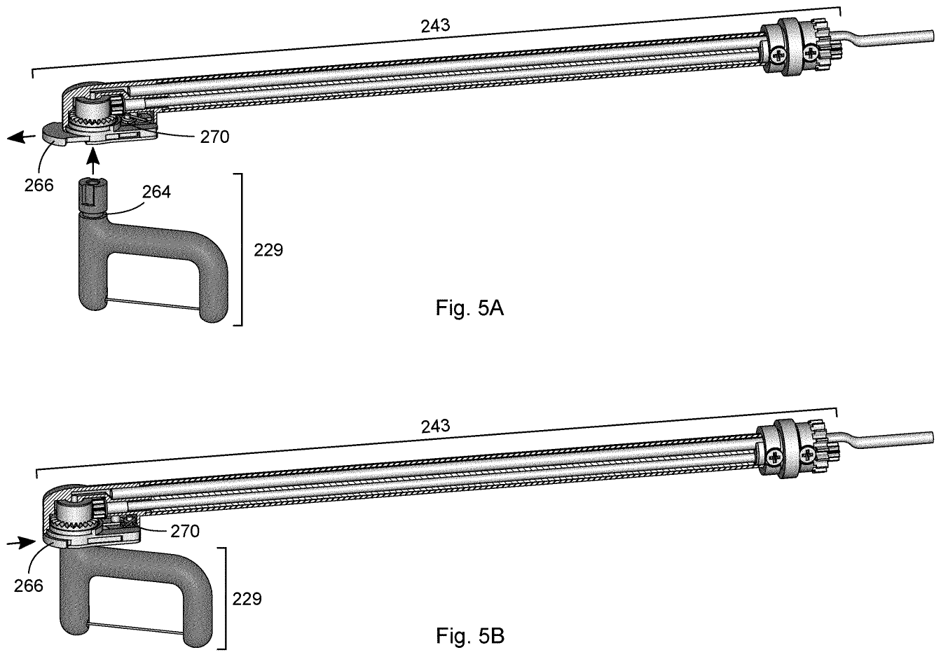

Tool holder 324 may also include a locking slide 266 that has a first position, shown in FIG. 5A where oral cavity tool 229 may be inserted through a hole 267 formed in locking slide 266, and a second position, shown in FIG. 5B, where edges of a slot 268 formed in locking slide 266 engage a retention feature 264, thereby retaining oral cavity tool 229 within tool holder 324. A torsion spring 270 positioned on a pin 271 formed on locking slide 266 may provide a bias against a plurality of posts 274 formed on or secured to tool support head 253 to keep locking slide 266 in the position that maintains oral cavity tool 229 within tool holder 324.

A retainer 269 which may be pressed into, welded, glued or otherwise secured to tool support head 253 may retain the internal elements of tool holder 324 within tool holder 324.

Tool arm 243 may have a tool arm substance tube 282, a tool holder 324 having one or more substance channels, and one or more exit orifices such as a nipple 259. Oral cavity tool 229 may have a connector 272 which may mate with and accept a substance from nipple 259, one or more substance channels 276 and one or more output orifices 275. Alternatively, oral cavity tool 229 may lack substance channels 276 and/or output orifices 275.

Tool arm substance tube 282 may extend from the proximate end of tool arm 243 to a distal end of tool arm 243. Tool arm substance tube 282 may be formed of, without limitation, a plastic, rubber, metal, or composite substance such as carbon fiber. Tool arm substance tube 282 may be positioned in and seal to a receiving recess formed in tool support head 253. A first substance channel may extend from the receiving recess. A second substance channel may intersect the first substance channel 276 and may extend approximately perpendicular to the first substance flow passage. Approximately perpendicular is in a range of plus or minus 200 degrees from perpendicular. However, the intersection of the first substance channel 276 and the second substance channel are not limited to a particular orientation with respect to each other. Alternatively, there may be only one substance channel and it may have a curve or bend. The second substance flow passage may connect to a nipple 259 which may mate with connector 272 of oral cavity tool 229 allowing for a substance flow into one or more substance channels 276 and then on to one or more orifices 275.

Substance jets from one or more orifices 275 may then impinge on a length of dental floss 273 to remove food debris and kill bacteria to minimize carryover from one tooth pocket to another tooth pocket. Alternatively or additionally, substance jets from one or more orifices 275 may impinge upon an individual's teeth and/or gums and/or tooth pockets for cleaning, disinfecting or massaging purposes.

Oral cavity tool 229 may include two legs or extensions that extend from connector 272. The legs or extensions may be spaced apart from each other at a distal end thereof, and join together at a proximate end that may also be a distal end of connector 272. The spacing of the legs or extensions may form a gap that is greater than a maximum expected width of any human tooth.

Oral cavity tool 229 may include two integral tools for operating in the individual's oral cavity.

First, dental floss 273 may be integrally molded or attached to the legs or extensions and may extend across the gap. During manufacturing of oral cavity tool 229, dental floss 273 may be held under tension to maintain a preload on dental floss 273 until the oral cavity tool body, which in some examples is formed of plastic, solidifies during a molding process. Alternatively or additionally, dental floss 273 may be tensioned after a molding process and secured with a ball or other deformation created by compressing, punching, softening or melting the material of dental floss 273, or with a knot.

Second, oral cavity tool 229 may include one or more substance channels 276 that may extend from connector 272, which may interface with a substance flow passage formed in tool support head 253, into one or both of the legs or extensions. The legs or extensions may include one or more outlet orifices 275 that may be connected to a substance inlet formed in connector 272.

Any or all of the output orifices 275 may be generally coaxial with dental floss 273. It may be understood that in the context of this disclosure that generally coaxial may be, for example, within 15 degrees of parallel, and within 3 millimeters. Furthermore, dental floss 273 may be offset a predetermined amount such that a larger space is provided to one side of dental floss 273 than to an opposite side. Such a configuration may have more substance flow to the side having the larger space, which may be advantageous in certain situations such as providing greater substance flow to the individual's gums or tooth pocket.

Alternatively or additionally, one or more of the output orifices 275 may be non-coaxial with dental floss 273. For example, an orifice may have a “fan” spray pattern and may be perpendicular to dental floss 273 so as to clean the entire length of dental floss.

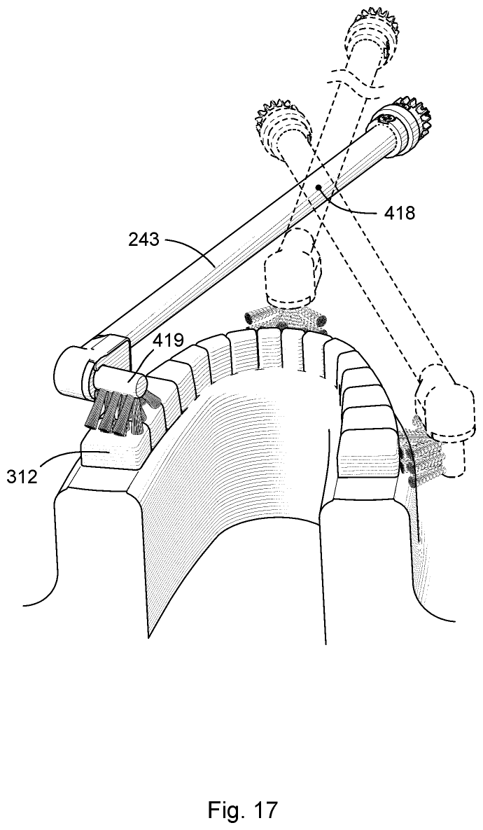

Alternatively, oral cavity tool 229 may be equipped with bristles for brushing teeth, as shown in FIG. 17, with or without integral substance channels for conveying substances like liquid or gel toothpaste.

FIGS. 5A and 5B show a procedure for inserting an oral cavity tool 229 into tool arm 243. Locking slide 266, which is normally held in a closed position by torsion spring 270 is pulled by the user such that oral cavity tool 229 may be inserted through a hole 267 formed in locking slide 266, as shown in FIG. 4. After oral cavity tool 229 is inserted into tool holder 324, the user may release locking slide 266, and torsion spring 270 may drive the edges of a slot 268 formed in locking slide 266 into retention feature 264 of oral cavity tool 229, thereby retaining oral cavity tool 229 within tool holder 324. Torsion spring 270 positioned on a pin 271 formed on locking slide 266 may provide a bias against a plurality of posts 274 formed on or secured to tool support head 253 to keep locking slide 266 in the position that maintains oral cavity tool 229 within tool holder 324.

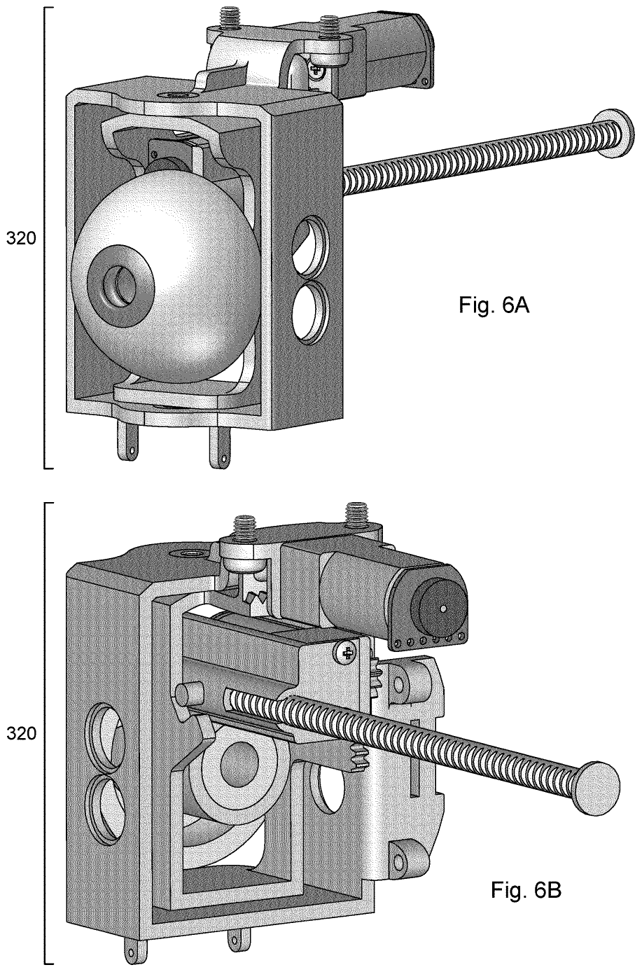

FIG. 6A shows a right-front perspective view of gimbal assembly 320.

FIG. 6B shows a right-rear perspective view of gimbal assembly 320.

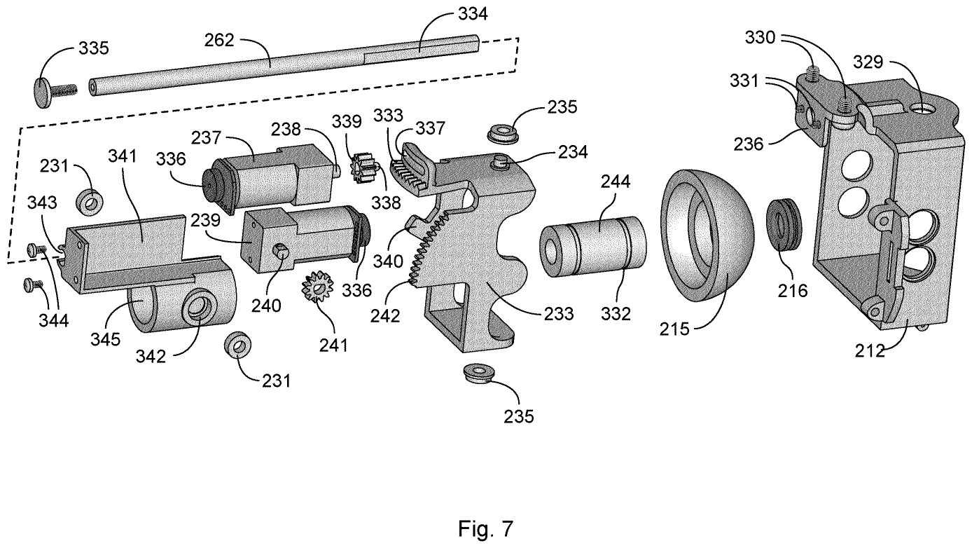

As shown in FIG. 7, a gimbal assembly 320 may include a motion generator support frame 212. Motion generator support frame 212 may be attached to front housing 204 with one or more fasteners 330, thus anchoring motion generator 209 to the housing of oral appliance 200. In another example, motion generator 209 may be affixed to one or more of front housing 204, upper housing 202 or lower housing 203 via, without limitation, adhesives, clamping or injection molding around motion generator support frame 212. As such, any forces generated by oral cavity tool 229 acting against features of the oral cavity when driven by motion generator 209 may be transmitted to the housing of oral appliance 200.

Gimbal assembly 320 may include a horizontal gimbal 233 and may include a vertical gimbal 341 positioned within horizontal gimbal 233. Alternatively, horizontal gimbal 233 may be connected to vertical gimbal 341 to permit both horizontal and vertical motion of tool arm 243, but not enclose it. Instead of a vertical gimbal positioned within a horizontal gimbal, a horizontal gimbal may be positioned within or connected to a vertical gimbal. Vertical gimbal 341 may have a bore 345 into which may snugly fit a linear bearing or bushing 244. Linear bearing or bushing 244 may be secured to vertical gimbal 341 via one or more circlips or e-clips which fit into one or more grooves 332 in linear bearing or bushing 244, or via press-fit, adhesives, fasteners or other methods. Rigid tube 249 of tool arm 243 may snugly fit into the bore of linear bearing or bushing 244. As such, linear bearing or bushing 244, acting through tool arm 243, converts horizontal rotation of horizontal gimbal 233 and vertical rotation of vertical gimbal 341 into horizontal and vertical motion, respectively, of oral cavity tool 229. Linear bearing or bushing 244 also may support and permit linear in-out and rotational motion of tool arm 243. Alternatively, in the absence of a bearing or bushing, a bore in vertical gimbal 341 may directly transfer the horizontal and vertical rotation to tool arm 243.

Gimbal assembly 320 may include a shield 215 to reduce substance ingress into oral appliance 200. Shield 215 may be attached to linear bearing or bushing 244 and/or vertical gimbal 341 via press-fit, adhesives, fasteners or other methods. Shield 215 may have a hemispherical shape which may conform to a complementary shaped shield seal 214 around a periphery of opening 213 in front housing 204. The contact of shield 215 and shield seal 214 may form a wiping action to reduce the ingress of contaminates into oral appliance 200.

Shield 215 may have a tool arm seal 216 which may be constructed of, without limitation, plastic, rubber or an elastomeric material and which may contact rigid tube 249 of tool arm 243 to reduce substance ingress into linear bearing or bushing 244 via a wiping action.

Horizontal gimbal 233 may include two horizontal pivot pins 234 positioned on a first, vertical axis. Motion generator support frame 212 may include two horizontal bearing recesses 329 into which may be positioned two horizontal gimbal bearings 235. Horizontal pivot pins 234 may be positioned within horizontal gimbal bearings 235, which may be supported by horizontal bearing recesses 329. Upper horizontal pivot pin 234 may be coaxial with a lower horizontal pivot pin and may form a central axis of rotation for horizontal gimbal 233 that results in left-right horizontal movement of oral cavity tool 229 when driven by a horizontal motion motor 237.

Motion generator support frame 212 may have a horizontal motor mounting plate 236. A horizontal motion motor 237 may be attached to horizontal motor mounting plate 236 with one or more fasteners 331. Horizontal motion motor 237 having a horizontal motor output shaft 238 may be fixedly attached to a spur gear 339 via press-fit, adhesives, fasteners or other methods.

Spur gear 339 may have a retention pin 338 which may fit into a retention groove 337. Retention groove 337 may be an integral part of horizontal gimbal 233 or may be a separate part fixedly attached to horizontal gimbal 233 via press-fit, adhesives, fasteners or other methods. Retention pin 338 and retention groove 337 constrain spur gear 339 to a relatively fixed distance from a crown gear 333 and thus resist skipping gear teeth if the force transmitted by horizontal gimbal 233 to oral cavity tool 229 is excessive, for example, due to oral cavity tool 229 hitting a fixed obstruction in the oral cavity. Relatively fixed distance in this context is plus or minus 1 millimeter from the nominal distance between the axis of spur gear 339 to the median plane of the teeth of crown gear 333 or whatever distance doesn't skip teeth and/or introduce excessive slop, jitter or backlash into the horizontal motion.

Spur gear 339 may mesh with a crown gear 333 which may be part of horizontal gimbal 233. Crown gear 333 may be an integral part of horizontal gimbal 233 or may be a separate part fixedly attached to horizontal gimbal 233 via press-fit, adhesives, fasteners or other methods. When horizontal motion motor 237 is actuated by processing circuitry, horizontal motion motor 237 may rotate horizontal motor output shaft 238 coupled to spur gear 339 meshed with crown gear 333 which may rotate horizontal gimbal 233 about a vertical axis that passes through horizontal pivot pins 234 and ball bearings 235. The rotation of horizontal gimbal 233 causes tool arm 243 to rotate right or left thereby causing oral cavity tool 229 to move right or left. Horizontal motion motor 237 may have an optical or magnetic encoder assembly 336 to monitor the position of the motor, which in conjunction with a processing unit controlling the driving voltage and/or current to the motor, may position oral cavity tool 229 to a desired left or right position within the oral cavity.

Vertical gimbal 341 may include two vertical bearing recesses 342 into which may be positioned two vertical gimbal bearings 231. Horizontal gimbal 233 may include two vertical pivot pins positioned on a second, horizontal axis. Vertical pivot pins on horizontal gimbal 233 may be positioned within vertical gimbal bearings 231, which may be supported by vertical bearing recesses 342. Vertical gimbal 341 may be configured to rotate about the horizontal axis running through the center of vertical gimbal bearings 231, that results in up-down vertical movement of oral cavity tool 229 when driven by a vertical motion motor 239.

Vertical motion motor 239 may be attached to vertical gimbal 341 with one or more fasteners 344. Vertical motion motor 239 having a vertical motor output shaft 240 may be fixedly attached to a spur gear 241 via press-fit, adhesives, fasteners or other methods.

Spur gear 241 may mesh with a gimbal gear 242 which may be part of horizontal gimbal 233. Gimbal gear 242 may be an integral part of horizontal gimbal 233 or may be a separate part fixedly attached to horizontal gimbal 233 via press-fit, adhesives, fasteners or other methods. When vertical motion motor 239 is actuated by processing circuitry, vertical motion motor 239 rotates vertical motor output shaft 240 coupled to spur gear 241 meshed with gimbal gear 242 which rotates vertical gimbal 341 about a horizontal axis that passes through vertical gimbal bearings 231. The rotation of vertical gimbal 341 causes tool arm 243 to rotate up or down thereby causing oral cavity tool 229 to move up or down. Vertical motion motor 239 may have an optical or magnetic encoder assembly 336 to monitor the position of the motor, which in conjunction with a processing unit controlling the driving voltage and/or current to the motor, may position oral cavity tool 229 to a desired up or down position within the oral cavity.

In order to calibrate the gimbal(s) to known position, horizontal gimbal 233 and/or vertical gimbal 341 may have one or more holes, tabs or flanges which may permit or block a beam generated from a light source such as, without limitation, an LED, lamp, or laser. The presence or absence of light may then be detected by an optical detector such as, without limitation, a phototransistor, photodiode or photocell. The respective motor or actuator may then be commanded to move until the beam is present or absent, thereby establishing a known positional reference. Alternatively or additionally, other types of sensors such as Hall effect sensors in combination with a source of magnetic flux (i.e. a magnetic encoder), inductive sensors or a mechanical calibration stop may be used to establish a known positional reference. In the case of a mechanical stop, the processing circuitry may command a movement speed which will not damage the motor or actuator when it encounters a hard stop, and then may monitor the output of an optical or magnetic encoder assembly 336 on a motor, or a linear sensor such as, without limitation, an ultrasonic ranger, Time-of-Flight sensor, linear potentiometer or glass scales, or a rotary sensor such as a potentiometer until the encoder and/or sensor no longer indicates movement.

Vertical gimbal 341 may include a circular counter-torque rack 262 that may extend from a circular counter-torque rack pocket 343 in vertical gimbal 341. Circular counter-torque rack 262 may have a flat 334 with a corresponding flat on circular counter-torque rack pocket 343 such that circular counter-torque rack 262 may have a fixed orientation relative to vertical gimbal 341. Circular counter-torque rack 262 may be attached to circular counter-torque rack pocket 343 via press-fit, adhesives, fasteners or other methods.

With additional reference to FIG. 9, circular counter-torque rack 262 may extend into a linear bearing or bushing 263 which may be a part of motor platform assembly 245. When arm rotation motor 246 is actuated to rotate tool arm 243, the rotation exerts torque on motor platform assembly 245 which would normally cause it to rotate. Circular counter-torque rack 262 prevents the rotation of motor platform assembly 245. When an extension/retraction motor 260 is actuated to rotate an extension/retraction pinion spur gear 354, the rotation pulls or pushes motor platform assembly 245, which slides along circular counter-torque rack 262. The movement of motor platform assembly 245 moves tool arm 243 with it, such that tool arm 243 slides through linear bearing or bushing 244, either extending or retracting tool arm 243 relative to vertical gimbal 341. When oral appliance 200 is positioned adjacent to the individual's oral cavity, extension or retraction of tool arm 243 moves oral cavity tool 229, deeper or less deep into the individual's oral cavity.

Circular counter-torque rack 262 may be attached to an endstop 335 with a greater diameter than the bore of linear bearing or bushing 263 attached to motor platform assembly 245 in order to prevent motor platform assembly 245 from travelling past the end of circular counter-torque rack 262 in case of a hardware or software fault. Endstop 335 may also be used as a calibration stop to establish a known extension/retraction position of tool arm 243 by the processing circuitry commanding an extension speed which will not damage extension/retraction motor 260 when it encounters a hard stop, and then monitoring the output of optical or magnetic encoder assembly 336 on extension/retraction motor 260 or another linear sensor such as an ultrasonic ranger, Time-of-Flight sensor, linear potentiometer or glass scales until it no longer indicates extension movement.

Alternatively, another type of positioning mechanism may be used other than gimbals, such as a ball joint. As an example, tool arm 243 may pass through a tunnel in a ball made of or coated with a low-friction material such as PTFE captured in a complementary joint, thereby allowing tool arm 243 to rotate left-right, up-down and around the central axis of tool arm 243, as well as linearly move in-out. A plurality of linear actuators may be attached to a frame which also supports the complementary joint, and may have the movable ends of the actuators attached to the distal end of tool arm 243 (i.e. the end furthest from tool holder 324). The ends of the actuators may be flexibly or rotatably coupled to tool arm 243, such as, without limitation, ball-and-socket, fork-and-ball, Cardan or magnetic joints, rod end bearings, helical or elastomeric couplings to permit tool arm 243 to assume varying orientations while still being attached to and driven by the actuators. Alternatively, one or more of the joints may restrict the degrees of freedom, such as a hinge, or universal, prismatic or revolute joint. Similarly, the stationary ends of the actuators may be rotatably anchored to a support frame using, for example, the same types of joints specified above. Three linear actuators, for example at 222 degree angles between them, can position tool arm 243, and by extension, tool holder 324 at a variety of positions and depths. Similarly, four or more linear actuators may be used.

Tool arm 243 may also be rotatably coupled to an actuator or motor so as to permit rotation of tool arm 243. This may be a motor or servo directly coupled to tool arm 243 or via an indirect coupling such as through a rod and a universal or constant-velocity joint. Alternatively, tool holder 324 rather than tool arm 243 may be rotated, for example, via a motor mounted to the proximal (tool) end of tool arm 243 and connected to tool holder 324. Alternatively, tool holder 324 and/or oral cavity tool 229 may be rotated by one or more motors attached to one or more actuators, either directly or via an intermediate member such as a motor support platform, without a tool arm. As such, tool arm 243, and/or tool holder 324 may be driven to a variety of positions, orientations and rotations.

As another alternative, tool holder 324 may be directly or indirectly driven by actuators or motors without a tool arm 243. For example, tool holder 324 may be flexibly or rotatably connected to one or more linear actuators using, for example, the same types of joints specified above. Alternatively, tool holder 324 may be connected to one or more motors or actuators via guy wires, such that actuation of the motor or actuator takes up a length of wire from an attached spool, thereby pulling tool holder 324 in that direction.

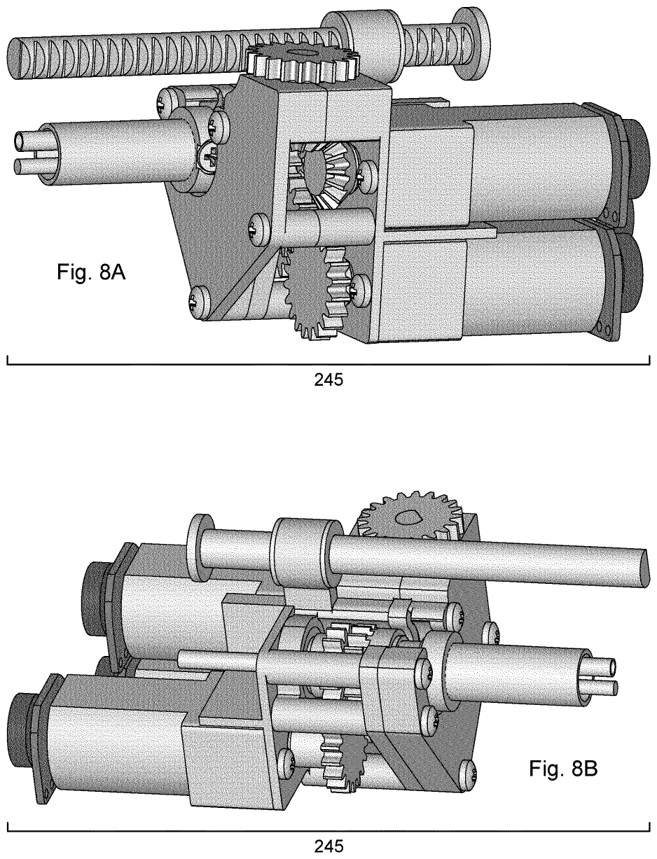

FIG. 8A shows a right perspective view of motor platform assembly 245.

FIG. 8B shows a left perspective view of motor platform assembly 245.

As shown in FIG. 9, a motor platform assembly 245 may consist of a motor support platform 361, to which may be attached an arm rotation motor 246, a tool rotation motor 247, and an extension/retraction motor 260 via one or more fasteners 232, press-fit, adhesives or other methods. Actuation of arm rotation motor 246 via processing circuitry may cause tool arm 243 to rotate around an axis lengthwise down the center of rigid tube 249. Actuation of tool rotation motor 247 via processing circuitry may cause oral cavity tool 229 to rotate around an axis lengthwise down the center of rotating tool holder 256. Actuation of extension/retraction motor 260 via processing circuitry may cause extension or retraction of tool arm 243 which moves oral cavity tool 229, deeper or less deep into the individual's oral cavity.

When arm rotation motor 246 is actuated to rotate tool arm 243, the rotation exerts torque on motor platform assembly 245 which would normally cause it to rotate. A motor support platform 361 may be fixedly attached to a linear bearing or bushing 263 which surrounds and may slide along a circular counter-torque rack 262. Torque applied to motor platform assembly 245 is transferred via linear bearing or bushing 263 to circular counter-torque rack 262 which prevents the rotation of motor platform assembly 245.

Motor platform assembly 245 may be connected to tool arm 243 via a ball bearing 326. With regards to the attachment of ball bearing 326 to motor platform assembly 245, the outer race of ball bearing 326 may be clamped between a front tube bearing clamp 348 and a rear tube bearing clamp 349, both of which may be fixedly attached to motor support platform 361 with fasteners 232. With regards to the attachment of ball bearing 326 to tool arm 243, the inner race of ball bearing 326 may be clamped between a bearing clamp 327 and an arm rotation spur gear 251, both of which may be fixedly attached to rigid tube 249 via fasteners 232 through holes in a rigid tube 249 to threads in a driveshaft support 328. In this way, tool arm 243 may freely rotate relative to motor platform assembly 245 due to ball bearing 326, but tool arm 243 and motor platform assembly 245 are fixedly attached with regards to linear motion due to ball bearing 326 being clamped to both.

Arm rotation motor 246 includes an arm rotation motor output shaft 363 on which may be fixedly positioned an arm rotation motor gear 350. Arm rotation motor gear 350 may mesh with an arm rotation intermediate gear 248 which may be mounted to and rotate about an arm rotation intermediate gear axle 360. Arm rotation intermediate gear axle 360 may be fixedly attached to motor support platform 361 via press-fit, adhesives, fasteners or other methods. Arm rotation intermediate gear 248 may then mesh with an arm rotation spur gear 251 to drive rigid tube 249, which may cause rotation of oral cavity tool 229 about the longitudinal axis of rigid tube 249 when arm rotation motor 246 is activated by processing circuitry. Arm rotation motor 246 may have an optical or magnetic encoder assembly 336 to monitor the angular position of the motor, which in conjunction with a processing unit controlling the driving voltage and/or current to the motor, may rotate tool arm 243 to a desired angle relative to motor platform assembly 245. Since motor platform assembly 245 has a fixed rotation angle relative to vertical gimbal 341 due to circular counter-torque rack 262, this also would result in a desired angle of tool arm 243 relative to vertical gimbal 341.

Tool rotation motor 247 may include a tool rotation motor output shaft 362 on which may be fixedly positioned a tool rotation motor gear 352. Tool rotation motor gear 352 may mesh with the exterior teeth of a tool rotation ring gear 351, which may be pressed into or otherwise attached to a ball bearing 353 thereby allowing free rotation of tool rotation ring gear 351. The outer race of ball bearing 353 may be pressed into a recess of motor support platform 361 or otherwise fixedly attached to motor support platform 361. When tool rotation ring gear 351 is driven by tool rotation motor gear 352, the internal teeth mesh with and rotate a spur gear 252, which rotationally drives a tool rotation driveshaft 250. With additional reference to FIG. 4, tool rotation driveshaft 250 may then drive gear 255. Gear 255 may then drive rotating tool holder 256. Oral cavity tool 229 may have a connector 272, which may fit into a recess formed in the interior of rotating tool holder 256, and may be frictionally engaged with splines formed in the walls of rotating tool holder 256. Accordingly, actuation of tool rotation motor 247 may cause rotation of oral cavity tool 229 relative to the longitudinal axis of tool arm 243. Tool rotation motor 247 may have an optical or magnetic encoder assembly 336 to monitor the angular position of the motor, which in conjunction with a processing unit controlling the driving voltage and/or current to the motor, may position oral cavity tool 229 to a desired angle relative to the longitudinal axis of tool arm 243.

Rigid tube 249 may also enclose a tool arm substance tube 282 for transporting a substance such as, without limitation, water, mouthwash or fluoride rinse to oral cavity tool 229. Tool arm substance tube 282 may pass through the interior of tool rotation ring gear 351 and ball bearing 353 and may have a crimp and/or bend to avoid collision with spur gear 252, as may be seen in FIG. 4.

Extension/retraction motor 260 includes an extension/retraction motor output shaft 261 on which may be fixedly positioned an extension/retraction motor bevel gear 359. Extension/retraction motor bevel gear 359 may mesh with an extension/retraction intermediate bevel gear 358 to convert the horizontal rotation of extension/retraction motor output shaft 261 into vertical rotation. Extension/retraction intermediate bevel gear 358 is fixedly attached to an extension/retraction driveshaft 355, which is fixedly attached to an extension/retraction pinion spur gear 354. Extension/retraction driveshaft 355 may pass through a flanged ball bearing 357, whose flange and outer race may be clamped between front tube bearing clamp 348 and motor support platform 361, and whose inner race may be clamped between extension/retraction intermediate bevel gear 358 and extension/retraction pinion spur gear 354. This allows transmission of rotary motion from extension/retraction intermediate bevel gear 358 to extension/retraction pinion spur gear 354, but prevents linear movement of the gears.

Extension/retraction pinion spur gear 354 may mesh with teeth 356 of circular counter-torque rack 262. Thus, when extension/retraction motor 260 is actuated to rotate extension/retraction pinion spur gear 354, the rotation pulls or pushes motor platform assembly 245, which slides along circular counter-torque rack 262 via linear bearing or bushing 263. Circular counter-torque rack 262 may be attached to an endstop 335 with a greater diameter than the bore of linear bearing or bushing 263 in order to prevent motor platform assembly 245 from travelling past the end of circular counter-torque rack 262 in case of a hardware or software fault.

The movement of motor platform assembly 245 moves tool arm 243 with it. Accordingly, when oral appliance 200 is positioned adjacent to the individual's oral cavity, actuation of extension/retraction motor 260 may cause extension or retraction of tool arm 243 which may then move oral cavity tool 229, deeper or less deep into the individual's oral cavity. Extension/retraction motor 260 may have an optical or magnetic encoder assembly 336 to monitor the angular position of the motor, which in conjunction with a processing unit controlling the driving voltage and/or current to the motor, may position oral cavity tool 229 to a desired depth in the individual's oral cavity.

With additional reference to FIG. 7, motion generator 209 may include five motors or actuators for longitudinal or in-out movement of oral cavity tool 229, up-down movement of oral cavity tool 229, left-right movement of oral cavity tool 229, rotation of oral cavity tool 229 about a first axis that may extend along tool arm 243, and rotation of oral cavity tool 229 about a second axis that may be perpendicular to the first axis.

In order to calibrate the motors or actuators to known positions, any moveable component between a motor or actuator and oral cavity tool 229 may have one or more holes, tabs or flanges which may permit or block a beam generated from a light source such as, without limitation, an LED, lamp, or laser. The presence or absence of light may then be detected by an optical detector such as, without limitation, a phototransistor, photodiode or photocell. The respective motor or actuator may then be commanded to move until the beam is present or absent, thereby establishing a known positional reference. Alternatively or additionally, other types of sensors such as Hall effect sensors in combination with a source of magnetic flux (i.e. a magnetic encoder), inductive sensors or a mechanical calibration stop may be used to establish a known positional reference. In the case of a mechanical stop, the processing circuitry may command a movement speed which will not damage the motor or actuator when it encounters a hard stop, and then may monitor the output of an optical or magnetic encoder assembly 336 on a motor, a linear sensor such as an ultrasonic ranger, Time-of-Flight sensor, linear potentiometer or glass scales, or a rotary sensor such as a potentiometer until the encoder and/or sensor no longer indicates movement.

As may be apparent from the description herein, the motors or actuators of motion generator 209 are able to move oral cavity tool 229 at a plurality of angles within the individual's oral cavity. For example, the motors or actuators may move oral cavity tool 229, which may carry dental floss 273, to be aligned with any gap between any two teeth anywhere in the individual's oral cavity, on the left, right, top or bottom side of the individual's oral cavity. Additionally, with reference to FIG. 17, the motors or actuators of motion generator 209 may allow a brushing cartridge 419 to be positioned and rotated along any and all teeth surfaces to clean them.

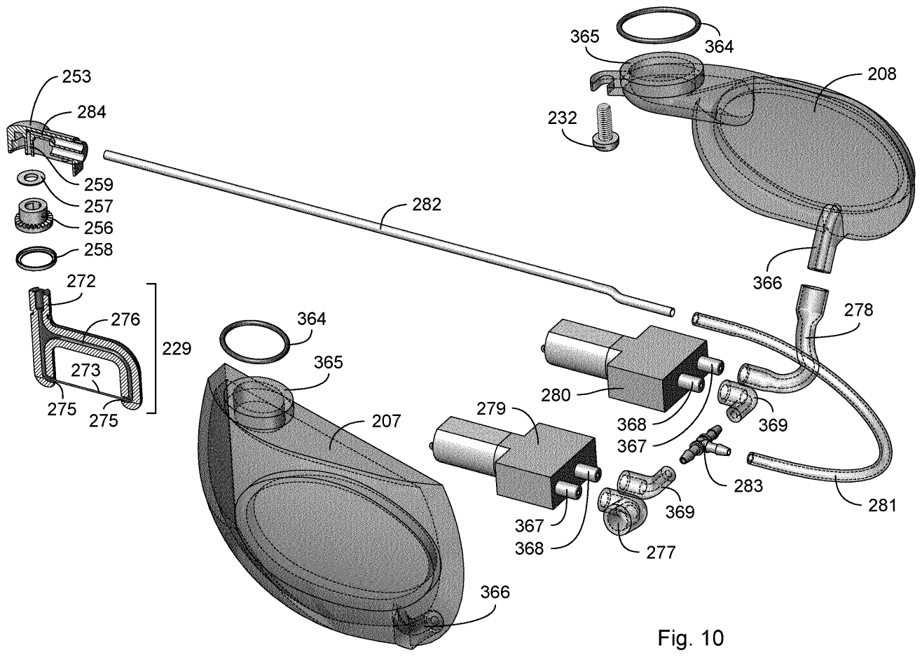

Referring to FIG. 10, a substance delivery assembly 211 may provide substances or fluids from a first tank 207 and/or a second tank 208 to oral cavity tool 229. Substance delivery assembly 211 may include one or more of the following: a first tank 207 having an output port 366, a second tank 208 having an output port 366, a tool support head 253 having a nipple 259, a first tank-to-pump tube 277, a second tank-to-pump tube 278, a first pump 279 having an input port 367 and an output port 368, a second pump 280 having a input port 367 and a output port 368, a length of tubing 281, a tool arm substance tube 282, a Y- or T-adapter 283, an o-ring 364, a fill opening 365, and a pump-to-tee connecting tube 369. Substance delivery assembly 211 may also include one or more check valves to prevent backflow of substance.

First tank 207, which normally contains a cleaning and/or disinfecting substance such as water, mouthwash, sugar alcohols like sorbitol or chlorhexidine gluconate, may have a fill opening 365 to permit adding a substance to the tank, and may have an o-ring 364 to seal fill opening 365 to upper housing 202. First tank 207 may have an output port 366. First tank-to-pump tube 277, which may be made of a flexible plastic or rubber, may connect the first tank output port 366 to the input port 367 of first pump 279. The output port 368 of first pump 279 may then be connected to a Y- or T-adapter 283, via a pump-to-tee connecting tube 369. Thus, when first pump 279 is activated, a substance may be drawn from first tank 207 and pumped to Y- or T-adapter 283.

Second tank 208, which normally may contain a cleaning and/or flushing substance, such as water, may have a fill opening 365 to permit adding a substance to the tank, and may have an o-ring 364 to seal fill opening 365 to upper housing 202. Second tank 208 may also be secured to one or more housings via one or more fasteners 232. Second tank 208 may have an output port 366. Second tank-to-pump tube 278, which may be made of a flexible plastic or rubber, may connect the second tank output port 366 to the input port 367 of second pump 280. The output port 368 of second pump 280 may then be connected to a Y- or T-adapter 283, via a pump-to-tee connecting tube 369. Thus, when second pump 280 is activated, a substance may be drawn from first tank 207 and pumped to Y- or T-adapter 283.

Each of first tank 207 and second tank 208 may be formed of a transparent or translucent plastic. Such transparency or translucency may help an individual determine a remaining quantity of substance within the interior of the tanks. Transparency may also be advantageous in viewing the operation and condition of elements positioned within the interior of oral appliance 200, including viewing of such operation by the individual.

Each of first pump 279 and second pump 280 may be independently or simultaneously electrically actuated or operated by processing circuitry, powered by a battery pack or other power source such as an AC to DC adapter. Processing circuitry may independently adjust the speed and/or power of each pump, for example by utilizing pulse-width modulation or by altering the voltage and/or current supplied to the pump. If the pump is operated in a pulsed mode with a low duty cycle, the pump motor may be provided with a voltage in excess of the rated voltage in order to boost the pressure and/or flow of the pump without overheating the motor.

In some examples, each of first pump 279 and second pump 280 may be model number SC3101PW supplied by Shenzhen Skoocom Electronic Co., Ltd., of Shenzhen, Guangdong, China.

Tubing 281 may then extend from Y- or T-adapter 283 to tool arm substance tube 282, which may extend from the proximate end of tool arm 243 to a distal end of tool arm 243. Tool arm substance tube 282 may be formed of, without limitation, a plastic, rubber, metal, or composite substance such as carbon fiber. Tool arm substance tube 282 may be positioned in and seal to a receiving recess formed in tool support head 253. A substance passage 284 may extend from the receiving recess to nipple 259 of tool support head 253.

A rotating tool holder 256 may be positioned within tool support head 253. Rotating tool holder 256 may have an upper seal 257 to help prevent substance leaks and loss of substance pressure, which may be positioned on nipple 259. Nipple 259 may be formed integrally with tool support head 253. Rotating tool holder 256 may also have a lower seal 258, which may fit around rotating tool holder 256 to help prevent substance leaks and loss of substance pressure.

Oral cavity tool 229 may have a connector 272, which may fit into a recess formed in the interior of rotating tool holder 256. Connector 272 may mate with and accept a substance from nipple 259, allowing for a substance flow into one or more substance channels 276 and then on to one or more orifices 275.

Processing circuitry may actuate first pump 279, which may pull or draw cleaning and/or disinfecting substance from first tank 207. A substance, which may be a fluid, may flow from first tank 207 through output port 366, to first tank-to-pump tube 277, into input port 367 of first pump 279, then out of output port 368, through pump-to-tee connecting tube 369 to Y- or T-adapter 283, through tubing 281 to tool arm substance tube 282, through substance passage 284 to nipple 259 in tool support head 253. The substance then may flow into connector 272 of oral cavity tool 229, through one or more substance channels 276 to one or more orifices 275. Substance jets from one or more orifices 275 may then impinge on a length of dental floss 273 to remove food debris and kill bacteria to minimize carryover from one tooth pocket to another tooth pocket. Alternatively or additionally, substance jets from one or more orifices 275 may impinge upon an individual's teeth and/or gums and/or tooth pockets for cleaning, disinfecting or massaging purposes.

Processing circuitry may separately actuate second pump 280, which may pull or draw a cleaning and/or flushing substance, such as water, from second tank 208. through output port 366, to second tank-to-pump tube 278, into input port 367 of second pump 280, then out of output port 368, through pump-to-tee connecting tube 369 to Y- or T-adapter 283, which then flows through the substance path described above for first pump 279 in order to flush the substance delivery assembly of cleaning and/or disinfecting substance from first tank 207.

As an alternative to a tank and pump system, oral appliance 200 may have a temporary or permanent connection to the water mains, for example, via a fitting which attaches to the output of a faucet. The fitting may be connected to tubing which then routes to oral cavity tool 229, either directly or via intermediate connections and components. An electronically or pneumatically controlled valve or solenoid may be included in the substance path, such that the substance or fluid flow can be controlled by processing circuitry, for example, to produce a jet of water to clean oral cavity tool 229, to jet into the user's tooth pocket for cleaning or to massage the user's gums.

As an alternative to a substance or fluidics system for cleaning oral cavity tool 229, one or more cleaning members such as, without limitation, brushes, wipers and/or sponges may be used. The brushes, wipers and/or sponges may be stationary or they may be moving and/or rotating. As one example, a stationary brush, wiper or sponge may be mounted to the housing of oral appliance 200, such that oral cavity tool 229 may be moved and/or rotated to brush against it, via commands from the processing circuitry to motion generator 209. As another example, a moving or rotating brush, wiper or sponge powered by a motor, either directly or via a cam or other translating mechanism, may be mounted to the housing of oral appliance 200 or to tool holder 324 or to rigid tube 249. Oral cavity tool 229 may then be moved and/or rotated to contact the cleaning member(s), via commands from the processing circuitry to motion generator 209.

FIG. 11A shows a right-front perspective view of a mouth anchoring assembly 318.

FIG. 11B shows a right-rear perspective view of a mouth anchoring assembly 318.

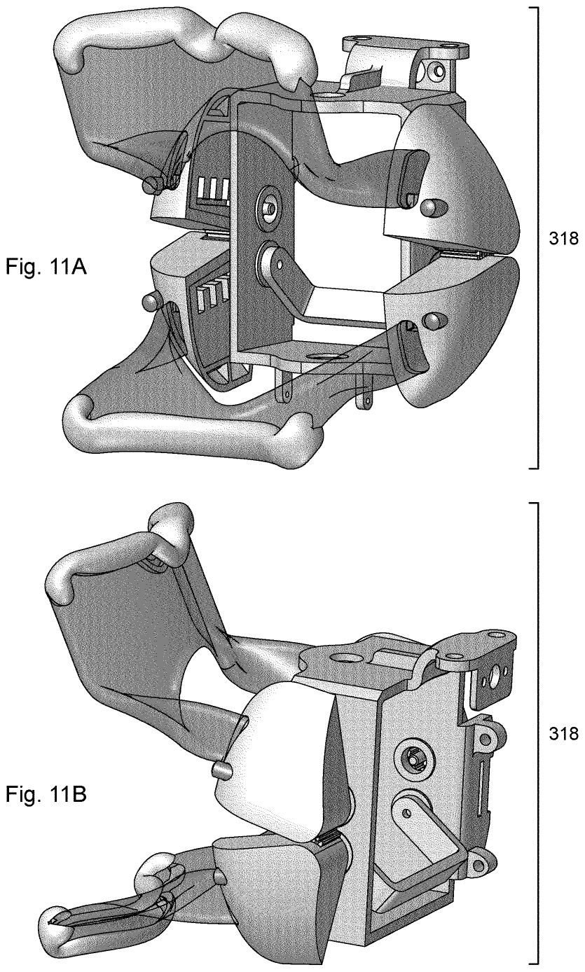

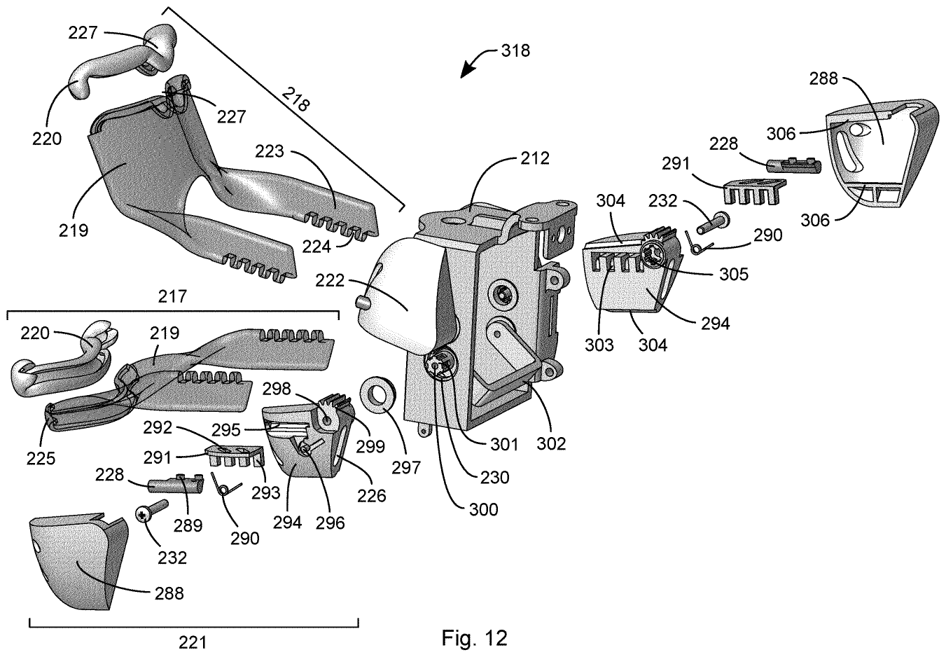

FIG. 12 shows an exploded view of a mouth anchoring assembly 318.

Upper mouth anchor 218 and/or lower mouth anchor 217 may include a mouth anchor body 219 and may include a soft silicone or rubberized overmold 220 for the comfort of the user. Mouth anchor body 219 may include a mouth anchor ridge or interface 225 that may be complementary to the mouth geometry between the front gum space and the inside of the lip of the individual, as may be seen in FIG. 1. Since mouth anchor ridge or interface 225 may be positioned directly between the inner lip and gum of the individual, and since mouth anchor ridge or interface 225 and/or mouth anchor body 219 may be formed of a rigid material such as plastic or metal, upper mouth anchor 218 and/or lower mouth anchor 217 may include a soft silicone or rubberized overmold 220 positioned externally to the mouth anchor ridge or interface 225, or may surround it. Overmold 220 may thus avoid direct contact between the hard surface of mouth anchor body 219 and/or ridge or interface 225 and the sensitive gums and labial tissues of the gum pocket. Overmold 220 may be made of, without limitation, plastic, synthetic or natural rubber, silicone, fluoropolymer, thermoplastic elastomer (TPE), thermoplastic olefin (TPO) or thermoplastic vulcanizates (TPV). Mouth anchor body 219 may include one or more anchor extensions 223, and each of anchor extensions 223 may include one or more engaging holes, protrusions, recesses or notches 224. It may be understood that engaging holes, protrusions, recesses or notches 224 may be on a lower side of each anchor extension 223, as shown in FIG. 12, or may be in other locations, such as on a top and/or left and/or right side of each anchor extension 223, or in the case of holes, through anchor extension 223.

Each of lower mouth anchor holder 221 and/or upper mouth anchor holder 222 may include a hole or passageway 226 that is configured to mate with an anchor extension 223. Each mouth anchor holder 221 and 222 may include a locking plate 291 that is configured to engage with one or more of the engaging holes, protrusions, recesses or notches 224 to lock the position of lower mouth anchor 217 and upper mouth anchor 218, respectively. Each mouth anchor holder 221 and 222 may include a mouth anchor adjustment button 228 that may be pressed to release the locking plate 291 from engaging with one or more of the engaging holes, protrusions, recesses or notches 224. Accordingly, when anchor extensions 223 extend into each respective hole or passageway 226, and mouth anchor adjustment buttons 228 are released, anchor extensions 223 may be locked to lower mouth anchor holder 221 and/or upper mouth anchor holder 222.

One function of the adjustability of anchor extensions 223 with respect to lower mouth anchor holder 221 and/or upper mouth anchor holder 222 may be to provide a position of lower mouth anchor 217 and/or upper mouth anchor 218 to accommodate a variety of mouth sizes. For example, for a larger mouth, anchor extensions 223 could extend further from lower mouth anchor holder 221 and/or upper mouth anchor holder 222, thus permitting a greater amount of rotational distance of mouth anchor body 219, because anchor extensions 223 would be at a greater radial distance from a bushing or bearing 297.

Another function of the adjustability of anchor extensions 223 with respect to upper mouth anchor holder 222 and/or lower mouth anchor holder 221 may be to accommodate overbite and underbite conditions. In this instance, upper mouth anchor 218 and/or lower mouth anchor 217 may have their positions adjusted such that when oral appliance 200 is anchored to the mouth, it is centered and directly facing into the mouth and not at an angle.

To accommodate an upper frenulum of the individual, each of mouth anchor ridge or interface 225 and overmold 220 may include a notch or recess 227. For example, when mouth anchor ridge or interface 225 is positioned in an individual's mouth, the individual's upper frenulum may extend downwardly and may extend into notch or recess 227, depending on the position of the individual's upper frenulum and the position of mouth anchor ridge or interface 225 relative to the upper frenulum. Additionally, the upper frenulum of the individual may serve as a “landmark” indicating the center of the face, and by constraining it in a notch or recess 227, the device will be generally centered on the user's face. In the context of this disclosure, generally centered means within 200 millimeters of the centerline of the face.

Although rare, certain individuals may have a prominent lower frenulum, and therefore, lower mouth anchor 217 may also have a notch or recess so as to avoid pain or discomfort when placed in the user's lower gum pocket.

Motion generator support frame 212 may have a plurality of openings 230 into which one or more bushings or bearings 297 may be placed. Bushing or bearing 297 may be pressed into motion generator support frame 212 or secured via other techniques such as adhesives, fasteners or cover plates. Each lower mouth anchor holder 221 and each upper mouth anchor holder 222 may be pivotably supported by a bushing or bearing 297 such that each mouth anchor holder is able to move upwardly and downwardly on an axis running through the center of the bearing. Alternatively, holes in motion generator support frame 212 may function as a bushing directly, thus obviating the need for separate bearings or bushings 297.

Oral appliance 200 may have a cross-bar 302 which transmits force between a left lower mouth anchor holder and right lower mouth anchor holder 221 to keep the movement of both sides synchronized and prevent undue differential force being exerted on lower mouth anchor 217 and possibly bending it. Cross-bar 302 may have one or more splines 301 with one or more threaded holes 300 in the center, which may pass through bushings or bearings 297. Spline 301 may mate with a complementary splined recess 305 which may be part of mouth anchor holder body 294, thereby rotationally locking the pair together. Alternatively, mouth anchor holder body 294 may have a spline and cross-bar 302 may have a splined recess. Mouth anchor holder body 294 may be secured to cross-bar 302 via fastener 232 which may pass through a non-threaded clearance hole 298 and mate with threaded hole 300.

Mouth anchor holder body 294 may have a plurality of gear teeth 299 which mate with the corresponding gear teeth of the opposing mouth anchor holder thereby causing synchronized rotation between the two such that when upper mouth anchor 218 is raised, lower mouth anchor 217 will be driven lower, or vice versa.

Lower mouth anchor holder 221 may include a locking plate 291 which may have one or more tines 293 which engage with one or more engaging holes, protrusions, recesses or notches 224 to lock the position of mouth anchor body 219. Locking plate 291 may fit into a slot 295 of mouth anchor holder body 294 and may slide inwards towards motion generator support frame 212 which may move tines 293 out of the path of engaging holes, protrusions, recesses or notches 224, thus allowing anchor extension 223 to slide freely through hole or passageway 226.

Mouth anchor adjustment button 228 may have one or more cam followers 289 which may engage with one or more cam slots 292. Cam slot 292 may be a part of locking plate 291. Mouth anchor adjustment button 228 may also have a groove into which may fit a lead of torsion spring 290. Torsion spring 290 may fit into a recess of mouth anchor holder body 294. One lead of torsion spring 290 may be constrained in a pocket of mouth anchor holder body 294 and a central hole of torsion spring 290 may fit over a protrusion 296 of said mouth anchor holder body, thereby causing the other lead to exert force on mouth anchor adjustment button 228 and causing its rest position to be extended outward.

When mouth anchor adjustment button 228 is pressed by the user, one or more of the cam followers 289 may exert force on cam slot 292. As the slots are angled, this may cause locking plate 291 to slide inward, thereby disengaging one or more tines 293 from the path of engaging holes, protrusions, recesses or notches 224. This allows anchor extension 223 to slide freely through hole or passageway 226 and thus the user can adjust the position of mouth anchor body 219 or remove it altogether.

When mouth anchor adjustment button 228 is released, a lead of torsion spring 290 may exert a force on mouth anchor adjustment button 228, thereby driving it back into its extended position. This may cause one or more of cam followers 289 to drive one or more of cam slots 292 causing locking plate 291 to slide outward until one or more of tines 293 hit a stop surface 303 of mouth anchor holder body 294.

Mouth anchor holder body 294 may have a cover 288 to protect it from splashes and liquid ingress as well as hide the internals of lower mouth anchor holder 221. Cover 288 may have one or more retention flanges 306 which may fit into one or more retention grooves 304 of mouth anchor holder body 294, thereby securing cover 288 and preventing it from falling off. Cover 288 may also constrain torsion spring 290 thereby preventing it from falling off protrusion 296.

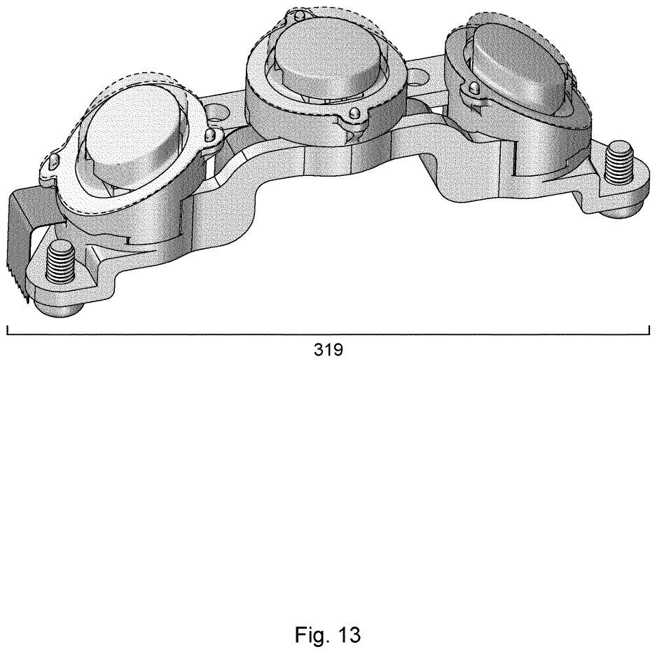

FIG. 13 shows a perspective view of an illuminated switch assembly 319, which may be used to control the operation of oral appliance 200. Illuminated switch assembly 319 may also be used to indicate various states of oral appliance 200, such as an error or charging state, or may indicate available options, such as a blinking button indicating that the user can press that button to activate a function.

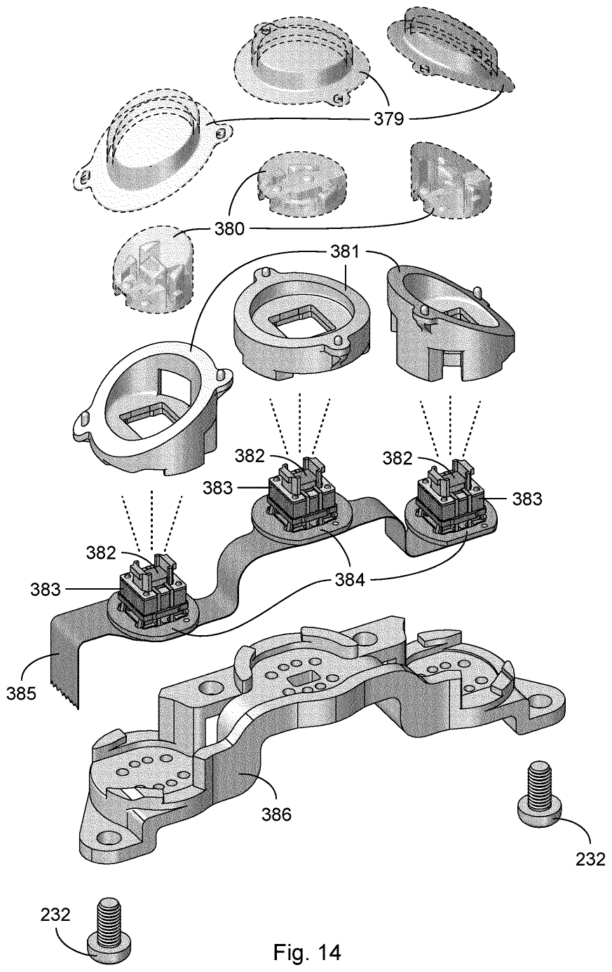

FIG. 14 shows an exploded view of illuminated switch assembly 319. Illuminated switch assembly 319 may contain one or more momentary pushbutton switches 383. Switch 383 may contain one or more LEDs 382. The LEDs 382 may be of different colors, such as red, green and blue, and may be combined to synthesize other colors. The LEDs 382 may be controlled by a processing unit such as a microprocessor 414 or a safety coprocessor 412 either directly, or through a driver such as a transistor. The driving signal for the LEDs 382 may be a switched constant current or a variable current or a digital pulse train such as pulse-width modulation (PWM), which allows for the brightness of the LEDs 382 to be controlled. By combining multiple colored LEDs 382 with brightness control, a huge range of colors may be created for various signaling purposes.

One or more switches 383 may be mounted to a flexible printed circuit (flex cable) 385. Flex cable 385 may have one or more stiffeners 384 to support and position switch 383 and distribute the forces applied to the switch when it is depressed. Flex cable 385 may convey the signals and status of one or more switches 383 to the processing circuitry and may convey the driving signals to any LEDs 382.

A switch cap 380 may fit over switch 383 in order to convert the sharp and limited area of the switch plunger into a larger and more rounded surface that is more conducive to being pressed. Switch cap 380 may be translucent in order to diffusely transmit light from one or more LEDs 382 and avoid a bright point of light which could be harsh to the user's eyes. Alternatively, switch cap 380 may be transparent.

One or more stiffeners 384 may fit into recesses in a switch support bracket 386. Switch support bracket 386 may attach to upper housing 202 via one or more fasteners 232. Alternatively or additionally, switch support bracket 386 may be attached with another attachment type such as adhesives or snap fit tabs.

One or more switch seal clamps 381 may fit over a switch 383 and into a recess on switch support bracket 386, thereby constraining switch 383 from moving laterally or upwards. Switch seal clamp 381 also may compress a flexible cap cover 379 against upper housing 202, thereby preventing liquid ingress into the housing. Switch seal clamp 381 may be transparent or translucent, so as to transmit light from one or more LEDs 382.

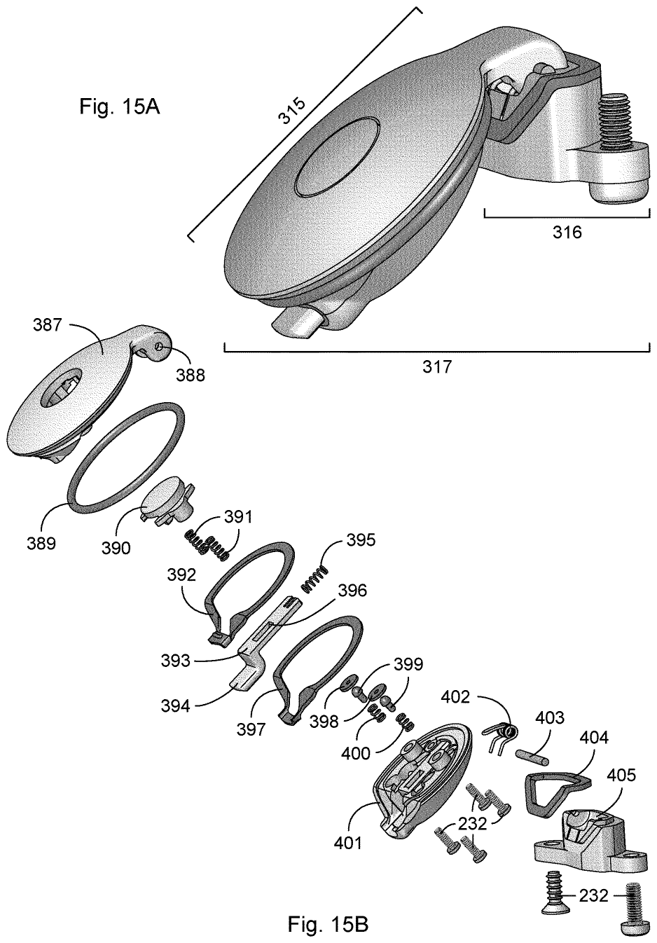

FIG. 15A shows a perspective view of a hatch-hinge assembly 317. Hatch-hinge assembly 317 may consist of a hatch assembly 315 and a hinge assembly 316. Hatch assembly 315 protects the fill port 370 for a tank to prevent dust or dirt ingress, and prevents the liquid in the tank from escaping if the oral appliance is inverted. Hatch assembly 315 may also contain one or more check valves to allow air to enter when the liquid is pumped from the tank in order to avoid creating a partial vacuum. Hinge assembly 316 may provide a pin for hatch assembly 315 to rotate upon, and a torsion spring to pop open hatch assembly 315 when a hatch release button 390 is pressed. Hinge assembly 316 may also seal to upper housing 202 to prevent moisture, liquid, dust, dirt or other contaminates from getting into oral appliance 200.

FIG. 15B shows an exploded view of hatch-hinge assembly 317. An upper hatch cover 387 and a lower hatch cover 401 may be attached with fasteners 232 and may clamp an o-ring 389 which forms a seal when pressed against the fill port of upper housing 202. This seal may prevent substance or fluid in first tank 207 or second tank 208 from escaping if oral appliance 200 is tipped or inverted. Hatch assembly 315 may have additional seals to prevent substance, fluid or contaminate ingress, such as an upper gasket 392 and/or a lower gasket 397 which may be compressed between upper hatch cover 387 and lower hatch cover 401. O-rings and gaskets may be constructed of, without limitation, a natural or synthetic rubber, a thermoplastic elastomer (TPE) a thermoplastic olefin (TPO), a plastic, a silicone or a fluoropolymer.

Hatch assembly 315 may have a hatch release button 390 which may extend through an opening in upper hatch cover 387. Hatch release button 390 may be biased with one or more compression springs 391 such that the surface of hatch release button 390 is flush with the surface of upper hatch cover 387 when not being depressed. Hatch release button 390 may have a ramp formed integrally or attached to it which contacts a complementary ramp 396 on a latch 393 such that when hatch release button 390 is pressed and moves toward the center of oral appliance 200, ramp 396 forces latch 393 to retract along a track formed by upper hatch cover 387 and lower hatch cover 401, towards pivot hole 388. Latch 393 may have a tongue 394 which may engage a lip of fill port 370, holding hatch assembly 315 flush with the surface of upper housing 202 and compressing o-ring 389 between the upper and lower hatch covers and upper housing 202 to prevent substance or fluid egress. When latch 393 retracts, tongue 394 also retracts into hatch assembly 315 thereby releasing hatch assembly 315. A torsion spring 402 which may be part of hinge assembly 316 may then exert force on upper hatch cover 387 popping hatch assembly 315 open.

When hatch release button 390 is released, one or more compression springs 391 may push hatch release button 390 flush with upper hatch cover 387. As hatch release button 390 retracts, the ramp on hatch release button 390 disengages from complementary ramp 396 on latch 393. A compression spring 395 then slides latch 393 away from pivot hole 388, thus causing tongue 394 to protrude from hatch assembly 315. When hatch assembly 315 is pressed down onto upper housing 202 to close it, tongue 394 is momentarily pressed into hatch assembly 315 as it traverses the lip of fill port 370. Once tongue 394 clears the lip of fill port 370, compression spring 395 then extends tongue 394 out of hatch assembly 315 under the lip of fill port 370, thereby keeping hatch assembly 315 closed. Upper gasket 392 and lower gasket 397 may surround tongue 394 to prevent substance or fluid ingress into hatch assembly 315.

Hatch assembly 315 may have one or more check valves which may consist of one or more of a seal 398, a plunger 399 and a compression spring 400. Seal 398 may fit into a cavity molded into upper hatch cover 387 having a central hole with a passageway leading to the exterior atmosphere. Seal 398 may also sealingly contact a cavity molded into lower hatch cover 401 having a central hole leading to the exterior of lower hatch cover 401 and thus to fill port 370 and a tank. Compression spring 400 may bias plunger 399 against seal 398, thereby preventing substance or fluid from the tank from escaping past plunger 399 to the exterior of hatch assembly 315.

During pumping of liquid from a tank, a partial vacuum may be created which may reduce the flow from the pump. In order to avoid the creation of a partial vacuum, when the pressure inside the tank is less than atmospheric pressure, plunger 399 may be pulled away from seal 398 thus allowing the passage of air from the outside of hatch assembly 315 to fill port 370 and the tank, thus equalizing the pressure and reducing or eliminating the partial vacuum.

Hinge assembly 316 may provide multiple functions: Providing a hinge pin 403 for hatch assembly 315 to rotate upon, a torsion spring 402 to pop open hatch assembly 315 when latch 393 is released, connecting hatch assembly 315 to upper housing 202, and sealing the openings in upper housing 202 against liquid and contaminate ingress.

A hinge cover 405 may attach to upper housing 202 with one or more fasteners 232. A gasket 404 and a hinge pin 403 may be clamped between hinge cover 405 and upper housing 202. Gasket 404 may seal the openings in upper housing 202 against liquid and contaminate ingress. Hinge pin 403 may pass through pivot hole 388 to provide an axis for hatch assembly 315 to rotate upon. Hinge pin 403 may also pass through the center of torsion spring 402. Torsion spring 402 may have a central loop which presses against an under surface of upper hatch cover 387 and two legs to provide counter-torque to the loop, which may fit into, and press against, grooves on hinge cover 405.

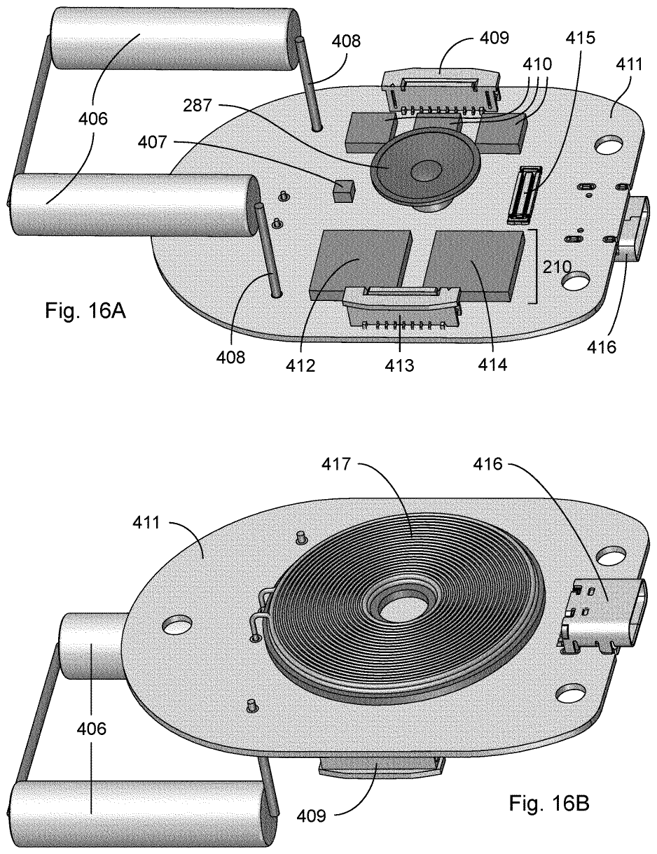

FIG. 16A shows a top perspective view of a printed circuit board (PCB) assembly 321.

FIG. 16B shows a bottom perspective view of a printed circuit board (PCB) assembly 321.

Printed circuit board (PCB) assembly 321 may include a printed circuit board (PCB) 411 to which various components are attached via soldering, connectors or mechanically. Printed circuit board (PCB) assembly 321 may contain processing circuitry 210 for controlling the operation of oral appliance 200. The processing circuitry 210 may consist of one or more processing units, such as one or more microprocessors 414. If there is more than one processing unit, then one or more of the processing units may function as safety coprocessors, such as one or more combination Bluetooth transceiver and safety coprocessors 412, which may check sensor and/or redundant sensor data and/or motor position and/or commanded moves and/or main processor(s) health and telemetry to verify the proper functioning of oral appliance 200. Printed circuit board (PCB) assembly 321 may also contain one or more communication transceivers such as Bluetooth, WiFi, USB or RS-247, for example, a combination Bluetooth transceiver and safety coprocessor 412. The communication transceivers may be wired to one or more connectors, such as a USB-C connector 416.

Printed circuit board (PCB) assembly 321 may contain one or more batteries 406 to power the processing circuitry 210, sensors, motors and audio components of oral appliance 200. The batteries 406 may be, without limitation, non-rechargeable carbon-zinc or alkaline batteries, or rechargeable batteries such as, without limitation, NiCd, NiMH, Li-ion, LiFePO₄ or LiPo. The batteries 406 may be connected in series and/or parallel with one or more wires 408.

Printed circuit board (PCB) assembly 321 may contain circuitry for charging the batteries, including wired or wireless charging. Wireless charging circuitry may include a wireless charging coil 417 and may include electronics to route and condition electrical current from wireless charging coil 417 to recharge batteries 406. Charging station 205 may include another wireless charging coil that induces current flow in wireless charging coil 417 to provide power to recharge batteries 406. Alternatively, charging station 205 may have electrical contacts or a connector such as USB-C which physically make contact with the corresponding electrical contacts or mating connector on lower housing 203 in order to transfer power to batteries 406.

Printed circuit board (PCB) assembly 321 may also contain one or more motor or actuator drivers 410 for generating the voltages and/or currents and/or pulse patterns to control the speed and/or direction of one or more motors, actuators or pumps. Printed circuit board (PCB) assembly 321 may contain light source driving circuitry for generating the proper voltages and/or currents and/or pulse patterns to control the output of one or more light sources such as LEDs under processing circuitry 210 control. Printed circuit board (PCB) assembly 321 may also contain audio driving circuitry and one or more speakers 287 or audio transducers to generate tones, verbal cues or music to assist in the operation of oral appliance 200.

Printed circuit board (PCB) assembly 321 may also contain circuitry such as linear regulators and/or buck, boost or buck-boost converters to convert the unregulated raw battery voltage or other power input such as USB or AC or DC input into a regulated voltage so that the processing circuitry 210 is not subject to undervoltage or overvoltage conditions and/or so that the motor speed and torque do not significantly vary with the state of charge of the batteries.

Printed circuit board (PCB) assembly 321 may also contain circuitry to process and/or condition sensor data such as from, without limitation, magnetic or optical encoders, ultrasonic transducers, capacitive contact/touch sensors, linear variable-displacement transformers (LVDTs), linear or rotary potentiometers, strain gauges or time-of-flight (ToF) distance sensors. Printed circuit board (PCB) assembly 321 may contain an accelerometer 407 to measure the local gravity field or vector in order to determine the orientation of oral appliance 200 and prevent or stop operation if oral appliance 200 is placed in a damaging or hazardous orientation such as upside-down.

Printed circuit board (PCB) assembly 321 may also contain one or more connectors to attach to various subsystems of oral appliance 200. For example, there may be a sensor flex cable connector 409 to receive or drive signals from various sensors such as strain gauges or microswitches. Printed circuit board (PCB) assembly 321 may have a switch assembly flex cable connector 413 to connect to illuminated switch assembly 319 to route signals to drive LEDs and to receive the status of pushbutton switches. Printed circuit board (PCB) assembly 321 may have a motor cable connector 415 to route driving voltages and currents to various motors, pumps and/or actuators, and receive position signals from various encoders attached to the motors or actuators.

Although the illustrations thus far have demonstrated the use of the oral appliance for flossing, the use of the oral appliance is not limited to flossing. FIG. 17 shows, in a composite image of three different positions, the use of oral appliance 200 for brushing teeth. A brushing cartridge 419 may have bristle clusters parallel to the axis of the tool arm 243 which may allow for greatly reduced complexity of the actuator, with the range of motion required to clean an entire mouth of teeth 312 channeled through a single pivot point 418. Pivot point 418 may be located at the intersection of axes of a pair of nested, stacked or coupled gimbals.

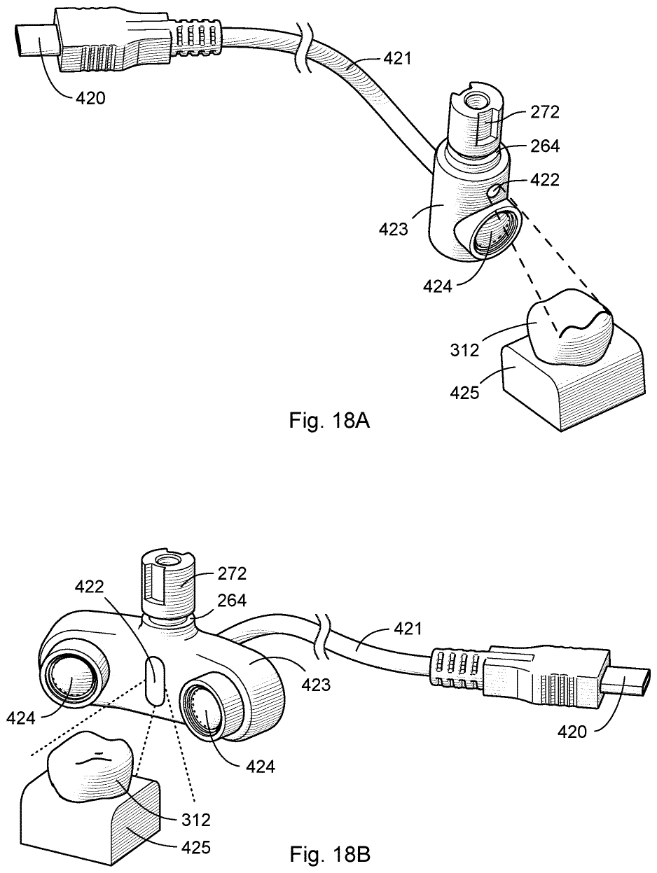

FIG. 18A shows the use of a scanner cartridge having a structured light source such as a line or LCD projector or digital light projector (DLP) and one or more cameras to generate 3D maps and/or images of the oral cavity, for example, for the construction of clear aligners for teeth. FIG. 18B shows the use of a stereo camera cartridge, for the purpose of generating 3D maps and/or images of the oral cavity, such as one or more teeth 312 and/or gums 425. Besides the use of the camera(s) to construct 3D maps, one or more cameras, as part of a 3D scanner or alone, may also be used to image the oral cavity in order to diagnose abnormalities such as cavities, disease, impacted teeth or tumors in order to determine the relative oral health of an individual.

Other modalities of 3D scanning may be used other than structured light with a camera. A camera or scanner 424 may be any device which receives data about a surface in the mouth. Besides being one or more cameras with or without a structured light source it could also be, without limitation, a time-of-flight (ToF) camera or a scanning apparatus such as LIDAR, SONAR or RADAR. An imaging and/or scanning cartridge 423 may have an illumination unit 422 to project illumination onto a surface in the mouth. Illumination unit 422 could be a simple light source, such as a filament or LED, or could be, without limitation, a smart illuminator such as programmable light, LCD projector, DLP or a laser with galvo. There may be a cable 421 and/or a connector 420 to relay signals from and/or transmit power and/or commands to the imaging and/or scanning cartridge 423. Alternatively or additionally, imaging and/or scanning cartridge 423 may have batteries and/or a wireless power receiver and/or a wireless connection such as WiFi so as not to require a cable and/or connector. Wireless power may be provided by electromagnetic, radio frequency (RF) or optical means. Imaging and/or scanning cartridge 423 may have a connector 272 and/or retention feature 264 to temporarily or permanently attach it to a tool holder or other platform.

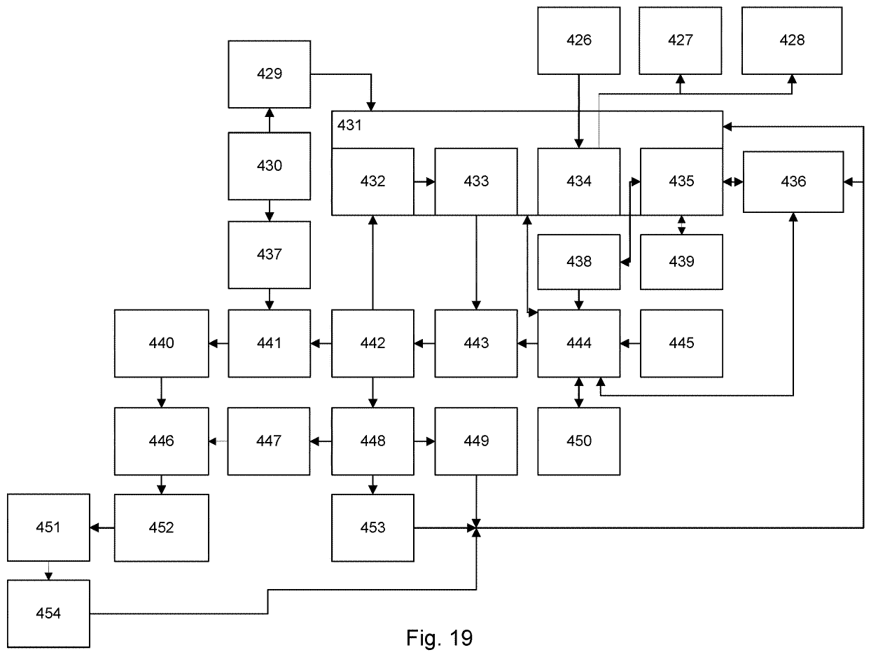

FIG. 19 shows an example connection diagram for an example oral appliance 200. One or more processors 431 may be part of processing circuitry 210. Processing circuitry 210 may also have one or more safety coprocessors 436. Processor(s) 431 and/or safety coprocessor(s) 436 may have, without limitation, non-volatile memory like Flash or EEPROM, volatile memory such as static RAM or SDRAM or storage such as a hard disk or solid-state disk. Processor(s) 431 and/or safety coprocessor(s) 436 may execute various programs, subroutines, algorithms or tasks such as a trajectory planning task 432, an actuator control task 433, a user interface task 434 and/or a communications (comms) task 435.

Oral appliance 200 may be powered via various means such as, without limitation, one or more batteries 450, a wireless charging circuit 445, an external power input such as a USB connection 438, a mains power connection or an AC/DC adapter.

Oral appliance 200 may have a power control circuit 444 for conditioning or transforming the various input power sources into the proper voltages and currents to power the processing circuitry, actuators, motors, displays, indicators, sensors, speakers and/or to charge the battery 450. Power control circuit 444 may also have circuitry to depower various subsystems of oral appliance 200 under control of processor(s) 431 and/or safety coprocessor(s) 436. For example, if safety coprocessor 436 detects a malfunction in processor 431, it may command power control circuit 444 to cycle the power to processor 431, thereby forcing a reboot and a reload of the operating program. If after a reboot, safety coprocessor 436 still detects malfunctioning operation in processor 431, it may command power control circuit 444 to permanently disconnect power from processor 431 until repairs can be made. In a similar way, if processor 431 and/or safety coprocessor 436 detects a malfunctioning actuator or motor, or an improper battery charge, the appropriate subsystem may be depowered to prevent damage or injury.

Processor 431 may run a user interface task 434. User interface task 434 may receive input from one or more of, without limitation, a button 426 or plurality of buttons such as a keyboard, a microphone, a capacitive or resistive touch digitizer or an infrared or RF remote control. User interface task 434 may also generate output for the user via, one or more of, without limitation, a visual output such as an LED or a display 427, or an audio output such as a buzzer or a speaker 428. Display 427 may be, without limitation, an LCD, OLED, DLP, CRT or LED matrix display. Processor(s) 431 and/or safety coprocessor 436 may be connected to inputs and outputs via, without limitation, individual wires, a cable with multiple wires, a printed circuit board (PCB) or printed wiring board (PWB) or flex cable traces. User interface task 434 may be as simple as setting a continuous LED status indicator or as complex as a machine-learning voice recognition algorithm, voice synthesis, audio playback, animations and/or video playback. User interface task 434 may solely use hardware within oral appliance 200, or may communicate with, accept input from and/or control external devices such as a Bluetooth-connected smartphone or Internet-connected servers.

Processor 431 may run a communications (comms) task 435 or may simply communicate via commands from the main program. Processor 431 may be connected to, without limitation, one or more safety coprocessors 436, transceivers or chips for USB or USB-C 438, transceivers or chips for Bluetooth 439, radio frequency transceivers or chips such as WiFi, Zigbee, LoRa, RFID or NFC, or optical transceivers or chips such as IrDA. The communications hardware may be a part of processor 431 or may be one or more separate chips. Processor 431 may be connected to the communications hardware with direct electrical connections or via a bus such as, without limitation, AXI, AMBA or PCI. Processor 431 may transfer and/or receive data to/from the communications hardware with protocols such as, without limitation, RS-247, SPI, I2C or I2S.

Processor 431 may run a trajectory planning task 432 which may use algorithms such as Catmull-Rom to calculate trajectories between successive locations and orientations of oral cavity tool 229. The output of trajectory planning task 432 may be fed to an actuator control task 433, which may calculate the proper voltages, currents and/or signals for one or more actuator and/or motor and/or pump drivers 443 in order to place one or more actuators or motors 448 at the desired position and/or orientation. Trajectory planning task 432 may use inputs from sensors such as, without limitation, one or more position sensors 449, current sensors 442, force sensors 453, or oral cavity tool sensors 454 to implement and/or adjust the trajectories it generates. Data from multiple sensors and/or redundant sensors may be integrated, for example, by using a Kalman filter. Current sensor 442 may be, without limitation, a shunt resistance with or without amplification, a Hall effect-based sensor (open or closed loop), magneto-resistive current sensor, fluxgate, Rogowski coil or current sense transformer. Actuator control task 433 may use one or more algorithms such as, without limitation, Proportional-Integral-Derivative control (PID), feedforward, sliding mode control, Model Predictive Control (MPC) or linear-quadratic-Gaussian control (LQG). Actuator control task 433 may obviate the need for a force or current sensor by commanding a position, then observing the output required to obtain and/or maintain that position, thus serving as a proxy force measurement. Actuator control task 433 may then transmit the signal(s) to actuator and/or motor and/or pump driver(s) 443 via, without limitation, voltages generated by a Digital-to-Analog Converter (DAC), pulse-width modulation from a timer or software-toggled input/output (I/O) pin or high-level coordinate commands transmitted with serial, parallel, I2C or SPI protocols.

Actuator and/or motor and/or pump driver 443 may be, without limitation, anything from a direct I/O pin output from processor 431 to a simple bipolar or MOSFET or IGBT transistor, to an H-bridge, to an entire closed-loop intelligent driver module. The output of actuator and/or motor and/or pump driver 443 may be monitored by various sensors such as current sensor 442, which may provide information about the torque output, status or health of the powered actuator or motor 448 or pump 441.

Actuator and/or motor and/or pump driver 443 may be connected to one or more pumps 441. Pump 441 may draw a fluid or other substance from one or more tanks 430, optionally with one or more check valves 437 in the line to prevent backflow. Tank 430 may have one or more level sensors 429 which may be connected to processor 431 to inform the user that the tank needs to be filled, or to inhibit the operation of the apparatus if the level of the substance in the tank is insufficient.

Pump 441 may distribute the substance or fluid drawn from tank 430 through one or more substance and/or fluid channels 440. Substance and/or fluid channel 440 may be, without limitation, flexible or rigid tubing, piping, ducting, channels, fittings, adapters or other substance conveyance methods known to those of ordinary skill in the art. Substance and/or fluid channel 440 may be constructed of, without limitation, plastic, synthetic or natural rubber, silicone, fluoropolymer, metal, composites such as fiberglass or carbon fiber, thermoplastic elastomer (TPE), thermoplastic olefin (TPO) or thermoplastic vulcanizates (TPV).

Substance or fluid from tank 430 may pass through substance and/or fluid channel 440 to a tool arm 446 to a tool holder 452 and then to an oral cavity tool 451. Alternatively or additionally, substance or fluid from tank 430 may pass through substance and/or fluid channel 440 to a cleaning area or station for oral cavity tool 451. The cleaning station may have one or more cleaning jets and/or brushes and/or sponges to clean oral cavity tool 451. The brushes and/or sponges may be static or motorized to remove debris from oral cavity tool 451. If the brushes and/or sponges are static, processor 431 may command one or more actuators or motors 448 to cause tool arm 446 and tool holder 452 to rub oral cavity tool 451 against the brushes and/or sponges to clean it.

Oral appliance 200 may lack a substance or fluidics system altogether, with oral cavity tool 451 either not needing cleaning, or cleaning of it may be manually performed by the user, or it may be cleaned by manipulating it to be in contact with a cleaning device such as a brush or sponge.

One or more actuators or motors 448 may have one or more position sensors 449. Position sensor 449 may be directly mounted to the actuator, for example, an optical or magnetic rotary encoder mounted to a motor, or may indirectly measure the position of the actuator, for example, via a linear variable differential transformer (LVDT) mounted to tool arm 446. Position sensor 449 may be, without limitation, one or more of magnetic or optical encoders, ultrasonic transducers, capacitive or inductive sensors, linear variable-displacement transformers (LVDTs), linear or rotary potentiometers, time-of-flight (ToF) distance sensors, glass scales or switches.

One or more actuators or motors 448 may have or be mechanically coupled to, one or more force sensors 453. Force sensor 453 may be directly measure the force of the actuator, for example, a strain gauge mounted to a motor, motor beam or motor support beam, or may indirectly measure the force of the actuator, for example, via a force-sensitive resistor (FSR) mounted to tool holder 452.

One or more actuators or motors 448 may be connected to and drive one or more gimbals 447. There may be a plurality of gimbals 447, and they may be nested, stacked or coupled so as to permit motion in more than one axis. Gimbal 447 may be tightly or slidingly coupled to a tool arm 446, such that movement of the gimbal 447 causes tool arm 446 to rotate in one or more axes.

One or more actuators or motors 448 may also be directly or indirectly coupled to tool arm 446 and/or tool holder 452 and/or oral cavity tool 451 to permit additional degrees of motion, such as extension/retraction or rotation of tool arm 446 or rotation of oral cavity tool 451.

While sensing may be accomplished by position sensors 449, current sensors 442 or force sensors 453, in some other examples one or more sensors 454 may be positioned on, for example, oral cavity tool 451, and may be used for such tasks as mapping the individual's oral cavity. Such sensor may be, without limitation, a capacitive contact/touch sensor, a force-sensitive resistor (FSR), a resistance-based contact/touch sensor, an ultrasonic transducer or transducer array, a switch or microswitch, one or more cameras, a 1D or 2D or 3D scanner or other devices configured to provide the location and/or images of hard tissues such as teeth and/or soft tissues such as gums, cheeks, uvula and/or frenulum.

Sensor 454 may be connected to processor 431 either directly, for example via a cable, or wirelessly, for example via WiFi or Bluetooth, or indirectly, for example via a smartphone or the Internet. Sensor 454 may not be connected to processor 431 at all, for example, the output from sensor 454 may go to a personal computer or a computer server. The output of sensor 454 may be encoded with a protocol such as SPI or USB and/or encrypted. Sensor 454 may assist with one or more of processor 431's tasks, for example, a capacitive contact/touch sensor or 3D scanner may assist with mapping the oral cavity.

Electrical connections between the components and/or subsystems of oral appliance 200 may be via, without limitation, individual wires, a cable with multiple wires, a wiring harness, connectors, printed circuit board (PCB) traces or printed wiring board (PWB) traces or flex cable traces. Other connections may be via optical components, for example, via emitters and receivers travelling through free space or via lightguides or fiber optics.

With reference to FIGS. 1, 3 and 14, oral appliance 200 may include an illuminated first button 285 and/or an illuminated second button 286 and/or an illuminated third button 307 which may be positioned on upper housing 202. First button 285 and/or second button 286 and/or third button 307 may be connected to processing circuitry by a flex cable 385. First button 285 and/or second button 286 and/or third button 307 may operate the functions of oral appliance 200. For example, any or all of the buttons may function as an ON button, such that when pressed, the device is powered up, for example, by energizing a MOSFET transistor to provide power to the processing circuitry, which may then latch the MOSFET on via an I/O pin. Operation of first button 285 and/or second button 286 and/or third button 307 may then operate the functions of oral appliance 200. Alternatively or additionally, oral appliance 200 may be controlled remotely, for example, via a Bluetooth connection to a smartphone or via a USB connection to a personal computer.

Illuminated first button 285 and/or illuminated second button 286 and/or illuminated third button 307 may form a menu system for operation of oral appliance 200. For example, a language selection system on the very first activation of oral appliance 200 may cause illuminated second button 286 to shine solid blue, while illuminated first button 285 and illuminated third button 285 blink green. Processing circuitry may then direct the audio circuitry to emit a voice prompt from audio speaker 287, for example in English “If English is the correct language, press and hold the middle blue button for 2 seconds.” Pressing blinking green first button 285 would then go to the previous language, and pressing blinking green third button 307 would go to the next language. Pressing and holding illuminated blue second button 286 could then store the user's preferred language choice into non-volatile memory.

One function of oral appliance 200 that may be selected by pressing one or more of the buttons may be a calibration function that maps the individual's oral cavity, which may include teeth, teeth height to gums, gum line, teeth width, position and orientation of gaps between teeth, the width of such gaps, and the like. Calibration may only need to be performed once to establish the individual's oral cavity configuration. After calibration is complete, oral appliance 200 may provide treatment or cleaning of the individual's oral cavity. Calibration may be accomplished by inserting upper mouth anchor 218 and lower mouth anchor 217 into the individual's mouth. Oral appliance 200 may then be powered by pressing second button 286 momentarily. Once powered, which may be indicated by the illumination of second button 286, or by audio output from an audio speaker 287 connected to processing circuitry, calibration may be started by pressing, or pressing and holding one of the buttons or by a verbal command relayed via a microphone connected to processing circuitry. In some other examples, calibration may be commanded by pressing both first button 285 and third button 307 at the same time. Alternatively, pressing first button 285 or third button 307 may cycle through different available functions announced audibly and verbally by audio speaker 287, which may then be activated by the user momentarily pressing or holding down second button 286.

Processing may be done locally, such as by processing circuitry in oral appliance 200 or a connected personal computer, or may be transmitted to remote servers, for example, via WiFi to the Internet, for remote processing and the results returned to the processing circuitry in oral appliance 200. For example, raw or pre-processed sensor data may be uploaded to cloud servers for processing, perhaps using machine learning techniques to identify oral cavity features, and the resulting oral cavity map downloaded and stored in oral appliance 200. As another possible example, if oral appliance 200 has a microphone, speech data may be transmitted to a remote server for processing and speech recognition, and the resulting commands relayed back to oral appliance 200 for execution.

Oral appliance 200 may perform calibration by having an initial map, which may be stored in machine-readable non-volatile memory in the processing circuitry, of the approximate location and number of human teeth. Oral appliance 200 may now use, for example, oral cavity tool 229 with dental floss installed to “feel” for the specific location and orientation of individual teeth. Feedback provided by, for example, position sensors 449 indicating no further movement when one or more actuators or motors 448 are commanded to move with low force (so as not to injure the user) may help determine where teeth, gaps between teeth, and gums are encountered.

Alternatively or additionally, one or more force sensors 453 such as strain gauges or force-sensitive resistors may be mounted to, without limitation, actuators or motors, actuator or motor mounts, beams, gimbals, tool arm 446 or tool holder 452. Feedback provided by one or more force sensors 453 may help determine where teeth, gaps between teeth, and gums are encountered. Feedback provided by one or more force sensors 453 may also provide safety features, such as cutting off the power to an actuator or motor if excessive force is detected, or if force is detected when it is not expected and vice versa, as in the case of an actuator or motor driver failure.

Alternatively or additionally, feedback provided by, for example, one or more current sensors 442 that provide current measurements from one or more actuators or motors 448 may help determine where teeth, gaps between teeth, and gums are encountered. Feedback provided by one or more current sensors 442 may also provide safety features, such as cutting off the power to an actuator or motor if excessive current is detected, or if current is detected when it is not expected and vice versa, as in the case of an actuator or motor driver failure.

The feedback from position sensors 449 and/or force sensors 453 and/or current sensors 442 may limit the position and/or orientation and/or force applied to oral cavity tool 229 by any or all of horizontal motion motor 237, vertical motion motor 239, extension/retraction motor 260, arm rotation motor 246 and tool rotation motor 247, to reduce the possibility of damage to the individual's oral cavity. Multiple redundant sensors using either the same or different sensing technologies, such as position sensing using both optical encoders as well as a linear variable-displacement transformer (LVDT) or ultrasonic ranger may be used to cross-check the sensor data and detect failure or malfunction of a sensor. Sensor malfunction or failure may cause the processing circuitry to return the oral cavity tool to a safe location and/or notify the user and/or stop operation of the oral appliance.

Once processing circuitry has performed mapping of the individual's oral cavity, subsequent pressing and/or pressing and holding one or more buttons may initiate an operation condition of oral appliance 200. Such operation condition may be, without limitation, flossing, flossing with fluid cleaning of the floss, fluid jet cleaning, brushing with the use of a brushing cartridge, application of prophylactic or treatment substances such as teeth whitening fluid or gel, fluoride or chlorhexidine gluconate, mechanical or laser drilling, teeth polishing or imaging and/or scanning of the oral cavity.

TABLE 1
Labels for FIG. 19

| # | Label |
|---|---|
| 426 | Buttons |
| 427 | LEDs/Displays |
| 428 | Audio/Speaker(s) |
| 429 | Level Sensor(s) |
| 430 | Tank(s) |
| 431 | Processor(s) |
| 432 | Trajectory Planning |
| 433 | Actuator Control |
| 434 | User Interface |
| 435 | Comms |
| 436 | Safety Coprocessor |
| 437 | Check Valve(s) |
| 438 | USB |
| 439 | Bluetooth |
| 440 | Substance Channel |
| 441 | Pump(s) |
| 442 | Current Sensor(s) |
| 443 | Actuator Drivers |
| 444 | Power Control |
| 445 | Wireless Charging |
| 446 | Tool Arm |
| 447 | Gimbals |
| 448 | Actuators |
| 449 | Position Sensor(s) |
| 450 | Batter(ies) |
| 451 | Oral Cavity Tool |
| 452 | Tool Holder |
| 453 | Force Sensor(s) |
| 454 | Sensor(s) |

### Oral Positioning Apparatuses Detailed Description

### Introduction

In the field of dental care, it is often necessary to have an individual open his or her mouth to permit access to the oral cavity for dental work such as cleaning, inspection, mapping, surgery or repair.

Described herein are example apparatuses for temporarily fixating an individual's jaws in an open position suitable for the performance of dental work along with the optional ability for the user to signal a desired start and/or stop to the operation hands-free.

These apparatuses may permit hands-free operation, with the expansion to the position that supports the user's open jaws and the collapse to the storage position being controlled simply by the user repeatedly biting down and opening his or her jaws.

An example sequence of events for a complete cycle of a passively-powered (e.g. via spring) oral positioning apparatus may be:
1. The user inserts the collapsed apparatus into his or her mouth.
2. The user bites down on the locating members. In the examples described, the locating members take the form of “mouth anchors” which may fit into the upper and/or lower gum pockets between the front gums and lips. Other locating members may be envisioned by one of ordinary skill in the art, such as anchors which fit into the side gum pockets between the side teeth and the cheeks, anchors that contact the mandible and/or maxilla behind the rearmost molars. or that temporarily attach to or constrain a user's chin and/or jaw and/or nose and/or mentolabial sulcus (the divot between the lower lip and the chin).
3. Upon biting down on the locating members, the apparatus is released from the collapsed storage position.
4. As the user relaxes his or her jaws, the mouth anchors follow the gum pockets separating as the mouth opens.
5. When the mouth anchors reach their maximum open position, the user may then bite down on them again until the mouth anchors collapse slightly to the active operating position. In this position, the user's mouth is held open due to the user's jaws resting on the temporarily uncompressible mouth anchors.
6. When the operation or procedure is complete, or if the user wishes to pause or abort the operation, he or she may open the jaws wider than the active operating position, which causes the mouth anchors to unlock.
7. The user may then bite down again, causing the mouth anchors to collapse to a minimal distance. Upon release of the user's jaws, the apparatus will remain in a collapsed state whereupon it may be removed from the user's oral cavity.

An example sequence of events for a complete cycle of a motorized oral positioning apparatus may be:
1. The user inserts the collapsed apparatus into his or her mouth.
2. The user bites down on the locating members.
3. Upon biting down on the locating members, the apparatus detects the force applied via a force or other type of sensor and activates a motor or actuator to drive the locating members apart.
4. The mouth anchors drive the user's jaws apart until the normal active operating position is reached. In this position, the user's mouth is held open due to the user's jaws resting on the mouth anchors, which are held at the normal operating position by either being actively driven by a motor or actuator or passively stable such as from a high-ratio or worm gearbox.
5. If the user wishes to pause or abort the operation, he or she may open the jaws wider than the active operating position, which may be detected by a sensor. The apparatus may then perform a variety of safing actions, such as prompting the user for the cause of the abort to determine the next step, or activating the motor or actuator to drive the locating members to the collapsed storage position so that the apparatus may be removed from the user's mouth.
6. When the operation or procedure is successfully completed, the motor or actuator may be commanded to drive the locating members to the collapsed storage position so that the apparatus may be removed from the user's mouth.

In one example of a use case, it may be desired to position a dental robot device in a fixed orientation relative to an individual's mouth. This application may have several desired features:

To have the apparatus be applicable to multiple users, all of whom may have different mouth geometries, it may be desirable to have the mouth opening width be adjustable.

To reduce cost and to prevent injury from a malfunction of the positioning apparatus, it may be desirable that the oral positioning apparatus have safety features.

To prevent strain and fatigue to the user's jaw while the mouth is in the open position, it may be desirable to have the jaw be supported during the device's operation.

In the event of a malfunction, it may be desirable to provide the user with a simple means to stop the operation of the device. Because one of the most common instinctual reactions to unpleasant sensations in the oral cavity is to open the mouth to expel the offending material, it may be desirable for the mechanism to be able to detect the increased opening of the mouth.

To facilitate removal of the oral positioning apparatus from the user's mouth, it may be desirable that the features which locate the apparatus relative to oral cavity landmarks be collapsible.

To minimize the number of controls and make the operation of the oral positioning apparatus as intuitive as possible, it may be desirable that the entire operation of the oral positioning apparatus, from expansion to the operating position to collapse to the storage position, be controlled solely by biting down on the locating members.

To facilitate providing instructions for the user to properly prepare the apparatus for storage, and to reduce power consumption and/or extend battery life by detecting when it is safe to shut down, it may be desirable for the mechanism to detect when the user has collapsed the locating members to the storage position.

The apparatuses described in this application can fulfill all of the aforementioned criteria. A discussion of each point follows:

To have the apparatus be applicable to multiple users, all of whom may have different mouth geometries, it may be desirable to have the mouth opening width be adjustable.

In order to access the interior of the oral cavity, the mouth needs to be open. One major difference between users, especially children vs. adults, is in the amount that they can comfortably open the mouth. As such, a mouth opening width that is suitable for a child's mouth may not afford enough access to an adult's teeth, and conversely, a suitable width for an adult may cause pain for a child. As such, it would be beneficial to have the mouth opening width be adjustable.

To reduce cost and to prevent injury from a malfunction of the positioning apparatus, it may be desirable that the oral positioning apparatus have safety features.

A passive mechanism that relies solely upon energy from the user's jaw stored in springs intrinsically limits the force which can be applied to the user's oral cavity features and increases the safety margin. Passive mechanisms may also cost less due to not having active components. Alternatively, active mechanisms powered by motors and/or actuators may be simpler to construct and may enable additional features such as automatic mouth width calibration. Active mechanisms may have sensors and/or processing circuitry to detect abnormal conditions and may have redundant sensors and/or processors to protect against sensor failure or malfunction.

To prevent strain and fatigue to the user's jaw while the mouth is in the open position, it may be desirable to have the jaw be supported during the device's operation.

During the operation of the device, the user's mouth must be open. Because it is fatiguing to hold one's jaw open for extended periods of time, it is preferred to have the jaw be held open during the operation. This may be accomplished by temporarily locking the locating members in place.

In the event of a malfunction, it may be desirable to provide the user with a simple means to stop the operation of the device. Because one of the most common instinctual reactions to unpleasant sensations in the oral cavity is to open the mouth to expel the offending material, it may be desirable for the mechanism to be able to detect the increased opening of the mouth.

If a malfunction occurs, valuable seconds can be wasted trying to find the On/Off button or Emergency Stop switch. It would be preferable if a normal instinctive panic reaction could be used to stop the device operation. For most people, the normal response to an unpleasant sensation in the oral cavity is to open the mouth to expel the offending material. If the mouth is already held open (as one real-world example, due to having a SCUBA breathing mouthpiece in place), the instinctive reaction is to open the mouth even further to release the object. If this increased opening can be detected, it provides an extremely quick and intuitive way for the user to stop the device operation.

This function can be combined with the above-described function #3 (Jaw rest). When the jaw is being held wide open, the restoring force of the stretched muscles provides a force clamping the mouth onto the locating members. If this force disappears, then it is known that the user has opened his or her mouth further. The force can either be detected directly with a force sensor, or indirectly by means of switches or sensors connected to the locating members that are closed when the gum pocket or jaw is pressed against the locating members and open when the gum pocket or jaw moves away. Another option is using spring-loaded probes which follow the motion of the jaw. When the mouth opens further, the increased distance can be detected as an indication of increased mouth opening.

Finally, this same sensing mechanism can detect when the user has expanded the locating members to the operational position and is ready for operation to begin. This could prompt the user to press a button to begin the operational sequence, or begin an audio or visual countdown until automatic operational start, or may simply begin the operation.

To facilitate removal of the oral positioning apparatus from the user's mouth, it may be desirable that the features which locate the apparatus relative to oral cavity landmarks be collapsible.

To assist with removal of the oral positioning apparatus from the mouth, the locating members may be collapsible. This may also help with storage of the apparatus by making it more compact when not in use.

To minimize the number of controls and make the operation of the oral positioning apparatus as intuitive as possible, it may be desirable that the entire operation of the oral positioning apparatus, from expansion to the operating position to collapse to the storage position, be controlled solely by biting down on the locating members.

Rather than having a variety of buttons or sliders or knobs to control the operation and position of the oral positioning apparatus, it would ideal for there to be the minimal number of controls possible both for cost and intuitive operation reasons. The simplest possible implementation would be no explicit controls, solely using the locating members themselves as controls by biting down on them to expand to the operating position and biting down on them again to collapse them to the storage position.

To facilitate providing instructions for the user to properly prepare the apparatus for storage, and to reduce power consumption and extend battery life by detecting when it is safe to shut down, it may be desirable for the apparatus to detect when the user has collapsed the locating members to the storage position.

For a new user, it may be desirable to provide displayed or audio instructions (for example, about how to clean and/or stow the apparatus) after each operational step. For an experienced user, having the ability to detect when the oral positioning apparatus is placed in the storage position may extend the battery life by allowing the device to automatically power off either immediately or after a delay in case the user forgets to press a power off button. In order to implement these features, it is necessary to have a means to detect when the locating members are in the storage position.

In another example of a use case, a dentist or other oral professional may wish to have the patient's mouth held open while he or she performs dental work. The apparatuses described in this application may also be suitable for that purpose.

### Example Oral Positioning Apparatuses

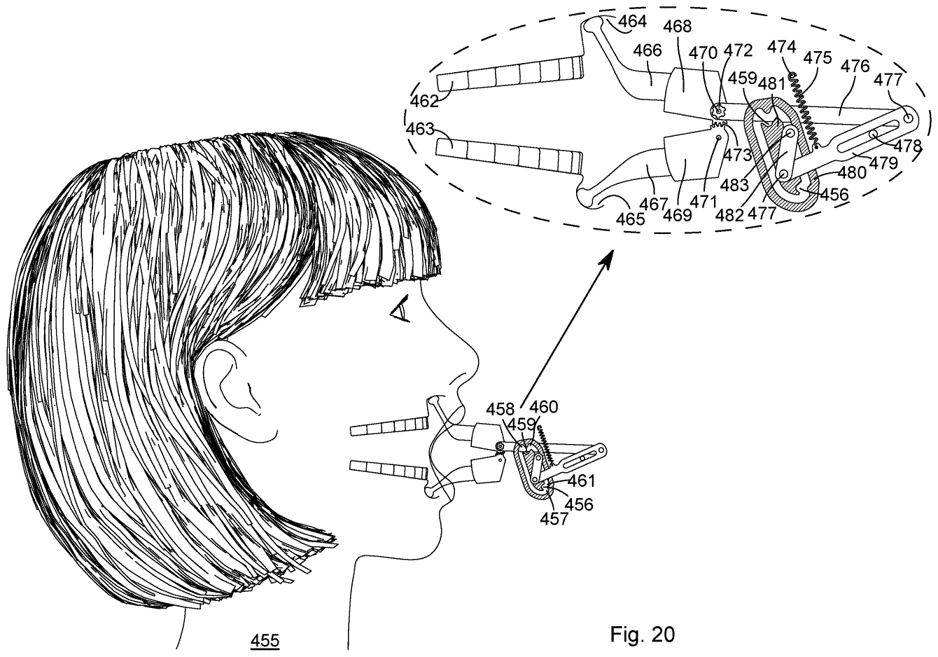

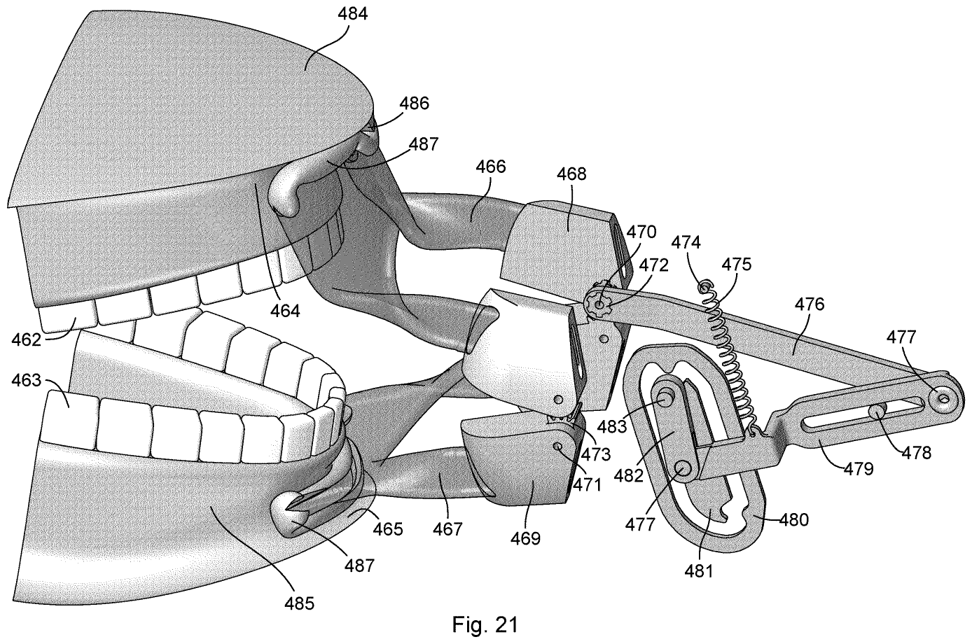

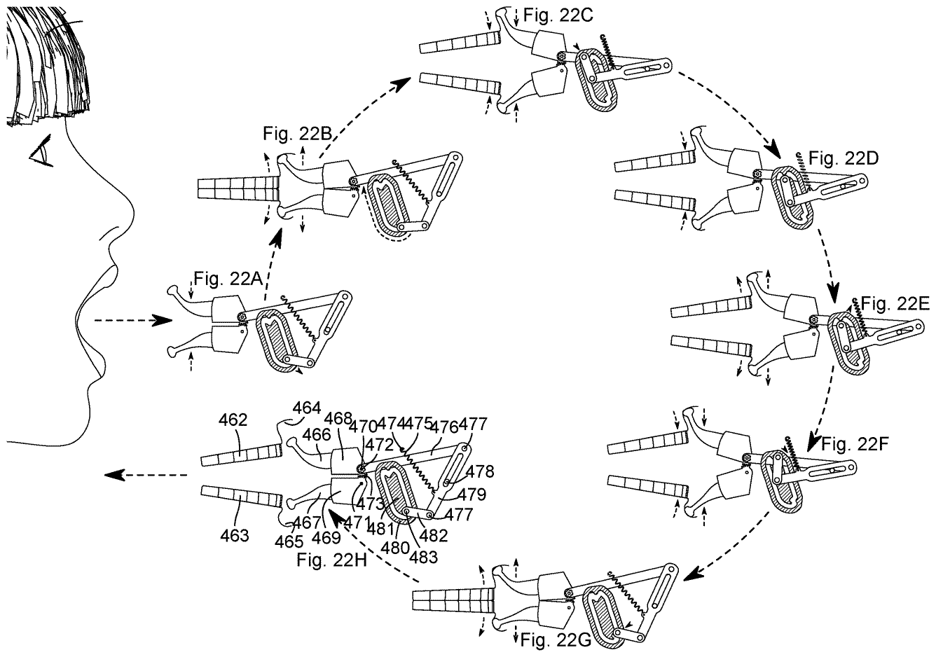

FIGS. 20 and 21 and the cycle shown in FIG. 22 gives an overview of the operation of an example oral positioning apparatus.

FIG. 22A shows the apparatus in the Storage position. In this stable position, an Upper Mouth Anchor 466 and a Lower Mouth Anchor 467 are in a collapsed state with the distance between them at a near minimum. This collapsed state allows the apparatus to be inserted into the oral cavity of an End User 455. End User 455 then bites down onto Upper Mouth Anchor 466 and Lower Mouth Anchor 467 which releases the apparatus from the Storage position into a Storage Release position.

FIG. 22B shows the apparatus in the Storage Release position. The Storage Release position is not a stable position due to an Extension Spring 475, which expands the Mouth Anchors to the Pre-Activation position as soon as End User 455 stops biting down and relaxes his or her jaws.

FIG. 22C shows the apparatus in the stable Pre-Activation position. When End User 455 is ready to proceed, he or she may then bite down slightly until the Mouth Anchors no longer compress, which indicates that the apparatus has entered the Active position.

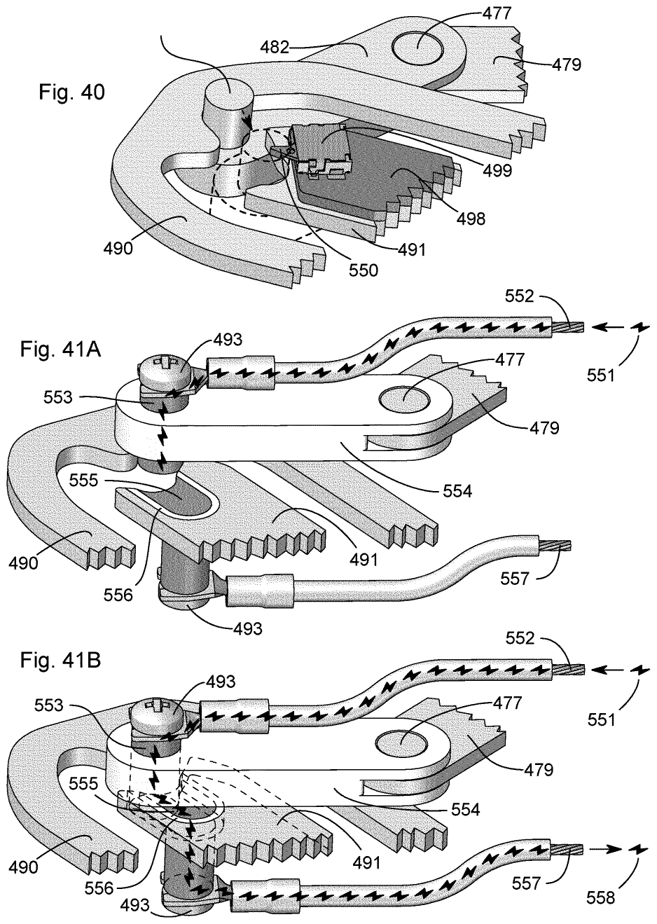

FIG. 22D shows the Active position. In the Active position, the user's jaws are open for access to the oral cavity. The Active position is not a stable position due to Extension Spring 475, and requires End User 455 to continually apply force to the Mouth Anchors to retain the apparatus in the Active position. The Active position may have one or more switches or sensors to detect when a Cam Follower Pin 483 is in the Active position, such as those shown in FIGS. 40 and 41, or other types of sensors such as, without limitation: optical sensors such as a phototransistor or photodiode with a light source such as an LED, a magnetic sensor such as a Hall Effect sensor with a corresponding source of magnetic flux such as a magnet or electromagnet, or an inductive or capacitive sensor with appropriate signal conditioning circuitry. Other cam positions may also have one or more sensors to detect when the apparatus is in that position.

Alternatively, rather than detecting discrete cam position(s), the oral positioning apparatus may have continuous sensors that detect either relative motion or absolute position of one or more Mouth Anchors or another component in the motion train. For example, a potentiometer or an optical or magnetic encoder may be attached to Upper Mouth Anchor Holder 468 along Upper Axis 470, thereby providing a direct measurement of the relative and/or absolute rotation of Upper Mouth Anchor Holder 468 and thereby the position of Upper Mouth Anchor 466.

The combination of an Active position which requires force to maintain and one or more sensors indicating when the apparatus is in the Active position allows for safety and usability features. If the user wants to abort or pause the procedure, he or she can simply open the mouth wider than the Active position. Extension Spring 475 may then drive the apparatus to the Post-Activation position. When the sensor(s) detect that the apparatus has left the Active position, various actions may be taken such as, without limitation, stopping any active mechanisms and/or inquiring through visual or audible means whether the user accidentally or purposefully stopped the procedure, and if the latter, whether it was due to a malfunction or simply a desire to pause.

FIG. 22E shows the apparatus moving from the Active position to the Post-Activation position, as would occur when End User 455 opens his or her mouth further than the Active position after the operation is complete or if he or she desires to pause or abort the operation.

FIG. 22F shows the Post-Activation position. This stable position is transiently passed through after End User 455 opens his or her mouth wider to leave the Active Position, before biting down to go to the Pre-Storage position. As the user is biting down to go to the Pre-Storage position, energy from the user's jaw is being stored in Extension Spring 475, which will later be used to expand the Mouth Anchors from the Storage Release position to the Pre-Activation position.

FIG. 22G shows the Pre-Storage position. The Pre-Storage position is not a stable position due to the force from Extension Spring 475, which drives the apparatus to the stable Storage position as soon as End User 455 relaxes his or her jaws.

FIG. 22H shows the apparatus in the collapsed Storage position and removal from the user's mouth. In this position, the Mouth Anchors have a near-minimum distance between them which permits easy removal from the user's mouth and storage of the apparatus until the next use.

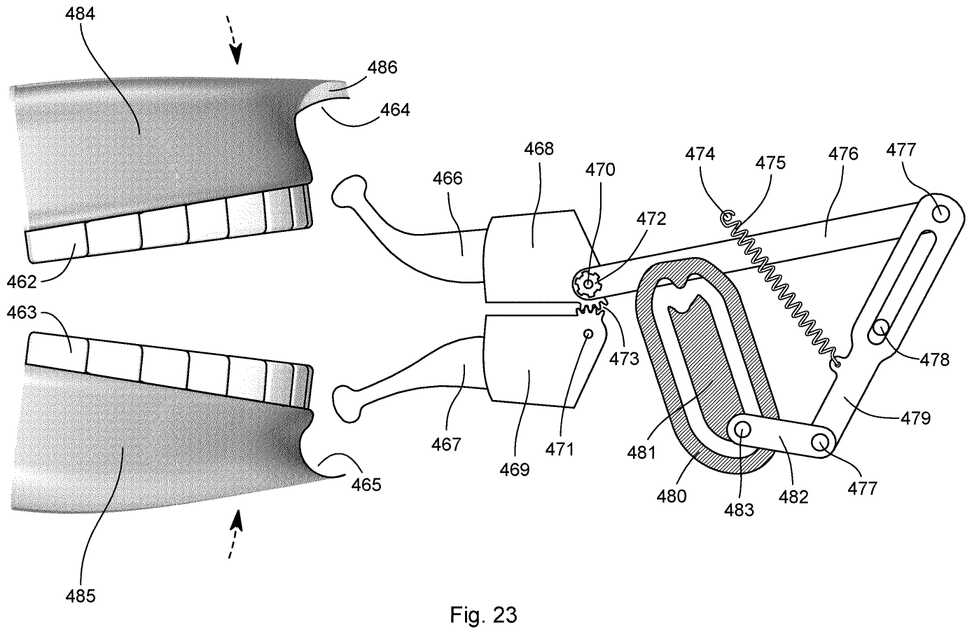

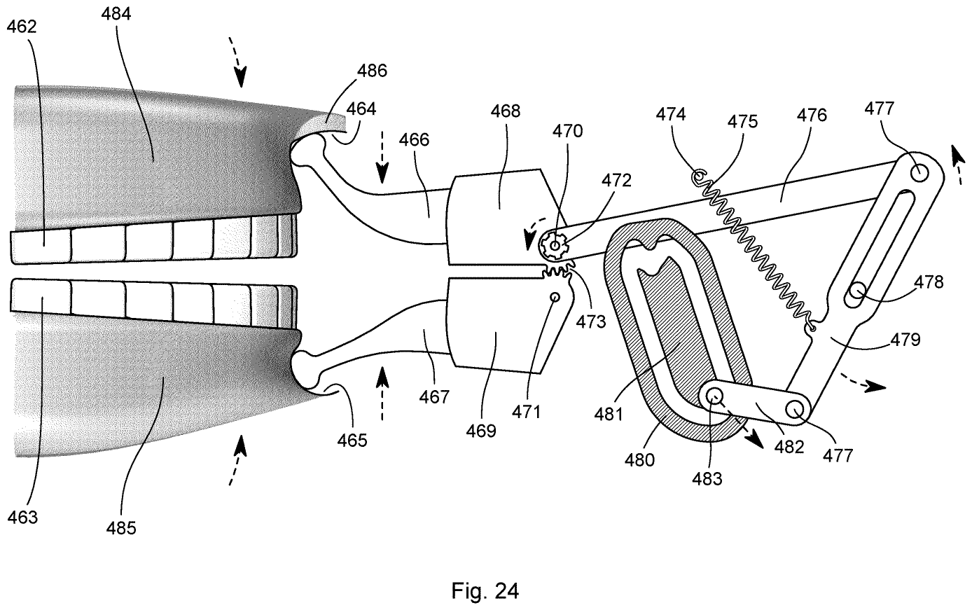

With reference to FIGS. 20 through 31 and 38, a description of an example oral positioning apparatus follows:

In one use case, it is desired to temporarily expose a plurality of Upper Teeth 462 and/or Lower Teeth 463 of an End User 455 to permit dental operations. In order to support the user's mouth in the open position, An Upper Mouth Anchor 466 may fit into and support an Upper Gum Pocket 464, and Lower Mouth Anchor 467 may fit into and support a Lower Gum Pocket 465.

Upper Mouth Anchor 466 may fit into an Upper Mouth Anchor Holder 468, and Lower Mouth Anchor 467 may fit into a Lower Mouth Anchor Holder 469. Upper Mouth Anchor Holder 468 may rotate on an Upper Axis 470 and Lower Mouth Anchor Holder 469 may rotate on a Lower Axis 471. Upper Mouth Anchor Holder 468 and Lower Mouth Anchor Holder 469 may have synchronized complementary rotation via Synchronization Gears 473 or another mechanical mechanism to create complementary or opposing motion or rotation such as, without limitation, pushrods, levers or a scissor lift.

Upper Mouth Anchor Holder 468 may be connected to a Linkage One 476 via a Rigid Connection 472. Linkage One 476 may be connected to a Linkage Two 479 via a Pivot Connection 477 which may allow the two linkages to rotate along an axis. Linkage Two 479 may rotate around a Pivot Point 478, which may have a fixed position or be adjustable.

Linkage Two 479 may be attached to an Extension Spring 475, which may be connected to a Spring Fixed Point Attachment 474 and Extension Spring 475 may provide a restoring force to keep the apparatus in a Cam Position 1 (Storage) 456 and additionally may provide force to pull a Cam Follower Pin 483 out of a Cam Position 2 (Storage Release) 457 and/or a Cam Position 4 (Active) 459 when the user opens his or her mouth wider.

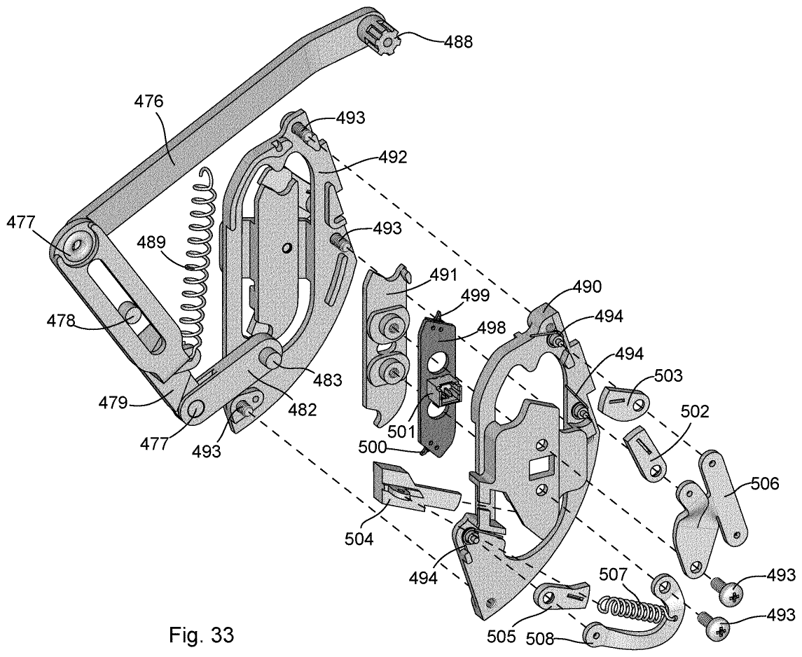

Linkage Two 479 may be connected to a Linkage Three 482 via a Pivot Connection 477 which allows the two linkages to rotate along an axis. Linkage Three 482 may have a Cam Follower Pin 483 which may follow a cam path between a Cam Track 480 and a Cam Island 481. Cam Track 480 and a Cam Island 481 may form collectively, a cam. Alternatively, the cam may be a single piece, as shown in FIG. 33, or may be a plurality of pieces. One possible cam path may proceed from a Cam Position 1 (Storage) 456 to a Cam Position 2 (Storage Release) 457 to a Cam Position 3 (Pre-Activation) 458 to a Cam Position 4 (Active) 459 to a Cam Position 5 (Post-Activation) 460 to a Cam Position 6 (Pre-Storage) 461 and back to Cam Position 1 (Storage) 456. Other paths and different numbers of positions are possible and will be evident to one of ordinary skill in the art. For example, a very simple design without a Storage Position could simply have a spring-maintained Active Position. The user could then either bite down or open up to move out of the Active Position to signal a desired end to the operation.

FIG. 21 shows additional details, such as an individual's Upper Gums 484 and Lower Gums 485. An Upper Frenulum 486 is a flap of tissue present on most people, which generally should not have direct pressure applied to it as it may cause pain. It may be used as a mouth location point reference due to its centered location at the top of an Upper Gum Pocket 464. Upper Mouth Anchor 466 may have a notch to constrain and/or locate and/or avoid pressure on Upper Frenulum 486. Some people also have a prominent lower frenulum and therefore Lower Mouth Anchor 467 may also have a notch. Also shown in FIG. 21 is a Cushion Pad 487 which may cover Upper Mouth Anchor 466 and/or Lower Mouth Anchor 467 to provide comfort for the user's gums. Cushion Pad 487 may also have a matching notch to constrain and/or locate and/or avoid putting pressure on an individual's frenulum.

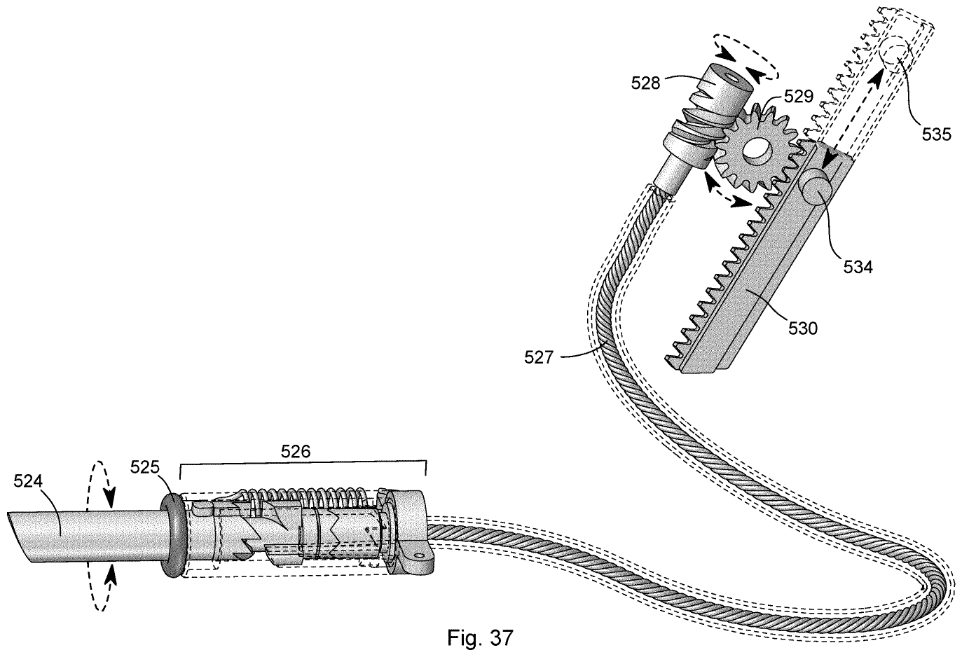

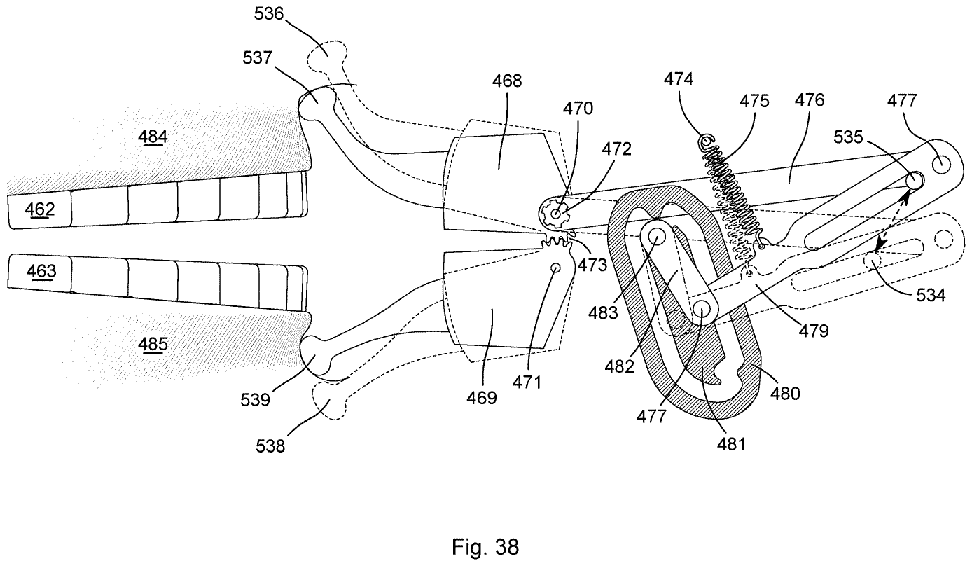

FIG. 38 shows how the mouth opening width in Cam Position 4 (Active) 459 may be adjusted by varying the location of the pivot point. A Pivot Point in the Minimum Width Position 535 (shown with solid lines), results in the lowest position of Upper Teeth 462 and Upper Gums 484 (i.e. minimum mouth opening width) due to an Upper Mouth Anchor in the Minimum Width Position 537 in the upper gum pocket and the highest position of Lower Teeth 463 and Lower Gums 485 (i.e. minimum mouth opening width) due to a Lower Mouth Anchor in the Minimum Width Position 539 in the lower gum pocket.

A Pivot Point in the Maximum Width Position 534 (shown with dashed lines), results in the position of an Upper Mouth Anchor in the Maximum Width Position 536 and a Lower Mouth Anchor in the Maximum Width Position 538.

FIGS. 22A, 23 and 24 show insertion of the apparatus into the oral cavity and release from the Storage Position. With the apparatus in Cam Position 1 (Storage) 456, End User 455 may insert the apparatus into the front of his or her mouth and bite down on Upper Mouth Anchor 466 and Lower Mouth Anchor 467. When compressed by the user's Upper Gum Pocket 464 and Lower Gum Pocket 465, Cam Follower Pin 483 may be displaced from Cam Position 1 (Storage) 456 to Cam Position 2 (Storage Release) 457.

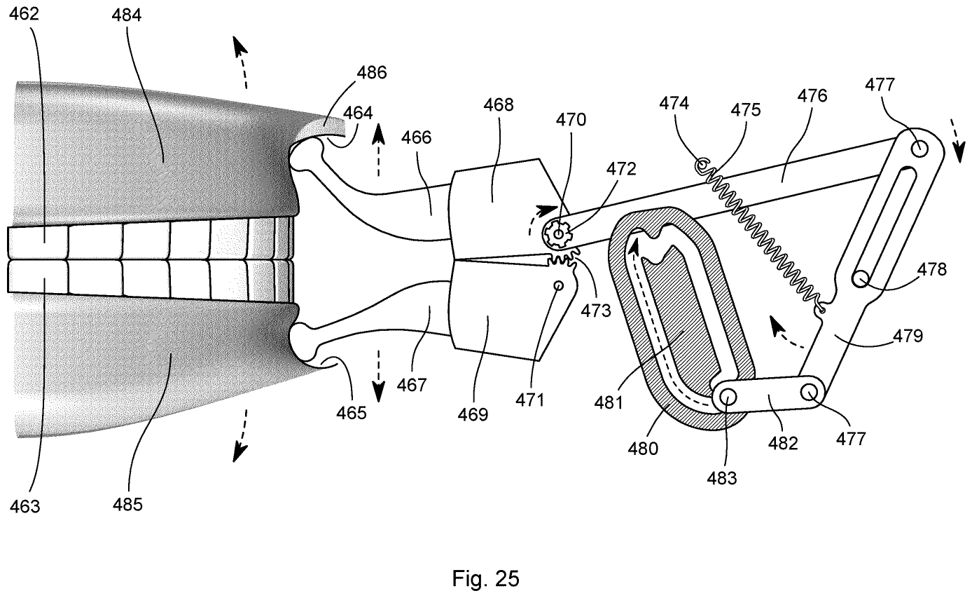

FIGS. 22B and 25 show the expansion to the Pre-Activation Position. Once Cam Follower Pin 483 bottoms out at Cam Position 2 (Storage Release) 457, End User 455 may then stop biting down and relax his or her jaw muscles. The energy stored in Extension Spring 475 may then drive Cam Follower Pin 483 to Cam Position 3 (Pre-Activation) 458, which may drive coupled Upper Mouth Anchor 466 and Lower Mouth Anchor 467 apart, thereby following the user's jaws as they open.

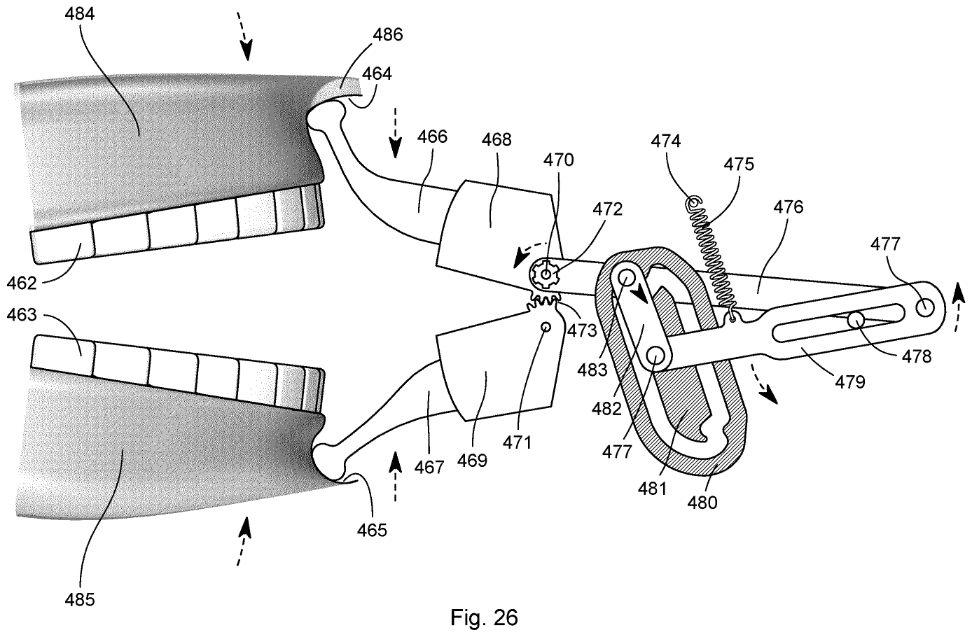

FIGS. 22C and 26 show the compression to the Active Position. Once Cam Follower Pin 483 has fully reached Cam Position 3 (Pre-Activation) 458, Upper Mouth Anchor 466 and Lower Mouth Anchor 467 will have reached their maximum opening width. End User 455 may then bite down with the jaws closing until Cam Follower Pin 483 reaches Cam Position 4 (Active) 459, thereby stopping Upper Mouth Anchor 466 and Lower Mouth Anchor 467 from compressing further. The movement to the Cam Position 4 (Active) 459 also may extend Extension Spring 475 relative to its length in Cam Position 3 (Pre-Activation) 458.

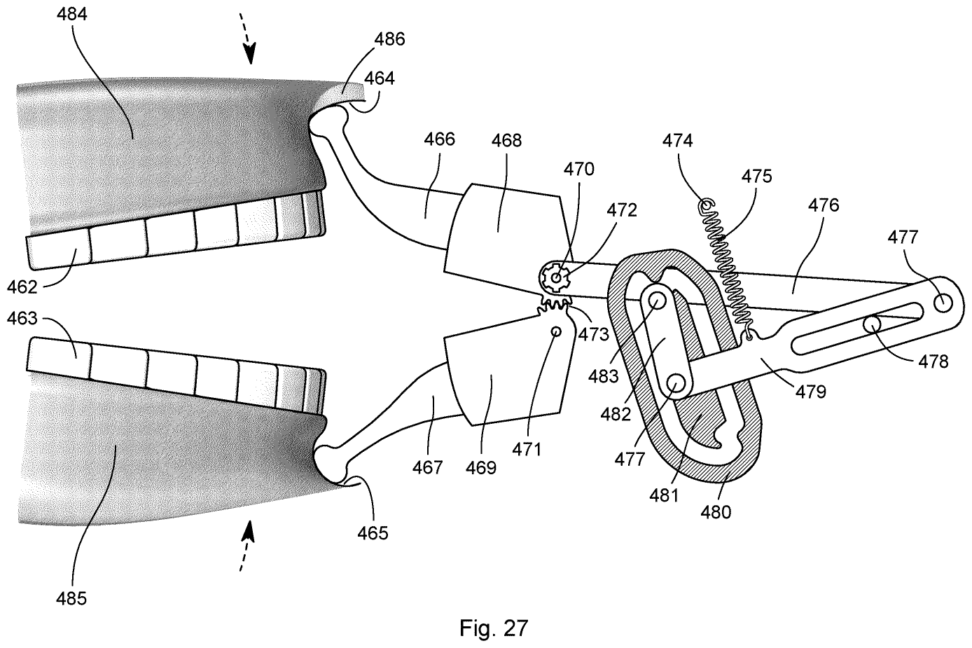

FIGS. 22D and 27 show the Active Position. While in the active position, End User 455 must continue to bite down and exert force on Upper Mouth Anchor 466 and Lower Mouth Anchor 467 to keep Cam Follower Pin 483 in Cam Position 4 (Active) 459. This is because Extension Spring 475 constantly exerts force on Cam Follower Pin 483, trying to move it to Cam Position 5 (Post-Activation) 460. This provides an important safety feature, as a normal instinctual reaction of most people to pain in the mouth is to open the mouth to expel the offending material. This mouth opening can be detected, as shown in FIGS. 40 and 41, and used to emergency stop the operation of the device.

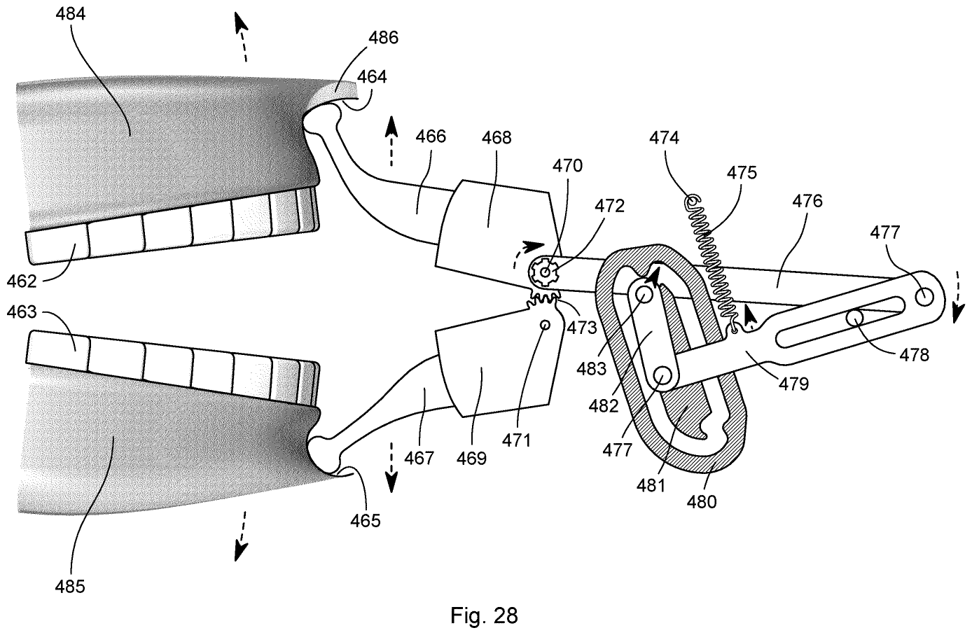

FIGS. 22E and 28 show the Post-Activation Position. When the device operation is complete or if End User 455 wishes to initiate an abort, End User 455 opens his or her mouth wider than the width in Cam Position 4 (Active) 459, which may cause Extension Spring 475 to drive Cam Follower Pin 483 to Cam Position 5 (Post-Activation) 460.

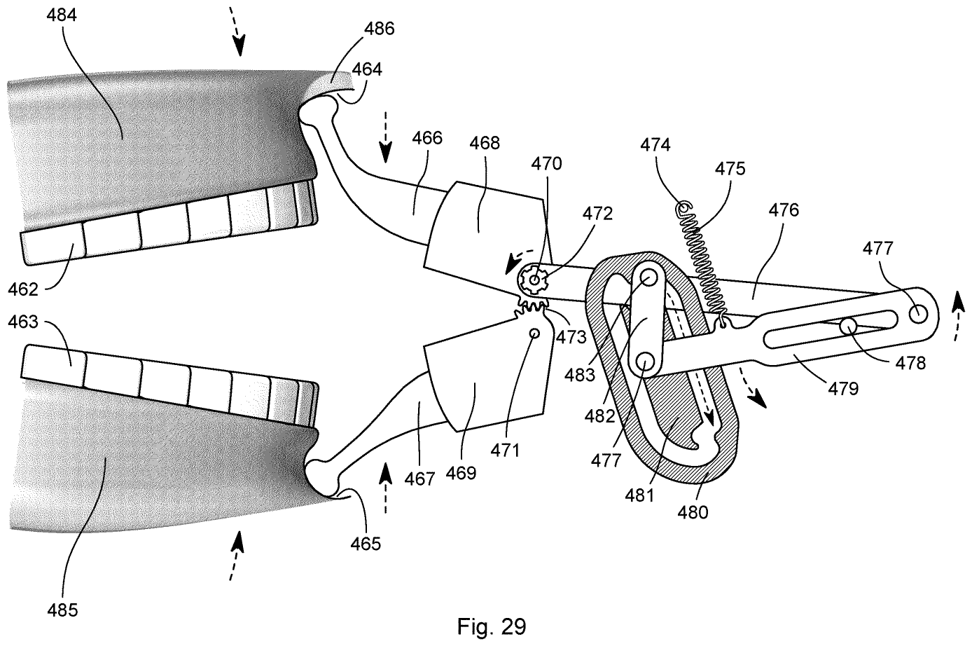

FIGS. 22F and 29 show the Pre-Storage Position. End User 455 may then bite down on Upper Mouth Anchor 466 and Lower Mouth Anchor 467 to collapse Upper Mouth Anchor 466 and Lower Mouth Anchor 467 and drive Cam Follower Pin 483 to Cam Position 5 (Post-Activation) 460. This also extends and stores energy in Extension Spring 475.

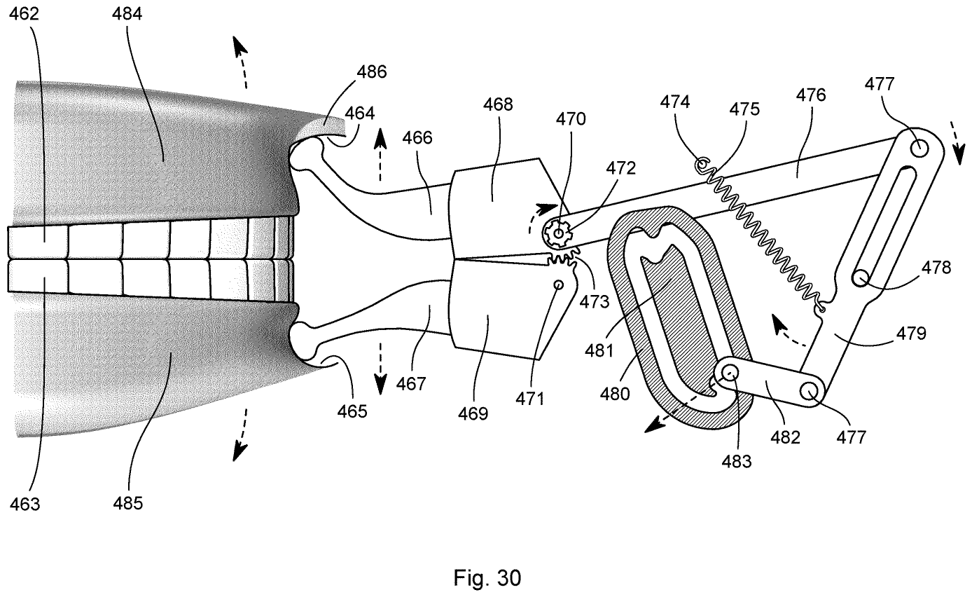

FIGS. 22G and 30 show the Storage Position. End User 455 then opens his or her mouth, which may cause Extension Spring 475 to drive Cam Follower Pin 483 to Cam Position 1 (Storage) 456, which may hold Upper Mouth Anchor 466 and Lower Mouth Anchor 467 in the collapsed storage position.

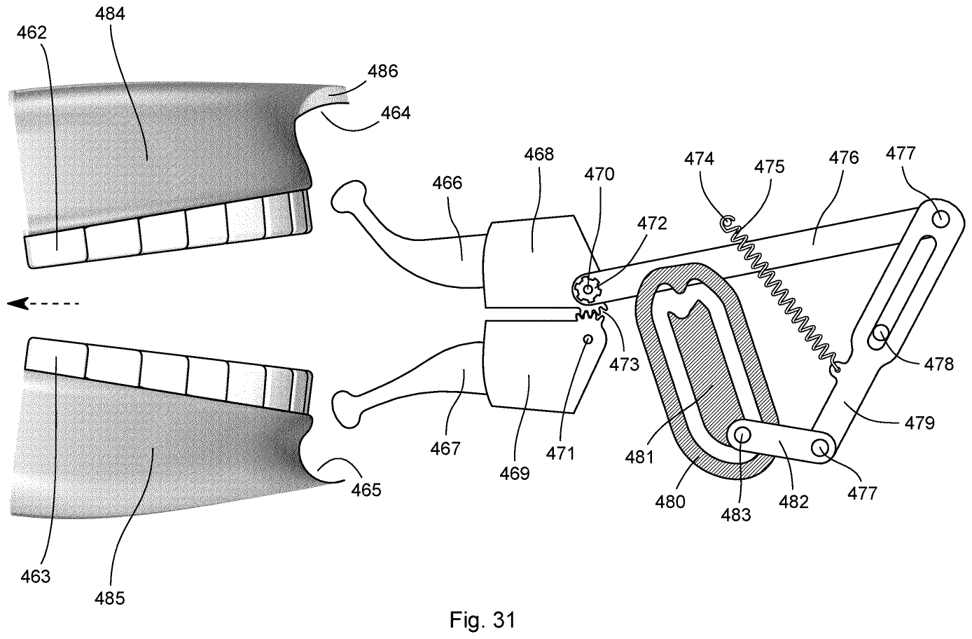

FIGS. 22H and 31, show removal of the apparatus into the oral cavity. End User 455 then removes the collapsed apparatus in the Storage Position from the mouth.

Although the example given utilizes mouth anchors which fit into the front gum pockets of an individual, other implementations may be contemplated by one of ordinary skill in the art. For example, instead of the front gum pockets, mouth anchor(s) may fit into the upper and/or lower gum pockets between the gums and the inner surface of the left and/or right cheeks of an individual.

As another example, instead of mouth anchor(s) internal to the oral cavity, external members may provide position references and/or anchoring points via touching or constraining facial features. For example, the lower jaw (mandible) may be grasped or constrained externally through the cheeks via a clamp or robotic hand. Similarly, the chin may be grasped or constrained externally via a clamp or robotic hand, or via a straight or curved rod or robotic finger pressed into the mentolabial sulcus between the chin and the lower lip. The nose may be used similarly, for example, via a straight or curved rod or robotic finger which presses against the nasal base at the intersection of the nasal septum and the philtrum to provide a position reference and/or anchoring point.

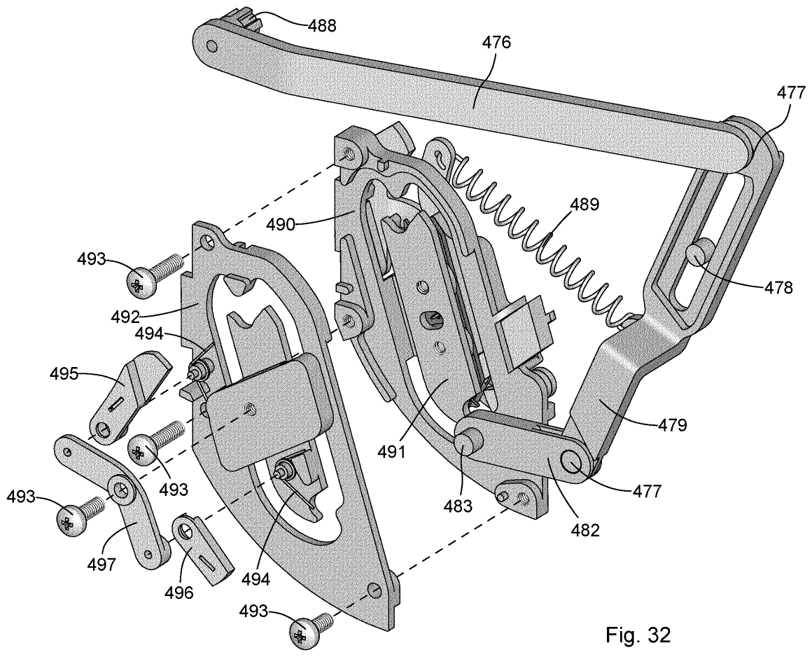

FIGS. 32 and 33 show front and rear exploded views, respectively, of an example apparatus.

A coupling such as a Spline 488 may form a rigid connection from a Mouth Anchor Holder to Linkage One 476 which may then connect to Linkage Two 479 via a Pivot Connection 477 which may allow the two linkages to rotate along an axis. Linkage Two 479 may rotate around a Pivot Point 478, which may have a fixed position or be adjustable.

Linkage Two 479 may be connected to Linkage Three 482 via a Pivot Connection 477 which may allow the two linkages to rotate along an axis. Linkage Three 482 may have a Cam Follower Pin 483. Alternatively, there may be a lesser or greater number of linkages. For example, Linkage One 476 may have a Cam Follower Pin 483 which may be directly connected or connected with an extension slide or shaft allowing the pin to have constrained travel. Alternatively, Linkage Two 479 may have a Cam Follower Pin 483, again with or without a mechanism allowing it to have constrained movement. The reduction in linkages may be advantageous in space-constrained or lower-cost applications or where mouth opening width adjustability is not necessary.

A Front Cam Track & Island 492 may be combined with a Rear Cam Track 490 and a Rear Cam Island 491 and may be clamped with one or more of a Pan-Head Screw 493 which may form a constrained passageway and 2-dimensional cam path which Cam Follower Pin 483 may follow from the Storage Position to the Active Position and back again.

Linkage Two 479 may be attached to a Linkage Two Extension Spring 489, which may provide a restoring force to keep the mechanism in the Storage Position and additionally to pull the Cam Follower Pin 483 out of the Active Position when the user opens his or her mouth.

An Upper Cam Gate Three 495 may prevent Cam Follower Pin 483 from returning to the Active Position from the Post-Activation Position. A Torsion Spring 494 may provide a restoring force that may hold Upper Cam Gate Three 495 in a closed position until Cam Follower Pin 483 moves to the Active Position and forces Upper Cam Gate Three 495 into the open position.

A Lower Cam Gate Three 496 may prevent Cam Follower Pin 483 from returning to the Storage Position from the Storage Release Position. A Torsion Spring 494 may provide a restoring force that may hold Lower Cam Gate Three 496 in a closed position until Cam Follower Pin 483 moves to the Storage Position and forces Lower Cam Gate Three 496 into the open position.

A Front Cam Gates Retainer 497 may hold Upper Cam Gate Three 495 and Lower Cam Gate Three 496 in position.

A Cam Switch Printed Circuit Board (PCB) 498 may be clamped between Rear Cam Track 490 and Rear Cam Island 491 and held in place with one or more of a Pan-Head Screw 493 or other fastener or attachment method. Cam Switch PCB 498 may have an Active Position Detection Microswitch 499 mounted to it, which detects when Cam Follower Pin 483 is in the Active Position, and may have a Storage Position Detection Microswitch 500 also mounted to it, which detects when Cam Follower Pin 483 is in the Storage Position. Cam Switch PCB 498 may also have an Electrical Connector 501 mounted to it, which routes the signals from the position detection microswitches to the processing circuitry.

An Upper Cam Gate One 502 may prevent Cam Follower Pin 483 from returning to the Storage Release Position from the Pre-Activation Position. A Torsion Spring 494 provides a restoring force that may hold Upper Cam Gate One 502 in a closed position until Cam Follower Pin 483 moves to the Pre-Activation Position and forces Upper Cam Gate One 502 into the open position.

An Upper Cam Gate Two 503 may prevent Cam Follower Pin 483 from returning to the Pre-Activation Release Position from the Active Position. A Torsion Spring 494 may provide a restoring force that holds Upper Cam Gate Two 503 in the closed position until Cam Follower Pin 483 moves to the Active Position and forces Upper Cam Gate Two 503 into the open position.

A Lower Cam Gate One 504 may prevent Cam Follower Pin 483 from returning to the Post-Activation Position from the Pre-Storage Position. A Lower Cam Gate One Extension Spring 507 which may be attached to a Lower Cam Gate Two Retainer 508 may provide a restoring force that holds Lower Cam Gate One 504 in the closed position until Cam Follower Pin 483 moves to the Pre-Storage Position and forces Lower Cam Gate One 504 into the open position.

A Lower Cam Gate Two 505 may prevent Cam Follower Pin 483 from returning to the Pre-Storage Position from the Storage Position. A Torsion Spring 494 may provide a restoring force that holds Lower Cam Gate Two 505 in the closed position until Cam Follower Pin 483 moves to the Pre-Storage Position and forces Lower Cam Gate Two 505 into the open position.

A Rear Upper Cam Gates Retainer 506 may hold Upper Cam Gate One 502 and Upper Cam Gate Two 503 in position. A Lower Cam Gate Two Retainer 508 may hold Lower Cam Gate Two 505 in position. Rear Upper Cam Gates Retainer 506 and Lower Cam Gate Two Retainer 508 may be held in position with Pan-Head Screws 493.

Although the above description shows the use of a 2-D (2 Dimensional) cam, other equivalent cam geometries known to one of ordinary skill in the art may be substituted, such as, without limitation, barrel, globoid, or 3-D (3 Dimensional) cams. Similarly, although the above description shows the use of linkages to transmit force and/or motion from the mouth anchors to the cam mechanism, other power transmission mechanisms may be used, such as, without limitations, belts, gears or flexible shafts Although the above description shows the Mouth Anchors coupled to a cam follower, alternatively, the Mouth Anchors or other locating members may be coupled to the cam itself, with a track roller, pin, or other member constraining the motion of the cam (a so-called “inverse cam”).

Although the above description shows the use of a cam, other non-cam geometries may be utilized. For example, Upper Mouth Anchor Holder 468 and/or Lower Mouth Anchor Holder 469 may be attached to one or more extension springs which pull Upper Mouth Anchor 466 and/or Lower Mouth Anchor 467 apart. End User 455 may then compress the Mouth Anchors together, perhaps with his or her fingers until insertion into the oral cavity whereupon the Mouth Anchors are released and expand, thereby holding End User 455's jaws apart. Alternatively, one or more compression springs attached to Upper Mouth Anchor Holder 468 and/or Lower Mouth Anchor Holder 469 may provide the force to drive them apart instead of extension spring(s). The force-producing component(s) such as springs may be attached to Upper Mouth Anchor 466 and/or Lower Mouth Anchor 467 instead of Mouth Anchor Holders, or may be attached to another member indirectly linked to the Mouth Anchors, such as Linkage One 476. Other means of providing force known to one of ordinary skill in the art, such as, without limitation, elastic bands or rods, members such as strips or rods made of a flexible material such as spring steel or rubber, gravity-driven weights, shape-memory alloys, hydraulic or pneumatic cylinders, motors or actuators may be substituted for springs in this cam or cam-less application.

Another non-cam example may have Upper Mouth Anchor 466 and Lower Mouth Anchor 467 connected together via a hinge, pivot point(s) such as rivets or screws, or a scissor lift, such that the combination may be collapsed for insertion into the oral cavity. The combination may have one or more springs or other force-producing members providing force to drive the Mouth Anchors apart and thus support the user's jaws.

Other alternative non-cam geometries may be envisioned by one of ordinary skill in the art. For example, a mouth anchor in a ‘U’ or ‘V’ shape, wherein the ends of the shape fit into the upper and lower gum pockets, similarly to the way that the ridges of Upper Mouth Anchor 466 and/or Lower Mouth Anchor 467 do. The body (non-ends portion) of the ‘U’ or ‘V’ shape may be constructed of rigid material, such as, without limitation, metal or a stiff plastic such as polycarbonate. Alternatively, the body may be constructed of a flexible or semi-flexible material such as, without limitation, spring steel or a plastic with the addition of plasticizers so that the mouth anchor can be compressed for insertion into the oral cavity and then released to hold the user's jaws apart. This mouth anchor may be a single piece, a single piece with Cushion Pad(s) 487 to avoid irritation to the user's gums, or a multi-piece assembly consisting of individual components bonded or attached together.

The above cam or non-cam geometries may have endstops or another mechanism to limit the maximum opening width such as tethers made of wire or another minimally extensible material, and may have one or more sensors to detect the position, rotation and/or force applied to or received from the Mouth Anchors.

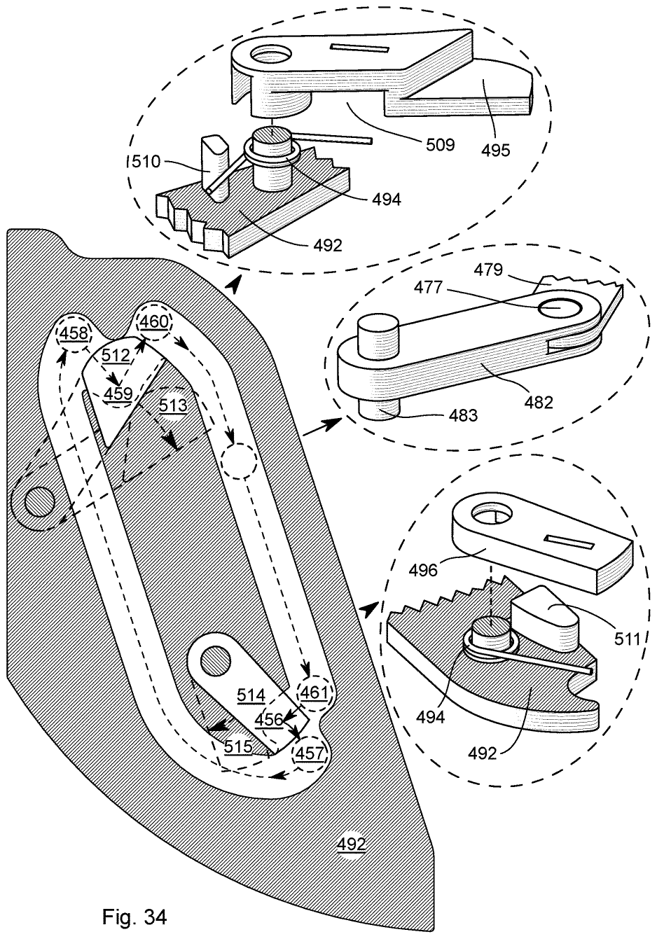

FIG. 34 shows the structure and operation of the front-side cam gates, Upper Cam Gate Three 495 and Lower Cam Gate Three 496, which may prevent Cam Follower Pin 483 from moving backward (counterclockwise) from Cam Position 5 (Post-Activation) 460 and Cam Position 2 (Storage Release) 457, respectively. Cam Follower Pin 483 may move around the path created by Front Cam Track & Island 492.

Normally, Upper Cam Gate Three 495 is held in Upper Cam Gate Three (Closed Position) 512 via the force exerted by a Torsion Spring 494. However, when Cam Follower Pin 483 moves from Cam Position 3 (Pre-Activation) 458 to Cam Position 4 (Active) 459, it pushes Upper Cam Gate Three 495 into Upper Cam Gate Three (Opened Position) 513. When Cam Follower Pin 483 then moves to Cam Position 5 (Post-Activation) 460, Upper Cam Gate Three 495 snaps back to Upper Cam Gate Three (Closed Position) 512, which prevents Cam Follower Pin 483 from moving backwards (counterclockwise) to Cam Position 4 (Active) 459.

Normally, Lower Cam Gate Three 496 is held in Lower Cam Gate Three (Closed Position) 514 via the force exerted by a Torsion Spring 494. However, when Cam Follower Pin 483 moves from Cam Position 6 (Pre-Storage) 461 to Cam Position 1 (Storage) 456, it pushes Lower Cam Gate Three 496 into Lower Cam Gate Three (Opened Position) 515. When Cam Follower Pin 483 then moves to Cam Position 2 (Storage Release) 457, Lower Cam Gate Three 496 snaps back to Lower Cam Gate Three (Closed Position) 514, which prevents Cam Follower Pin 483 from moving backwards (counterclockwise) to Cam Position 1 (Storage) 456.

The upper panel of FIG. 34 shows an expanded view of Upper Cam Gate Three 495 and supporting hardware. A Tunnel 509 allows Cam Follower Pin 483 to pass from Cam Position 2 (Storage Release) 457 to Cam Position 3 (Pre-Activation) 458 underneath Upper Cam Gate Three 495 when it is in the closed position. A Torsion Spring 494, in combination with a Torsion Spring Hardstop 510 (which may be part of Front Cam Track & Island 492), provides torque to keep Upper Cam Gate Three 495 in the closed position normally.

The middle panel of FIG. 34 shows an expanded view of Cam Follower Pin 483 and connected hardware. Cam Follower Pin 483 may be either part of, or connected to, Linkage Three 482, depending on manufacturing or electrical (insulating) preferences. Linkage Three 482 may be connected to Linkage Two 479 via a Pivot Connection 477 which allows the two linkages to rotate along an axis.

The lower panel of FIG. 34 shows an expanded view of Lower Cam Gate Three 496 and supporting hardware. A Torsion Spring 494, in combination with a Torsion Spring & Cam Gate Hardstop 511 (which may be part of Front Cam Track & Island 492), provides torque to keep Lower Cam Gate Three 496 in the closed position normally. A Torsion Spring & Cam Gate Hardstop 511 may also prevent Lower Cam Gate Three 496 from rotating past the closed position.

FIG. 35 shows the structure and operation of the rear-side cam gates, Upper Cam Gate One 502, Upper Cam Gate Two 503, Lower Cam Gate One 504 and Lower Cam Gate Two 505, which may prevent Cam Follower Pin 483 from moving backward (counterclockwise) from Cam Position 3 (Pre-Activation) 458, Cam Position 4 (Active) 459, Cam Position 6 (Pre-Storage) 461, and Cam Position 1 (Storage) 456, respectively. Cam Follower Pin 483 may move around the path created between Rear Cam Track 490 and Rear Cam Island 491.

Normally, Upper Cam Gate One 502 is held in Upper Cam Gate One (Closed Position) 516 via the force exerted by a Torsion Spring 494. However, when Cam Follower Pin 483 moves from Cam Position 2 (Storage Release) 457 toward Cam Position 3 (Pre-Activation) 458, it pushes Upper Cam Gate One 502 into Upper Cam Gate One (Opened Position) 517. When Cam Follower Pin 483 moves to Cam Position 3 (Pre-Activation) 458, Upper Cam Gate One 502 snaps back to Upper Cam Gate One (Closed Position) 516, which prevents Cam Follower Pin 483 from moving backwards (counterclockwise) to Cam Position 2 (Storage Release) 457.

Normally, Upper Cam Gate Two 503 is held in Upper Cam Gate Two (Closed Position) 518 via the force exerted by a Torsion Spring 494. However, when Cam Follower Pin 483 moves from Cam Position 2 (Storage Release) 457 to Cam Position 3 (Pre-Activation) 458, it pushes Upper Cam Gate Two 503 into Upper Cam Gate Two (Opened Position) 519. When Cam Follower Pin 483 then moves to Cam Position 4 (Active) 459, Upper Cam Gate Two 503 snaps back to Upper Cam Gate Two (Closed Position) 518, which prevents Cam Follower Pin 483 from moving backwards (counterclockwise) to Cam Position 3 (Pre-Activation) 458.

Normally, Lower Cam Gate One 504 is held in Lower Cam Gate One (Closed Position) 520 via the force exerted by an Extension Spring 507. However, when Cam Follower Pin 483 moves from Cam Position 5 (Post-Activation) 460 toward Cam Position 6 (Pre-Storage) 461, it pushes Lower Cam Gate One 504 into Lower Cam Gate One (Opened Position) 521. When Cam Follower Pin 483 moves to Cam Position 6 (Pre-Storage) 461, Lower Cam Gate One 504 snaps back to Lower Cam Gate One (Closed Position) 520, which prevents Cam Follower Pin 483 from moving backwards (counterclockwise) to Cam Position 5 (Post-Activation) 460.

Normally, Lower Cam Gate Two 505 is held in Lower Cam Gate Two (Closed Position) 522 via the force exerted by a Torsion Spring 494. However, when Cam Follower Pin 483 moves from Cam Position 5 (Post-Activation) 460 to Cam Position 6 (Pre-Storage) 461, it pushes Lower Cam Gate Two 505 into Lower Cam Gate Two (Opened Position) 523. When Cam Follower Pin 483 then moves to Cam Position 1 (Storage) 456, Lower Cam Gate Two 505 snaps back to Lower Cam Gate Two (Closed Position) 522, which prevents Cam Follower Pin 483 from moving backwards (counterclockwise) to Cam Position 6 (Pre-Storage) 461.

The upper panel of FIG. 35 shows an expanded view of Upper Cam Gate One 502, Upper Cam Gate Two 503 and supporting hardware. Torsion Springs 494, in combination with Torsion Spring Hardstops 510 (which may be part of Rear Cam Track 490), provides torque to keep Upper Cam Gate One 502 and Upper Cam Gate Two 503 in the closed position normally.

The lower panel of FIG. 35 shows an expanded view of Lower Cam Gate One 504, Lower Cam Gate Two 505 and supporting hardware. Extension Spring 507 provides force to keep Lower Cam Gate One 504 in the closed position normally. A Torsion Spring 494, in combination with a Torsion Spring Hardstop 510 (which may be part of Rear Cam Track 490), provides torque to keep Lower Cam Gate Two 505 in the closed position normally.

Although the above example utilizes rotating or sliding gates for restricting the cam follower to one-way motion, other variations may be contemplated by one of ordinary skill in the art, such as deflectable strips made of a springy material or ramps on a 3-D cam track.

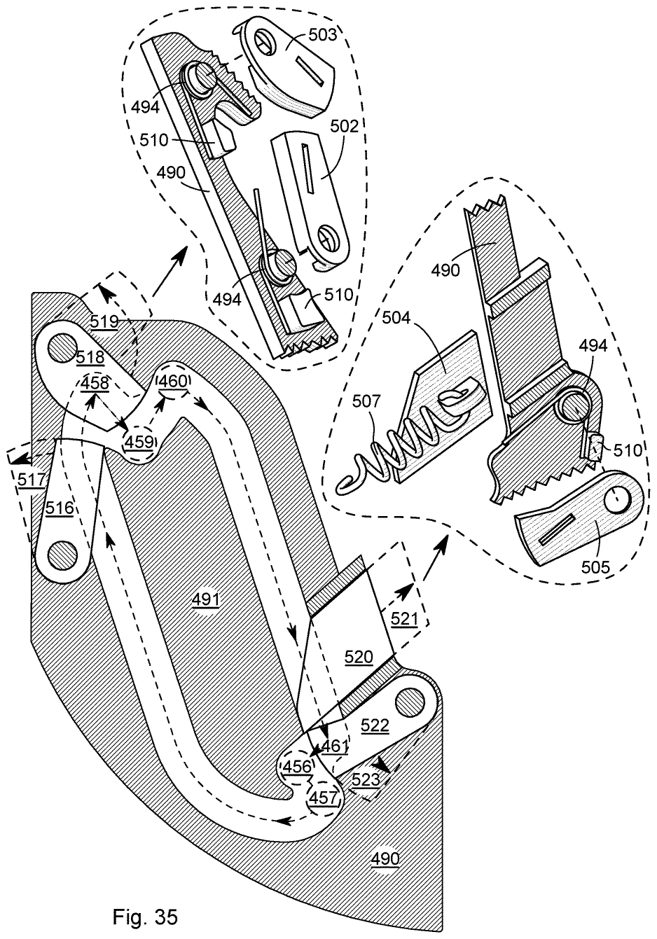

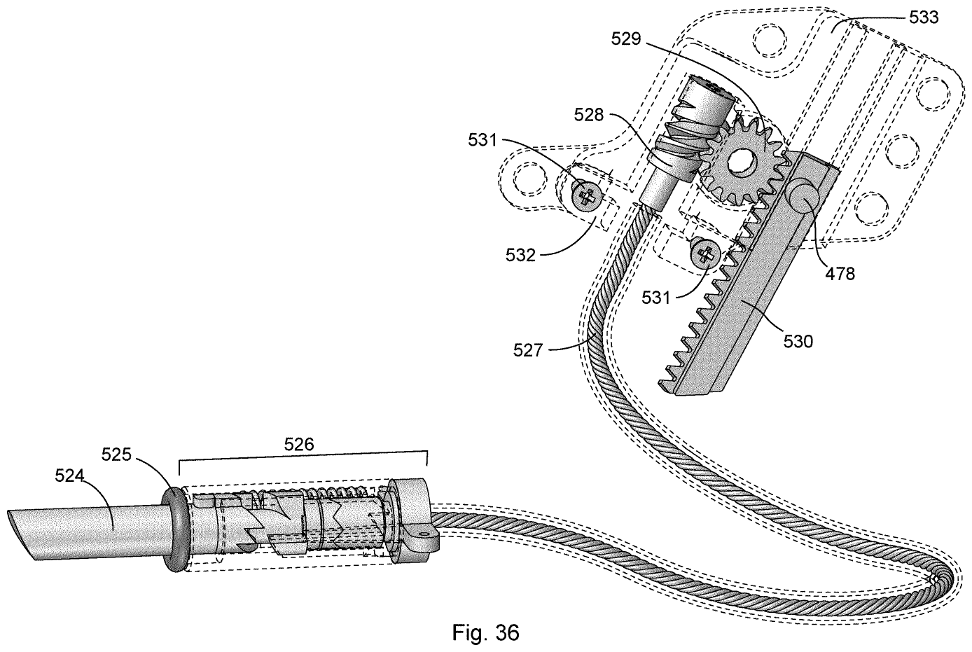

FIGS. 36, 37 and 39, show an overview, operation and exploded view of an example cam adjustment mechanism which allows the mouth anchor opening width to be adjusted.

An Adjustment Knob 524 may be rotated so as to change the location of a Pivot Point 478 upon which Linkage Two 479 may pivot. By changing the location of Pivot Point 478, the cam leverage may be adjusted and thereby, the mouth opening width in the Active position of the apparatus.

Adjustment Knob 524 may transmit rotational motion to a Push-Push Mechanism & Overrun Clutch 526 which may then transmit the rotational motion through a Flexible Shaft 527 to a Helical Worm Gear 528. Helical Worm Gear 528 may then transmit the rotational motion through a Helical Pinion Gear 529 to a Helical Rack 530, where it may be converted to linear motion. The linear motion may drive a Pivot Point 478 between Pivot Point (Maximum Width Position) 534 and Pivot Point (Minimum Width Position) 535. A Linkage Two Retention Flange 549 may keep Linkage Two 479 from falling off or separating from Pivot Point 478. Helical Worm Gear 528 may be held in place by a Worm Gear Bushing 532 which attaches to a Geartrain Housing 533 with one or more of a Flat-Head Screw 531. Adjustment Knob 524 may be sealed against fluid or contaminant ingress by a Sealing O-Ring 525.

A Push-Push Mechanism & Overrun Clutch 526 may allow Adjustment Knob 524 to be stowed when not in use. Each push of Adjustment Knob 524 may cause it to be cycle between the extended state where it may be rotated, and the retracted state where the body of the knob may be hidden.

When Adjustment Knob 524 is pushed, it may drive a Plunger 541 into a Follower 542. Plunger 541 may be prevented from rotating by having one or more protrusions which may fit into corresponding grooves in a Housing 540. Housing 540 may have one or more angled grooves at various depths into which the angled protrusions of Follower 542 may fit. Plunger 541 may also have one or more angled protrusions which may be offset from the angled protrusions of Follower 542 when Follower 542 is at rest in the grooves of Housing 540. When Adjustment Knob 524 pushes the angled protrusions of Plunger 541 into the angled protrusions of Follower 542, Follower 542 initially moves backwards (i.e. away from Adjustment Knob 524) without rotation due to the grooves of Housing 540 preventing Follower 542 from rotating. As soon as the angled protrusions of Follower 542 clear the rotation-restricting grooves of Housing 540, the angled protrusions of Plunger 541 may cause Follower 542 to rotate due to the interaction of the angled protrusions causing rotational force. Due to the V-like shape of the angled protrusions on Plunger 541 and Follower 542 and the V-like shape of the angled grooves of Housing 540, Follower 542 only rotates a half-step until its angled protrusions drop to the bottom of the V's of Plunger 541.

Adjustment Knob 524 may be attached or bonded to a Clutch Pressure Plate & Shaft 544 with adhesives, fasteners, insert molding or other attachment means. Clutch Pressure Plate & Shaft 544 may be indirectly driven by one or more of a Clutch Extension Spring 547 via a Clutch Driven Plate 545, a Clutch Driven Plate Ball Bearing 546 and a Clutch Cover Plate 548 such that a biasing force is continuously present on Adjustment Knob 524 wanting to drive it to the extended position.

The V's of Plunger 541 may be located between the V's of Housing 540, so that when Adjustment Knob 524 is released and driven outward towards the extended position, Follower 542 may rotate another half-step when it encounters the angled grooves of Housing 540. As the angled grooves of Housing 540 alternate between deep and shallow, Adjustment Knob 524 correspondingly alternates between the extended and retracted positions.

Push-Push Mechanism & Overrun Clutch 526 may consist of:

A Housing 540, which may have one or more grooves that allow Adjustment Knob 524 to only be pushed in with one orientation (such that the curvature at end of the knob matches the surface of the device that it is part of) and also may provide one or more stops for a Follower 542, which may limit the distance that the knob can extend out to. Housing 540 may also have internal grooves to constrain Plunger 541 to linear motion. A Plunger 541 may rotate Follower 542 with each push, causing it to cycle between the extended and retracted states, thereby allowing Adjustment Knob 524 to either be extended for user adjustment of the mouth opening width, or retracted for aesthetic and interference reasons.

A Clutch Pressure Plate & Shaft 544 may be rigidly attached to Adjustment Knob 524 such that rotation of the adjustment knob may be transmitted to the clutch pressure plate, and may allow the axial position of the clutch pressure plate to control the depth of extension of the adjustment knob. Clutch Pressure Plate & Shaft 544 may have knurling and may have Adjustment Knob 524 injection molded around it, or may be attached with adhesives, ultrasonic or heat welding, fasteners or other attachment means. Follower 542 may be rotationally isolated from Clutch Pressure Plate & Shaft 544 by a Clutch Pressure Plate Ball Bearing 543, which allows the knob to spin freely while still allowing Follower 542 to control the depth of extension of Adjustment Knob 524 (via the clutch pressure plate).

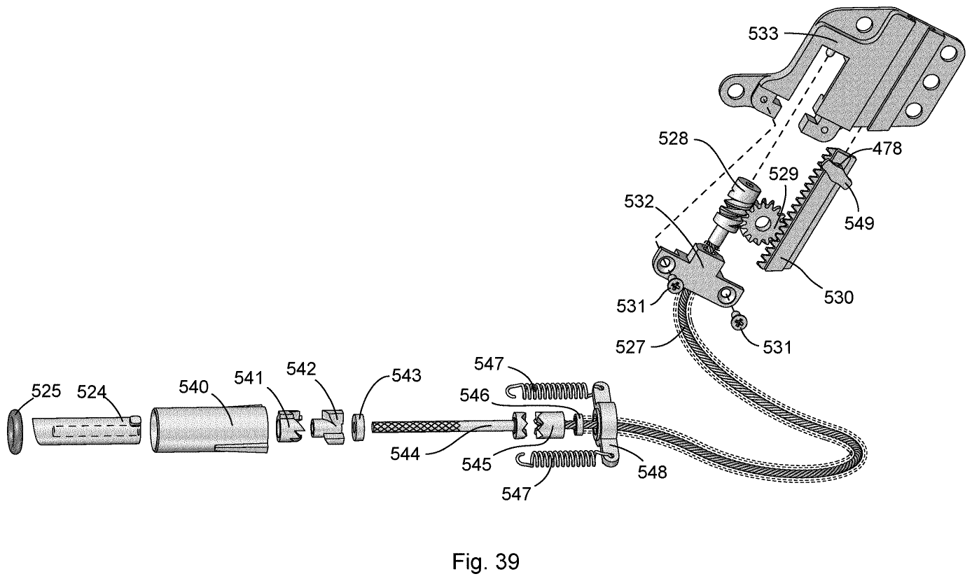

A Clutch Pressure Plate & Shaft 544 and a Clutch Driven Plate 545, along with a Clutch Driven Plate Ball Bearing 546, Clutch Extension Springs 547 and Clutch Cover Plate 548 may form an overrun clutch which may prevent damage to the mechanism in case the user fails to stop turning the adjustment knob when it reaches the limits. The pressure plate and the driven plate can be smooth flat, roughened flat, or have geometrical protrusions (as shown in FIG. 39, a so-called “dog clutch”) depending on the amount of friction required to transmit the sufficient force to Helical Worm Gear 528 to drive Helical Rack 530.

While the above cam adjustment example utilizes a flexible cable, a worm gear, a helical spur gear, a helical rack, and an adjustable pivot point, other variations may be contemplated by one of ordinary skill in the art. For example, an adjustment knob may be attached or coupled to a threaded rod that meshes with a threaded hole in a constrained pivot point, thus causing the pivot point to move when the knob is turned. Alternatively, an adjustment knob may have or be attached or coupled to gear teeth that mesh with complementary gear teeth on a rack or circular gear containing a pivot point, thus causing the rack and pivot point to move when the knob is turned. The coupling may be direct or through an intermediary such as a flexible shaft or CV or universal joint. The adjustment mechanism may incorporate electrical and/or electronic components. For example, an adjustment knob may be connected to a potentiometer or encoder that delivers a signal that controls the output of a motor or actuator coupled to a pivot point.

FIG. 40 shows cam position detection via a microswitch.

Cam Follower Pin 483 may be connected to Linkage Three 482, which may be connected to Linkage Two 479 via Pivot Connection 477, which allows the two linkages to rotate along an axis. Cam Follower Pin 483 may move along a path defined by Rear Cam Track 490 and Rear Cam Island 491.

Cam Switch PCB 498 may contain an Active Position Detection Microswitch 499 and may be attached (directly or indirectly) to Rear Cam Island 491. When Cam Follower Pin 483 is not in the active position (as shown in FIG. 40), a Microswitch Plunger 550 is not depressed and Active Position Detection Microswitch 499 does not register a signal with the processing circuitry.

However, when Cam Follower Pin 483 moves to the active position (as shown by the dotted lines), Microswitch Plunger 550 is depressed and Active Position Detection Microswitch 499 sends a signal to the processing circuitry indicating that Cam Follower Pin 483 is in the active position and that the operation may proceed.

The same microswitch arrangement can be used for the Storage Position or any other cam position that is desired to be sensed.

FIG. 41 shows cam position detection via isolated contacts.

A Conductive Cam Follower Pin 553 may be bonded to an Insulated Linkage Three 554, which may be connected to Linkage Two 479 via a Pivot Connection 477, which allows the two linkages to rotate along an axis. Conductive Cam Follower Pin 553 moves along a path defined by Rear Cam Track 490 and Rear Cam Island 491. Conductive Cam Follower Pin 553 may be connected to a Sense Current Wire 552 using one or more of a Pan-Head Screw 493 or other means of electrical connection such as soldering or crimping.

An Active Position Conductor 555 may be insulated from Rear Cam Island 491 via an Insulator 556. Active Position Conductor 555 may be connected to a Sense Current Return Wire 557 using one or more of a Pan-Head Screw 493 or other means of electrical connection such as soldering or crimping.

When Conductive Cam Follower Pin 553 is not in the active position (as shown in FIG. 41A), A Sense Current 551 passes through a Sense Current Wire 552 but stops at Conductive Cam Follower Pin 553.

However, when Conductive Cam Follower Pin 553 moves to the active position (as shown in FIG. 41B), Sense Current 551 may pass through Sense Current Wire 552 then through Conductive Cam Follower Pin 553 then through Active Position Conductor 555 then through Sense Current Return Wire 557, where a Sense Current Return 558 may then proceed to the processing circuitry indicating that Conductive Cam Follower Pin 553 is in the active position and that the operation may proceed.

The same isolated contact arrangement can be used for the Storage Position or any other cam position that is desired to be sensed.

FIG. 42 shows an active anchoring mechanism powered by a motor or actuator and capable of measuring the force applied or received.

Upper Mouth Anchor 466 and/or Lower Mouth Anchor 467 may be covered with a Cushion Pad 487 and which may fit into the upper and/or lower gum pockets, as shown in FIG. 21. The Mouth Anchors may have one or more Mouth Anchor Extensions 559 which may fit into an Opening or Tunnel 561 of a Mouth Anchor Holder Body 560. The Mouth Anchor Extension 559 may slide through Opening or Tunnel 561, for example, to adjust the lever arm distance to accommodate wider or narrower mouths, or to compensate for overbite or underbite. Mouth Anchor Holder Body 560 may contain or interface with a mechanism to lock and/or adjust the in-out position of a Mouth Anchor relative to Opening or Tunnel 561.

A Support Frame 562 may have one or more holes into which may be mounted one or more Bushings or Bearings 563. The Bushings or Bearings 563 may be secured to Support Frame 562 via, without limitation, press-fit, clamping, welding, adhesives or fasteners. Bushings or Bearings 563 may be sealed against moisture and/or debris ingress, for example with gaskets, o-rings or sealants. Alternatively, instead of Bushings or Bearings 563, Support Frame 562 may have holes bored or formed in it which directly serve as bushings. Mouth Anchor Holder Body 560 may have a protrusion or attached member which fits into a hole or Bushing or Bearing 563 and serves as an axle upon which Mouth Anchor Holder Body 560 may rotate. Alternatively, Mouth Anchor Holder Body 560 may have a hole or recess into which a rod, spline or other protrusion may fit, again forming an axle upon which Mouth Anchor Holder Body 560 may rotate.

One or more Mouth Anchor Holder Bodies 560 may be mounted to Support Frame 562. Mouth Anchor Holder Body 560 may have a hole through which a Pan-Head Screw 493 or other fastener may pass. Pan-Head Screw 493 may pass through a Bushing or Bearing 563 and screw into a Threaded Hole 568 which may be part of a Retention Plug 564 or a Cross-Bar 569, thereby clamping Mouth Anchor Holder Body 560 to Support Frame 562 while allowing rotation.

Mouth Anchor Holder Body 560 may have a Synchronization Gear 473 which may mesh with a Synchronization Gear 473 on the complementary Mouth Anchor Holder Body, such that rotation applied to Upper Mouth Anchor 466 results in counter-rotation of Lower Mouth Anchor 467 and vice versa.

Cross-Bar 569 may transmit force between a left Mouth Anchor Holder and a right Mouth Anchor Holder to keep the movement of both sides synchronized and prevent undue differential force being exerted on the Mouth Anchor and possibly bending or breaking it. Cross-Bar 569 may have a spline with a Threaded Hole 568 in the center, which may pass through Bushing or Bearing 563. The Cross-Bar spline may mate with a complementary splined recess which may be part of Mouth Anchor Holder Body 560, thereby rotationally locking the pair together. Alternatively, Mouth Anchor Holder Body 560 may have a spline and Cross-Bar 569 may have a splined recess. Other types of interlocking features known to one of ordinary skill in the art may be used, such as a keyway with Woodruff key or a polygon such as a square drive. Mouth Anchor Holder Body 560 may be secured to Cross-Bar 569 via a Pan-Head Screw 493 or other fastener which may pass through a non-threaded clearance hole of Mouth Anchor Holder Body 560 and mate with Threaded Hole 568 on Cross-Bar 569.

Cross-Bar 569 may have a plurality of Gear Teeth 570 which may mesh with a Gear 573, such that rotation of Gear 573 rotates Cross-Bar 569. Cross-Bar 569 may have one or more Gear Stops 567 to prevent excessive rotation by placing a physical limit to the amount that Cross-Bar 569 can rotate. Alternatively, there may be physical stops on a different component, such as Support Frame 562 which physically prevent Cross-Bar 569 from rotating too far. This may be useful to prevent damage to the apparatus and/or injury to the user in case of a motor driver circuit failure or firmware error.

Gear 573 may be mounted to Shaft 574 of Motor or Actuator 565, such that activation of Motor or Actuator 565 causes rotation of Gear 573. Motor or Actuator 565 may be powered by a motor or actuator driver having a bipolar or equivalent output such that Motor or Actuator 565 may be commanded to rotate in a clockwise direction or a counterclockwise direction, thereby driving the Mouth Anchors together or apart. Rather than having a rotary output, Motor or Actuator 565 may have a linear output, for example, from a linear actuator. The linear output may directly drive Cross-Bar 569, Mouth Anchor Holder Body 560 or one or both Mouth Anchors, for example, via one or more push-rods. The power source for Motor or Actuator 565 may be, without limitation, a battery, AC/DC adapter, USB or mains power.

Motor or Actuator 565 may be attached to Support Frame 562 either directly or via a Bracket or Beam 571. Motor or Actuator 565 may be attached with Pan-Head Screws 493, other types of fasteners, adhesives, welding, clamping or other mounting techniques. One or more Force Sensors 572 may be mounted to Bracket or Beam 571 and/or Motor or Actuator 565 and/or Shaft 574 and/or Cross-Bar 569 and/or Mouth Anchor Holder Body 560. Multiple force sensors of the same or different types may be used for redundancy.

Motor or Actuator 565 may have an Optical or Magnetic Encoder 566 to measure the angular rotation and thereby the degree of opening of the Mouth Anchors. Motor or Actuator 565 may be a type of motor such as a stepper motor or a servo whereby an external sensor such as a magnetic encoder is not required to move or rotate a specified amount. Other sensors may also be used, for example, without limitation, a rotary or linear potentiometer or a switch or an optical interrupter, which may be mounted to Motor or Actuator 565 or to another part of the apparatus. The current supplied to Motor or Actuator 565 may be measured by a current sensor and used to calculate the torque generated, thus serving as a type of force sensor. Motor or Actuator 565 and/or Optical or Magnetic Encoder 566 and/or Force Sensor(s) 572 and/or other sensors may be connected to processing circuitry such that the opening width of the Mouth Anchors may be commanded and/or faults detected. Processing circuitry may control one or more motor or actuator drivers for generating the voltages and/or currents and/or pulse patterns to control the speed and/or direction of one or more Motors or Actuators 565. Processing circuitry may utilize feedback from one or more sensors combined with algorithms such as a PID controller to move or hold position of the Mouth Anchors. A PID controller may obviate the need for a force or current sensor by commanding a position, then observing the PID output required to obtain and/or maintain that position, thus serving as a proxy force measurement. Processing circuitry may incorporate a microprocessor, microcontroller or other programmable device such as a field-programmable gate array (FPGA), or may be discrete circuitry that generates voltages, currents and/or signals for Motor or Actuator 565 based on hardwired circuits.

The oral positioning apparatus may have sensors and/or mechanisms and/or algorithms to calibrate the Mouth Anchors to a known position. For example, to set the Mouth Anchors zero position, processing circuitry may command the Motor or Actuator 565 to close the Mouth Anchors (at a reduced speed and/or force that won't cause damage when stalled) until Optical or Magnetic Encoder 566 indicates that the motor or actuator is no longer making progress, or until a time which is greater than the maximum closing time has elapsed. As another example, Cross-Bar 569 or another component in the motion chain may contact a switch when moved to a certain position, which may be sensed and relayed to processing circuitry. As a third example, Cross-Bar 569 or another component in the motion chain may interrupt a beam of light when moved through a certain position, which may be sensed by an optical detector and relayed to processing circuitry. As a fourth example, Cross-Bar 569 or another component in the motion chain may have a magnet or other source of magnetic flux mounted to it, which may be sensed by a magnetic detector such as a Hall-effect sensor and relayed to processing circuitry. As a fifth example, Cross-Bar 569 or another component in the motion chain may be constructed of a conductive material or may have a conductive patch attached to it, which completes a circuit when moved to a certain position and sends a signal to processing circuitry.

Motor or Actuator 565 may have, or be connected to, a gearbox to reduce the motor speed and increase the motor torque. The gearbox may be of a type which allows the motor to be back-driven if the user bites down on the Mouth Anchors with sufficient force. This has the advantage of allowing the user to collapse the Mouth Anchors for removal from the mouth in case of a failure of the motor driver(s), motor(s), power supply or processing circuitry, but has the disadvantage of requiring the motors to be actively driven in order to hold the user's jaws apart. Alternatively, the gearbox may be of a type such as a worm gear or high-ratio spur gear which does not allow the motor to be back-driven. This has the advantage of not requiring any power to hold the user's jaws apart, but may make removal of the Mouth Anchors difficult in case of a failure of the motor driver(s), motor(s), power supply or processing circuitry.

An example cycle of operation may be as follows: Upon startup, processing circuitry may turn off the motor or actuator driver(s), and perform self-checks, for example, looking for out-of-bounds, illegal, changing or discordant sensor values. If the self-check fails, processing circuitry may notify the user, for example, via a blinking or solid red light, an audio buzzer, or a warning message on a display or given via voice playback. If the self-check passes, processing circuitry may then calibrate the position of the Mouth Anchors, for example, by commanding the Motor or Actuator 565 to close the Mouth Anchors (at a reduced speed and/or force that won't cause damage when stalled) until Optical or Magnetic Encoder 566 indicates that the motor or actuator is no longer making progress, or until a time which is greater than the maximum closing time has elapsed. The internal position variable may then be zeroed.

Processing circuitry may then command the Mouth Anchors to be slightly apart, waiting for the user to insert the oral positioning apparatus into his or her mouth and bite down on the Mouth Anchors. Processing circuitry may then wait until detecting the Mouth Anchors closing from the user biting down on them, for example, from Optical or Magnetic Encoder 566 or another sensor indicating closing movement, or Force Sensor 572 or a motor current sensor indicating force applied to the Mouth Anchors.

Processing circuitry may then command Motor or Actuator 565 to open the Mouth Anchors to a normal operating width. This normal opening width may vary between individuals, for example a child may have a smaller opening width than an adult. The normal opening width may be set once and then stored in non-volatile memory such that the value is retained even when power is lost. The normal opening width may be set in various ways, for example, the apparatus may have pushbuttons which activate Motor or Actuator 565 to increase or decrease the Mouth Anchors opening width and a third pushbutton to store the normal operating width value. Alternatively, processing circuitry may command Motor or Actuator 565 to open the Mouth Anchors at a reduced speed and/or force that won't cause injury until Optical or Magnetic Encoder 566 indicates no further opening, or Force Sensor 572 or a current sensor exceeds a threshold value, signifying that the user's jaws have been opened to their maximum physical width. Processing circuitry may then subtract some width from the measured value so that the user's jaws aren't forced to an uncomfortable position and store that value as the normal opening width or simply perform this auto-adjustment every time the apparatus is activated.

Processing circuitry may then wait until force on the Mouth Anchors is detected by Force Sensor 572 or a current sensor, signifying that the user is either biting down or resting his or her jaws on the Mouth Anchors. Processing circuitry may then signal the user to press a button to activate additional operations such as automated cleaning, inspection or dental repair, or may immediately activate the operation(s) upon force detection without user intervention. Alternatively, processing circuitry may signal with visual or auditory cues to a professional such as an oral hygienist or dentist that the user's jaws are in the nominal position and that the work may begin.

During the operation(s), processing circuitry may monitor the force exerted on the Mouth Anchors. In the case of a malfunction or excessive pain, the user may signal his or her desire to stop the procedure by opening the mouth wider, thereby reducing the force applied to the Mouth Anchors. Processing circuitry may detect this decrease in force via Force Sensor 572 or a current sensor and stop the operation or signal to the dental professional to halt the procedure. Alternatively or additionally, instead of a force or current sensor, the oral positioning apparatus may detect the lack of contact between the gums and Mouth Anchors, for example, with a microswitch depressed by contact with the gums, or via a capacitive touch sensor. Processing circuitry may also monitor for other faults during the operation(s), such as excessive force detected or motor control failure and abort the operation(s) and/or return the apparatus to a safe state, for example, by stopping power to the motor drivers. The oral positioning apparatus may have additional safety systems, such as redundant sensors, an independent monitoring subroutine or a safety coprocessor.

After the conclusion of the operation(s), whether successful or aborted, processing circuitry may command Motor or Actuator 565 to collapse the Mouth Anchors to permit removal from the user's mouth.

Although the above description shows the use of an electrical motor, other power sources and/or actuators known to one of ordinary skill in the art may be substituted, such as, without limitation, a pneumatic or hydraulic cylinder powered by an air, gas, water, oil or hydraulic pump. Similarly, the control mechanism of the actuator may be, without limitation, a manual valve, an electrically-controlled valve, a pneumatically controlled valve or a solenoid.

FIG. 43 illustrates an example oral positioning apparatus 923 consisting of one or more spacers 575, which fit between an individual's upper and lower jaws behind the rear molars of the upper teeth 462 and the lower teeth 583 and hold the individual's jaws apart to permit access to the oral cavity. Additionally, as shown in FIG. 43, one or more spacers 575 may be attached to one or more members extending outside the oral cavity which may be transiently or permanently attached to an oral appliance or other device in order to position it in a fixed relationship to an individual's oral cavity. The oral positioning apparatus 923 may have a mechanism for detecting when an individual has opened his or her jaws to reduce or eliminate force upon the spacer(s) 575, which may be useful for allowing the user to signal a desired stop simply by opening his or her mouth. The oral positioning apparatus 923 may include one or more inner drainage tubes 577 and/or outer drainage tubes 578 in order to remove debris or saliva 580 from the individual's mouth.

With regards to FIGS. 43 through 47, spacer 575 and/or drain tube 584 may be constructed of, without limitation, an elastomer, such as natural, synthetic or silicone rubber, fluoropolymer, thermoplastic elastomer (TPE), thermoplastic olefin (TPO) or thermoplastic vulcanizates (TPV), plastic, wood, metal or a composite material. Spacer 575 may be covered, coated or bonded with a second material for comfort, durability, corrosion or aesthetic reasons, such as a soft silicone overmold. Spacer 575 may be compressible to permit easier insertion behind the rear molars. Spacer 575 may have one or more passageways, tunnels or channels formed or cut into it. Spacer 575 may be a simple shape such as a cube, or a complex shape such as a curved rectangular block with rounded edges. The upper and/or lower contact patches 594 of spacer 575 may be curved, shaped or molded to either loosely or tightly conform to the corresponding jaw geometry. Spacer 575 may have one or more access channels 598 which may permit swapping with a spacer 575 having a different size or geometry so as to accommodate different sizes or shapes of the oral cavity, for example, such as for children vs. adults or, in the case of vertebrate animals, different species.

Oral positioning apparatus 923 may have one or more members to mechanically couple to another device such as an oral appliance in order to provide a fixed localization of the device relative to one or more features of the oral cavity, such as the upper jaw (maxilla) 920 and/or lower jaw (mandible) 921. The oral features may form reference points for locating other oral structures and the relative distances and orientations between them. For example, if one or more spacers 575 are clamped between and thus anchored to the upper jaw (maxilla) 920 and/or lower jaw (mandible) 921 and the distance and geometry of the member(s) connecting the spacer(s) 575 to the oral appliance are known, then the approximate location of the front teeth may be inferred. The approximate location of the front teeth may then be used as a starting point for precisely locating the gap between the frontmost two lower teeth via probing. Once the front gap is precisely located and used as a reference point, other oral features such as the locations of the rear molars may be determined using an oral map synced to or mathematically transformed to match one or more reference locations.

Some members may serve additional functions in addition to mechanical coupling. For example, as shown in FIG. 43, upper conductor 589 and lower conductor 588 and insulator 587 may be rigid and serve the function of mechanical coupling in addition to carrying current. Similarly, drain tube 584 may be made of a rigid material and may serve as a mechanical connection between spacer 575 and another device such as an oral appliance.

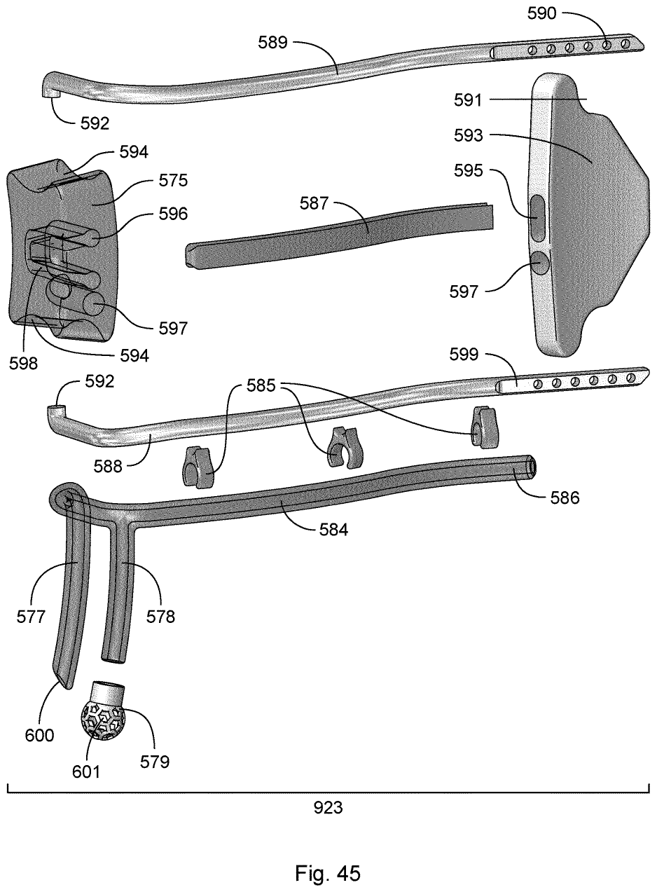

The mechanical coupling to another device may be permanently bonded or may have features for mating, attachment and separation. As an example, FIG. 45 shows a mating feature 599 which may be complementary to a corresponding mating feature on the connected device. The mating feature may be, without limitation, a reduced-width, height or thickness section, a member having a cross-section of a geometric shape such as a circle, triangle, square, rectangle, rounded rectangle, oval, star or other polygon. Mating feature 599 may be tapered so as to permit easy insertion into the connected device and/or provide a physical stop when the mechanical coupling member(s) have been fully inserted.

The mechanical coupling to another device may have one or more retention features 590 to permit the oral positioning apparatus 923 to be permanently or temporarily attached to another device. Retention feature(s) 590 may be, without limitation, holes, protrusions, recesses, notches, flanges or magnets. The retention features may be engaged by one or more complementarily-shaped engagement features on the connected device, similar to FIG. 12. Alternatively, if the retention features 590 are magnetically-based such as permanent magnets, then they may be engaged with magnets and/or electromagnets in the connected device.

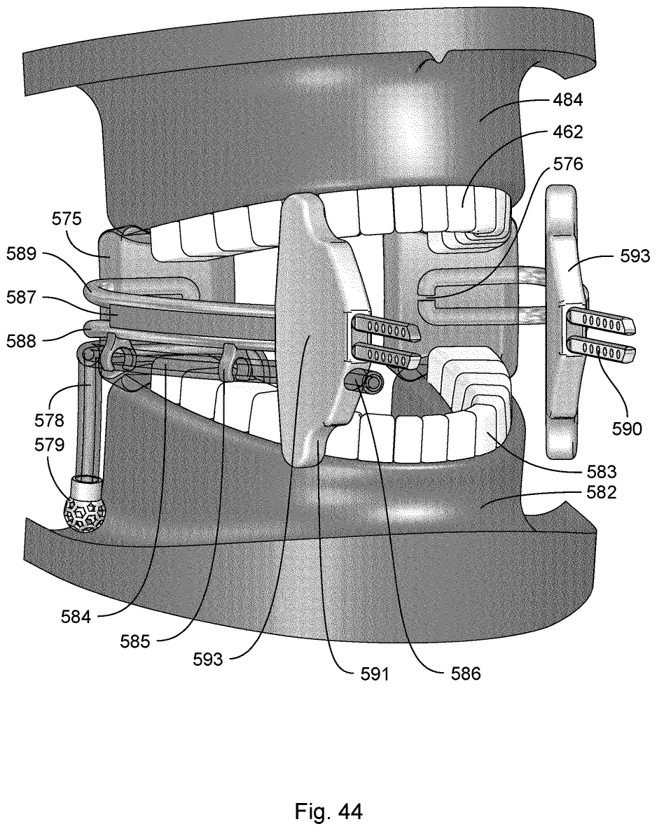

Oral positioning apparatus 923 may include features for displacing the lips or other soft tissues of the mouth such as the cheeks to avoid pinching or damage. FIGS. 44 and 45 illustrate a soft-tissue displacer 593. Soft-tissue displacer 593 may be made of, without limitation, plastic, an elastomer, such as natural, synthetic or silicone rubber, fluoropolymer, thermoplastic elastomer (TPE), thermoplastic olefin (TPO) or thermoplastic vulcanizates (TPV), wood, metal or a composite material. Soft-tissue displacer 593 may be attached to spacer 575 and/or mechanical coupling members. Soft-tissue displacer 593 may have one or more channels or grooves 591 to retain the lips or other soft-tissues in a defined place. Soft-tissue displacer 593 may have, without limitation, rails, rods, rigid tubes or flat or curved plates to displace soft-tissues such as the cheeks to avoid being pinched or damaged. Soft-tissue displacer 593 may have one or more passageways 595 and/or tube passageways 597 to permit members and/or tubes to pass through the soft-tissue displacer 593. The members and/or tubes may pass through unattached or may be attached to the soft-tissue displacer 593 by clamping via a groove and flange, fasteners, or engaging features such as interlocking tabs or clasps, adhesives, heat staking, welding, overmolding and the like.

Oral positioning apparatus 923 may include a drainage system for removing saliva and/or debris from the oral cavity. FIGS. 43 to 45 illustrate the use of drain tubes to remove saliva and/or debris 580 from the oral cavity. A drain tube 584 may be permanently or removably attached to oral positioning apparatus 923 with clamps 585, fasteners, or engaging features such as interlocking tabs or clasps, adhesives, heat staking, welding, overmolding and the like. Drain tube 584 may be integrally molded with spacer 575 or may be separate from it and pass through and/or be bonded to one or more tube passageways 597. Similarly, drain tube 584 may pass through and/or be bonded to one or more tube passageways 597 in a soft-tissue displacer 593.

Drain tube 584 has a connector or terminus 586 for attachment to a pump, either directly or through intermediate tubing and/or piping. The pump may be, without limitation, a peristaltic pump, a venturi vacuum pump or a mechanical vacuum pump such as rotary vane, diaphragm, liquid ring, scroll or screw, Connector or terminus 586 may simply be the cut end of drain tube 584 or may be a specialized fitting such as a quick disconnect fitting, nipple, barbed fitting, Luer connector or probe such as for probe-and-drogue connections.

Drain tube 584 may directly terminate inside the oral cavity or may have one or more auxiliary drain lines connected to it. Drain tube 584 may have an inner drain tube 577 to drain the inner portion of the oral cavity (i.e. where the tongue is located) and/or an outer drain tube 578 to drain the outer portion of the oral cavity (i.e. where lower gum pocket 581 is located).

In order to reduce the likelihood of the drain tube being blocked by either debris or by sticking to the soft tissues and/or gums of the oral cavity, the end(s) of the drain tube(s) may have an angled cut 600 or have an intake filter 579. The holes 601 in intake filter 579 may be sized to permit the passage of debris, for example, bits of polishing compound while blocking larger objects that would clog the drain line(s) such as chunks of toothpaste. Intake filter 579 may be a separate piece attached to inner drain tube 577 and/or outer drain tube 578 or may be an integrally molded part of the drain tube(s). Intake filter 579 may have a spherical or polyhedral shape such as a dodecahedron or icosahedron to reduce the likelihood of being blocked by surrounding soft tissues or gums due to having holes 601 in almost all directions.

Oral positioning apparatus 923 may omit the mechanical coupling member(s) and simply have spacer 575 be standalone and not connected to a device or apparatus. This configuration may be useful to dentists and/or orthodontists who need to have a patient's mouth propped open to perform cleaning or repair operations or surgery, especially if the patient is anesthetized and cannot comply with instructions to hold his or her mouth open. Additionally, one or more drain tubes 584 may be attached to and/or pass through spacer 575 and be connected to a suction pump for automatic draining of debris and saliva 580, thus obviating the need for periodic manual suctioning of the oral cavity. A left-side spacer and a right-side spacer may be separately inserted behind the rear molars, or a single-piece unit comprised of a left-side spacer and a right-side spacer connected with a flexible or rigid member may be utilized for convenience.

Oral positioning apparatus 923 may include a mechanism for detecting when an individual has bitten down on and/or opened his or her jaws to reduce or eliminate force upon the spacer(s) 575. Such a detection mechanism may be based on, without limitation, electrical, magnetic, electromagnetic, optical, mechanical, pneumatic or hydraulic principles.

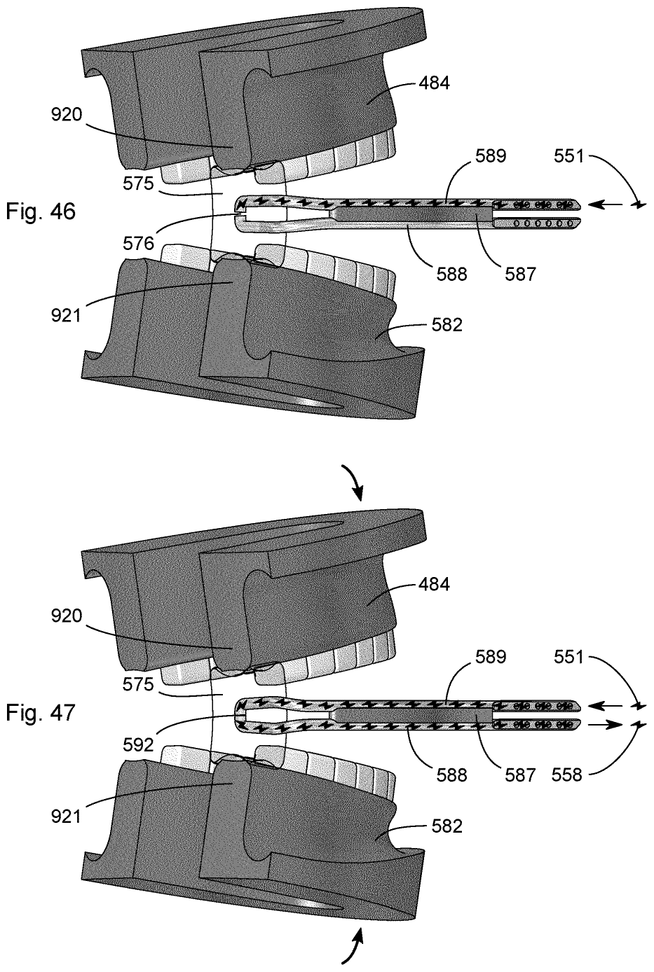

FIGS. 46 and 47 illustrate the principle of operation of an example electrical contact-based system for detecting force on spacer 575. An upper conductor 589 and a lower conductor 588 are electrically separated, but may be physically connected or bonded, for example, by one or more insulators 587. Upper conductor 589 and lower conductor 588 may have a gap 576 or another type of electrical separation which can be breached upon the application of mechanical force, such as an electrical switch. As seen in FIG. 45 The switch, gap 576 or other means of transient electrical connection may be located internal to and/or mechanically coupled to spacer 575. Spacer 575 may be constructed of an elastomeric material such as rubber, and upper conductor 589 and lower conductor 588 may be located in one or more conductor channels 596 of spacer 575 with a section of elastomeric material between the conductors to maintain gap 576. Spacer 575 may have one or more access channels 598 which may permit swapping of spacers 575 with a greater or lesser hardness (durometer) and/or amount of material between the conductors, thereby adjusting the threshold of force required to bridge the gap 576 or activate a transient electrical connection device such as switch. The threshold of force may be set so that the user is actively required to bite down on the spacer(s) 575 to activate the electrical connection, or may be set so that the normal restoring force of stretched muscles when the jaws are held apart by spacer(s) 575 is sufficient to activate the electrical connection.

FIG. 46 illustrates an electrical contact-based force detection apparatus when zero force or insufficient force to bridge gap 576 is applied to spacer 575 via the upper jaw (maxilla) 920 and lower jaw (mandible) 921. A current source such as a battery, transformer or input/output pin of a microprocessor may apply a sense current 551 to upper conductor 589. However, due to gap 576, the current cannot flow to lower conductor 588. In order to prevent electrolysis of water and aqueous salts in the mouth, potentially generating hydrogen and/or chlorine gases and/or sodium hypochlorite, a voltage of the current source below 1.23 volts is preferred.

FIG. 47 illustrates an electrical contact-based force detection apparatus when sufficient force has been applied to spacer 575 to cause contact between the electrical contacts 592 of upper conductor 589 and lower conductor 588. Sense current 551 can then flow through the conductors to sense current return 558 where it can be converted to a voltage and/or detected by a microprocessor and/or processed to detect a change from current flow to no current flow. The detected current or lack thereof can trigger various actions. For example, detection of current (i.e. indicating jaws resting or biting down on the spacer(s) 575) may prompt the user to press a button to begin an automated cleaning cycle, or may simply begin the operation. Conversely, a detection of stopped current (i.e. indicating that the user has opened his or her jaws wider to reduce or eliminate force upon the spacer(s) 575) may indicate that the user wishes to stop or abort operation of the device and thus may cause circuitry to cutoff power to actuators or cause a control program running on processing circuitry to return an oral cavity tool to a storage position. Other types of actions triggered by the presence or absence of current may be contemplated, such as prompting the user for confirmation that he or she wishes to stop operation of the device.

While FIGS. 43 through 47 show the use of binary (presence/absence) force sensing using electrical contacts, other modalities of force or touch sensing may be contemplated by one of ordinary skill in the art. For example, one or more sensors may be embedded inside spacer 575 and connected to processing circuitry through either rigid conductors, wires or rigid or flexible tubes. More than one of the same type or dissimilar sensors may be used to provide redundancy and detection of faults in the sensor or the connecting wiring or tubing. The sensor(s) may be standalone or may be mounted to a printed-circuit board (PCB) or other type of substrate.

As a first example, a force or strain sensor may be embedded in and/or mechanically coupled to spacer 575. Such a sensor may be, without limitation, a force-sensitive resistor, strain gauge, imaging system using polarized light for detecting strain or deformation or an interferometer which measures a change in dimensions of either the spacer itself or a light pipe passing through it due to deformation caused by applied force. The sensor may be excited with a constant or switched voltage or current source and the signal from the sensor may be converted and/or processed using, without limitation, a resistor, Wheatstone bridge, op-amp, current-to-voltage converter or filtered using either electronic circuits or software algorithms. Analog force or pressure measurements may be converted to digital signals using, without limitation, a comparator, op-amp or software algorithms such as fixed or moving-average thresholding.

As a second example, a fluid reservoir such as a bladder, sac, hollow or pinched/capped flexible tube may be internal to or mechanically bonded to spacer 575. The fluid reservoir may be connected to a pressure sensor, either directly or via a rigid or flexible tube. The working fluid may be, without limitation, air, water, saline, oil, an inert gas such as nitrogen or a noble gas, hydraulic fluid or another suitable liquid. The pressure sensor may output an analog signal proportional to the pressure, or a digital signal when the pressure exceeds a threshold value. As with the force sensors, analog pressure signals may be converted to digital signals using, without limitation, a comparator, op-amp or a fixed or moving-average thresholding software algorithm. Upon the application of force via upper jaw (maxilla) 920 and lower jaw (mandible) 921, spacer 575 will be deformed, which will compress the fluid reservoir, thereby increasing the pressure of the working fluid, which will be detected by the pressure sensor. Additional sensors of the same, similar or different types may be used for redundancy.

As a third example, a sensor which detects touch, contact, moisture, pressure or heat may be mounted to the top and/or bottom of spacer 575 to detect when spacer 575 has come in contact with the upper gums 484 covering the upper jaw (maxilla) 920 and/or the lower gums 582 covering the lower jaw (mandible) 921. Some examples of such sensors are, without limitation, a capacitive touch sensor, a switch or microswitch for detecting contact, a moisture or conductivity sensor for detecting the saliva coating the gums, or a thermistor, thermocouple, passive IR or other thermal sensor for detecting the heat of the gums. Such a sensor may be in one or more parts, for example, a capacitive touch sensor may consist of a conductive sensing patch located on top of spacer 575 connected via shielded or unshielded wire to a capacitive sensing chip such as a TI LDC0851 or FDC1004, which may then be connected to a microprocessor or other electronic circuit. As another example, a tube running through spacer 575 with an open-end terminating on the top of spacer 575 may connect to a remote pressure sensor. When the user bites down on spacer 575, it seals the end of the tube and further compression causes the pressure in the tube to increase, which is detected by the pressure sensor.

As a fourth example, spacer 575 may have a magnet or electromagnet and a magnetic sensor, such as a Hall-effect sensor embedded in it. Upon compression of spacer 575 due to the normal restoring force of the jaw muscles when the jaws are held apart, or due to the user biting down upon the spacer(s) 575, the distance between the (electro) magnet and sensor decreases which may be detected by the magnetic sensor and relayed to processing and/or control circuitry. The sensor may output a binary signal indicating compressed/not compressed or a continuous or analog signal indicating magnetic strength which may be further processed by electronic circuit(s) and/or processing circuitry. Although a Hall-effect sensor was used in this example, other types of magnetic sensors are listed elsewhere in this disclosure and may be substituted instead.

As a fifth example, spacer 575 may have an optical source such as an LED or laser either embedded in it, or mechanically connected to it or transmitted to it, for example, with fiber optics. Similarly, an optical detector, such as a photocell, photodiode or phototransistor may also be embedded in spacer 575 or mechanically or optically coupled to it, such as with fiber optics. The optical source and the optical detector may be arranged such that compression of spacer 575 causes a cutoff or dimming of the light reaching the optical detector. This may be accomplished by having a light blocker such as a strip, bar, rod, opaque tape or other light blocking member mechanically coupled to spacer 575 such that compression causes the light blocker to move into the path of the light thus reducing the flux reaching the detector. Alternatively, the light blocker may be in the light path when no or little force is applied and subsequently moved out of the light path when spacer 575 is compressed thus causing an increase in flux reaching the detector when compressed. The signal generated by the optical detector may be a binary signal indicating compressed/not compressed or a continuous or analog signal indicating optical flux which may be further processed by electronic or optical circuit(s) and/or processing circuitry.

Other types of mechanical optical modulation are known to those of ordinary skill in the art and may be substituted. For example, the beam path between the optical source and detector may be altered to vary the light flux reaching the detector. One example of this is the case where separate optical fibers are connected to the source and detector and are in-line and facing each other when no force is applied to spacer 575. Upon the application of force to spacer 575, the optical fibers may become misaligned, thus decreasing the light flux reaching the detector. Additional optical components may be included in the optical modulator, such as mirrors, lenses, polarizers, films, reflective or polarizing coatings and the like. These components may be mechanically mounted to spacer 575 and cause modulation of the optical flux upon compression. As one example, a mirror or reflective patch mechanically coupled to spacer 575 may be configured to partially or fully reflect the light beam from the optical source to the optical detector. Compression of spacer 575 may alter the angle of the mirror, thus decreasing or increasing the light flux reaching the detector.

TABLE 2
Reference number descriptions for FIGS. 20 to 42
LIST OF REFERENCE NUMERALS

| # | Label | Description |
|---|---|---|
| 455 | End User | A human or animal being treated. |
| 456 | Cam Position 1 | The stable storage (i.e. collapsed) position of the cam. |
| | (Storage) | |
| 457 | Cam Position 2 | The transient cam position after the user bites down to |
| | (Storage | release the apparatus from the storage position. |
| | Release) | |
| 458 | Cam Position 3 | The expanded cam position immediately before the user |
| | (Pre- | bites down to the active position. |
| | Activation) | |
| 459 | Cam Position 4 | The active position of the cam where the operations are |
| | (Active) | performed. May require constant force from the user's jaw to |
| | | maintain in this position. |
| 460 | Cam Position 5 | The cam position after the user opens his or her mouth from |
| | (Post- | the active position in order to initiate the process of |
| | Activation) | apparatus removal. |
| 461 | Cam Position 6 | The transient cam position immediately before the user |
| | (Pre-Storage) | relaxes his or her jaws to return to the collapsed storage |
| | | position. |
| 462 | Upper Teeth | Upper teeth of the user. |
| 463 | Lower Teeth | Lower teeth of the user. |
| 464 | Upper Gum | Pocket between the user's upper front gums and the inside of |
| | Pocket | the upper lip. May have an Upper Frenulum 486. |
| 465 | Lower Gum | Pocket between the user's lower front gums and the inside of |
| | Pocket | the lower lip. |
| 466 | Upper Mouth | Part which may fit into and locate the apparatus relative to |
| | Anchor | the user's Upper Gum Pocket 464 and/or Upper Frenulum |
| | | 486. May be constructed of, without limitation, plastic for |
| | | cost, cleanability and aesthetics, optionally with plasticizers |
| | | to inhibit shattering if overloaded. |
| 467 | Lower Mouth | Part which may fit into and locate the apparatus relative to |
| | Anchor | the user's Lower Gum Pocket 465. May be constructed of, |
| | | without limitation, plastic for cost, cleanability and |
| | | aesthetics, optionally with plasticizers to inhibit shattering if |
| | | overloaded. |
| 468 | Upper Mouth | Attaches to, and constrains movement of the Upper Mouth |
| | Anchor Holder | Anchor, and may couple jaw movement via Upper Mouth |
| | | Anchor 466 to the cam mechanism. May be constructed of, |
| | | without limitation, metal, plastic or fiber-reinforced plastic |
| | | for strength. |
| 469 | Lower Mouth | Attaches to, and constrains movement of the Lower Mouth |
| | Anchor Holder | Anchor, and may couple jaw movement the Lower Mouth |
| | | Anchor 467 to the cam mechanism. May be constructed of, |
| | | without limitation, metal, plastic or fiber-reinforced plastic |
| | | for strength. |
| 470 | Upper Axis | Rotational axis for the Upper Mouth Anchor Holder(s) 468. |
| 471 | Lower Axis | Rotational axis for the Lower Mouth Anchor Holder(s) 469. |
| 472 | Rigid | Spline or other interlocking mechanism which couples |
| | Connection | rotational motion from a Mouth Anchor Holder to Linkage |
| | | One 476. |
| 473 | Synchronization | Gears which synchronize mirrored rotational motion |
| | Gear(s) | between Upper and Lower Mouth Anchors. May be |
| | | constructed of, without limitation, metal, plastic or fiber- |
| | | reinforced plastic for strength. |
| 474 | Spring Fixed | Fixed anchor point which permits the spring to generate |
| | Point | force. |
| | Attachment | |
| 475 | Extension | Spring that stores the user's jaw energy to power the motion |
| | Spring | of the Mouth Anchors and enables the unstable active |
| | | position and corresponding intrinsic safety features. |
| 476 | Linkage One | Linkage that transmits rotational motion from the Mouth |
| | | Anchor Holder to Linkage Two 479. May be constructed of, |
| | | without limitation, metal, plastic or fiber-reinforced plastic |
| | | for strength. |
| 477 | Pivot | Connection between two linkages that permits free rotation |
| | Connection | along one axis only, such as, without limitation, rivets, a |
| | | shaft with circlip(s) or an axle with retention screws or bolts. |
| 478 | Pivot Point | Fixed or adjustable point that determines the amount of |
| | | leverage and travel distance of Linkage Two 479, and thus |
| | | the opening width of the Mouth Anchors. |
| 479 | Linkage Two | Linkage that transmits the motion from Linkage One 476 to |
| | | Linkage Three 482. May have a slot which works with Pivot |
| | | Point 478 in order to adjust the amount of leverage and |
| | | travel distance. May be constructed of, without limitation, |
| | | metal, plastic or fiber-reinforced plastic for strength. |
| 480 | Cam Track | Outer guide which, along with Cam Island 481, forms the |
| | | path that Cam Follower Pin 483 follows. May be |
| | | constructed of, without limitation, metal, plastic or fiber- |
| | | reinforced plastic for strength. |
| 481 | Cam Island | Inner guide which, along with Cam Track 480, forms the |
| | | path that Cam Follower Pin 483 follows. May be |
| | | constructed of, without limitation, metal, plastic or fiber- |
| | | reinforced plastic for strength. |
| 482 | Linkage Three | Linkage that transmits the motion from Linkage Two 479 to |
| | | Cam Follower Pin 483. May be constructed of, without |
| | | limitation, metal for strength, plastic or fiber-reinforced |
| | | plastic for strength and non-conductivity. |
| 483 | Cam Follower | Pin that follows the cam path created by Cam Track 480 and |
| | Pin | Cam Island 481. May be constructed of, without limitation, |
| | | metal, plastic or fiber-reinforced plastic for strength. |
| 484 | Upper Gums | Upper gums of the user. |
| 485 | Lower Gums | Lower gums of the user. |
| 486 | Upper | Flap of sensitive skin, present in most people, which |
| | Frenulum | connects the upper gums to the inside of the upper lip. May |
| | | necessitate a notch in Upper Mouth Anchor 466 due to being |
| | | painful when pressed. May be used as a locating feature due |
| | | to its centered location. |
| 487 | Cushion Pad | Soft cushion pad to protect the sensitive gums of the user |
| | | from the optionally stiff material of the Mouth Anchor(s). |
| | | May have a notch to constrain and/or locate and/or protect |
| | | the user's frenulum. May be constructed of, without |
| | | limitation, silicone, synthetic or natural rubber or a |
| | | thermoplastic elastomer (TPE). May be overmolded or |
| | | attached via, without limitation, adhesives, fasteners or |
| | | mechanical interlocks. |
| 488 | Spline | Mating feature for rotating elements which transmits |
| | | rotational motion from the Mouth Anchor Holder to Linkage |
| | | One 476. |
| 489 | Linkage Two | Extension spring that stores the user's jaw energy to power |
| | Extension | the motion of the Mouth Anchors and enables the unstable |
| | Spring | active position and corresponding intrinsic safety features. |
| 490 | | Rear outer guide which, along with Rear Cam Island 491, |
| | Rear Cam | creates the path that Cam Follower Pin 483 follows. May be |
| | Track | constructed of, without limitation, metal, plastic or fiber- |
| | | reinforced plastic for strength. |
| 491 | Rear Cam | Rear inner guide which, along with Rear Cam Track 490, |
| | Island | creates the path that Cam Follower Pin 483 follows. May be |
| | | constructed of, without limitation, metal, plastic or fiber- |
| | | reinforced plastic for strength. |
| 492 | Front Cam | Front guide which forms the path that Cam Follower Pin |
| | Track & Island | 483 follows. May be constructed of, without limitation, |
| | | metal, plastic or fiber-reinforced plastic for strength. |
| 493 | Pan-Head | Pan-Head Screw which may be used for fastening parts |
| | Screw | together. |
| 494 | Torsion Spring | Torsion spring which supplies force to keep the rotary cam |
| | | gates in the closed position. |
| 495 | Upper Cam | Rotary Upper Cam Gate Three prevents Cam Follower Pin |
| | Gate Three | 483 from returning to Cam Position 4 (Active) 459 from |
| | | Cam Position 5 (Post-Activation) 460. May be constructed |
| | | of, without limitation, metal for durability, or plastic for |
| | | cost. |
| 496 | Lower Cam | Rotary Lower Cam Gate Three prevents Cam Follower Pin |
| | Gate Three | 483 from returning to Cam Position 1 (Storage) 456 from |
| | | Cam Position 2 (Storage Release) 457. May be constructed |
| | | of, without limitation, metal for durability, or plastic for |
| | | cost. |
| 497 | Front Cam | Retention tab that holds Upper Cam Gate Three 495 and |
| | Gates Retainer | Lower Cam Gate Three 496 onto their respective rotational |
| | | shafts. May be constructed of, without limitation, metal, |
| | | plastic or fiber-reinforced plastic for strength. |
| 498 | Cam Switch | Printed Circuit Board (PCB) that forms a mount for the |
| | PCB | position detection microswitch(es) and routes their electrical |
| | | signals to Connector 501. |
| 499 | Active | |
| | Position | Microswitch that detects when Cam Follower Pin 483 is in |
| | Detection | Cam Position 4 (Active) 459. |
| | Microswitch | |
| 500 | Storage | |
| | Position | Microswitch that detects when Cam Follower Pin 483 is in |
| | Detection | Cam Position 1 (Storage) 456. |
| | Microswitch | |
| 501 | Electrical | Electrical connector that carries the signals from the position |
| | Connector | detection microswitches to the processing circuitry. |
| 502 | Upper Cam | Rotary Upper Cam Gate One prevents Cam Follower Pin |
| | Gate One | 483 from returning to Cam Position 2 (Storage Release) 457 |
| | | from Cam Position 3 (Pre-Activation) 458. May be |
| | | constructed of, without limitation, metal for durability, or |
| | | plastic for cost. |
| 503 | Upper Cam | Rotary Upper Cam Gate Two prevents Cam Follower Pin |
| | Gate Two | 483 from returning to Cam Position 3 (Pre-Activation) 458 |
| | | from Cam Position 4 (Active) 459. May be constructed of, |
| | | without limitation, metal for durability, or plastic for cost. |
| 504 | Lower Cam | Linear Lower Cam Gate One prevents Cam Follower Pin |
| | Gate One | 483 from returning to Cam Position 5 (Post-Activation) 460 |
| | | from Cam Position 6 (Pre-Storage) 461. May be constructed |
| | | of, without limitation, metal for durability, or plastic for |
| | | cost. |
| 505 | Lower Cam | Rotary Lower Cam Gate Two prevents Cam Follower Pin |
| | Gate Two | 483 from returning to Cam Position 6 (Pre-Storage) 461 |
| | | from Cam Position 1 (Storage) 456. May be constructed of, |
| | | without limitation, metal for durability, or plastic for cost. |
| 506 | Rear Upper | Retention tab that holds Upper Cam Gate One 502 and |
| | Cam Gates | Upper Cam Gate Two 503 onto their respective rotational |
| | Retainer | shafts. Also provides an anchor point for Linkage Two |
| | | Extension Spring 489. May be constructed of, without |
| | | limitation, metal, plastic or fiber-reinforced plastic for |
| | | strength. |
| 507 | Lower Cam | Extension spring that keeps linear Lower Cam Gate One 504 |
| | Gate One | in the closed position when it is not being displaced by the |
| | Extension | passage of Cam Follower Pin 483. |
| | Spring | |
| 508 | Lower Cam | Retention tab that holds Lower Cam Gate Two 505 onto its |
| | Gate Two | rotational shaft. Also provides an anchor point for Lower |
| | Retainer | Cam Gate One Extension Spring 507. May be constructed |
| | | of, without limitation, metal, plastic or fiber-reinforced |
| | | plastic for strength. |
| 509 | Tunnel | Tunnel in Upper Cam Gate Three 495 which allows Cam |
| | | Follower Pin 483 to pass under the gate as it moves from |
| | | Cam Position 2 (Storage Release) 457 from Cam Position 3 |
| | | (Pre-Activation) 458. |
| 510 | Torsion Spring | Fixed backstop which permits the torsion spring to generate |
| | Hardstop | force by constraining one of the torsion spring legs. May be |
| | | a part of, and may be constructed of the same material as the |
| | | track that it is on. |
| 511 | Torsion Spring | Fixed backstop which permits the torsion spring to generate |
| | & Cam Gate | force and prevents Lower Cam Gate Three 496 from moving |
| | Hardstop | past the closed position. May be a part of, and may be |
| | | constructed of the same material as the track that it is on. |
| 512 | Upper Cam | Upper Cam Gate Three 495 in its normally closed position |
| | Gate Three | which prevents Cam Follower Pin 483 moving backwards |
| | (Closed | from Cam Position 5 (Post-Activation) 460 to Cam Position |
| | Position) | 4 (Active) 459. |
| 513 | Upper Cam | Upper Cam Gate Three 495 displaced into an opened |
| | Gate Three | position by Cam Follower Pin 483 moving to Cam Position |
| | (Opened | 4 (Active) 459. |
| | Position) | |
| 514 | Lower Cam | Lower Cam Gate Three 496 in its normally closed position |
| | Gate Three | which prevents Cam Follower Pin 483 moving backwards |
| | (Closed | from Cam Position 2 (Storage Release) 457 to Cam Position |
| | Position) | 1 (Storage) 456. |
| 515 | Lower Cam | Lower Cam Gate Three 496 displaced into an opened |
| | Gate Three | position by Cam Follower Pin 483 moving to Cam Position |
| | (Opened | 1 (Storage) 456. |
| | Position) | |
| 516 | Upper Cam | Upper Cam Gate One 502 in its normally closed position |
| | Gate One | which prevents Cam Follower Pin 483 moving backwards |
| | (Closed | from Cam Position 3 (Pre-Activation) 458 to Cam Position 2 |
| | Position) | (Storage Release) 457. |
| 517 | Upper Cam | Upper Cam Gate One 502 displaced into an opened position |
| | Gate One | by Cam Follower Pin 483 moving to Cam Position 3 (Pre- |
| | (Opened | Activation) 458. |
| | Position) | |
| 518 | Upper Cam | Upper Cam Gate Two 503 in its normally closed position |
| | Gate Two | which prevents Cam Follower Pin 483 moving backwards |
| | (Closed | from Cam Position 4 (Active) 459 to Cam Position 3 (Pre- |
| | Position) | Activation) 458. |
| 519 | Upper Cam | Upper Cam Gate Two 503 displaced into an opened position |
| | Gate Two | by Cam Follower Pin 483 moving to Cam Position 3 (Pre- |
| | (Opened | Activation) 458. |
| | Position) | |
| 520 | Lower Cam | Lower Cam Gate One 504 in its normally closed position |
| | Gate One | which prevents Cam Follower Pin 483 moving backwards |
| | (Closed | from Cam Position 6 (Pre-Storage) 461 to Cam Position 5 |
| | Position) | (Post-Activation) 460. |
| 521 | Lower Cam | Lower Cam Gate One 504 displaced into an opened position |
| | Gate One | by Cam Follower Pin 483 moving to Cam Position 6 (Pre- |
| | (Opened | Storage) 461. |
| | Position) | |
| 522 | Lower Cam | Lower Cam Gate Two 505 in its normally closed position |
| | Gate Two | which prevents Cam Follower Pin 483 moving backwards |
| | (Closed | from Cam Position 1 (Storage) 456 to Cam Position 6 (Pre- |
| | Position) | Storage) 461. |
| 523 | Lower Cam | Lower Cam Gate Two 505 displaced into an opened position |
| | Gate Two | by Cam Follower Pin 483 moving to Cam Position 6 (Pre- |
| | (Opened | Storage) 461. |
| | Position) | |
| 524 | Adjustment | Knob which allows the user to adjust the Mouth Anchor |
| | Knob | opening width in the active position. May be constructed of, |
| | | without limitation, plastic for cost. |
| 525 | Sealing O- | O-ring which seals the apparatus against water ingress via |
| | Ring | the adjustment knob hole. May be constructed of, without |
| | | limitation, silicone, synthetic or natural rubber or a |
| | | thermoplastic elastomer (TPE). |
| 526 | Push-Push | Mechanism to improve the aesthetics by hiding Adjustment |
| | Mechanism & | Knob 524 when not in use, and which prevents damage |
| | Overrun | caused by turning the knob beyond the adjustment limits. |
| | Clutch | |
| 527 | Flexible Shaft | Flexible shaft which transmits the rotary motion from |
| | | Adjustment Knob 524 to Helical Worm Gear 528. May be |
| | | constructed of alternately wound filaments around a central |
| | | core with a sheath that prevents the formation of loops and |
| | | kinks. |
| 528 | Helical Worm | Helical worm gear which transmits the rotary motion from |
| | Gear | Flexible Shaft 527 to Helical Pinion Gear 529 and inhibits |
| | | the backdriving of Adjustment Knob 524 caused by forces |
| | | acting on Pivot Point 478. May be constructed of, without |
| | | limitation, metal or durable plastic for strength. |
| 529 | Helical Pinion | Helical pinion gear, which in concert with Helical Rack 530 |
| | Gear | converts the rotary motion of Helical Worm Gear 528 into |
| | | the linear motion of Pivot Point 478. May be constructed of, |
| | | without limitation, metal or durable plastic for strength. |
| 530 | Helical Rack | Helical gear rack, which in concert with Helical Pinion Gear |
| | | 529 converts the rotary motion of Helical Worm Gear 528 |
| | | into the linear motion of Pivot Point 478. May be |
| | | constructed of, without limitation, metal, carbon fiber or |
| | | fiber-reinforced plastic for strength. |
| 531 | Flat-Head | Flat-Head Screw which may be used for fastening parts |
| | Screw | together. |
| 532 | Worm Gear | Bushing which holds Helical Worm Gear 528 in place and |
| | Bushing | allows for rotary motion of the worm gear. May be |
| | | constructed of, without limitation, metal for durability or |
| | | plastic for cost. |
| 533 | Geartrain | Housing which contains the geartrain parts and holds them |
| | Housing | in the proper orientation. May be constructed of, without |
| | | limitation, metal for durability, or plastic for cost. |
| 534 | Pivot Point | |
| | (Maximum | The position of the pivot point which causes the maximum |
| | Width | Mouth Anchor opening width in the active position. |
| | Position) | |
| 535 | Pivot Point | |
| | (Minimum | The position of the pivot point which causes the minimum |
| | Width | Mouth Anchor opening width in the active position. |
| | Position) | |
| 536 | Upper Mouth | |
| | Anchor | The maximum position of Upper Mouth Anchor 466 caused |
| | (Maximum | by the pivot point being at Pivot Point (Maximum Width |
| | Width | Position) 534. |
| | Position) | |
| 537 | Upper Mouth | The minimum position of Upper Mouth Anchor 466 caused |
| | Anchor | by the pivot point being at Pivot Point (Minimum Width |
| | (Minimum | Position) 535. |
| | Width | |
| | Position) | |
| 538 | Lower Mouth | |
| | Anchor | The maximum position of Lower Mouth Anchor 467 caused |
| | (Maximum | by the pivot point being at Pivot Point (Maximum Width |
| | Width | Position) 534. |
| | Position) | |
| 539 | Lower Mouth | |
| | Anchor | The minimum position of Lower Mouth Anchor 467 caused |
| | (Minimum | by the pivot point being at Pivot Point (Minimum Width |
| | Width | Position) 535. |
| | Position) | |
| 540 | Housing | The push-push mechanism housing which contains the |
| | | constituent parts and may have internal grooves to constrain |
| | | Follower 542 to linear motion to enable the push-push |
| | | effect. May be constructed of, without limitation, plastic for |
| | | cost. |
| 541 | Plunger | A part which controls the rotation and depth of Follower 542 |
| | | to enable the push-push effect. May be constructed of, |
| | | without limitation, plastic for cost. |
| 542 | Follower | Cam follower which alternates between retracted and |
| | | extended positions in order to enable the push-push effect. |
| | | May be constructed of, without limitation, plastic for cost. |
| 543 | Clutch | Ball bearing which rotationally isolates Follower 542 from |
| | Pressure Plate | Clutch Pressure Plate & Shaft 544, while allowing for |
| | Ball Bearing | coupled linear motion between them. |
| 544 | Clutch | Clutch pressure plate which may be connected to a knurled |
| | Pressure Plate | shaft that is bonded to Adjustment Knob 524 in order to |
| | & Shaft | convey rotary motion. If Helical Rack 530 is at one of its |
| | | limits, then the pressure plate will slip, thus preventing |
| | | damage to the mechanism. May be constructed of, without |
| | | limitation, metal for durability, or plastic for cost. |
| 545 | Clutch Driven | The driven plate of the clutch which receives rotational |
| | Plate | motion from the pressure plate via friction. May be |
| | | constructed of, without limitation, metal for durability, or |
| | | plastic for cost. |
| 546 | Clutch Driven | Ball bearing which rotationally isolates the Clutch Driven |
| | Plate Ball | Plate 545 from Clutch Cover Plate 548, while allowing for |
| | Bearing | coupled linear motion between them. |
| 547 | Clutch | Extension spring that stores the energy to power the push- |
| | Extension | push mechanism and also forces the clutch plates together, |
| | Spring | allowing for the transmission of rotary motion. |
| 548 | Clutch Cover | A part that conveys the force from the extension springs to |
| | Plate | the push-push mechanism and clutch. May be constructed |
| | | of, without limitation, plastic for cost. |
| 549 | Linkage Two | Retention flange to keep Linkage Two 479 from slipping off |
| | Retention | Pivot Point 478. May be constructed of, without limitation, |
| | Flange | metal for durability, or plastic for cost. |
| 550 | Microswitch | Plunger that is the sense element for the Active Position |
| | Plunger | Detection Microswitch 499. Actuates the microswitch |
| | | contacts when the plunger is depressed by Cam Follower Pin |
| | | 483. |
| 551 | Sense Current | Electrical current applied to Sense Current Wire 552 for |
| | | detection of Cam Follower Pin 483 in the active position. |
| 552 | Sense Current | Conductive wire for conveying Sense Current 551 to |
| | Wire | Conductive Cam Follower Pin 553. May be constructed of, |
| | | without limitation, metal for conductivity. |
| 553 | Conductive | Conductive pin which follows the cam path created by Rear |
| | Cam Follower | Cam Track 490 and Rear Cam Island 491, and serves as a |
| | Pin | position detection mechanism by transmitting current to |
| | | Active Position Conductor 555 when at the active position. |
| | | May be constructed of, without limitation, metal or plastic |
| | | impregnated with conductive particles. |
| 554 | Insulated | Electrically isolates Conductive Cam Follower Pin 553 from |
| | Linkage Three | Linkage Two 479, Rear Cam Track 490 and Rear Cam |
| | | Island 491. May be constructed of, without limitation, fiber- |
| | | reinforced plastic for strength and non-conductivity. |
| 555 | Active | Conductive area at the active position which passes Sense |
| | Position | Current 551 to Sense Current Return Wire 557 when in |
| | Conductor | contact with Conductive Cam Follower Pin 553. May be |
| | | constructed of, without limitation, metal or plastic |
| | | impregnated with conductive particles. |
| 556 | Insulator | Electrically isolates Active Position Conductor 555 from |
| | | Rear Cam Island 491. May be any non-conductive material |
| | | with the required characteristics, such as, without limitation, |
| | | plastic, epoxy, fiberglass or even air in some cases. |
| 557 | Sense Current | Conductive wire for conveying Sense Current 551 to the |
| | Return Wire | processing circuitry. May be constructed of, without |
| | | limitation, metal for conductivity. |
| 558 | Sense Current | Electrical current transmitted to the processing circuitry |
| | Return | when Cam Follower Pin 483 is in the active position. |
| 559 | Mouth Anchor | A protrusion or extension of a Mouth Anchor to enable it to |
| | Extension | be moved and/or rotated and/or manipulated. May be an |
| | | integral part of, or may be attached or affixed to a Mouth |
| | | Anchor. May have notches, teeth, holes, pegs, flanges, |
| | | grooves or other features to permit it to be aligned and/or |
| | | grasped and/or locked in place. |
| 560 | Mouth Anchor | Member which constrains a Mouth Anchor. May have an |
| | Holder Body | Opening or Tunnel 561 through which may pass one or |
| | | more Extensions 559 of a Mouth Anchor. May contain or |
| | | interface with a mechanism to lock and/or adjust the position |
| | | of a Mouth Anchor. May have splines, shafts, hooks, holes |
| | | or other power transmission features to permit the |
| | | transmission of rotational and/or linear motion from and/or |
| | | to the Mouth Anchor. |
| 561 | Opening or | An opening through which may pass one or more extensions |
| | Tunnel | of a Mouth Anchor for the purpose of constraining the |
| | | motion of the Mouth Anchor. |
| 562 | Support Frame | A support frame to which one or more Mouth Anchor |
| | | Holders may be attached. May have holes which may |
| | | directly or indirectly (via Bushings or Bearings 563) support |
| | | and/or transmit rotational motion from and/or to Mouth |
| | | Anchors. |
| 563 | Bushing or | A bushing or bearing which may support and/or facilitate the |
| | Bearing | transmission of rotational motion from and/or to a Mouth |
| | | Anchor Holder Body. May be secured to Support Frame 562 |
| 564 | Retention Plug | A plug used to retain a Mouth Anchor Holder Body 560 to a |
| | | Support Frame 562 while permitting rotational motion. May |
| | | have one or more Threaded Holes 568, which may clamp |
| | | Mouth Anchor Holder Body 560 via one or more pan-head |
| | | screws 493 or other fasteners. |
| 565 | Motor or | A motor or actuator which may provide force to rotate |
| | Actuator | and/or move one or more Mouth Anchors. |
| 566 | Optical or | A sensor for measuring angular rotation or linear distance |
| | Magnetic | utilizing one or more optical or magnetic detectors |
| | Encoder | combined with a source of optical or magnetic flux. May |
| | | have signal conditioning circuitry. |
| 567 | Gear Stop | A physical stop to prevent rotation beyond a certain value. |
| | | May prevent damage to machinery and/or injury to an |
| | | individual by limiting the range of motion. |
| 568 | Threaded Hole | A hole with screw threads tapped into it. |
| 569 | Cross-Bar | A linkage to convey rotational force and/or motion from/to a |
| | | left Mouth Anchor Holder from/to a right Mouth Anchor |
| | | Holder and/or from/to Gear Teeth 570. May have one or |
| | | more Threaded Holes 568, which may clamp Mouth Anchor |
| | | Holder Body 560 via one or more Pan-Head Screws 493 or |
| | | other fasteners. |
| 570 | Gear Teeth | Gear teeth which may mesh with a Gear 573 in order to |
| | | transmit and/or receive rotational motion from a Motor or |
| | | Actuator 565. |
| 571 | Bracket or | A support member to which Motor or Actuator 565 may be |
| | Beam | attached. May be bonded or attached to a Force Sensor 572 |
| | | in order to measure force generated or received by Motor or |
| | | Actuator 565. |
| 572 | Force Sensor | A force and/or strain and/or stretch measuring sensor such |
| | | as, without limitation, a strain gauge, load cell, piezoresistor, |
| | | force-sensitive resistor, force-sensitive capacitor or fiber |
| | | optic sensor. May have signal conditioning circuitry. |
| 573 | Gear | A gear connected to Shaft 574 to transmit and/or receive |
| | | force from/to Motor or Actuator 565 from/to Gear Teeth |
| | | 570. |
| 574 | Shaft | An output shaft of Motor or Actuator 565. |

FIG. 43 illustrates an example oral positioning apparatus 923 consisting of one or more jaw wedges 575, which are wedges which fit between an individual's upper and lower jaws behind the rear molars and hold the individual's jaws apart to permit access to the oral cavity. Additionally, as shown in FIG. 43, one or more jaw wedges may be attached to one or more members extending outside the oral cavity which may be transiently or permanently attached to an oral appliance or other device in order to position it in a fixed relationship to an individual's oral cavity. The oral positioning apparatus 923 may have a mechanism for detecting when an individual has opened his or her jaws to reduce or eliminate force upon the jaw wedge(s) 575, which may be useful for allowing the user to signal a desired stop simply by opening his or her mouth. The oral positioning apparatus 923 may include one or more inner drainage tubes 577 and/or outer drainage tubes 578 in order to remove debris or saliva 580 from the individual's mouth.

With regards to FIGS. 43 through 47, jaw wedge 575 and/or drain tube 584 may be constructed of, without limitation, an elastomer, such as natural, synthetic or silicone rubber, fluoropolymer, thermoplastic elastomer (TPE), thermoplastic olefin (TPO) or thermoplastic vulcanizates (TPV), plastic, wood, metal or a composite material. Jaw wedge 575 may be covered, coated or bonded with a second material for comfort, durability, corrosion or aesthetic reasons, such as a soft silicone overmold. Jaw wedge 575 may be compressible to permit easier insertion behind the rear molars. Jaw wedge 575 may have one or more passageways, tunnels or channels formed or cut into it. Jaw wedge 575 may be a simple shape such as a cube, or a complex shape such as a curved rectangular block with rounded edges. The upper and/or lower contact patches 594 of jaw wedge 575 may be curved, shaped or molded to either loosely or tightly conform to the corresponding jaw geometry.

Oral positioning apparatus 923 may have one or more members to mechanically couple to another device such as an oral appliance in order to provide a fixed localization of the device relative to one or more features of the oral cavity, such as the upper jaw (maxilla) 920 and/or lower jaw (mandible) 921. The oral features may form reference points for locating other oral structures and the relative distances and orientations between them. For example, if one or more jaw wedges 575 are clamped between and thus anchored to the upper jaw (maxilla) 920 and/or lower jaw (mandible) 921 and the distance and geometry of the member(s) connecting the jaw wedge(s) 575 to the oral appliance are known, then localizing the gap between the frontmost two lower teeth through probing will give a relative distance and orientation to the jaw wedge(s)

Such members may serve additional functions in addition to mechanical coupling. For example, as shown in FIG. 43, rigid upper conductor 589 and

Oral positioning apparatus 923 may include a mechanism for detecting when an individual has opened his or her jaws to reduce or eliminate force upon the jaw wedge(s) 575. Such a detection mechanism may be based on, without limitation, electrical, magnetic, electromagnetic, optical, mechanical, pneumatic or hydraulic principles.

FIGS. 46 and 47 illustrate the principle of operation of an example electrical contact-based system for detecting force on jaw wedge 575. An upper conductor 589 and a lower conductor 588 are electrically separated, but may be physically connected or bonded, for example, by one or more insulators 587. Upper conductor 589 and lower conductor 588 may have a gap 576 or another type of electrical separation which can be breached upon the application of mechanical force, such as an electrical switch. The switch, gap 576 or other means of transient electrical connection may be located internal to and/or mechanically coupled to jaw wedge 575. Jaw wedge 575 may be constructed of an elastomeric material such as rubber, and upper conductor 589 and lower conductor 588 may be located in one or more conductor channels 596 of jaw wedge 575 with a section of elastomeric material between the conductors to maintain gap 576. Jaw wedge 575 may have one or more access channels 598 which may permit swapping of jaw wedges 575 with a greater or lesser hardness (durometer) and/or amount of material between the conductors, thereby adjusting the threshold of force required to bridge the gap 576 or activate a transient electrical connection device such as switch. The threshold of force may be set so that the user is actively required to bite down on the jaw wedge(s) 575 to activate the electrical connection, or may be set so that the normal restoring force of stretched muscles when the jaws are held apart by jaw wedge(s) 575 is sufficient to activate the electrical connection.

FIG. 46 illustrates an electrical contact-based force detection apparatus when zero force or insufficient force to bridge gap 576 is applied to jaw wedge 575 via the upper jaw (maxilla) 920 and lower jaw (mandible) 921. A current source such as a battery, transformer or input/output pin of a microprocessor may apply a sense current 551 to upper conductor 589. However, due to gap 576, the current cannot flow to lower conductor 588. In order to prevent electrolysis of water and aqueous salts in the mouth, potentially generating hydrogen and/or chlorine gases and/or sodium hypochlorite, a voltage of the current source below 1.23 volts is preferred.

FIG. 47 illustrates an electrical contact-based force detection apparatus when sufficient force has been applied to jaw wedge 575 to cause electrical contact 922 between upper conductor 589 and lower conductor 588. Sense current 551 can then flow through the conductors to sense current return 558 where it can be converted to a voltage and/or detected by a microprocessor and/or processed to detect a change from current flow to no current flow. The detected current or lack thereof can trigger various actions. For example, detection of current (i.e. indicating jaws resting or biting down on the jaw wedge(s) 575) may prompt the user to press a button to begin an automated cleaning cycle, or may simply begin the operation. Conversely, a detection of stopped current (i.e. indicating that the user has opened his or her jaws wider to reduce or eliminate force upon the jaw wedge(s) 575) may indicate that the user wishes to stop or abort operation of the device and thus may cause circuitry to cutoff power to actuators or cause a control program running on processing circuitry to return an oral cavity tool to a storage position. Other types of actions triggered by the presence or absence of current may be contemplated, such as prompting the user for confirmation that he or she wishes to stop operation of the device.

While FIGS. 43 through 47 show the use of binary (presence/absence) force sensing using electrical contacts, other modalities of force or touch sensing may be contemplated by one of ordinary skill in the art. For example, one or more sensors may be embedded inside jaw wedge 575 and connected to processing circuitry through either rigid conductors, wires or rigid or flexible tubes. More than one of the same type or dissimilar sensors may be used to provide redundancy and detection of faults in the sensor or the connecting wiring or tubing. The sensor(s) may be standalone or may be mounted to a printed-circuit board (PCB) or other type of substrate.

As a first example, a force or strain sensor may be embedded in and/or mechanically coupled to jaw wedge 575. Such a sensor may be, without limitation, a force-sensitive resistor, strain gauge, imaging system using polarized light for detecting strain or deformation or an interferometer which measures a change in dimensions of either the jaw wedge itself or a light pipe passing through it due to deformation caused by applied force. The sensor may be excited with a constant or switched voltage or current source and the signal from the sensor may be converted and/or processed using, without limitation, a resistor, Wheatstone bridge, op-amp, current-to-voltage converter or filtered using either electronic circuits or software algorithms. Analog force or pressure measurements may be converted to digital signals using, without limitation, a comparator, op-amp or software algorithms such as fixed or moving-average thresholding.

As a second example, a fluid reservoir such as a bladder, sac, hollow or pinched/capped flexible tube may be internal to or mechanically bonded to jaw wedge 575. The fluid reservoir may be connected to a pressure sensor, either directly or via a rigid or flexible tube. The working fluid may be, without limitation, air, water, saline, oil, an inert gas such as nitrogen or a noble gas, hydraulic fluid or another suitable liquid. The pressure sensor may output an analog signal proportional to the pressure, or a digital signal when the pressure exceeds a threshold value. As with the force sensors, analog pressure signals may be converted to digital signals using, without limitation, a comparator, op-amp or a fixed or moving-average thresholding software algorithm. Upon the application of force via upper jaw (maxilla) 920 and lower jaw (mandible) 921, jaw wedge 575 will be deformed, which will compress the fluid reservoir, thereby increasing the pressure of the working fluid, which will be detected by the pressure sensor. Additional sensors of the same, similar or different types may be used for redundancy.

As a third example, a sensor which detects touch, contact, moisture, pressure or heat may be mounted to the top and/or bottom of jaw wedge 575 to detect when jaw wedge 575 has come in contact with the upper gums 592 covering the upper jaw (maxilla) 920 and/or the lower gums 582 covering the lower jaw (mandible) 921. Some examples of such sensors are, without limitation, a capacitive touch sensor, a switch or microswitch for detecting contact, a moisture or conductivity sensor for detecting the saliva coating the gums, or a thermistor, thermocouple, passive IR or other thermal sensor for detecting the heat of the gums. Such a sensor may be in one or more parts, for example, a capacitive touch sensor may consist of a conductive sensing patch located on top of jaw wedge 575 connected via shielded or unshielded wire to a capacitive sensing chip such as a TI LDC0851 or FDC1004, which may then be connected to a microprocessor or other electronic circuit. As another example, a tube running through jaw wedge 575 with an open-end terminating on the top of jaw wedge 575 may connect to a remote pressure sensor. When the user bites down on jaw wedge 575, it seals the end of the tube and further compression causes the pressure in the tube to increase, which is detected by the pressure sensor.

### Cartridge and Tools Detailed Description

### Introduction

In the field of dentistry, oral hygiene appliances can include an oral hygiene tool that is inserted into an oral cavity of an individual. Such automated and semi-automated instruments include, for example, automated or motorized toothbrushes and automated or motorized flossing devices that use water and/or string.

Some automated or semi-automated oral hygiene instruments include a detachable element. For example, automated or motorized toothbrushes often feature detachable heads that can be removed for storage, cleaning, or replacement. In many such apparatuses, the detachable element remains stationary relative to the body of the apparatus to which the detachable element is attached. In some other apparatuses, the detachable element includes a movable element, such as a rotatable brush head that, when actuated, rotates about an axis of the brush head to clean a contact surface, such as the surface of a tooth. While the movable element can be actuated for motion, the remainder of the detachable element remains stationary relative to the body of the apparatus. Further, some automated and semi-automated oral hygiene instruments include an automated substance dispenser that dispenses a substance into the oral cavity, such as water, mouthwash, or toothpaste. The substance can aid with an oral hygiene task, such as applying a fluoride solution to the oral cavity or rinsing the oral cavity to remove a cleaning solution, such as toothpaste.

Presented herein are a variety of elements for use with oral hygiene apparatuses. In some examples, a detachable element, or cartridge, is configured for actuation by an actuator within the oral hygiene apparatus. A connector is configured to connect to an actuator and to receive one or both of a rotational force around an axis or a translational motion. A first member may extend in a lengthwise direction along the axis. The first member may include or be coupled to an oral hygiene tool. The detachable element may include one or more second members that are coupled to the first member, wherein the second member may extend from the first member in a direction that is non-parallel with the axis. The second member may include or be coupled to an oral hygiene tool. The detachable element may also include one or more third members that extend from the second member and may include or be coupled to an oral hygiene tool. The detachable element may also include one or more fourth members that extend from the third member and may include or be coupled to an oral hygiene tool.

The first, and optionally second, third and/or fourth members may be combined or fused in such a way as to not appear as discernably separate members. For example, the first, second and third members may form an ‘h’ shape, where the second and third members form a contiguous arc. Or the first member and two second members may form a ‘Y’ shape, again optionally with smooth arcs so as not to appear as separate members. A member may be composed of sub-members, which combined, produce the same effect as a member. For example, the first member may be composed of two sub-members forming a ‘<’ shape having the same effective structure as a single straight member.

The cartridge may incorporate motion translations and may have a fixed portion that forms part of the tool arm. For example, a brushing cartridge with bristle clusters in a plane parallel to the tool arm axis may comprise part of the tool arm and may have the connector be parallel to the tool arm axis, and may incorporate bevel gears, spur and crown gears, hypoid gears, worm gears or other means known to one of ordinary skill in the art to convert horizontal motion into vertical rotary motion. Alternatively or additionally, the cartridge may incorporate a push rod turning a cylinder or disc or crankshaft in order to convert linear motion into rotary motion.

Some implementations of an oral hygiene apparatus cartridge may not have a discernable connector and/or retention feature. For example, an oral hygiene apparatus may have a claw or Jacobs chuck to grasp a portion of a cartridge which then serves as a de facto connector. As another example, the connector may be of the twist-lock variety where the retention feature is an integral part of the connector. In some implementations, part or all of the cartridge may be permanently attached to the oral hygiene apparatus. For example, a floss insert holder may be a permanently attached feature of the oral hygiene apparatus which combines with a detachable floss insert to form a complete unit.

An oral hygiene apparatus may include an oral hygiene tool and a cleaning tool that is oriented toward the oral hygiene tool.

An oral hygiene apparatus may include an oral hygiene tool and a cleaning tool configured to apply a cleaning operation to the oral hygiene tool.

An oral hygiene apparatus may include an oral hygiene tool configured to perform a first oral hygiene task and a substance conduit that is configured to conduct a substance for the same task or a second oral hygiene task.

An oral hygiene apparatus may include a connector having one or more flats, splines, protrusions, grooves, depressions, polygons or other geometrical features for conveying rotational torque configured to connect to an actuator in a direction of an axis and to receive a rotational force around the axis, and a member that extends in a lengthwise direction, the member including or coupled to an oral hygiene tool, wherein the rotational force applied to the connector causes the member to rotate relative to the axis.

### B. Example Oral Apparatus

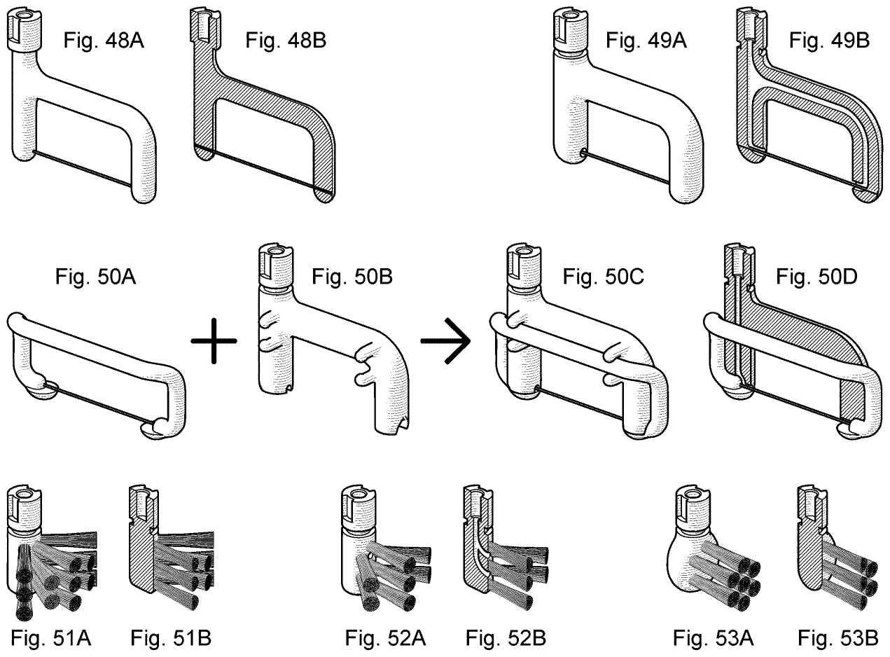

FIGS. 48A and 48B show perspective and section views, respectively, of a flossing oral cavity tool 605 without cleaning jets and/or dispensing orifices, suitable for use with an automated or semi-automated dental cleaning system.

FIGS. 49A and 49B show perspective and section views, respectively, of a flossing oral cavity tool 605 with cleaning jets suitable for use with an automated or semi-automated dental cleaning system. FIG. 49 shows a floss oral cavity tool 605 that incorporates a substance channel so that a cleaning and/or disinfecting substance can be jetted onto the floss to remove food debris and/or kill bacteria in the movement interval between successive teeth, thereby avoiding transporting food debris and/or viable bacteria from one tooth to the next.

FIG. 50A shows a perspective view of a floss insert 605. Because there is no hollow substance channel, such a cartridge may be made with a standard core-cavity mold rather than a more expensive gas-injection mold.

FIG. 50B shows a perspective view of a floss insert holder. Because the holder does not contain the replaceable oral hygiene tool (in this example, dental floss), the holder may be made out of a durable material such as a metal (for example, stainless steel) and may be permanently or semi-permanently integrated into the oral hygiene apparatus, which may simplify and/or reduce the cost of the apparatus due to not needing a mechanism to detach or replace the holder.

FIG. 50C shows a perspective view of an assembled floss insert in a floss insert holder. The floss insert is constrained, in this example, by fitting into grooves at the bottom of the holder and by snapping into restraining pegs on the holder. The constraints limit movement of the floss insert as it is inserted and removed from between teeth.

FIG. 50D shows a section view of an assembled floss insert in a floss insert holder. The combination of the floss insert and the substance channel in the holder creates a cleaning jet for cleaning the floss of food debris and/or killing bacteria on the floss.

FIGS. 51A and 51B show perspective and section views, respectively, of a brushing oral cavity tool 605 with radial bristle clusters. By using radial bristle clusters each bristle is roughly equidistant from the tooth surface as the cartridge rotates. This reduces the rotational force required to clean the teeth, thereby allowing the use of smaller, cheaper and less-powerful motors.

FIGS. 52A and 52B show perspective and section views, respectively, of a brushing oral cavity tool 605 with radial bristle clusters and substance dispensing or cleaning jets. By having a substance channel or tube as part of a brushing cartridge, various substances can be dispensed or jetted, such as fluids (mouthwash, disinfectant, water, sugar alcohols, air), slurries (liquid toothpaste) and gels. These substances can be used to assist in the dental cleaning process, cleaning and purging of the equipment including drying and antibiotic/antimicrobial action.

FIGS. 53A and 53B show perspective and section views, respectively, of a brushing oral cavity tool 605 with parallel bristle clusters.

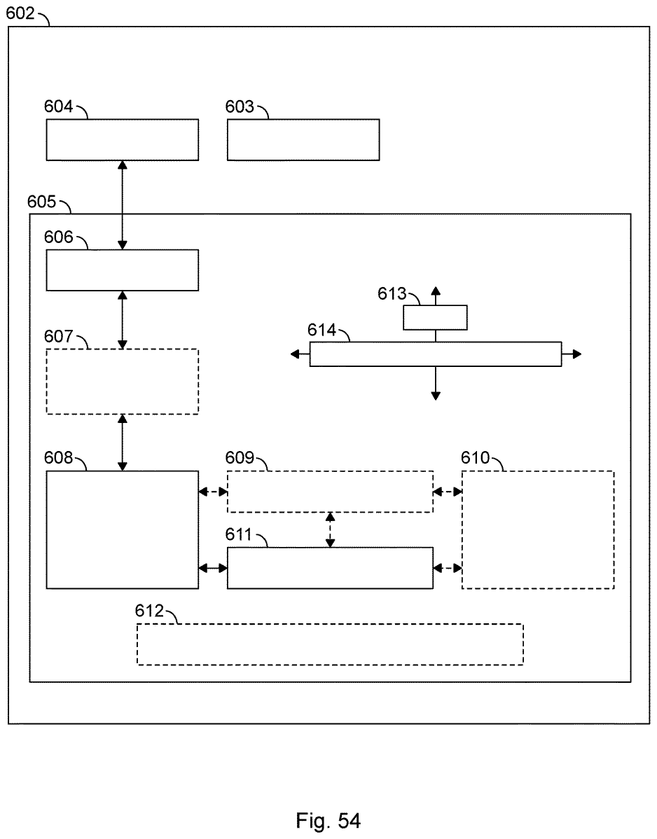

FIG. 54 is a block diagram of an example oral appliance 602 including a oral cavity tool 605, according to some example embodiments.

| # | Label |
|---|---|
| 602 | Oral Appliance |
| 603 | Tool Arm |
| 604 | Actuator |
| 605 | Oral Cavity Tool |
| 606 | Connector |
| 607 | Retention Feature |
| 608 | First Member |
| 609 | Second Member |
| 610 | Third Member |
| 611 | Oral Hygiene Tool |
| 612 | Cleaning And/ |
| | Or Dispensing Tool |
| 613 | Axis |
| 614 | Non-Parallel Direction |

As shown in FIG. 54, the oral appliance 602 may include a tool arm 603, and may include an actuator 604. The tool arm 603 may not be a single piece but may be formed of multiple members. The actuator 604 may include, for example, one or more rotational actuators (e.g., a motor, a servo, or a stepper) and/or one or more linear actuators (e.g., a linear servo motor). The actuator 604 may be coupled to a oral cavity tool 605 via a connector 606. In some examples, the oral cavity tool 605 is fixed to the actuator 604 (e.g., by an adhesive, by a locking fastener such as a bolt and lock nut, or by adjoining coupling portions of the actuator 604 and the oral cavity tool 605). In some examples, the oral cavity tool 605 is detachably coupled to the actuator 604 (e.g., by a groove and matching fork, a flange and matching groove, by threads that can be uncoupled by rotation, or by snap-fit coupling portions of the actuator 604 and the oral cavity tool 605 that can be uncoupled by lateral tension). The oral cavity tool 605 may be removed for cleaning of the tool arm 603 and the oral cavity tool 605, for storage of the oral appliance 602 and the oral cavity tool 605, for swapping oral cavity tools 605 used by different individuals, and/or for replacement of the oral cavity tool 605.

The oral cavity tool 605 may have a retention feature 607 to retain it in the oral hygiene apparatus. The retention feature 607 may permit rotation of the oral cavity tool 605. The oral cavity tool 605 may be coupled to the actuator without a retention feature 607, for example, with a claw or a Jacob's chuck.

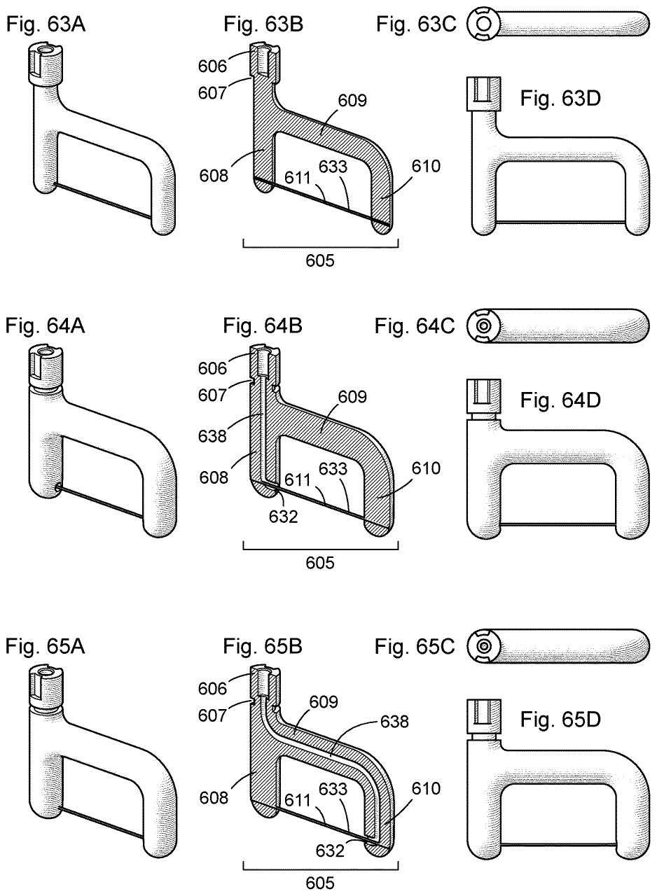

The retention feature 607 may be a byproduct of the connector shape and not a separate feature. For example, FIG. 63B shows a flossing oral cavity tool 605 without a groove or flange retention feature. However, the bottom face of the connector can, in conjunction with a semi-circular fork on the actuator be used to stop the cartridge from movement in the downward direction. For the upward direction, the top face of the connector can, in conjunction with a corresponding face on the actuator stop upward motion of the cartridge.

The oral cavity tool 605 includes an oral hygiene tool 611. The oral hygiene tool 611 is associated with an oral hygiene task, such as brushing, flossing, scraping, imaging, or scanning an oral cavity of an individual. The oral hygiene tool 611 may include one or more of (without limitation) a brush, a pick, a length of dental floss, a dispenser of a substance (e.g., water, toothpaste, or dental floss), a camera, or a scanning tool. The oral hygiene tool 611 may be used by a user who is the individual (e.g., a self-administered task) and/or by a user who is a caregiver of the individual (e.g., a family member, guardian, or a healthcare provider such as a dentist, dental hygienist, or oral surgeon).

The actuator 604 is configured to actuate at least a portion of the oral cavity tool 605 to perform an oral hygiene task. As a first example, the oral hygiene task may include brushing an interior surface of the oral cavity, the oral hygiene tool 611 may include a brush, and the actuator 604 may be configured to apply rotational and/or translational force to the oral cavity tool 605 to move the brush within the oral cavity. As a second example, the oral hygiene task may include flossing between an adjacent pair of teeth of the oral cavity, the oral hygiene tool 611 may include a length of floss, and the actuator 604 may be configured to apply rotational and/or translational force to the oral cavity tool 605 to move the length of floss between adjacent pairs of teeth within the oral cavity. As a third example, the oral hygiene task may include applying a substance to a location within the oral cavity (e.g., water, mouthwash, or toothpaste). The oral appliance 602 may include a dispenser or applicator for the substance (e.g., a pump 669), and the oral appliance 602 may actuate the dispenser or applicator to dispense and/or apply the substance within the oral cavity. As a fourth example, the oral hygiene task may include capturing an image or a scan of the oral cavity, the oral hygiene tool 611 may include a camera or sensor, and the actuator 604 may position the camera or sensor at one or more locations and/or orientations within the oral cavity. In some examples, the actuator 604 is actuated by a user, such as the individual, to perform the task. In some examples, the actuator 604 is actuated automatically, such as by software and/or firmware that determines a location within the oral cavity to position the oral hygiene tool 611 to perform the oral hygiene task. In some examples, the oral hygiene tool 611 is integrally formed with a first member 608 and/or a second member 609 and/or a third member 610 and/or a fourth member 650. In some examples, the oral hygiene tool 611 is fixed to one or more of the members (e.g., by adhesive, by a locking fastener such as a bolt and lock nut, or by adjoining coupling portions of the second member 609 and the oral hygiene tool 611). In some examples, the oral hygiene tool 611 may be detachably coupled to one or more of the members (e.g., by threads that can be uncoupled by rotation, or by snap-fit coupling portions of the tool arm 603 and the oral cavity tool 605 that can be uncoupled by lateral tension).

The connector 606 of the oral cavity tool 605 may be coupled to a first member 608, which may be coupled to the oral hygiene tool 611. More particularly, the connector 606 is configured to connect to the actuator 604 and to receive one or both of a rotational force around an axis 613 and/or a translational motion. In some examples, the actuator 604 and the connector 606 couple in the direction of the axis 613, and the actuator 604 actuates the oral cavity tool 605 in the direction of the axis 613, such as translational motion along the axis 613 and/or rotational motion pivoting around the axis 613. In some examples, the actuator 604 and the connector 606 couple in a direction that is different than the axis 613 of rotational and/or translational motion, such as an orthogonal direction with respect to axis 613.

In some examples, a second member 609 is integrally formed with a first member 608. In some examples, a second member 609 is fixed to a first member 608 (e.g., by adhesive, by a locking fastener such as a bolt and lock nut, or by adjoining coupling portions of a first member 608 and a second member 609). In some examples, a second member 609 is detachably coupled to a first member 608 (e.g., by threads that can be uncoupled by rotation, or by snap-fit coupling portions of a first member 608 and a second member 609 that can be uncoupled by lateral tension).

In some examples, a third member 610 is integrally formed with a second member 609. In some examples, a third member 610 is fixed to a second member 609 (e.g., by adhesive, by a locking fastener such as a bolt and lock nut, or by adjoining coupling portions of a second member 609 and a third member 610). In some examples, a third member 610 is detachably coupled to a second member 609 (e.g., by threads that can be uncoupled by rotation, or by snap-fit coupling portions of a second member 609 and a third member 610 that can be uncoupled by lateral tension).

In some examples, a fourth member 650 is integrally formed with a third member 610. In some examples, a fourth member 650 is fixed to a third member 610 (e.g., by adhesive, by a locking fastener such as a bolt and lock nut, or by adjoining coupling portions of a third member 610 and a fourth member 650). In some examples, a fourth member 650 is detachably coupled to a third member 610 (e.g., by threads that can be uncoupled by rotation, or by snap-fit coupling portions of a third member 610 and a fourth member 650 that can be uncoupled by lateral tension).

A first member 608 may extend from the connector 606 in a lengthwise direction along the axis 613. In some examples, the first member 608 extends in a lengthwise direction that is the same direction as the axis 613. In some examples, the first member 608 extends in a direction that is neither perpendicular to the axis 613 or parallel with the axis 613. That is, the lengthwise direction in which the first member 608 may extend from the connector 606 forms an angle with respect to the axis 613. In some examples, the angle is small (e.g., one degree). In some examples, the actuator 604 linearly actuates the connector 606 in the direction along the axis 613, and the first member 608, extending in a lengthwise direction along the axis 613, moves longitudinally with respect to the axis 613. In some examples, the actuator 604 rotationally actuates the connector 606 around the axis 613, and a length of the first member 608, extending in a lengthwise direction along the axis 613, revolves around the axis 613.

A second member 609 may extend in a non-parallel direction 614 with respect to the axis 613. For example, the non-parallel direction 614 can be perpendicular to the axis 613, e.g., forming a right angle with respect to the axis 613 of rotational and/or translational motion. In some examples, the actuator 604 linearly actuates the connector 606 in the direction along the axis 613, and the length of the second member 609, extending in the non-parallel direction 614 with respect to the axis 613, moves laterally along the axis 613. In some examples, the actuator 604 rotationally actuates the connector 606 around the axis 613, and the second member 609, extending in the non-parallel direction 614 with respect to the axis 613, also rotates around the axis 613.

It is to be appreciated that the example oral appliance 602 of FIG. 54 is a simplified representation featuring a subset of components, and that more sophisticated devices may include different numbers, types, organizations, and/or interrelationships of components. Some more detailed and complete representations of such oral appliances 602 that may be usable for oral hygiene tasks are provided elsewhere in this disclosure.

As a first example, the oral appliance 602 may include a cleaning and/or dispensing tool 612 that is configured to clean at least a portion of the tool arm 603 and/or the oral cavity tool 605. More particularly, in some examples, the cleaning and/or dispensing tool 612 is oriented toward the oral hygiene tool 611. For example, the cleaning and/or dispensing tool 612 can be a dispenser of a cleaning substance that cleans the oral hygiene tool 611, and a nozzle of the cleaning and/or dispensing tool 612 can be pointed toward the oral hygiene tool 611. Alternatively, or additionally, in some examples, the oral appliance 602 includes a cleaning and/or dispensing tool 612 that is configured to apply a cleaning operation to the oral hygiene tool 611. For example, the cleaning and/or dispensing tool 612 can be a brush or a wiper that brushes or wipes the oral hygiene tool 611 before, during, and/or after use. These examples may also include other variations; for example, the first member 608 may extend in a lengthwise direction along the axis 613 (as shown) or, alternatively, may extend in a non-parallel direction 614. Alternatively, or additionally, in some examples, the oral appliance 602 includes a cleaning and/or dispensing tool 612 that is configured to dispense a cleaning substance for an oral hygiene task, such as toothpaste prior to a brushing operation.

As a second example, the oral hygiene tool 611 may be configured to perform a first oral hygiene task (e.g., brushing or flossing), and the oral appliance 602 includes a substance conduit that is configured to conduct a substance for the same task or a second oral hygiene task (e.g., dispensing mouthwash or a cleaning solution to clean the oral hygiene tool 611). In such embodiments, an orifice of the substance conduit may be oriented toward the oral hygiene tool 611 (e.g., to clean the oral hygiene tool) or may be oriented away from the oral hygiene tool 611 (e.g., in an outward direction).

As a third example, the connector 606 has one or more flats, splines, protrusions, grooves, depressions, polygons or other geometrical features for conveying rotational torque that is configured to insert into the actuator 604 in the direction of the axis 613 and to receive a rotational force around the axis 613. For example, one or more driving surfaces of actuator 604 may engage with one or more corresponding driving surfaces of connector 606, wherein rotational actuation of actuator 604 applies a rotational force to one or more driving surfaces of connector 606. The oral cavity tool 605 includes a member (e.g., the first member 608, second member 609, third member 610, or fourth member 650) that extends in a lengthwise direction along the axis 613. The rotational force applied to one or more driving surfaces of connector 606 by actuator 604 causes the member to rotate relative to axis 613.

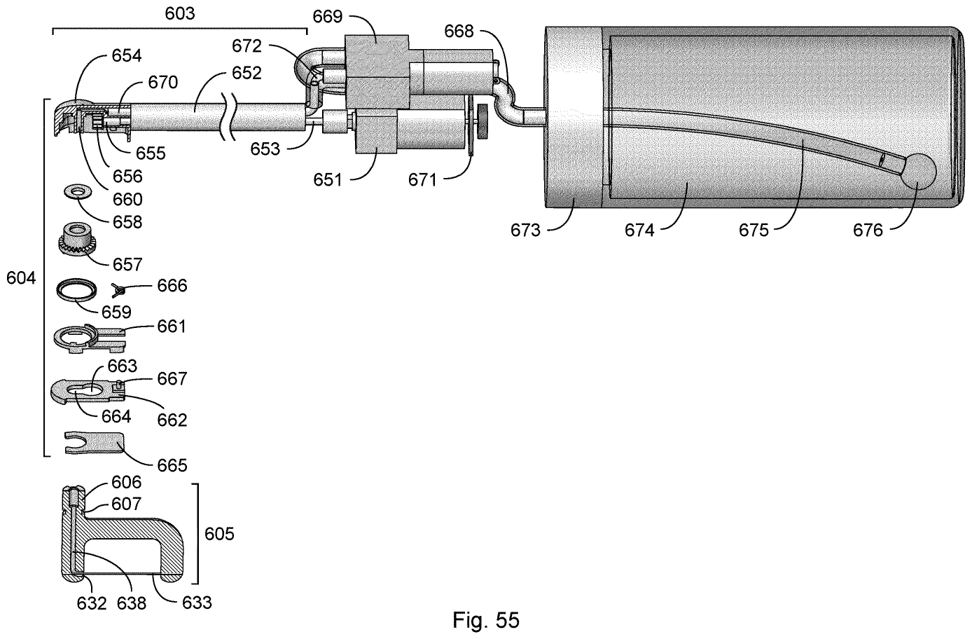

FIG. 55 shows an exploded view of an example actuator 604 and substance delivery system. Actuator 604 may consist of a tool arm 603 and a tool rotation motor 651.

Tool arm 603 may include a rigid tube 652 and may include a tool rotation driveshaft 653 positioned internal to rigid tube 652. Tool rotation driveshaft 653 may be configured to rotate oral cavity tool 605 along a second axis that extends along a direction that may be perpendicular to the rotational axis of tool rotation driveshaft 653. Tool rotation driveshaft 653 may have a connector, fitting, adapter, coupler or other means to couple to the output of tool rotation motor 651 or may be permanently bonded to the output of tool rotation motor 651, for example by welding or permanent adhesives. Tool rotation driveshaft 653 may be connected to and driven by a tool rotation motor 651, which may have a gearbox to reduce the raw speed of the motor and/or increase its torque. Tool rotation motor 651 may have an optical or magnetic encoder assembly 671 to monitor the angular position of the motor, which in conjunction with a processing unit controlling the driving voltage and/or current to the motor, may position oral cavity tool 605 to a desired angle.

Tool arm 603 may include a tool support head 654. Tool support head 654 may be fixedly attached to rigid tube 652, and rotation of rigid tube 652 causes rotation of tool support head 654 about the longitudinal axis of rigid tube 652, which may be understood as being a central axis since the longitudinal axis is at the center of rotation of rigid tube 652. Tool rotation driveshaft 653 extends into tool support head 654. Tool support head 654 may include a driveshaft seal 655 to help prevent liquid ingress into rigid tube 652. Tool rotation driveshaft 653 extends through and may be supported by driveshaft seal 655 and the walls of tool support head 654. Tool rotation driveshaft 653 may include a gear 656 that is fixedly attached to tool rotation driveshaft 653 such that gear 656 is rotationally driven when tool rotation driveshaft 653 is rotated. A rotating tool holder 657 may be positioned within tool support head 654, which may be perpendicular to the longitudinal axis of tool rotation driveshaft 653. Gear 656 may be a spur gear, a bevel gear, a worm gear, a spiral bevel gear, a hypoid gear or other type of gear which permits the off-axis transfer of rotational torque. Rotating tool holder 657 may have an integral crown gear, bevel gear, worm wheel, a spiral bevel gear, a hypoid gear or other type of gear which permits the off-axis transfer of rotational torque. Alternatively, linear motion may be provided down rigid tube 652, for example, by a linear motor, which may be coupled to a pushrod, which then may rotate rotating tool holder 657 via a lever arm or crankshaft. Gear 656 may mesh with and drive the integral gear of rotating tool holder 657. Rotating tool holder 657 may have an upper seal 658 to help prevent substance leaks and loss of substance pressure, which may be positioned on a nipple 660 which may be formed integrally with tool support head 654. Rotating tool holder 657 may also have a lower seal 659, which may fit around rotating tool holder 657 to help prevent substance leaks and loss of substance pressure.

When tool rotation motor 651 drives tool rotation driveshaft 653, tool rotation driveshaft 653 drives gear 656. Gear 656 then drives rotating tool holder 657. A connector 606 of oral cavity tool 605, which is positioned in a recess formed in the interior of rotating tool holder 657, and which contacts an upper surface of rotating tool holder 657 as well as the edge of upper seal 658, is frictionally engaged with the splines formed in the walls of rotating tool holder 657. Accordingly, rotation of rotating tool holder 657 causes rotation of oral cavity tool 605.

Oral cavity tool 605 may have a connector 606 that extends into tool support head 654 to frictionally engage with rotating tool holder 657 such that rotation of rotating tool holder 657 rotates oral cavity tool 605. Connector 606 may be “keyed” to be oriented in rotating tool holder 657 in only one orientation. Connector 606 may have an asymmetric pattern or design that mates with a complementary pattern or design in rotating tool holder 657.

Oral cavity tool 605 may include a retention feature 607 such as a groove or flange, to retain the tool in the rotating tool holder 657 while permitting rotation. Tool support head 654 may include a rotating tool holder retainer 661 that maintains the position of upper seal 658, rotating tool holder 657, and lower seal 659 within tool support head 654. Rotating tool holder 657 may have a calibration feature such as a pin, tang or tab and rotating tool holder retainer 661 may also have a pin, tang or tab serving as a calibration stop such that when the calibration feature of rotating tool holder 657 contacts the calibration stop of rotating tool holder retainer 661, oral cavity tool 605 is at a known rotation angle. Processing circuitry can then use the angle provided by the optical or magnetic encoder assembly 671 in order to position oral cavity tool 605 at a specified angle relative to tool arm 603.

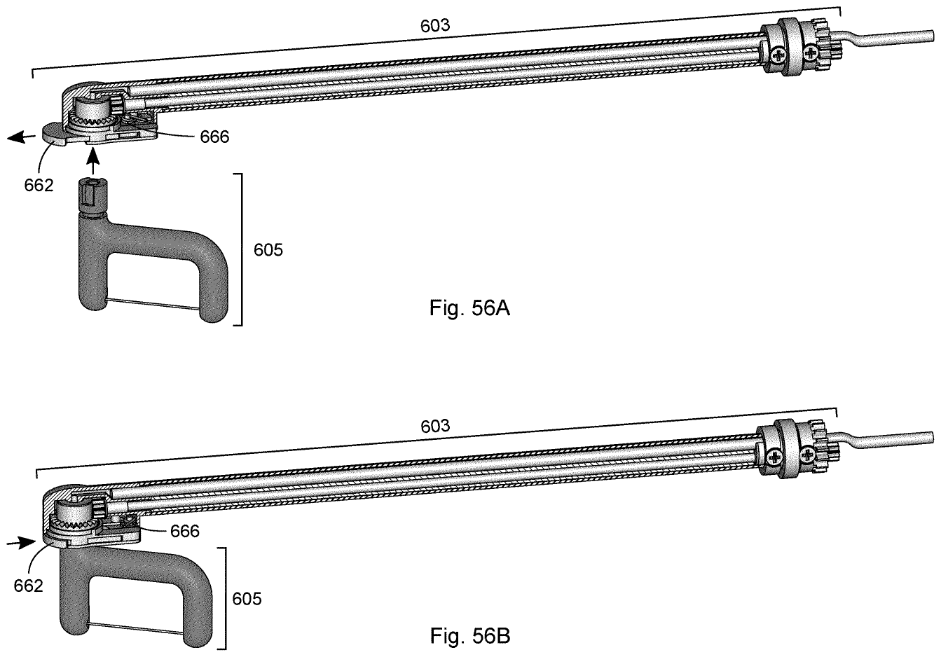

Tool support head 654 may also include a locking slide 662 that has a first position, shown in FIG. 56A where oral cavity tool 605 may be inserted through a hole 663 formed in locking slide 662, and a second position, shown in FIG. 56B, where edges of a slot 664 formed in locking slide 662 engage retention feature 607 of oral cavity tool 605, retaining oral cavity tool 605 within tool support head 654. A torsion spring 666 positioned on a pin 667 formed on locking slide 662 may provide a bias against a plurality of posts formed on or secured to tool support head 654 to keep locking slide 662 in the position that maintains oral cavity tool 605 within tool support head 654.

A retainer 665 which may be pressed into, welded, glued or otherwise secured to tool support head 654 retains the internal elements of tool support head 654 within tool support head 654.

A substance delivery system may provide substance from a tank 674 to a oral cavity tool 605. The substance delivery system may include a tank 674, a tank cap 673, an intake tube 675, a hollow weight 676, a tank to pump tube 668, a pump 669, a pump to tool arm tube adapter 672, a tool arm substance tube 670, a tool support head 654 including a nipple 660, and a oral cavity tool 605 having a connector 606, a substance channel 638 and an orifice 632.

Tank 674 may contain a cleaning and/or disinfecting substance, such as water, mouthwash, sugar alcohols like sorbitol or chlorhexidine gluconate. Intake tube 675, which may be made of a flexible plastic such as food-grade silicone or vinyl tubing, may be positioned to extend to the bottom of tank 674 due to the influence of gravity on a connected hollow weight 676. Intake tube 675 may be directly connected to the intake of pump 669, or may have additional components inline. For example, tank cap 673 may have a passageway of integrally formed nipples. Intake tube 675 may then be connected to the nipple on the tank side of tank cap 673, while tank to pump tube 668 may be connected to nipple on the other side of tank cap 673. Tank to pump tube 668, which may be made of a flexible plastic, may then connect to the intake of pump 669.

Pump 669 may be electrically actuated or operated by processing circuitry, powered by a battery pack or other power source such as an AC to DC adapter. Processing circuitry 84 may adjust the speed or power of pump 669, for example by utilizing pulse-width modulation (PWM). Alternatively, pump 669 and/or tool rotation motor 651 may be directly activated, for example by a pushbutton switch controlled by the user.

Pump 669 may then output substance drawn from tank 674 to pump to tool arm tube adapter 672, which may be made of a flexible plastic, which may then connect to tool arm substance tube 670, which may extend from the proximate end of tool arm 603 to a distal end of tool arm 603. Tool arm substance tube 670 may be formed of a plastic, rubber, or metal. Tool arm substance tube 670 may be positioned in and seal to a receiving recess formed in tool support head 654. A first substance flow passage may extend from the receiving recess. A second substance flow passage may intersect the first substance flow passage and may extend approximately perpendicular to the first substance flow passage. Approximately perpendicular is in a range of plus or minus 10 degrees from perpendicular. However, the intersection of the first substance flow passage and the second substance flow passage are not limited to a particular orientation with respect to each other. The second substance flow passage may connect to nipple 660 which may mate with connector 606 of oral cavity tool 605 allowing for a substance flow into substance channel 638 and then on to orifice 632.

Substance jets from one or more orifices 632 may then impinge on dental floss 633 to remove food debris and kill bacteria to minimize carryover from one tooth pocket to another tooth pocket. Alternatively or additionally, substance jets from one or more orifices 632 may impinge upon an individual's teeth and/or gums and/or tooth pockets for cleaning, disinfecting or massaging purposes.

FIGS. 56A and 56B show the procedure for inserting a oral cavity tool 605 into tool arm 603. Locking slide 662, which is normally held in a closed position by torsion spring 666 is pulled by the user such that oral cavity tool 605 may be inserted through a hole 663 formed in locking slide 662, as shown in FIG. 55. After oral cavity tool 605 is inserted into tool support head 654, the user releases locking slide 662, and torsion spring 666 drives the edges of a slot 664 formed in locking slide 662 into retention feature 607 of oral cavity tool 605, retaining oral cavity tool 605 within tool support head 654. Torsion spring 666 positioned on a pin 667 formed on locking slide 662 may provide a bias against a plurality of posts formed on or secured to tool support head 654 to keep locking slide 662 in the position that maintains oral cavity tool 605 within tool support head 654.

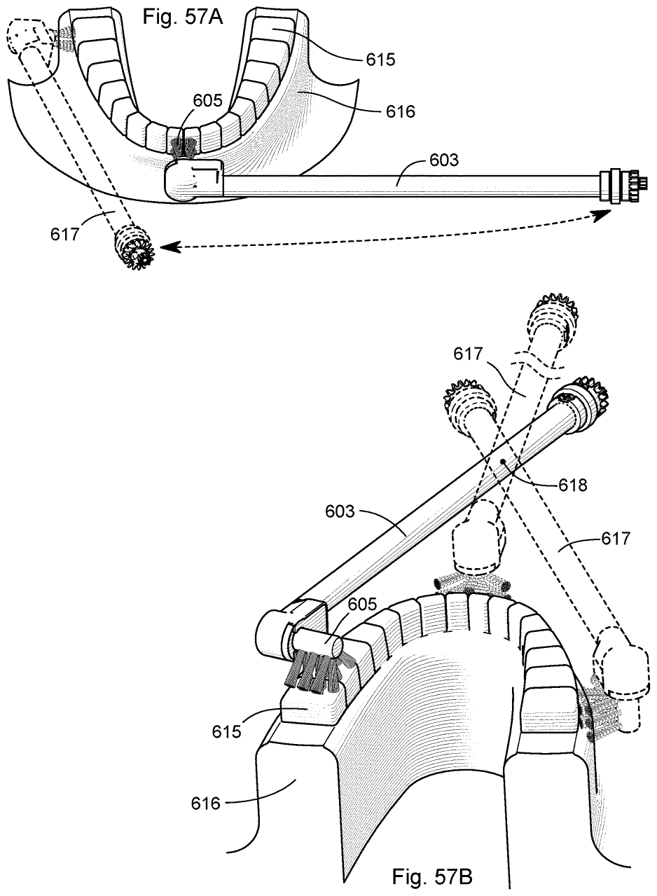

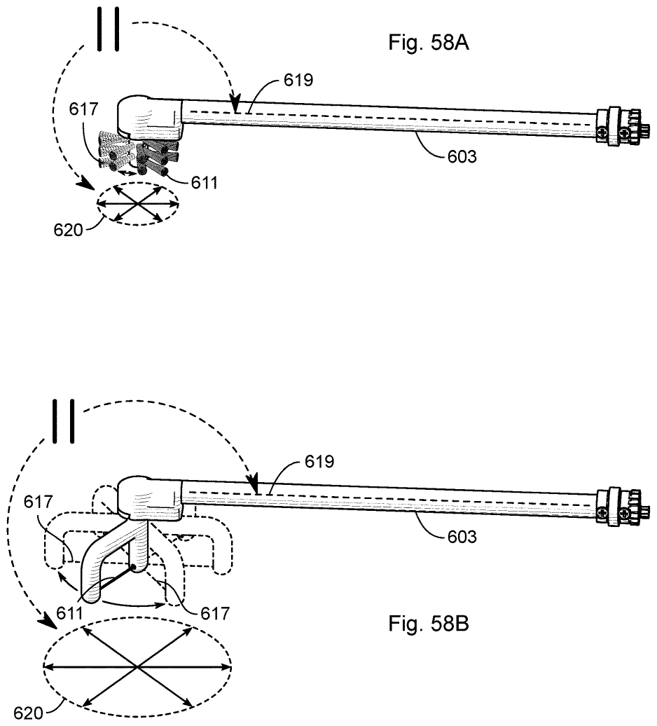

With regards to brushing, FIG. 57B shows, in a composite image of three different positions, how a brushing oral cavity tool 605 with bristle clusters in a plane parallel to the axis of the tool arm 603 allows for greatly reduced complexity of the actuator, with the range of motion required to clean an entire mouth of teeth 615 channeled through a single pivot point 618. In contrast, a cartridge with the plane of the bristle clusters perpendicular to the tool arm 603 requires a much greater range-of-motion as shown in FIG. 57A. This possible parallelism between the plane of the bristle clusters and the tool arm axis 619 is further illustrated in FIG. 58A. FIG. 58B illustrates a possible parallelism between the floss plane and the tool arm axis 619.

FIGS. 58A and 58B show how a plane 620 may be formed from rotating the oral hygiene tool 611 through alternate positions 617 and how this plane may be parallel to the tool arm axis 619.

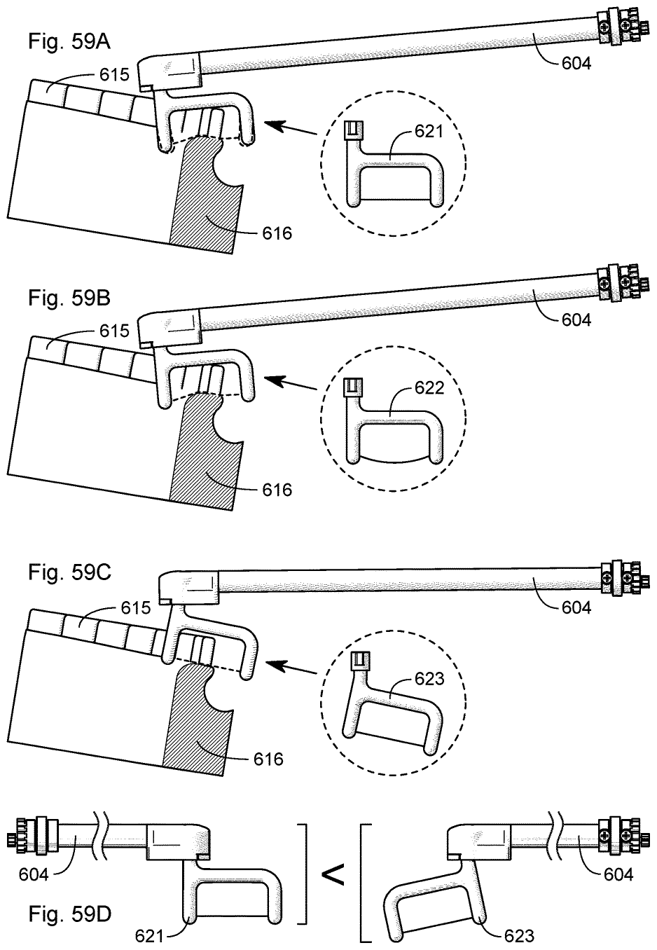

FIG. 59D shows how a cartridge with floss parallel to the tool arm 603 has a reduced height requirement over a floss cartridge optimized to be parallel to the gumline of the front teeth 615 in an open mouth (FIG. 59C). This is important for applications in which there is a reduced ability to open the mouth wide, such as children and the elderly. FIGS. 59A and 59B show ways of fully contacting the gumline of the front teeth 615 with a floss cartridge having floss parallel to the tool arm 603: FIG. 59A shows a floss cartridge with semi-flexible legs which can bend 621, and FIG. 59B shows a floss cartridge with slack in the floss 622.

Dental floss 633 may be integrally molded into or detachably bonded to first member 608 and third member 610. Regarding FIG. 59A, during manufacturing of oral cavity tool 605, dental floss 633 may be held under tension to maintain a preload on dental floss 633 until the cartridge body, which in some examples is formed of plastic, solidifies during a molding process. Alternatively, per FIG. 59B, during manufacture of oral cavity tool 605, dental floss 633 may have excess length compared to the distance between first member 608 and third member 610 such that the completed oral cavity tool 605 has slack in dental floss 633 in order to better conform to gums 616.

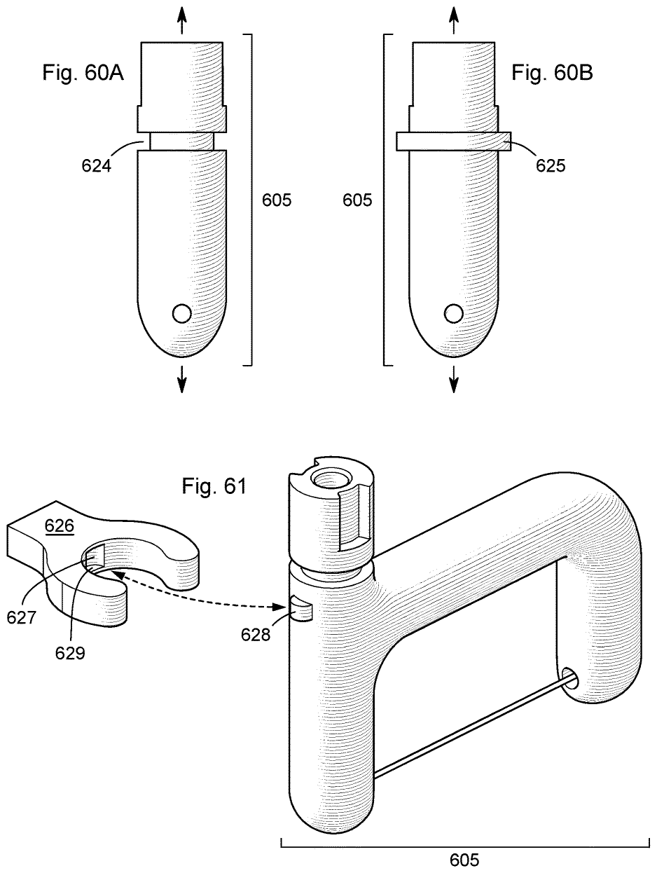

FIGS. 60A and 60B show retention features which allow the cartridge to rotate while bidirectional force is applied along the connector axis, as is required for some operations such as inserting and extracting floss from between teeth. FIG. 60A shows a groove 624 in a oral cavity tool 605 and FIG. 60B shows a flange 625 in a oral cavity tool 605.

FIG. 61 shows the use of a locating feature 628 on the oral cavity tool 605. Locating feature 628 may be a protrusion, bump, flange, cylinder, full or partial hemisphere, full or partial cube or other extruded geometric shape such as a triangle or hexagon. Locating feature 628 may be a groove, notch, divot, trench or the negative complement of a cylinder, full or partial hemisphere, full or partial cube or other extruded geometric shape such as a triangle or hexagon. Locating feature 628 may have draft angles or be rounded to facilitate easier injection molding or for improved aesthetics. When combined with a complementary locating feature 627 on a cartridge storage holder 626, it allows the cartridge to be stored in a known orientation, which reduces the time and algorithm complexity needed to swap cartridges (for example, between a flossing cartridge and a brushing cartridge), thereby reducing the time needed to perform a cleaning run. Cartridge storage holder 626 may have a stop surface 629 to facilitate more reliable swapping of oral cavity tools 605 by providing a constraint or stop to prevent oral cavity tool 605 from being pushed down when a tool arm 603 descends onto oral cavity tool 605 as part of the cartridge swap procedure.

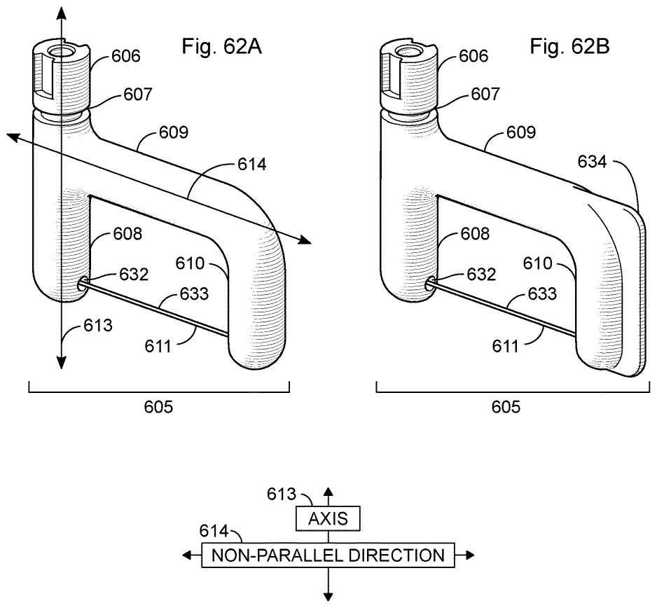

FIGS. 62 to 73 are a set of diagrams of oral hygiene apparatus oral cavity tools 605 for use with an oral appliance 602. Oral cavity tool 605 may include a connector 606 that is configured to connect to an actuator 604 of oral appliance 602. Oral cavity tool 605 may include a retention feature 607. The connector 606 may be configured to couple to the actuator 604 in a direction of an axis 613. The actuator 604 may rotate the connector 606 around the axis 613. The oral cavity tool 605 may include a first member 608 that may extend, in a lengthwise direction along the axis 613. The oral cavity tool 605 may include a second member 609 that is coupled to the first member 608 and that extends from the first member 608 in a non-parallel direction 614 with respect to the axis 613. The first member 608 may include an oral hygiene tool 611, specifically, a length of dental floss 633. The length of floss may extend from the first member 608 to a third member 610 that may extend from the second member 609 in a lengthwise direction along the axis 613. The length of floss may be affixed to one or both of the first member 608 or the third member 610, and/or may be detachably coupled to one or both of the first member 608 or the third member 610. The connector 606 may be configured to receive, from the actuator 604, a rotational force around an axis 613 (e.g., in the vertical direction of FIG. 485). The rotational force received from the actuator 604 may rotate the connector 606 around the axis 613, may rotate the first member 608 around the axis 613, may revolve the second member 609 radially around the axis 613, and may rotate the third member 610 around the axis 613. As a result, the length of floss 633 may rotate around the axis 613.

The spacing of the members attached to the dental floss 633 (in the example of FIG. 485, first member 608 and third member 610) forms a gap that is greater than a maximum expected width of the target audience teeth. Different types of oral cavity tools 605 may have different distances between the members attached to dental floss 633. For example, a oral cavity tool 605 for children may have a smaller distance between first member 608 and third member 610, and may have a smaller distance between second member 609 and dental floss 633.

Oral cavity tool 605 may include one or more substance channels 638 that may extend from connector 606, which may interface with a substance flow passage formed in tool support head 654, into first member 608 and/or second member 609 and/or third member 610 and/or fourth member 650. Oral cavity tool 605 may include one or more orifices 632 that are connected to one or more substance channels 638.

In the example of FIG. 62A, dental floss 633 extends from a first member 608. Also, in the example of FIG. 62A, orifice 632 is generally coaxial with dental floss 633. It may be understood that in the context of this disclosure that generally coaxial may be, for example, within 15 degrees of parallel, and within 3 millimeters. Furthermore, dental floss 633 may be offset a predetermined amount such that a larger space is provided to one side of dental floss 633 than to an opposite side. An advantage of such configuration is that more substance flow to the side having the larger space, which may be advantageous in certain situations such as providing greater substance flow to the individual's gums.

FIG. 62B shows an integrated tongue scraper 634 as part of oral cavity tool 605, allowing for the reduction of biofilms on the tongue as part of a cleaning cycle.

FIGS. 63A to 63D are perspective, section, plan and elevation views, respectively, of a flossing oral cavity tool 605 with the oral hygiene tool 611 consisting of a piece of dental floss 633 without cleaning jets and/or dispensing orifices 632. The lack of cleaning jets and/or dispensing orifices 632 may be easier and less expensive to manufacture.

FIG. 63C shows a keyed attachment mechanism such that the oral cavity tool 605 can only be inserted in one orientation. Having a fixed orientation of the oral cavity tool 605 relative to the actuator 604 through the use of a keyed connector 606 eliminates the need for a calibration step which either requires special sensors or the oral appliance 602 to move the oral cavity tool 605 and touch reference surfaces in order to determine the orientation of the oral cavity tool 605.

FIGS. 64A to 64D are perspective, section, plan and elevation views, respectively, of a flossing oral cavity tool 605 with the oral hygiene tool 611 consisting of a piece of dental floss 633 with one cleaning jet and/or dispensing orifice 632 on the connector side of the cartridge emerging from first member 608. Having a single cleaning jet and/or dispensing orifice 632 may be easier and less expensive to manufacture. Additionally, when the connector 606 is on the periphery of the oral cavity and the oral cavity tool 605 is pointing towards the central portion of the oral cavity, having a single cleaning jet and/or dispensing orifice 632 on the connector side directs the cleaning substance to the interior of the mouth rather than jetting it out of the oral cavity.

FIGS. 65A to 65D are perspective, section, plan and elevation views, respectively, of a flossing oral cavity tool 605 with the oral hygiene tool 611 consisting of a piece of dental floss 633 with one cleaning jet and/or dispensing orifice 632 on the non-connector side of the cartridge emerging from third member 610. Having a single cleaning jet and/or dispensing orifice 632 may be easier and less expensive to manufacture. Additionally, when the connector 606 is in the central portion of the oral cavity and the oral cavity tool 605 is pointing towards the periphery of the oral cavity, having a single cleaning jet and/or dispensing orifice 632 on the non-connector side directs the cleaning substance to the interior of the mouth rather than jetting it out of the oral cavity.

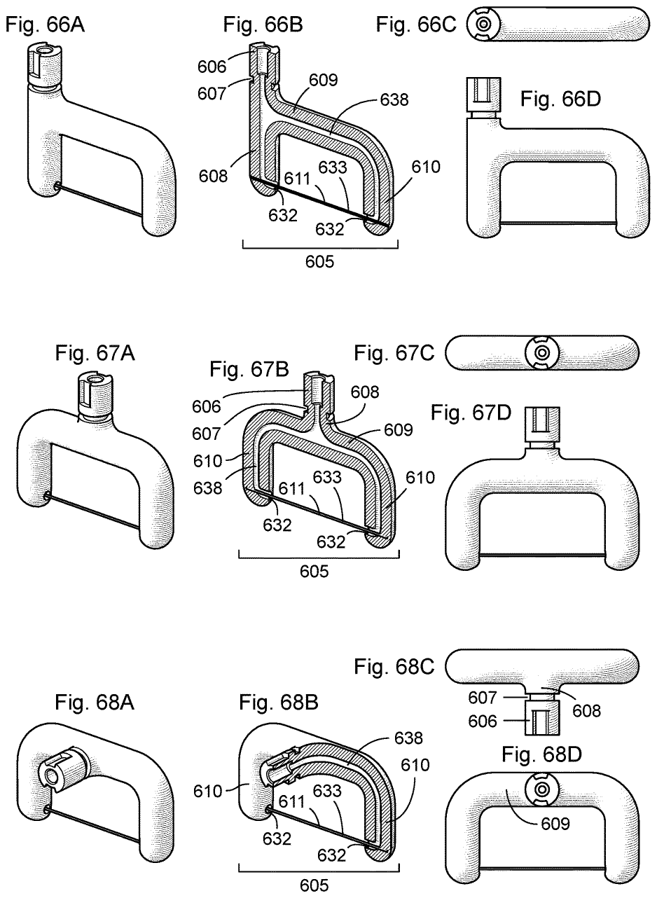

FIGS. 66A to 66D are perspective, section, plan and elevation views, respectively, of a flossing oral cavity tool 605 with the oral hygiene tool 611 consisting of a piece of dental floss 633 with two cleaning jets and/or dispensing orifices 632. Two cleaning jets may allow for the impingement of a cleaning or disinfecting solution such as mouthwash or chlorhexidine gluconate on both sides of a tooth pocket if the jets are activated while the dental floss 633 is in the tooth pocket at the base of two teeth 615.

Regarding FIGS. 67 and 68, a first member 608 extends from connector 606 and is connected to a second member 609 which may be perpendicular to first member 608. Two third members 610 may extend from second member 609. The third members may be perpendicular to second member 609. An oral hygiene tool 611, in this example, a length of dental floss 633 may be attached to the third members. The axis of connector 606 may be oriented towards oral hygiene tool 611, as in FIG. 490, or may be oriented orthogonally to oral hygiene tool 611, as in FIG. 491.

FIGS. 67A to 67D are perspective, section, plan and elevation views, respectively, of a flossing oral cavity tool 605 with the oral hygiene tool 611 consisting of a piece of dental floss 633 with two cleaning jets and/or dispensing orifices 632 and a centrally placed connector 606. Having a central connector 606 may allow for more balanced force distribution.

FIGS. 68A to 68D are perspective, section, plan and elevation views, respectively, of a flossing oral cavity tool 605 with the oral hygiene tool 611 consisting of a piece of dental floss 633 with two cleaning jets and/or dispensing orifices 632 and a frontally placed connector 606. Having a frontal connector 606 may allow for more balanced force distribution and reduced height clearance requirements.

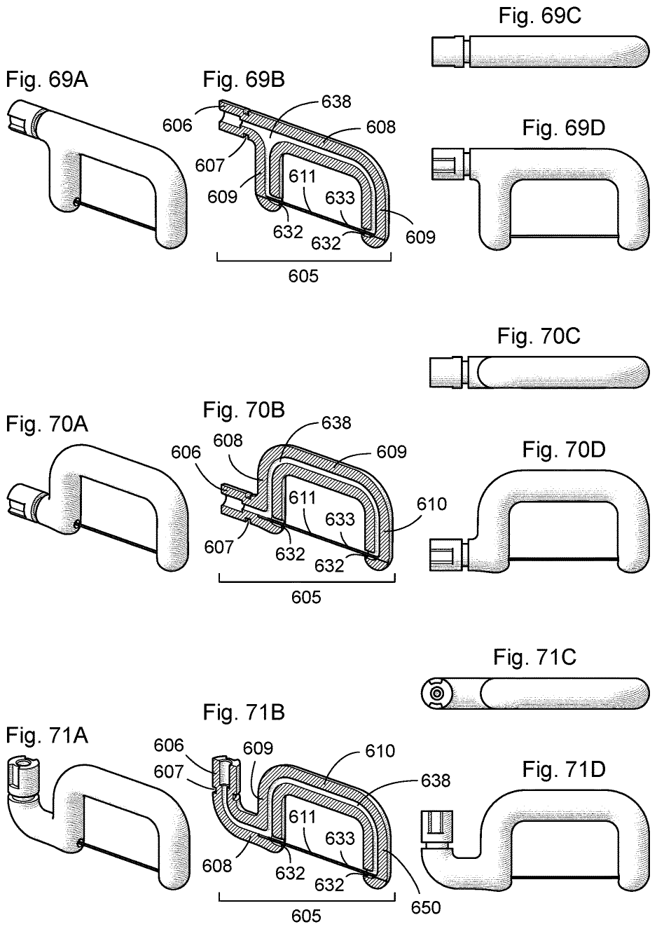

FIGS. 69A to 69D are perspective, section, plan and elevation views, respectively, of a flossing oral cavity tool 605 with the oral hygiene tool 611 consisting of a piece of dental floss 633 with two cleaning jets and/or dispensing orifices 632 and a side connector 606. Having a side connector 606 may allow for reduced height clearance requirements. A first member 608 extends from connector 606 and is connected to two second members 609 which may be perpendicular to first member 608. An oral hygiene tool 611, in this example, a length of dental floss 633 may be attached to the second members. The axis of connector 606 may be parallel to oral hygiene tool 611.

FIGS. 70A to 70D are perspective, section, plan and elevation views, respectively, of a flossing oral cavity tool 605 with the oral hygiene tool 611 consisting of a piece of dental floss 633 with two cleaning jets and/or dispensing orifices 632 and a side connector 606. Having a side connector 606 may allow for reduced height clearance requirements. A first member 608 may extend perpendicularly from connector 606 and may be connected to a second member 609. Second member 609 may be perpendicular to first member 608. A third member 610 may extend from second member 609. Third member 610 may be perpendicular to second member 609. An oral hygiene tool 611, in this example, a length of dental floss 633 may be attached to the first member 608 and third member 610. The axis of connector 606 may be parallel to oral hygiene tool 611.

FIGS. 71A to 71D are perspective, section, plan and elevation views, respectively, of a flossing oral cavity tool 605 with the oral hygiene tool 611 consisting of a piece of dental floss 633 with two cleaning jets and/or dispensing orifices 632 and a side connector 606. Having a side connector 606 may allow for reduced height clearance requirements. A first member 608 may extend perpendicularly from connector 606 and may be connected to a second member 609. Second member 609 may be perpendicular to first member 608. A third member 610 may extend from second member 609. Third member 610 may be perpendicular to second member 609. A fourth member 650 may extend from third member 610. Fourth member 650 may be perpendicular to third member 610. An oral hygiene tool 611, in this example, a length of dental floss 633 may be attached to the second member 609 and fourth member 650. The axis of connector 606 may be perpendicular to oral hygiene tool 611.

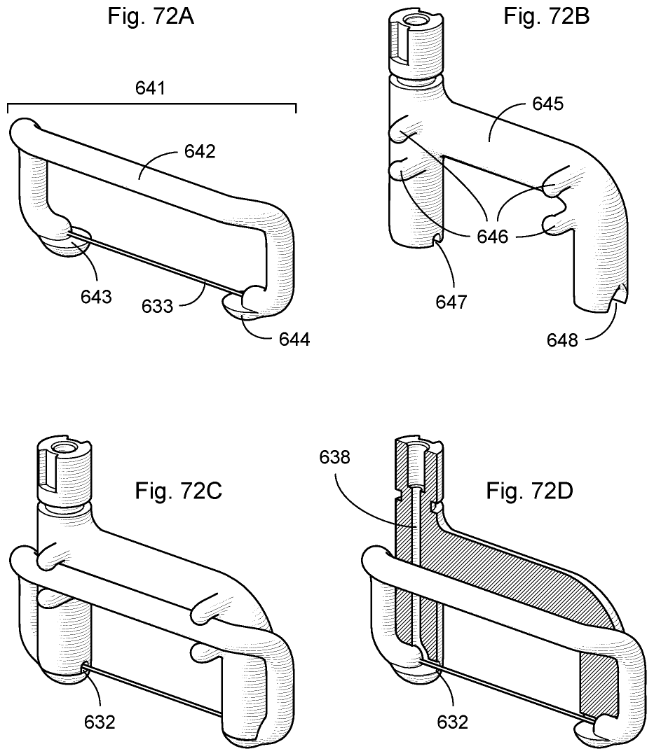

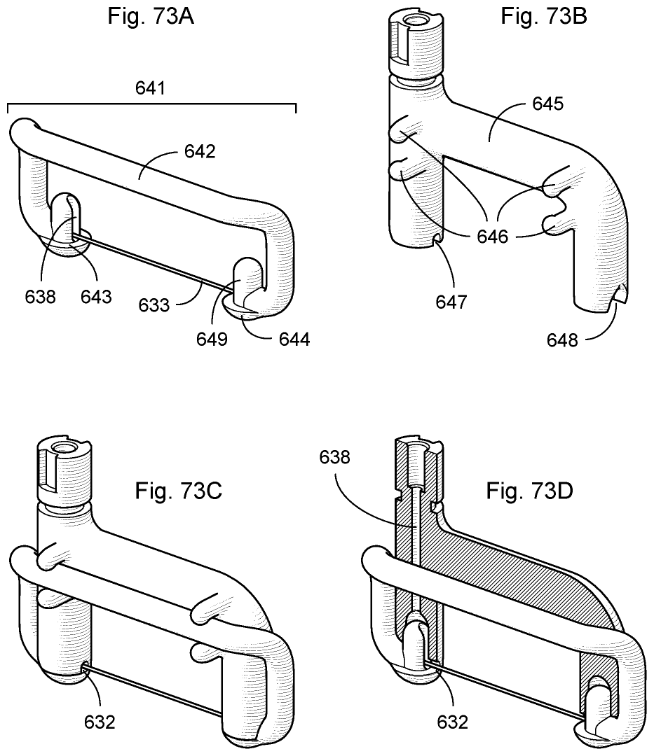

FIGS. 72A and 73A show perspective views of two examples of a floss insert 641. Floss insert 641 has a length of dental floss 633 held by a frame 642. Frame 642 may have a single member, such as an arc or semi-circle, or may consist of multiple members, of the same material and/or continuously connected, or heterogenous materials and/or bonded together. Frame 642 may have retention features, such as a clamp (for example, as shown in FIG. 61). Floss insert 641, in combination with a floss insert holder 645, may form one or more orifices 632. The orifice can be formed with most of the orifice formed by floss insert 641, or most of the orifice formed by floss insert holder 645, or each contributing half of the orifice. In the case of a lesser contribution to the orifice, such as shown in FIG. 72A by the floss insert 641, which contributes a sealing surface 643 to form the orifice, the sealing surface 643 can either be a discrete part, or may be a side-effect of another feature. For example, also in FIG. 72A, the sealing surface 643 is part of endcap 644. Endcap 644 may provide a smoother or softer surface than floss insert holder 645 in case of accidental contact of holder 645 with the user's gums 616

FIG. 73A also shows posts 649 with one or more substance channels 638. Having posts 649 may increase retention of floss insert 641 in floss holder 645 due to increased contact area/friction and minimize substance leakage due to having a labyrinth sealing pathway. Orifice 632 is formed from partial orifice 647 on floss insert holder 645 combined with substance channel 638 and sealing surface 643 on floss insert 641.

FIGS. 72B and 73B show perspective views of two examples of a floss insert holder 645. Floss insert holder 645 may be a detachable item, or may be permanently or semi-permanently integrated into tool arm 603. Floss insert holder 645 may have zero, one or more of substance channels 638. Floss insert holder 645 may have retention features to hold and/or constrain floss insert 641, such as one or more retention pegs 646 or floss insert guides 648 or clamps (for example, as shown in FIG. 61). Floss insert holder 645 may have one or more partial orifices 647 and/or sealing surfaces in order to form a complete orifice 632 in combination with floss insert 641.

FIGS. 72C and 73C show perspective views of two examples of an assembled floss insert 641 in a floss insert holder 645. These figures show the complete orifice 632 formed from partial orifice 647 and sealing surface 643. These figures also show floss insert frame 642 securely clamped onto retention pegs 646.

FIGS. 72D and 73D show perspective views of two examples of an assembled floss insert 641 in a floss insert holder 645. Substance can travel through one or more substance channels 638 to the complete orifice 632.

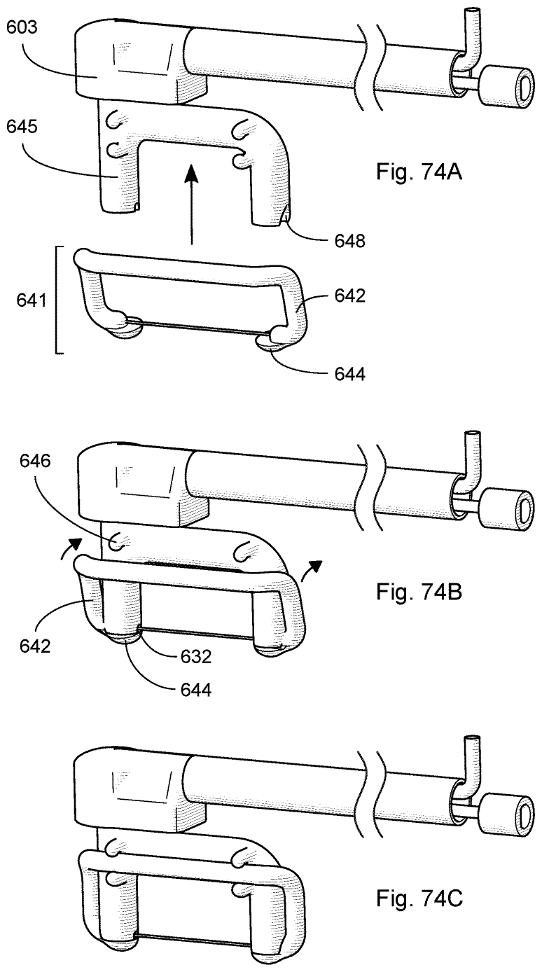

FIG. 74 illustrates the process of connecting the floss insert 641 to the floss insert holder 645 to form a complete assembly. Floss insert holder 645 may be detachably, semi-permanently, or permanently connected to tool arm 603.

Regarding FIG. 74A, floss insert 641 is pressed onto floss insert holder 645, making sure that floss insert frame 642 aligns with floss insert guides 648 until floss insert endcaps 644 touch the bottom of floss insert holder 645. Next, as shown in FIG. 74B, floss insert frame 642 is rotated onto retention pegs 646 until floss insert 641 and floss insert holder 645 are fastened together, thereby forming orifice 632 from floss insert holder 645 and floss insert endcap 644. FIG. 74C shows the fully assembled unit.

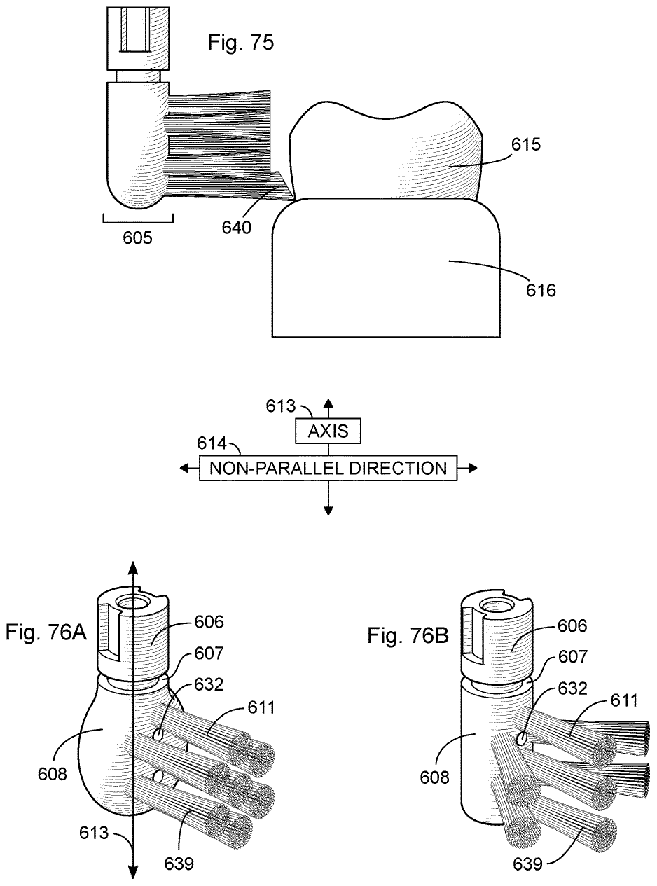

FIG. 75 shows how angled bristle clusters can enhance cleaning of the gumline. Oral cavity tool 605 may have one or more of an extended-length angled-down bristle cluster 640.

FIGS. 76 to 88 are a set of diagrams of oral cavity tools 605 for use with an oral appliance 602. Oral cavity tool 605 may include a connector 606 that may be configured to connect to an actuator 604 of the oral appliance 602. Oral cavity tool 605 may include a retention feature 607. The connector 606 may be configured to couple to the actuator 604 in a direction of an axis 613. The actuator 604 may rotate the connector 606 around the axis 613. The oral cavity tool 605 may include a first member 608 that may extend in a lengthwise direction along the axis 613. The first member 608 may include an oral hygiene tool 611, in this example, a plurality of bristle clusters. The bristle clusters may extend from the first member 608. The connector 606 may be configured to receive, from the actuator 604, a rotational force around an axis 613. The rotational force received from the actuator 604 may rotate the connector 606 and the first member 608 around the axis 613. As a result, the bristle clusters may rotate around the axis 613. Oral cavity tool 605 may also have substance channels 638 which may convey substances to orifices 632.

FIG. 76A is a perspective view of a brushing cartridge with regular-length flat parallel bristle clusters 639 and cleaning jets and/or dispensing orifices 632.

FIG. 76B is a perspective view of a brushing cartridge with regular-length flat radial bristle clusters 639 and cleaning jets and/or dispensing orifices 632.

FIGS. 77A to 77D are perspective, section, plan and elevation views, respectively, of a brushing oral cavity tool 605 with the oral hygiene tool 611 consisting of regular-length flat parallel bristle clusters 639 and cleaning jets and/or dispensing orifices 632. Uniform parallel bristle clusters may be easier and less expensive to manufacture. FIG. 77B shows integrated substance channels as part of a brushing oral cavity tool 605, which can dispense various substances (mouthwash, disinfectant, water, sugar alcohols, air), slurries (liquid toothpaste) and gels. These substances can be used to assist in the dental cleaning process, cleaning and purging of the equipment including drying and antibiotic/antimicrobial actions.

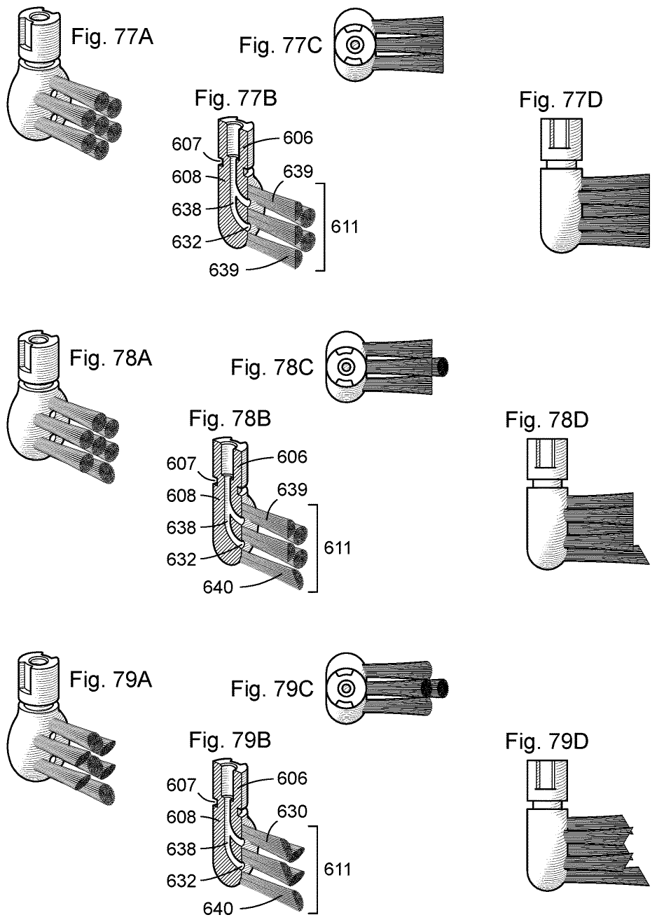

FIGS. 78A to 78D are perspective, section, plan and elevation views, respectively, of a brushing oral cavity tool 605 with the oral hygiene tool 611 consisting of regular-length flat parallel bristle clusters 639 and one or more extended-length angled-down parallel bristle clusters 630 and cleaning jets and/or dispensing orifices 632. The extended-length angled-down bristle clusters may enhance gum-line cleaning, as shown in FIG. 75.

FIGS. 79A to 79D are perspective, section, plan and elevation views, respectively, of a brushing oral cavity tool 605 with regular-length angled-alternating parallel bristle clusters 630 and extended-length angled-down parallel bristle clusters 640 and cleaning jets and/or dispensing orifices 632. The angled-alternating bristle clusters may enhance tooth surface cleaning and the extended-length angled-down bristle clusters may enhance gum-line cleaning, as shown in FIG. 75.

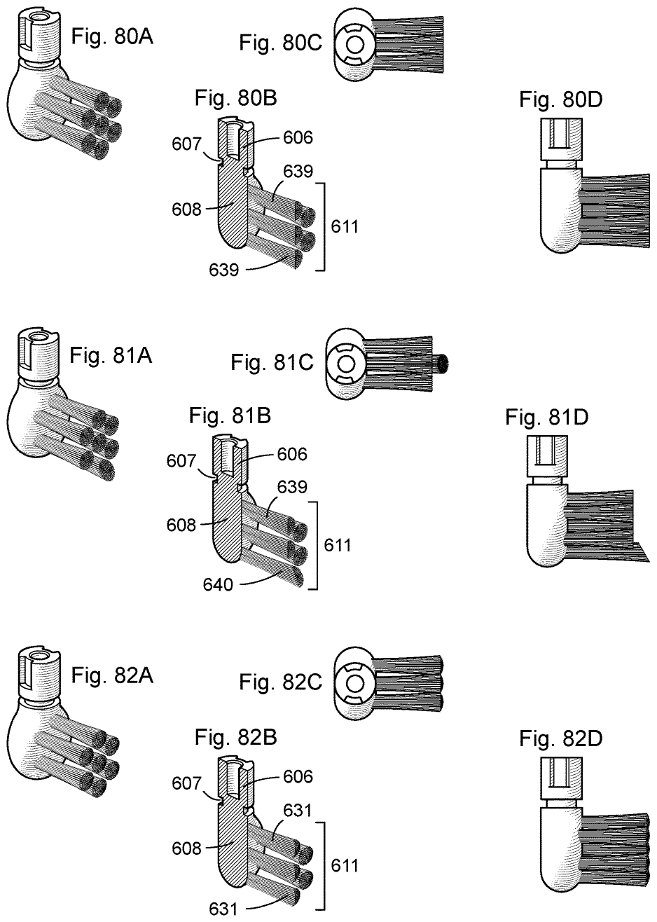

FIGS. 80A to 80D are perspective, section, plan and elevation views, respectively, of a brushing oral cavity tool 605 with the oral hygiene tool 611 consisting of regular-length flat parallel bristle clusters 639 without cleaning jets and/or dispensing orifices 632. Uniform parallel bristle clusters and the lack of cleaning jets and/or dispensing orifices 632 may be easier and less expensive to manufacture.

FIGS. 81A to 81D are perspective, section, plan and elevation views, respectively, of a brushing oral cavity tool 605 with the oral hygiene tool 611 consisting of regular-length flat parallel bristle clusters 639 and extended-length angled-down parallel bristle clusters 640 without cleaning jets and/or dispensing orifices 632. The extended-length angled-down bristle clusters may enhance gum-line cleaning, as shown in FIG. 75 and the lack of cleaning jets and/or dispensing orifices 632 may be easier and less expensive to manufacture.

FIGS. 82A to 82D are perspective, section, plan and elevation views, respectively, of a brushing oral cavity tool 605 with the oral hygiene tool 611 consisting of regular-length rounded parallel bristle clusters 631 without cleaning jets and/or dispensing orifices 632. Rounded bristle clusters may be gentler on a user's gums than flat or angled bristle clusters and this suitable for users with sensitive gums.

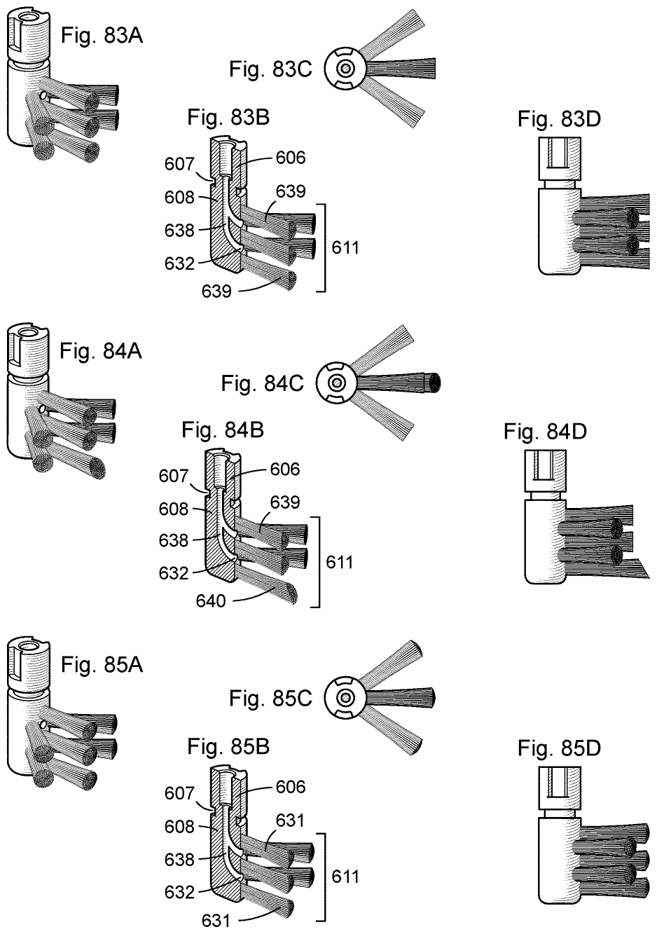

FIGS. 83A to 83D are perspective, section, plan and elevation views, respectively, of a brushing oral cavity tool 605 with the oral hygiene tool 611 consisting of regular-length flat radial bristle clusters 639 and cleaning jets and/or dispensing orifices 632. By using radial bristle clusters each bristle is roughly equidistant from the tooth surface as the cartridge rotates. This reduces the rotational force required to clean the teeth, thereby allowing the use of smaller, cheaper and less-powerful motors.

FIGS. 84A to 84D are perspective, section, plan and elevation views, respectively, of a brushing oral cavity tool 605 with the oral hygiene tool 611 consisting of regular-length flat radial bristle clusters 639 and extended-length angled-down radial bristle clusters 640 and cleaning jets and/or dispensing orifices 632.

FIGS. 85A to 85D are perspective, section, plan and elevation views, respectively, of a brushing oral cavity tool 605 with the oral hygiene tool 611 consisting of regular-length rounded radial bristle clusters 631 and cleaning jets and/or dispensing orifices 632.

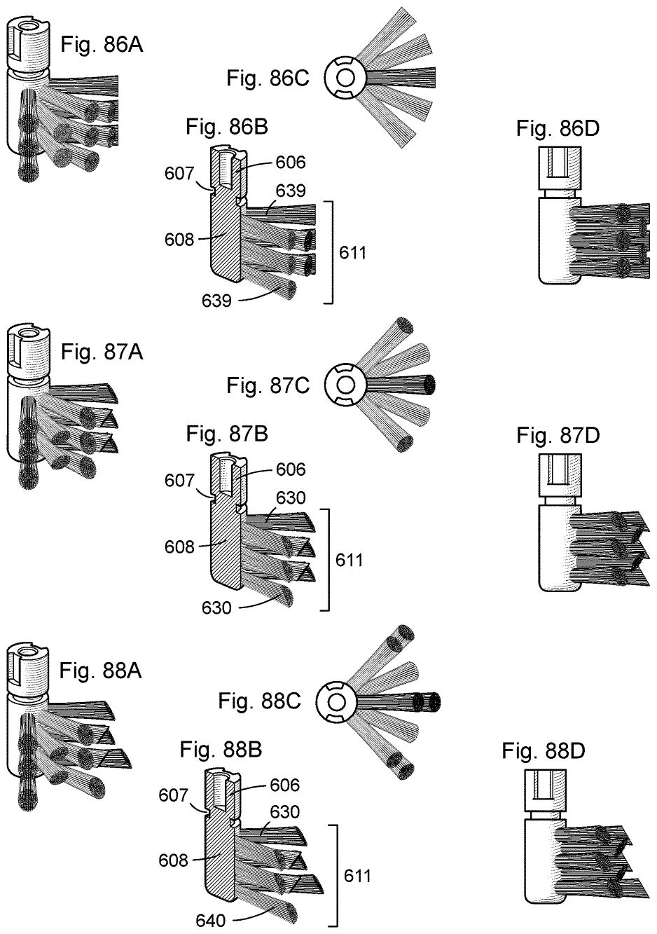

FIGS. 86A to 86D are perspective, section, plan and elevation views, respectively, of a brushing oral cavity tool 605 with the oral hygiene tool 611 consisting of regular-length flat radial bristle clusters 639 without cleaning jets and/or dispensing orifices 632.

FIGS. 87A to 87D are perspective, section, plan and elevation views, respectively, of a brushing oral cavity tool 605 with the oral hygiene tool 611 consisting of regular-length angled-alternating radial bristle clusters 630 without cleaning jets and/or dispensing orifices 632.

FIGS. 88A to 88D are perspective, section, plan and elevation views, respectively, of a brushing oral cavity tool 605 with the oral hygiene tool 611 consisting of regular-length angled-alternating radial bristle clusters 630 and extended-length angled-down radial bristle clusters 640 without cleaning jets and/or dispensing orifices 632.

Oral cavity tool example 1: An oral cavity tool, comprising:
a connector configured to connect to an actuator and to receive one or both of a rotational force around an axis and/or a translational motion; and
a first member extending from the connector in a lengthwise direction along the axis, and the first member including an oral hygiene tool.

Oral cavity tool example 2: The oral cavity tool of example 1, wherein the connector couples to the actuator in the direction of the axis.

Oral cavity tool example 3: The oral cavity tool of example 1, wherein the connector couples to the actuator in a direction that is nonparallel with the axis.

Oral cavity tool example 4: The oral cavity tool of example 1, wherein the oral hygiene tool includes a brush that extends from the first member in an outward direction.

Oral cavity tool example 5: The oral cavity tool of example 4, wherein the brush extends from the first member in the direction of the axis.

Oral cavity tool example 6: The oral cavity tool of example 4, wherein the brush includes a plurality of brush clusters extending outward from the first member.

Oral cavity tool example 7: The oral cavity tool of example 6, wherein a first brush cluster and a second brush cluster extend outward from the first member in a same direction.

Oral cavity tool example 8: The oral cavity tool of example 6, wherein a first brush cluster and a second brush cluster extend outward from the first member in different directions.

Oral cavity tool example 9: The oral cavity tool of example 6, wherein a first brush cluster includes brush fibers of a first length, and a second brush cluster includes brush fibers of a second length.

Oral cavity tool example 10: The oral cavity tool of example 4, wherein the brush includes a plurality of brush clusters that extend from the first member at different locations along the axis.

Oral cavity tool example 11: The oral cavity tool of example 4, wherein the brush is configured to rotate along an axis in the outward direction.

Oral cavity tool example 12: The oral cavity tool of example 4, wherein the brush includes a plurality of brush fibers, the plurality of brush fibers including a first brush fiber of a different length than a second brush fiber of the plurality of brush fibers.

Oral cavity tool example 13: The oral cavity tool of example 6, wherein the plurality of brush clusters includes one or more brush clusters having bristle ends forming an angle.

Oral cavity tool example 14: The oral cavity tool of example 6, wherein the plurality of brush clusters includes one or more brush clusters having bristles forming a rounded end.

Oral cavity tool example 15: The oral cavity tool of example 1, wherein the oral hygiene tool includes a length of floss that extends from the first member.

Oral cavity tool example 16: The oral cavity tool of example 15, further comprising a second member that extends from the first member in a non-parallel direction, and a third member that extends from the second member in a lengthwise direction along the axis, wherein the length of floss extends from the first member to the third member.

Oral cavity tool example 17: The oral cavity tool of example 15, further comprising: a tongue scraper tab attached to one or more of the members.

Oral cavity tool example 18: The oral cavity tool of example 1, further comprising: a locating feature attached to a member to permit the storage of the apparatus in a known orientation.

Oral cavity tool example 19: The oral cavity tool of example 1, further comprising a substance conduit configured to conduct a substance through at least one of a first member or a second member or a third member.

Oral cavity tool example 20: The oral cavity tool of example 19, wherein the connector includes an aperture of the substance conduit.

Oral cavity tool example 21: The oral cavity tool of example 19, wherein a surface of the first member includes an orifice of the substance conduit.

Oral cavity tool example 22: The oral cavity tool of example 21, wherein the orifice is oriented in a same direction as at least a portion of the oral hygiene tool.

Oral cavity tool example 23: The oral cavity tool of example 21, wherein the orifice of the substance conduit is oriented toward the oral hygiene tool.

Oral cavity tool example 24: The oral cavity tool of example 21, wherein the oral hygiene tool extends from the first member at a first position along the axis, and the orifice is located on the surface of the first member at a second position along the axis.

Oral cavity tool example 25: The oral cavity tool of example 21, wherein the orifice is located on the surface of the first member at a first position along the axis, and the oral hygiene tool extends from the first member surrounding the first position.

Oral cavity tool example 26: The oral cavity tool of example 21, wherein the surface of the first member includes at least two orifices of the substance conduit at different locations along the axis.

Oral cavity tool example 27: The oral cavity tool of example 19 further comprising a second member that extends from the first member in a non-parallel direction, and a third member that extends from the second member in a lengthwise direction along the axis, and a surface of the third member includes an orifice of the substance conduit.

Oral cavity tool example 28: The oral cavity tool of example 27, wherein the oral hygiene tool extends from the third member at a first position along the axis, and the orifice is located on the surface of the third member at a second position along the axis.

Oral cavity tool example 29: The oral cavity tool of example 27, wherein the orifice is located on the surface of the third member at a first position along the axis, and the oral hygiene tool extends from the third member surrounding the first position.

Oral cavity tool example 30: The oral cavity tool of example 27, wherein the orifice of the substance conduit is oriented toward the oral hygiene tool.

Oral cavity tool example 31: The oral cavity tool of example 27, wherein the surface of the third member includes at least two orifices of the substance conduit at different locations along the axis.

Oral cavity tool example 32: An oral cavity tool, comprising:
an oral hygiene tool; and
a cleaning tool that is oriented toward the oral hygiene tool.

Oral cavity tool example 33: An oral cavity tool, comprising:
an oral hygiene tool; and
a cleaning tool configured to apply a cleaning operation to the oral hygiene tool.

Oral cavity tool example 34: The oral cavity tool of example 33, wherein the cleaning tool is configured to contact the oral hygiene tool to clean the oral hygiene tool.

Oral cavity tool example 35: The oral cavity tool of example 33, wherein the oral hygiene tool includes a member, and the cleaning tool includes a substance conduit configured to conduct a substance to clean the oral hygiene tool.

Oral cavity tool example 36: The oral cavity tool of example 35, wherein an orifice of the substance conduit is located on a surface of the member, and the orifice is oriented toward the oral hygiene tool.

Oral cavity tool example 37: The oral cavity tool of example 36, wherein the oral hygiene tool surrounds the orifice when viewed in a direction into the orifice.

Oral cavity tool example 38: An apparatus comprising:
an oral hygiene tool configured to perform a first oral hygiene task; and
a substance conduit for a substance that is configured to conduct a substance for a second oral hygiene task.

Oral cavity tool example 39: The oral cavity tool of example 38, wherein the oral hygiene tool extends from a member of the apparatus in an outward direction, an orifice of the substance conduit is located on an outer surface of the member, and the orifice is configured to dispense substance in the outward direction.

Oral cavity tool example 40: The oral cavity tool of example 38, wherein the oral hygiene tool surrounds the orifice when viewed in a direction into the orifice.

Oral cavity tool example 41: An oral cavity tool, comprising:
a connector including one or more flats or splines configured to insert into an actuator in a direction of an axis and to receive a rotational force around the axis; and
a member that extends in a lengthwise direction, the member including an oral hygiene tool,
wherein the rotational force applied to one or more of the flats or splines of the connector causes the member to rotate relative to the axis.

Oral cavity tool example 42: The oral cavity tool of example 41, wherein the rotational force causes the member to rotate relative to the axis through a rotational range of more than five degrees.

Oral cavity tool example 43: The oral cavity tool of example 4, wherein the length of the apparatus down the axis is less than 20 mm.

Oral cavity tool example 44: The oral cavity tool of example 4, wherein the length of the apparatus down the axis is less than 30 mm.

Oral cavity tool example 45: The oral cavity tool of example 4, wherein the length of the apparatus down the axis is less than 40 mm.

Oral cavity tool example 46: The oral cavity tool of example 4, wherein the distance from the end of the connector to the start of the brush is less than 10 mm.

Oral cavity tool example 47: An oral cavity tool, comprising:
a connector having a connector axis, configured to connect to an actuator and to receive one or both of a rotational motion around a rotational axis and/or a translational motion;
one or more members, which may be connected with transitional segments such as bends, curves, arcs or fillets;
an oral hygiene tool.

Oral cavity tool example 48: The oral cavity tool of example 47, where the oral hygiene tool is a length of dental floss.

Oral cavity tool example 49: The oral cavity tool of example 48, having a first member attached to the connector, a second member attached to the first member, and a third member attached to the second member, where the oral hygiene tool is attached to the first and third members.

Oral cavity tool example 50: The oral cavity tool of example 49, where the first member proceeds along the connector axis, the second member is perpendicular to the first member, and the third member is parallel to the first member.

Oral cavity tool example 51: The oral cavity tool of example 49, where the first member proceeds within 30 degrees of the connector axis, the second member is within 30 degrees of perpendicular to the first member, and the third member is within 30 degrees of parallel to the first member.

Oral cavity tool example 52: The oral cavity tool of example 48, having a first member attached to the connector, a second member attached to the first member, and a set of two third members attached to the second member, where the oral hygiene tool is attached to the third members.

Oral cavity tool example 53: The oral cavity tool of example 52, where the first member proceeds along the connector axis, the second member is perpendicular to the first member, and the third members are parallel to the first member.

Oral cavity tool example 54: The oral cavity tool of example 52, where the first member proceeds within 30 degrees of the connector axis, the second member is within 30 degrees of perpendicular to the first member, and the third members are within 30 degrees of parallel to the first member.

Oral cavity tool example 55: The oral cavity tool of example 52, where the first member proceeds along the connector axis, the second member is perpendicular to the first member, and the third members are perpendicular to the first member.

Oral cavity tool example 56: The oral cavity tool of example 52, where the first member proceeds within 30 degrees of the connector axis, the second member is within 30 degrees of perpendicular to the first member, and the third members are within 30 degrees of perpendicular to the first member.

Oral cavity tool example 57: The oral cavity tool of example 48, having a first member attached to the connector, and a second member attached to the first member, where the oral hygiene tool is attached to the first and second members.

Oral cavity tool example 58: The oral cavity tool of example 57, where the first member proceeds along the connector axis, and the second member is an arc or semi-circle.

Oral cavity tool example 59: The oral cavity tool of example 11, where the first member proceeds within 30 degrees of the connector axis, and the second member is an arc or semi-circle.

Oral cavity tool example 60: The oral cavity tool of example 48, having a first member, which is an arc or semi-circle, attached to the connector, and where the oral hygiene tool is attached to the first member.

Oral cavity tool example 61: The oral cavity tool of example 60, where the oral hygiene tool is perpendicular to the connector axis.

Oral cavity tool example 62: The oral cavity tool of example 60, where the oral hygiene tool is within 30 degrees of perpendicular to the connector axis.

Oral cavity tool example 63: The oral cavity tool of example 60, where the oral hygiene tool is parallel to the connector axis.

Oral cavity tool example 64: The oral cavity tool of example 60, where the oral hygiene tool is within 30 degrees of parallel to the connector axis.

Oral cavity tool example 65: The oral cavity tool of example 48, having a first member attached to the connector, a second member attached to the first member, and a third member attached to the second member, where the oral hygiene tool is attached to the third member.

Oral cavity tool example 66: The oral cavity tool of example 65, where the first member proceeds along the connector axis, the second member is perpendicular to the first member, and the third member is an arc or semi-circle.

Oral cavity tool example 67: The oral cavity tool of example 65, where the first member proceeds within 30 degrees of the connector axis, the second member is within 30 degrees of perpendicular to the first member, and the third member is an arc or semi-circle.

Oral cavity tool example 68: The oral cavity tool of example 57, where the first member proceeds along the connector axis, and the second member is an arc or semi-circle.

Oral cavity tool example 69: The oral cavity tool of example 68, where the connector is located at the end of the first member.

Oral cavity tool example 70: The oral cavity tool of example 68, where the connector is located at the center of the first member.

Oral cavity tool example 71: The oral cavity tool of example 68, where the connector axis is oriented towards the oral hygiene tool.

Oral cavity tool example 72: The oral cavity tool of example 68, where the connector axis is oriented orthogonally to the oral hygiene tool.

Oral cavity tool example 73: The oral cavity tool of example 57, where the first member proceeds within 30 degrees of the connector axis, and the second member is an arc or semi-circle.

Oral cavity tool example 74: The oral cavity tool of example 73, where the connector is located at the end of the first member.

Oral cavity tool example 75: The oral cavity tool of example 73, where the connector is located at the center of the first member.

Oral cavity tool example 76: The oral cavity tool of example 73, where the connector axis is oriented towards the oral hygiene tool.

Oral cavity tool example 77: The oral cavity tool of example 73, where the connector axis is oriented orthogonally to the oral hygiene tool.

Oral cavity tool example 78: The oral cavity tool of example 48, having a first member attached to the connector, and two second members attached to the first member, where the oral hygiene tool is attached to the second members.

Oral cavity tool example 79: The oral cavity tool of example 78, where the first member proceeds along the connector axis.

Oral cavity tool example 80: The oral cavity tool of example 78, where the first member proceeds within 30 degrees of the connector axis.

Oral cavity tool example 81: The oral cavity tool of example 78, where the first member proceeds along the connector axis, and the second members are perpendicular to the first member.

Oral cavity tool example 82: The oral cavity tool of example 78, where the first member proceeds within 30 degrees of the connector axis, and the second members are within 30 degrees of perpendicular to the first member.

Oral cavity tool example 83: The oral cavity tool of example 48, having a first member attached to the connector, a second member attached to the first member, and a third member attached to the second member, and a fourth member attached to the third member, where the oral hygiene tool is attached to the second and fourth members.

Oral cavity tool example 84: The oral cavity tool of example 83, where the first member proceeds along the connector axis, the second member is non-parallel to the first member, the third member is perpendicular to the second member, and the fourth member is parallel to the second member.

Oral cavity tool example 85: The oral cavity tool of example 83, where the first member proceeds within 30 degrees of the connector axis, the second member is non-parallel to the first member, the third member is within 30 degrees of perpendicular to the second member, and the fourth member is within 30 degrees of parallel to the second member.

Oral cavity tool example 86: The oral cavity tool of example 60, where the connector has an aperture for receiving a substance, which is connected to a substance conduit in the first member, and which outputs at one or more orifices on the exterior of the first member.

Oral cavity tool example 87: The oral cavity tool of example 57, where the connector has an aperture for receiving a substance, which is connected to one or more substance conduits in one or both of the first and second members, and which outputs at one or more orifices on the exterior of the first member and/or the second member.

Oral cavity tool example 88: The oral cavity tool of example 49, where the connector has an aperture for receiving a substance, which is connected to one or more substance conduits in one or more of the first, second and/or third members, and which outputs at one or more orifices on the exterior of the first member and/or the second member and/or the third member.

Oral cavity tool example 89: The oral cavity tool of example 65, where the connector has an aperture for receiving a substance, which is connected to one or more substance conduits in one or more of the first, second and/or third members, and which outputs at one or more orifices on the exterior of the first member and/or the second member and/or the third member.

Oral cavity tool example 90: The oral cavity tool of example 78, where the connector has an aperture for receiving a substance, which is connected to one or more substance conduits in one or more of the first and/or second members, and which outputs at one or more orifices on the exterior of the first member and/or the second members.

Oral cavity tool example 91: The oral cavity tool of example 52, where the connector has an aperture for receiving a substance, which is connected to one or more substance conduits in one or more of the first and/or second and/or third members, and which outputs at one or more orifices on the exterior of the first member and/or the second member and/or the third members.

Oral cavity tool example 92: The oral cavity tool of example 83, where the connector has an aperture for receiving a substance, which is connected to one or more substance conduits in one or more of the first, second, third and/or fourth members, and which outputs at one or more orifices on the exterior of the first member and/or the second member and/or the third member and/or the fourth member.

Oral cavity tool example 93: An oral cavity tool, comprising:
a member that can rotatably connect to a tool arm having a tool arm axis; and
a plurality of bristles attached to the member.

Oral cavity tool example 94: The oral cavity tool of example 93, where the member is composed of sub-members attached or bonded together.

Oral cavity tool example 95: The oral cavity tool of example 93 where the length of the member is less than 20 mm.

Oral cavity tool example 96: The oral cavity tool of example 93 where the length of the member is less than 30 mm.

Oral cavity tool example 97: The oral cavity tool of example 93 where the length of the member is less than 40 mm.

Oral cavity tool example 98: The oral cavity tool of example 93, wherein the distance from the end of the member to the start of the brush is less than 10 mm.

Oral cavity tool example 99: The oral cavity tool of example 93, wherein the distance from the end of the member to the start of the brush is less than 15 mm.

Oral cavity tool example 100: The oral cavity tool of example 93, where the average direction of the combination of all bristles is parallel to the tool arm axis.

Oral cavity tool example 101: The oral cavity tool of example 100 where the length of the member is less than 20 mm.

Oral cavity tool example 102: The oral cavity tool of example 100 where the length of the member is less than 30 mm.

Oral cavity tool example 103: The oral cavity tool of example 100 where the length of the member is less than 40 mm.

Oral cavity tool example 104: The oral cavity tool of example 100, wherein the distance from the end of the member to the start of the brush is less than 10 mm.

Oral cavity tool example 105: The oral cavity tool of example 100, wherein the distance from the end of the member to the start of the brush is less than 15 mm.

Oral cavity tool example 106: The oral cavity tool of example 93, where the average direction of the combination of all bristles is within 15 degrees of parallel to the tool arm axis.

Oral cavity tool example 107: The oral cavity tool of example 106 where the length of the member is less than 20 mm.

Oral cavity tool example 108: The oral cavity tool of example 106 where the length of the member is less than 30 mm.

Oral cavity tool example 109: The oral cavity tool of example 106 where the length of the member is less than 40 mm.

Oral cavity tool example 110: The oral cavity tool of example 106, wherein the distance from the end of the member to the start of the brush is less than 10 mm.

Oral cavity tool example 111: The oral cavity tool of example 106, wherein the distance from the end of the member to the start of the brush is less than 15 mm.

Oral cavity tool example 112: The oral cavity tool of example 93, where the average direction of the combination of all bristles is within 30 degrees of parallel to the tool arm axis.

Oral cavity tool example 113: The oral cavity tool of example 112 where the length of the member is less than 20 mm.

Oral cavity tool example 114: The oral cavity tool of example 112 where the length of the member is less than 30 mm.

Oral cavity tool example 115: The oral cavity tool of example 112 where the length of the member is less than 40 mm.

Oral cavity tool example 116: The oral cavity tool of example 112, wherein the distance from the end of the member to the start of the brush is less than 10 mm.

Oral cavity tool example 117: The oral cavity tool of example 112, wherein the distance from the end of the member to the start of the brush is less than 15 mm.

Oral cavity tool example 118: The oral cavity tool of example 93, where the average direction of the combination of all bristles is within 45 degrees of parallel to the tool arm axis.

Oral cavity tool example 119: The oral cavity tool of example 118 where the length of the member is less than 20 mm.

Oral cavity tool example 120: The oral cavity tool of example 118 where the length of the member is less than 30 mm.

Oral cavity tool example 121: The oral cavity tool of example 118 where the length of the member is less than 40 mm.

Oral cavity tool example 122: The oral cavity tool of example 118, wherein the distance from the end of the member to the start of the brush is less than 10 mm.

Oral cavity tool example 123: The oral cavity tool of example 118, wherein the distance from the end of the member to the start of the brush is less than 15 mm.

Oral cavity tool example 124: The oral cavity tool of example 100, where the member has one or more substance channels which output to one or more orifices on the exterior of the member.

Oral cavity tool example 125: The oral cavity tool of example 124 where the length of the member is less than 20 mm.

Oral cavity tool example 126: The oral cavity tool of example 124 where the length of the member is less than 30 mm.

Oral cavity tool example 127: The oral cavity tool of example 124 where the length of the member is less than 40 mm.

Oral cavity tool example 128: The oral cavity tool of example 124, wherein the distance from the end of the member to the start of the brush is less than 10 mm.

Oral cavity tool example 129: The oral cavity tool of example 124, wherein the distance from the end of the member to the start of the brush is less than 15 mm.

Oral cavity tool example 130: The oral cavity tool of example 106, where the member has one or more substance channels which output to one or more orifices on the exterior of the member.

Oral cavity tool example 131: The oral cavity tool of example 130 where the length of the member is less than 20 mm.

Oral cavity tool example 132: The oral cavity tool of example 130 where the length of the member is less than 30 mm.

Oral cavity tool example 133: The oral cavity tool of example 130 where the length of the member is less than 40 mm.

Oral cavity tool example 134: The oral cavity tool of example 130, wherein the distance from the end of the member to the start of the brush is less than 10 mm.

Oral cavity tool example 135: The oral cavity tool of example 130, wherein the distance from the end of the member to the start of the brush is less than 15 mm.

Oral cavity tool example 136: The oral cavity tool of example 112, where the member has one or more substance channels which output to one or more orifices on the exterior of the member.

Oral cavity tool example 137: The oral cavity tool of example 136 where the length of the member is less than 20 mm.

Oral cavity tool example 138: The oral cavity tool of example 136 where the length of the member is less than 30 mm.

Oral cavity tool example 139: The oral cavity tool of example 136 where the length of the member is less than 40 mm.

Oral cavity tool example 140: The oral cavity tool of example 136, wherein the distance from the end of the member to the start of the brush is less than 10 mm.

Oral cavity tool example 141: The oral cavity tool of example 136, wherein the distance from the end of the member to the start of the brush is less than 15 mm.

Oral cavity tool example 142: The oral cavity tool of example 118, where the member has one or more substance channels which output to one or more orifices on the exterior of the member.

Oral cavity tool example 143: The oral cavity tool of example 142 where the length of the member is less than 20 mm.

Oral cavity tool example 144: The oral cavity tool of example 142 where the length of the member is less than 30 mm.

Oral cavity tool example 145: The oral cavity tool of example 142 where the length of the member is less than 40 mm.

Oral cavity tool example 146: The oral cavity tool of example 142, wherein the distance from the end of the member to the start of the brush is less than 10 mm.

Oral cavity tool example 147: The oral cavity tool of example 142, wherein the distance from the end of the member to the start of the brush is less than 15 mm.

Oral cavity tool example 148: A floss insert apparatus, comprising:
a length of dental floss; and
a frame which is attached to the dental floss on both ends and constrains the dental floss and which forms one or more substance orifices when combined with a floss insert apparatus holder having one or more substance channels.

Oral cavity tool example 149: The oral cavity tool of example 148, where the frame has a tubular or circular or ellipsoid or rectangular or polygonal cross-section which can be secured with pegs or claws or clamps or hooks on a floss insert apparatus holder.

Oral cavity tool example 150: The oral cavity tool of example 148, where the frame has one or more holes which mate with pegs on a floss insert holder.

Oral cavity tool example 151: The oral cavity tool of example 148, where the frame has one or more pins which mate with holes on a floss insert holder.

Oral cavity tool example 152: The oral cavity tool of example 148, where the frame has one or more hooks to attach to a floss insert holder.

Oral cavity tool example 153: The oral cavity tool of example 148, where the frame has one or more grooves which mate with hooks or flanges on a floss insert holder.

Oral cavity tool example 154: The oral cavity tool of example 148, where the frame has one or more flanges which mate with grooves or clasps on a floss insert holder.

Oral cavity tool example 155: The oral cavity tool of example 148, where the frame has a semi-circular or semi-ellipsoid shape.

Oral cavity tool example 156: The oral cavity tool of example 148, where the frame is comprised of a plurality of straight members.

Oral cavity tool example 157: The oral cavity tool of example 156, where the members are connected with curved segments.

Oral cavity tool example 158: The oral cavity tool of example 148, where the frame is comprised of a plurality of curved members.

Oral cavity tool example 159: An oral cavity tool, comprising:
a floss insert comprising a length of dental floss and a frame which is attached to the dental floss on both ends and constrains the dental floss; and
a floss insert holder comprising a frame which mates with and constrains the floss insert.

Oral cavity tool example 160: The oral cavity tool of example 159, where the floss insert frame has a tubular or circular or ellipsoid or rectangular or polygonal cross-section which can be secured with pegs or claws or clamps or hooks on the floss insert holder.

Oral cavity tool example 161: The oral cavity tool of example 159, where the floss insert frame has one or more holes which mate with pegs on the floss insert holder.

Oral cavity tool example 162: The oral cavity tool of example 159, where the floss insert frame has one or more pins which mate with holes on the floss insert holder.

Oral cavity tool example 163: The oral cavity tool of example 159, where the floss insert frame has one or more hooks to attach to the floss insert holder.

Oral cavity tool example 164: The oral cavity tool of example 159, where the floss insert frame has one or more grooves which mate with hooks or flanges on the floss insert holder.

Oral cavity tool example 165: The oral cavity tool of example 159, where the floss insert frame has one or more flanges which mate with grooves or clasps on the floss insert holder.

Oral cavity tool example 166: The oral cavity tool of example 159, where the floss insert frame has a semi-circular or semi-ellipsoid shape.

Oral cavity tool example 167: The oral cavity tool of example 159, where the floss insert frame is comprised of a plurality of straight members.

Oral cavity tool example 168: The oral cavity tool of example 167, where the members are connected with curved segments.

Oral cavity tool example 169: The oral cavity tool of example 159, where the floss insert frame is comprised of a plurality of curved members.

Oral cavity tool example 170: An oral cavity tool, comprising:
a floss insert comprising a length of dental floss and a frame which is attached to the dental floss on both ends and constrains the dental floss; and
a tool arm having a rotatable floss insert holder comprising a frame which mates with and constrains the floss insert.

Oral cavity tool example 171: The oral cavity tool of example 170, where the floss insert frame has a tubular or circular or ellipsoid or rectangular or polygonal cross-section which can be secured with pegs or claws or clamps or hooks on the floss insert holder.

Oral cavity tool example 172: The oral cavity tool of example 170, where the floss insert frame has one or more holes which mate with pegs on the floss insert holder.

Oral cavity tool example 173: The oral cavity tool of example 170, where the floss insert frame has one or more pins which mate with holes on the floss insert holder.

Oral cavity tool example 174: The oral cavity tool of example 170, where the floss insert frame has one or more hooks to attach to the floss insert holder.

Oral cavity tool example 175: The oral cavity tool of example 170, where the floss insert frame has one or more grooves which mate with hooks or flanges on the floss insert holder.

Oral cavity tool example 176: The oral cavity tool of example 170, where the floss insert frame has one or more flanges which mate with grooves or clasps on the floss insert holder.

Oral cavity tool example 177: The oral cavity tool of example 170, where the floss insert frame has a semi-circular or semi-ellipsoid shape.

Oral cavity tool example 178: The oral cavity tool of example 170, where the floss insert frame is comprised of a plurality of straight members.

Oral cavity tool example 179: The oral cavity tool of example 178, where the members are connected with curved segments.

Oral cavity tool example 180: The oral cavity tool of example 170, where the floss insert frame is comprised of a plurality of curved members.

Oral cavity tool example 181: An oral cavity tool, comprising:
a member, which can rotatably connect to a tool arm having a tool arm axis,
a plurality of bristles attached to the member where the average direction of the combination of all bristles is within 30 degrees of parallelism to the tool axis.

Oral cavity tool example 182: The oral cavity tool of example 181, where the member is composed of sub-members attached or bonded together

Oral cavity tool example 183: The oral cavity tool of example 181, where the length of the member is less than 20 mm.

Oral cavity tool example 184: The oral cavity tool of example 181, where the length of the member is less than 25 mm.

Oral cavity tool example 185: The oral cavity tool of example 181, where the length of the member is less than 30 mm.

Oral cavity tool example 186: The oral cavity tool of example 181, where the length of the member is less than 35 mm.

Oral cavity tool example 187: The oral cavity tool of example 181, where the length of the member is less than 40 mm.

Oral cavity tool example 188: An oral cavity tool, comprising:
a member that can rotatably connect to a tool arm having a tool arm axis,
a plurality of bristles attached to the member where the average direction of the combination of all bristles is within 45 degrees of parallelism to the tool axis.

Oral cavity tool example 189: The oral cavity tool of example 188, where the member is composed of sub-members attached or bonded together.

Oral cavity tool example 190: The oral cavity tool of example 188, where the length of the member is less than 20 mm.

Oral cavity tool example 191: The oral cavity tool of example 188, where the length of the member is less than 25 mm.

Oral cavity tool example 192: The oral cavity tool of example 188, where the length of the member is less than 30 mm.

Oral cavity tool example 193: The oral cavity tool of example 188, where the length of the member is less than 35 mm.

Oral cavity tool example 194: The oral cavity tool of example 188, where the length of the member is less than 40 mm.

Oral cavity tool example 195: An oral cavity tool, comprising:
a member having one or more substance channels that connects to a tool arm having a tool arm axis,
a plurality of bristles attached to the member where the average direction of the combination of all bristles is within 30 degrees of parallelism to the tool axis,
one or more orifices connected to one or more substance channels of the member.

Oral cavity tool example 196: The oral cavity tool of example 195, where the member is composed of sub-members attached or bonded together.

Oral cavity tool example 197: An oral cavity tool, comprising:
a member having one or more substance channels that connects to a tool arm having a tool arm axis,
a plurality of bristles attached to the member where the average direction of the combination of all bristles is within 45 degrees of parallelism to the tool axis,
one or more orifices connected to one or more substance channels of the member.

Oral cavity tool example 198: The oral cavity tool of example 197, where the member is composed of sub-members attached or bonded together.

Oral cavity tool example 199: An oral cavity tool, comprising:
a rotatable member that connects to a tool arm having a tool arm axis,
a plurality of bristles attached to the rotatable member where the average direction of the combination of all bristles is within 30 degrees of parallelism to the tool axis.

Oral cavity tool example 200: The oral cavity tool of example 199, where the member is composed of sub-members attached or bonded together.

Oral cavity tool example 201: An oral cavity tool, comprising:
a rotatable member that connects to a tool arm having a tool arm axis,
a plurality of bristles attached to the rotatable member where the average direction of the combination of all bristles is within 45 degrees of parallelism to the tool axis.

Oral cavity tool example 202: The oral cavity tool of example 201, where the member is composed of sub-members attached or bonded together.

Oral cavity tool example 203: An oral cavity tool, comprising:
a rotatable member that connects to a tool arm having a tool arm axis, the rotatable member having a rotation axis within 30 degrees of perpendicular to the tool arm axis,
a plurality of bristles attached to the rotatable member where the average direction of the combination of all bristles is within 30 degrees of parallelism to the tool axis.

Oral cavity tool example 204: The oral cavity tool of example 203, where the member is composed of sub-members attached or bonded together.

Oral cavity tool example 205: An oral cavity tool, comprising:
a rotatable member that connects to a tool arm having a tool arm axis, the rotatable member having a rotation axis within 45 degrees of perpendicular to the tool arm axis,
a plurality of bristles attached to the rotatable member where the average direction of the combination of all bristles is within 45 degrees of parallelism to the tool axis.

Oral cavity tool example 206: The oral cavity tool of example 205, where the member is composed of sub-members attached or bonded together.

Oral cavity tool example 207: An oral cavity tool, comprising:
a rotatable member having one or more substance channels that connects to a tool arm having a tool arm axis, the rotatable member having a rotation axis within 30 degrees of perpendicular to the tool arm axis,
a plurality of bristles attached to the rotatable member where the average direction of the combination of all bristles is within 30 degrees of parallelism to the tool axis,
one or more orifices connected to one or more substance channels of the member.

Oral cavity tool example 208: The oral cavity tool of example 207, where the member is composed of sub-members attached or bonded together.

Oral cavity tool example 209: An oral cavity tool, comprising:
a rotatable member having one or more substance channels that connects to a tool arm having a tool arm axis, the rotatable member having a rotation axis within 45 degrees of perpendicular to the tool arm axis,
a plurality of bristles attached to the rotatable member where the average direction of the combination of all bristles is within 45 degrees of parallelism to the tool axis,
one or more orifices connected to one or more substance channels of the member.

Oral cavity tool example 210: The oral cavity tool of example 209, where the member is composed of sub-members attached or bonded together.

Oral cavity tool example 211: An oral cavity tool, comprising:
a cartridge that connects to both a tool arm having a tool arm axis and an actuator,
a rotatable member of the cartridge having a rotation axis within 30 degrees of perpendicular to the tool arm axis,
a plurality of bristles attached to the rotatable member where the average of the axes of the bristles is within 30 degrees of perpendicular to the rotation axis,
a conversion mechanism to convert the motion provided by the actuator into rotary motion of the bristles.

Oral cavity tool example 212: The oral cavity tool of example 211 where the conversion mechanism comprises at least one or more of a spur gear, a bevel gear, a crown gear, a worm gear, a worm wheel, a hypoid gear, or a flexible shaft and combinations thereof.

Oral cavity tool example 213: The oral cavity tool of example 211 where the actuator has a pushrod which rotates the rotatable member, via a lever arm, crankshaft or other mechanism to convert linear motion into rotary motion.

Oral cavity tool example 214: The oral cavity tool of example 211 where the actuator has a pushrod which rotates the rotatable member, via a lever arm, crankshaft or other mechanism to convert linear motion into rotary motion, and one or more restoring springs.

Oral cavity tool example 215: The oral cavity tool of example 211 where the conversion mechanism is a pair of bevel gears.

Oral cavity tool example 216: The oral cavity tool of example 211 where the conversion mechanism is a spur gear meshing with a crown gear.

Oral cavity tool example 217: The oral cavity tool of example 211 where the conversion mechanism is a worm gear meshing with a worm wheel.

Oral cavity tool example 218: The oral cavity tool of example 211 where the conversion mechanism is a pair of hypoid gears.

Oral cavity tool example 219: An oral cavity tool, comprising:
a cartridge that connects to both a tool arm having a tool arm axis and an actuator,
a rotatable member of the cartridge having a rotation axis within 45 degrees of perpendicular to the tool arm axis,
a plurality of bristles attached to the rotatable member where the average of the axes of the bristles is within 45 degrees of perpendicular to the rotation axis,
a conversion mechanism to convert the motion provided by the actuator into rotary motion of the bristles.

Oral cavity tool example 220: The oral cavity tool of example 219 where the conversion mechanism comprises at least one or more of a spur gear, a bevel gear, a crown gear, a worm gear, a worm wheel, a hypoid gear, or a flexible shaft and combinations thereof.

Oral cavity tool example 221: The oral cavity tool of example 219 where the actuator has a pushrod which rotates the rotatable member, via a lever arm, crankshaft or other mechanism to convert linear motion into rotary motion.

Oral cavity tool example 222: The oral cavity tool of example 219 where the actuator has a pushrod which rotates the rotatable member, via a lever arm, crankshaft or other mechanism to convert linear motion into rotary motion, and one or more restoring springs.

Oral cavity tool example 223: The oral cavity tool of example 219 where the conversion mechanism is a pair of bevel gears.

Oral cavity tool example 224: The oral cavity tool of example 219 where the conversion mechanism is a spur gear meshing with a crown gear.

Oral cavity tool example 225: The oral cavity tool of example 219 where the conversion mechanism is a worm gear meshing with a worm wheel.

Oral cavity tool example 226: The oral cavity tool of example 219 where the conversion mechanism is a pair of hypoid gears.

Oral cavity tool example 227: An oral cavity tool, comprising:
a length of dental floss,
a holder which attaches to both ends of the dental floss and constrains it,
a protrusion from the holder which allows it to be gripped by or attached to an actuator.

Oral cavity tool example 228: An oral cavity tool, comprising:
a length of dental floss,
a holder which attaches to both ends of the dental floss and constrains it and which has one or more substance channels,
one or more orifices on the exterior of the holder connected to one or more substance channels of the holder,
a protrusion from the holder which allows it to accept substance input and transfer it to the holder substance channels, and be gripped by or attached to an actuator.

Oral cavity tool example 229: An oral cavity tool, comprising:
a length of dental floss,
a holder which attaches to both ends of the dental floss and constrains it,
a connector attached to the holder which allows it to be attached to an actuator.

Oral cavity tool example 230: An oral cavity tool, comprising:
a length of dental floss,
a holder which attaches to both ends of the dental floss and constrains it,
a connector attached to the holder which allows it to be attached to an actuator,
a retention feature which allows rotation of the apparatus.

Oral cavity tool example 231: The oral cavity tool of example 230, where the retention feature is an integral part of the connector.

Oral cavity tool example 232: An oral cavity tool, comprising:
a length of dental floss,
a holder which attaches to both ends of the dental floss and constrains it and which has one or more substance channels,
one or more orifices connected to one or more substance channels of the holder,
a connector attached to the holder which allows it to accept substance input and transfer it to the holder substance channels, and which allows it to be attached to an actuator.

Oral cavity tool example 233: An oral cavity tool, comprising:
a length of dental floss,
a holder which attaches to both ends of the dental floss and constrains it and which has one or more substance channels,
one or more orifices connected to one or more substance channels of the holder,
a connector attached to the holder which allows it to accept substance input and transfer it to the holder substance channels, and which allows it to be attached to an actuator,
a retention feature which allows rotation of the apparatus.

Oral cavity tool example 234: The oral cavity tool of example 233, where the retention feature is an integral part of the connector.

Oral cavity tool example 235: An oral cavity tool, comprising:
a length of dental floss,
a frame which attaches to both ends of the dental floss and constrains it,
thereby forming a floss insert.

Oral cavity tool example 236: The oral cavity tool of example 235, where the frame forms part of a substance orifice when mated with a floss insert holder.

Oral cavity tool example 237: The oral cavity tool of example 235, where the frame forms one or more hooks to attach to a floss insert holder.

Oral cavity tool example 238: The oral cavity tool of example 235, where the frame has one or more holes which mate with pegs on a floss insert holder.

Oral cavity tool example 239: The oral cavity tool of example 235, where the frame has one or more pins which mate with holes on a floss insert holder.

Oral cavity tool example 240: The oral cavity tool of example 235, where the frame consists of one or more tubular members which can be secured with pegs or claws or clamps on a floss insert holder.

Oral cavity tool example 241: An oral cavity tool, comprising:
a length of dental floss,
a frame which attaches to both ends of the dental floss and constrains it and which can mate with a holder,
the frame having one or more flanges or steps or baffles or posts or protrusions capable of alignment with a holder for the frame.

Oral cavity tool example 242: An oral cavity tool, comprising:
a length of dental floss,
a frame which attaches to both ends of the dental floss and constrains it, and which can mate with a holder having one or more substance channels,
the frame having one or more flanges or steps or baffles or posts or protrusions to minimize substance leakage with a holder for the frame.

Oral cavity tool example 243: An oral cavity tool, comprising:
a floss insert comprising a length of dental floss and a frame which attaches to both ends of the dental floss and constrains it,
a floss insert holder comprising a frame which mates with and constrains the floss insert,
a protrusion from the holder which allows it to be gripped by or attached to an actuator.

Oral cavity tool example 244: An oral cavity tool, comprising:
a floss insert comprising a length of dental floss and a frame which attaches to both ends of the dental floss and constrains it,
a floss insert holder comprising a frame which mates with and constrains the floss insert and having one or more substance channels,
one or more orifices formed from the combination of the floss insert and the floss insert holder and connected to one or more substance channels of the holder,
a protrusion from the holder which allows it to accept substance input and transfer it to the holder substance channels, and be gripped by or attached to an actuator.

Oral cavity tool example 245: The oral cavity tool of example 244, where the protrusion has a nipple which can be attached to substance tubing.

Oral cavity tool example 246: An oral cavity tool, comprising:
a floss insert comprising a length of dental floss and a frame which attaches to both ends of the dental floss and constrains it,
a floss insert holder comprising a frame which mates with and constrains the floss insert and having one or more substance channels,
one or more orifices formed from the combination of the floss insert and the floss insert holder and connected to one or more substance channels of the holder,
a connector attached to the holder which allows it to accept substance input and transfer it to the holder substance channels, and which allows it to be attached to an actuator.

Oral cavity tool example 247: An oral cavity tool, comprising:
a floss insert comprising a length of dental floss and a frame which attaches to both ends of the dental floss and constrains it,
a floss insert holder comprising a frame which mates with and constrains the floss insert and having one or more substance channels,
one or more orifices formed from the combination of the floss insert and the floss insert holder and connected to one or more substance channels of the holder,
a connector attached to the holder which allows it to accept substance input and transfer it to the holder substance channels, and which allows it to be attached to an actuator,
a retention feature which allows rotation of the apparatus.

Oral cavity tool example 248: The oral cavity tool of example 247, where the retention feature is an integral part of the connector.

Oral cavity tool example 249: An oral cavity tool, comprising:
a floss holder comprising a frame to which dental floss can be attached and having one or more substance channels,
one or more partial orifice pieces,
one or more orifices formed from the combination of the floss holder and the partial orifice pieces and connected to one or more substance channels of the holder,
a protrusion from the floss holder which allows it to accept substance input and transfer it to the holder substance channels, and be gripped by or attached to an actuator.

Oral cavity tool example 250: An oral cavity tool, comprising:
a floss holder comprising a frame to which dental floss can be attached and having one or more substance channels,
one or more partial orifice pieces,
one or more orifices formed from the combination of the floss holder and the partial orifice pieces and connected to one or more substance channels of the holder,
a connector attached to the holder which allows it to accept substance input and transfer it to the holder substance channels, and which allows it to be attached to an actuator.

Oral cavity tool example 251: An oral cavity tool, comprising:
a floss holder comprising a frame to which dental floss can be attached and having one or more substance channels,
one or more partial orifice pieces,
one or more orifices formed from the combination of the floss holder and the partial orifice pieces and connected to one or more substance channels of the holder,
a connector attached to the holder which allows it to accept substance input and transfer it to the holder substance channels, and which allows it to be attached to an actuator,
a retention feature which allows rotation of the apparatus.

Oral cavity tool example 252: The oral cavity tool of example 251, where the retention feature is an integral part of the connector.

Oral cavity tool example 253: An oral cavity tool, comprising:
a member,
a plurality of bristles attached to the member.

Oral cavity tool example 254: The oral cavity tool of example 253, where the member is composed of sub-members attached or bonded together.

Oral cavity tool example 255: The oral cavity tool of example 253, where the length of the member is less than 20 mm.

Oral cavity tool example 256: The oral cavity tool of example 253, where the length of the member is less than 25 mm.

Oral cavity tool example 257: The oral cavity tool of example 253, where the length of the member is less than 30 mm.

Oral cavity tool example 258: The oral cavity tool of example 253, where the length of the member is less than 35 mm.

Oral cavity tool example 259: The oral cavity tool of example 253, where the length of the member is less than 40 mm.

Oral cavity tool example 260: An oral cavity tool, comprising:
a member,
a plurality of bristles attached to the member,
a protrusion from the member which allows it to be gripped by or attached to an actuator.

Oral cavity tool example 261: The oral cavity tool of example 260, where the member is composed of sub-members attached or bonded together.

Oral cavity tool example 262: An oral cavity tool, comprising:
a member having one or more substance channels,
a plurality of bristles attached to the member,
one or more orifices connected to one or more substance channels of the member,
a protrusion from the member which allows it to accept substance input and transfer it to the member substance channels, and be gripped by or attached to an actuator.

Oral cavity tool example 263: The oral cavity tool of example 262, where the member is composed of sub-members attached or bonded together.

Oral cavity tool example 264: An oral cavity tool, comprising:
a length of dental floss,
a holder for the floss having one or more substance channels,
one or more orifices connected to one or more substance channels of the holder,
a protrusion from the holder which allows it to accept substance input and transfer it to the holder substance channels, and be gripped by or attached to an actuator.

Oral cavity tool example 265: The oral cavity tool of example 264, where the axis of the protrusion is perpendicular to the axis of the floss.

Oral cavity tool example 266: The oral cavity tool of example 264, where the axis of the protrusion is within 5 degrees of perpendicular to the axis of the floss.

Oral cavity tool example 267: The oral cavity tool of example 264, where the axis of the protrusion is within 10 degrees of perpendicular to the axis of the floss.

Oral cavity tool example 268: The oral cavity tool of example 264, where the axis of the protrusion is within 15 degrees of perpendicular to the axis of the floss.

Oral cavity tool example 269: The oral cavity tool of example 264, where the axis of the protrusion is within 20 degrees of perpendicular to the axis of the floss.

Oral cavity tool example 270: The oral cavity tool of example 264, where the axis of the protrusion is within 30 degrees of perpendicular to the axis of the floss.

Oral cavity tool example 271: An oral health apparatus, comprising:
An oral hygiene tool,
A means of rotation of the tool.

Oral cavity tool example 272: An oral cavity tool, comprising:
a threadlike means of dislodging food particles between teeth,
one or more of a member capable of transmitting force,
one or more of a means of attachment to an actuator,
a means for joining the threadlike means at both ends to one or more of the members; and
a means for joining one or more of the members to the means of attachment.

Oral cavity tool example 273: The oral cavity tool of example 272, wherein the means of attachment allows for removal and replacement of the apparatus, thereby allowing for replacement of the apparatus when it wears out, breaks or becomes dirty.

Oral cavity tool example 274: The oral cavity tool of example 272, wherein the means of attachment permanently attaches the apparatus to an actuator.

Oral cavity tool example 275: The oral cavity tool of example 272, wherein the apparatus has an aperture to accept a substance and is connected to one or more conduits which are capable of conveying the substance to one or more orifices.

Oral cavity tool example 276: The oral cavity tool of example 275, wherein one or more of the orifices are pointed at the threadlike means for cleaning and/or disinfecting purposes.

Oral cavity tool example 277: The oral cavity tool of example 275, wherein one or more of the orifices are formed from one or more partial orifices and/or sealing surfaces located on the apparatus and one or more inserts.

Oral cavity tool example 278: The oral cavity tool of example 272, wherein the threadlike means is constructed from a material comprised of at least one of synthetic fibers, natural fibers, plastic, natural or synthetic rubber, thermoplastic elastomers or metal.

Oral cavity tool example 279: The oral cavity tool of example 272, wherein the threadlike means is rigid, either through its intrinsic material properties (such as metal), or via being held under tension.

Oral cavity tool example 280: The oral cavity tool of example 272, wherein the threadlike means is constrained but flexible, whereby this allows a reduction in the required range of motion of the actuator.

Oral cavity tool example 281: The oral cavity tool of example 272, wherein one or more of the members is semi-flexible, whereby this allows the threadlike means to flex and thus reduce in the required range of motion of the actuator.

Oral cavity tool example 282: The oral cavity tool of example 272, wherein the means of attachment has a retention means which allows rotation of the apparatus.

Oral cavity tool example 283: The oral cavity tool of example 282, wherein the retention means is an annular groove.

Oral cavity tool example 284: The oral cavity tool of example 282, wherein the retention means is an annular flange.

Oral cavity tool example 285: The oral cavity tool of example 272, wherein the means of attachment is keyed such that the apparatus can only be attached to the actuator in a single orientation.

Oral cavity tool example 286: The oral cavity tool of example 272, wherein the means of attachment has angled surfaces and no undercuts to permit easy manufacturing with a simple two-part core/cavity injection mold.

Oral cavity tool example 287: The oral cavity tool of example 272, wherein the members and/or the means of attachment has one or more locating features, such that the apparatus can be stored in a known orientation, thereby reducing the time needed for position determination prior to a cleaning run.

Oral cavity tool example 288: The oral cavity tool of example 272, wherein the joining means allows for removal and replacement of the threadlike means, thereby allowing for replacement of the threadlike means when it wears out, breaks or becomes dirty.

Oral cavity tool example 289: The oral cavity tool of example 272, wherein the threadlike means is perpendicular to one or more of the members.

Oral cavity tool example 290: The oral cavity tool of example 272, wherein the threadlike means is within 15 degrees of perpendicular to one or more of the members.

Oral cavity tool example 291: The oral cavity tool of example 272, wherein the threadlike means is within 30 degrees of perpendicular to one or more of the members.

Oral cavity tool example 292: The oral cavity tool of example 272, including a tab suitable for scraping the user's tongue to remove biofilms and a means of attachment of the tab to the apparatus.

Oral cavity tool example 293: The oral cavity tool of example 272, wherein the actuator has a tool arm with a tool arm axis.

Oral cavity tool example 294: The oral cavity tool of example 293, wherein the plane of the threadlike means is parallel to the tool arm axis.

Oral cavity tool example 295: The oral cavity tool of example 293, wherein the plane of the threadlike means is within 15 degrees of parallel to the tool arm axis.

Oral cavity tool example 296: The oral cavity tool of example 293, wherein the plane of the threadlike means is within 15 degrees of parallel to the tool arm axis.

Oral cavity tool example 297: An oral cavity tool, comprising:
a plurality of bristles,
one or more of a member capable of transmitting force,
one or more of a means of attachment to an actuator,
a means for joining the bristles to one or more of the members; and
a means for joining one or more of the members to the means of attachment.

Oral cavity tool example 298: The oral cavity tool of example 297, wherein the means of attachment allows for removal and replacement of the apparatus, thereby allowing for replacement of the apparatus when it wears out, breaks or becomes dirty.

Oral cavity tool example 299: The oral cavity tool of example 297, wherein the means of attachment permanently attaches the apparatus to an actuator.

Oral cavity tool example 300: The oral cavity tool of example 297, wherein the apparatus has an aperture to accept a substance and is connected to one or more conduits which are capable of conveying the substance to one or more orifices.

Oral cavity tool example 301: The oral cavity tool of example 300, wherein one or more of the orifices are pointed at the threadlike means for cleaning and/or disinfecting purposes.

Oral cavity tool example 302: The oral cavity tool of example 300, wherein one or more of the orifices are pointed at the threadlike means for dispensing purposes.

Oral cavity tool example 303: The oral cavity tool of example 297, wherein the threadlike means is constructed from a material comprised of at least one of synthetic fibers, natural fibers, plastic, natural or synthetic rubber or thermoplastic elastomers.

Oral cavity tool example 304: The oral cavity tool of example 297, wherein the means of attachment has a retention means which allows rotation of the apparatus.

Oral cavity tool example 305: The oral cavity tool of example 304, wherein the retention means is an annular groove.

Oral cavity tool example 306: The oral cavity tool of example 304, wherein the retention means is an annular flange.

Oral cavity tool example 307: The oral cavity tool of example 297, wherein the means of attachment is keyed such that the apparatus can only be attached to the actuator in a single orientation.

Oral cavity tool example 308: The oral cavity tool of example 297, wherein the means of attachment has angled surfaces and no undercuts to permit easy manufacturing with a simple two-part core/cavity injection mold.

Oral cavity tool example 309: The oral cavity tool of example 297, wherein the members and/or the means of attachment has one or more locating features, such that the apparatus can be stored in a known orientation, thereby reducing the time needed for position determination prior to a cleaning run.

Oral cavity tool example 310: The oral cavity tool of example 297, wherein the joining means allows for removal and replacement of the bristles, thereby allowing for replacement of the bristles when they wear out, break or become dirty.

Oral cavity tool example 311: The oral cavity tool of example 297, wherein the average direction of the bristles is perpendicular to one or more of the members.

Oral cavity tool example 312: The oral cavity tool of example 297, wherein the average direction of the bristles is within 15 degrees of perpendicular to one or more of the members.

Oral cavity tool example 313: The oral cavity tool of example 297, wherein the average direction of the bristles is within 30 degrees of perpendicular to one or more of the members.

Oral cavity tool example 314: The oral cavity tool of example 297, wherein the bristles are organized into a plurality of bristle clusters.

Oral cavity tool example 315: The oral cavity tool of example 314, wherein one or more of the bristle clusters are parallel to each other.

Oral cavity tool example 316: The oral cavity tool of example 314, wherein one or more of the bristle clusters project radially from an axis of the member that the bristle clusters are attached to.

Oral cavity tool example 317: The oral cavity tool of example 314, wherein one or more of the bristle clusters have a rounded end.

Oral cavity tool example 318: The oral cavity tool of example 314, wherein one or more of the bristle clusters have different lengths than other bristle clusters.

Oral cavity tool example 319: The oral cavity tool of example 314, wherein one or more of the bristle clusters have an angled end.

Oral cavity tool example 320: The oral cavity tool of example 319, wherein one or more of the angled bristle clusters are angled down.

Oral cavity tool example 321: The oral cavity tool of example 319, wherein one or more of the angled bristle clusters are angled up.

Oral cavity tool example 322: The oral cavity tool of example 319, wherein one or more of the angled bristle clusters are angled left.

Oral cavity tool example 323: The oral cavity tool of example 319, wherein one or more of the angled bristle clusters are angled right.

Oral cavity tool example 324: The oral cavity tool of example 297, wherein the actuator has a tool arm with a tool arm axis.

Oral cavity tool example 325: The oral cavity tool of example 324, wherein the average direction of the bristles is parallel to the tool arm axis.

Oral cavity tool example 326: The oral cavity tool of example 324, wherein the average direction of the bristles is within 15 degrees of parallel to the tool arm axis.

Oral cavity tool example 327: The oral cavity tool of example 324, wherein the average direction of the bristles is within 30 degrees of parallel to the tool arm axis.

Oral cavity tool example 328: An oral cavity tool according to any of the preceding oral cavity examples permanently attached to an oral appliance.

### Mapping Detailed Description

### A. Introduction

In the field of dentistry, a variety of tasks involve the determination of information about the oral features of an individual. The oral features may include, for example: a point within an oral cavity of the individual, such as a location; a shape within the oral cavity of the individual; a description of an oral feature of the oral cavity of the individual; and an action performed within the oral cavity of the individual. Such actions may include, for example, dental, orthodontal, and endodontal tasks such as examination; cleaning of the teeth, gums, and/or tongue; and the fitting of oral apparatuses such as braces, retainers, and dentures utilizing high-resolution imaging in modalities such as visible light, ultraviolet, ultrasonic and X-ray imaging. Such imaging may be reviewed by healthcare professionals or processed by automated devices to determine the condition of the individual and to identify problems and options for care.

A need exists for collecting information about the oral features of an individual that may be well-suited for personal oral tasks that may be performed by consumer-grade apparatuses. An automated oral appliance may be inserted into an oral cavity of an individual in order to collect a set of oral features of the oval features of the individual. The oral features may include, for example, points of interest within the oral features, such as tooth surfaces; points within geometric features or shapes, such as planes or curves, that describe features of the oral features; and/or fixed points of the oral features of the individual with which other points may be relatively identified. A collected set of oral features may be stored as an oral mapping, which may be used for a variety of oral tasks. Such oral tasks include, for example, the operation of personal oral apparatuses, such as appliance-based brushing, flossing, rinsing, and mouthwash dispensing; oral analysis, such as identifying oral features or problems; displaying or rendering oral features for a user, such as the individual, a parent or guardian of the individual, or healthcare providers such as dentists, orthodontists, endodontists, and dental hygienists; and/or transmission to oral apparatus manufacturers and/or suppliers of automated dentistry devices or supplies for such devices. The representation of the oral features of the individual as a collection of detected oral features may be more useful for at least some of these tasks than a high-resolution image or 3D scan in which such oral features may be difficult to identify.

### B. Example Oral Apparatus

### B1. Component Block Diagram

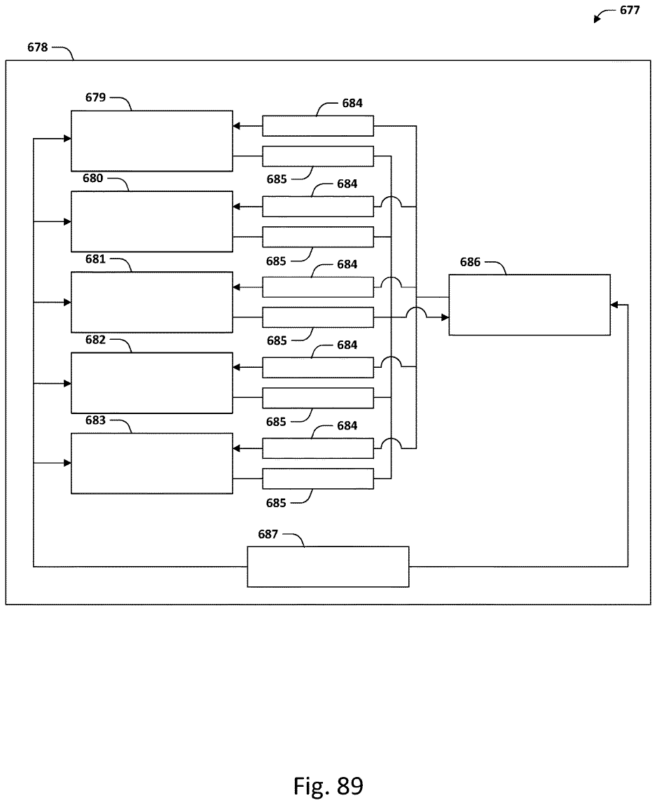

FIG. 89 is a component block diagram 677 of an example oral appliance 678.

The example oral appliance 678 of FIG. 89 is a simplified representation featuring a subset of components that may relate to some examples of oral mapping, and that more sophisticated devices may include different numbers, types, organizations, and/or interrelationships of components. Some more detailed and complete representations of such oral appliances that may be usable for oral mapping are provided elsewhere in this disclosure. Further, the example oral appliance 678 of FIG. 89 is but one example of many oral apparatuses that may include at least a portion of the oral mapping techniques disclosed by the present disclosure.

The example oral appliance 678 of FIG. 89 may include a set of actuators that move or control parts of the oral appliance. Such actuators may include, for example, linear actuators that create linear motion and/or rotary actuators that create rotational motion. Each actuator may receive power from a power source 687, for example, alternating-current or direct-current power from a power source, and/or a signal. Power and signal may be provided in one input, such as direct-current power provided on a duty cycle that provides a selectable motor speed, or pulse-width modulation that encodes a position of a servomotor. The example oral appliance 678 of FIG. 89 includes a set of five actuators: one linear actuator (a depth actuator 679) and four rotary actuators (a vertical actuator 680, a lateral actuator 681, an arm rotation actuator 682, and a tool rotation actuator 683), each having an encoder which provides feedback on a position or rotation, from which other details such as linear or angular speed, velocity, acceleration, and the like may be determined.

The example oral appliance 678 of FIG. 89 includes processing circuitry 686 that receives power from the power source 687 and that is interconnected with the actuators through a variety of connections. As a first such example, the processing circuitry 686 communicates signals to the respective actuators via a driver 684, for example, a timer or other digital pulse train generating peripheral generates a pulse-width modulation (PWM) signal, which may control transistors that drive the actuators forward or backward. Each driver 684 may provide a discrete control signal to one (or more) of the actuators; alternatively, each driver 684 may alter a power source to encode a signal, for example, an H-bridge which converts the digital signals from the processing circuitry into forward, backward or stopped polarity voltage applied to the actuators. Alternatively, a voltage-to-current converter can control a current supplied to the actuator so as to vary its speed, direction and torque. As a second such example, the processing circuitry 686 may receive, from each actuator, a signal indicating a performance of the actuator, such as current through the actuator as determined by a sensor 685 such as a current sensor. The processing circuitry 686 may be configured to detect or monitor a current level and/or current fluctuation by the current sensor. For example, increasing current and/or power may indicate that the actuator has encountered a physical barrier or obstacle, or has reached a limit, such as a maximum extension of the depth actuator 679. In the example oral appliance 678 of FIG. 89, each actuator may be coupled with a sensor 685 such as a current sensor by which the processing circuitry 686 may determine the current conducted by the actuator in response to the signal of the driver 684 and may adjust the example oral appliance 678 to alter the signals applied to the driver 684 in response thereto, e.g., by signaling an actuator to move more slowly, to stop, or to reverse direction in the event that the current flow of an actuator indicates that the example oral appliance 678 has encountered a blockage.

### B2. Example Actuator Set

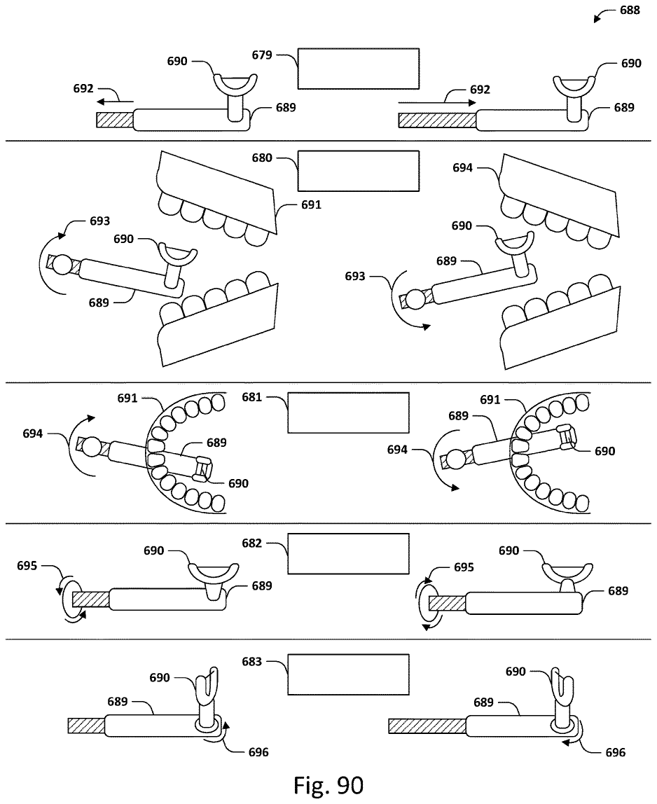

FIG. 90 is a diagram 688 of an example set of actuators that may be included in an example automated oral appliance 689.

The examples shown in the diagram 688 of FIG. 90 involve an example automated oral appliance 689 including an appliance tool 690 that may be usable in the oral cavity 691 of an individual. In the example shown in FIG. 90 and in other figures, the example automated oral appliance 689 may be a consumer-grade personal oral apparatus featuring an automated flossing program that is performed using a length of dental floss held by the appliance tool 690, but at least some of the concepts illustrated in FIG. 90 may be included in other devices that may have different features. The example automated oral appliance 689 may be or may include an automated oral appliance 678 such as shown in the component block diagram 677 of FIG. 89.

As a first example shown in FIG. 90, the example automated oral appliance 689 may include a depth actuator 679, which may be configured to extend and/or retract the length of the example automated oral appliance 689 along a reach axis 692 (e.g., a depth or length axis). The example automated oral appliance 689 may be configured to operate the depth actuator 679 to exhibit movement along the reach axis 692 in order to position and/or move the example automated oral appliance 689 into and out of the oral cavity 691 of the individual, for example, during an automated dental flossing program. The depth actuator 679 may include one or more linear actuators, which may be mechanical, electromechanical, hydraulic, pneumatic, and the like.

As a second example shown in FIG. 90, the example automated oral appliance 689 may include a vertical actuator 680, which may be configured to move the example automated oral appliance 689 in a manner that creates pitch rotation 693 (e.g., rotation that raises or lowers the example automated oral appliance 689). The example automated oral appliance 689 may be configured to operate the vertical actuator 680 to exhibit pitch rotation 693 in order to move the example automated oral appliance 689 to a selected vertical position within the oral cavity 691 of the individual to reach the upper teeth or lower teeth, for example, during an automated dental flossing program. The vertical actuator 680 may include one or more rotary actuators, which may be mechanical, electromechanical, hydraulic, pneumatic, and the like.

As a third example shown in FIG. 90, the example automated oral appliance 689 may include a lateral actuator 681, which may be configured to move the example automated oral appliance 689 in a manner that creates yaw rotation 694 (e.g., rotation around a vertical axis). The example automated oral appliance 689 may be configured to operate the lateral actuator 681 to exhibit yaw rotation 694 in order to move the example automated oral appliance 689 to a selected horizontal position within the oral cavity 691 of the individual to reach the left-hand teeth or the right-hand teeth, for example, during an automated dental flossing program. The lateral actuator 681 may include one or more rotary actuators, which may be mechanical, electromechanical, hydraulic, pneumatic, and the like.

As a fourth example shown in FIG. 90, the example automated oral appliance 689 may include an arm rotation actuator 682, which may be configured to rotate the example automated oral appliance 689 to exhibit a roll rotation 695 (e.g., rotation around the reach axis 692). The example automated oral appliance 689 may be configured to operate the arm rotation actuator 682 to exhibit roll rotation 695 in order to move the example automated oral appliance 689 to orient the appliance tool 690 toward the left-hand side or the right-hand side of the oral cavity 691 of the individual, and/or the upper side or the lower side of the oral cavity 691 of the individual, for example, during an automated dental flossing program. The arm rotation actuator 682 may include one or more rotary actuators, which may be mechanical, electromechanical, hydraulic, pneumatic, and the like.

As a fifth example shown in FIG. 90, the example automated oral appliance 689 may include a tool rotation actuator 683, which may be configured to rotate the appliance tool 690 of the example automated oral appliance 689 around a tool rotation axis (e.g., an axis that is orthogonal to the reach axis 692). The example automated oral appliance 689 may be configured to operate the tool rotation actuator 683 to exhibit rotation with respect to a tool rotation axis in order to orient a length of floss that is held by the appliance tool 690 to align with a pocket between two teeth in the oral cavity 691 of the individual, for example, during an automated dental flossing program. The tool rotation actuator 683 may include one or more rotary actuators, which may be mechanical, electromechanical, hydraulic, pneumatic, and the like.

The processing circuitry 686 may be configured to operate each actuator concurrently, sequentially, and/or in an interleaved manner. The processing circuitry 686 may be configured to operate one or more of the actuators independently of the other actuators, that is, irrespective of the operation of the other actuators. Alternatively or additionally, the processing circuitry may be configured to operate one or more of the actuators in a correlated manner with respect to other actuators. For example, some forms of motion of the example automated oral appliance 689 and/or appliance tool 690 due to the activation of some actuators may affect the position and/or motion of the example automated oral appliance 689 and/or appliance tool 690 along the same or other axes; for example, moving the example automated oral appliance 689 to achieve a desired yaw rotation 694 may also alter the orientation of the appliance tool 690. The processing circuitry 686 may be configured to operate the actuators in relation to one another. As an example, the processing circuitry 686 may be configured to apply a counteractive rotation 696 with respect to a tool rotation axis of the appliance tool 690 based on operating the lateral actuator 681 in order to maintain the orientation of the appliance tool 690. Such compensatory operation may occur in a concurrent manner (e.g., operating the tool rotation actuator 683 counter-rotating the appliance tool 690 to create rotation 696 concurrently with operating lateral actuator 681 to create yaw rotation 694) and/or sequentially (e.g., operating the tool rotation actuator 683 counter-rotating the appliance tool 690 to create rotation 696 before or after operating lateral actuator 681 to create yaw rotation 694). The example automated oral appliance 689 may be configured to coordinate such motion in a corresponding or proportional manner. The example automated oral appliance 689 may be configured to translate or otherwise adjust the motion of one actuator relative to the motion of another actuator (e.g., activating the tool rotation actuator 683 to create a larger rotation 696 in response to a first pitch rotation 693 than in response to a second pitch rotation 693).

The processing circuitry 686 may be configured to coordinate the control of two or more actuators based upon the physiological features 706 of the individual. Some examples, such as automated oral appliances, may be configured to reduce an operating vertical, for example, to reduce the range of motion of the individual's oral cavity during operation of the automated oral appliance. One technique for reducing such operating vertical may involve orienting and/or maintaining an orientation of an appliance tool 690 at an angle with respect to a physiological feature of an individual, rather than at an angle with respect to the automated oral appliance. Such orientation may be achieved or maintained, for example, by altering the rotation 696 of the appliance tool 690 with respect to a tool rotation axis based on a roll rotation 695 with respect to an arm rotation axis.

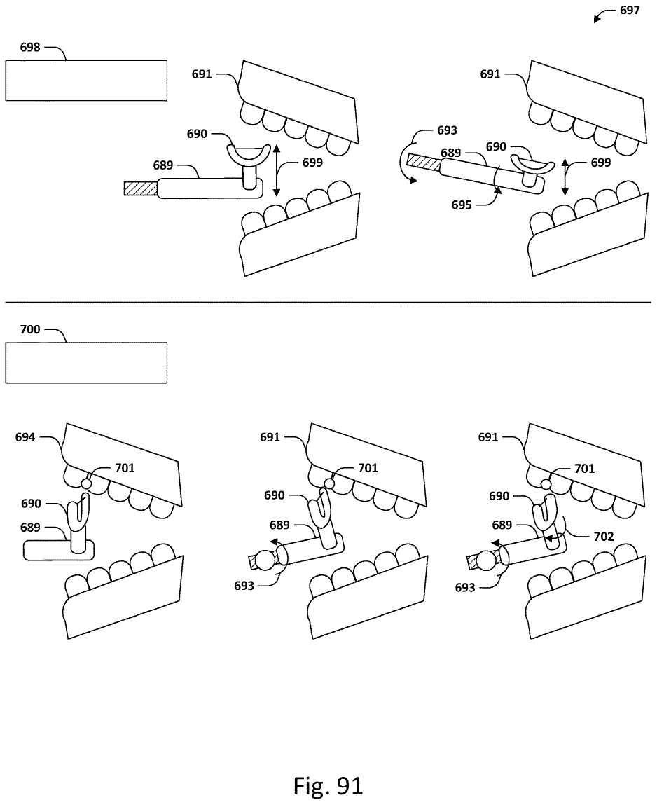

FIG. 91 is a diagram 697 of some examples of related movements of actuators that may be included in an automated oral appliance.

As shown in the diagram 697 of FIG. 91, a first set of coordinated movements may be provided to establish and maintain an angular orientation 698 with respect to an oral cavity 691 of an individual.

As a first example, during operation, an example automated oral appliance 689 may orient an appliance tool 690 in a manner such that the appliance tool 690 is vertical. However, this orientation may present a large vertical 699 of the example automated oral appliance 689 and the appliance tool 690. Use of the example automated oral appliance 689 might therefore depend upon the individual holding his or her oral cavity 691 open to a wide extent, which may be uncomfortable or painful. Instead, the example automated oral appliance 689 may be configured to establish an angular orientation of the appliance tool 690 with respect to the oral cavity 691 of the individual, for example, applying a pitch rotation 693 and a roll rotation 695, which may reduce a vertical 699 of the example automated oral appliance 689 during use and may permit the individual to hold his or her oral cavity 691 open to a less wide and more relaxed extent.

As a second example, during operation, an example automated oral appliance 689 may operate the actuators to orient an appliance tool 690 in order to maintain a target position 700 of the appliance tool 690 with respect to a target position 701, for example, a pocket between a pair of adjacent teeth. If the example automated oral appliance 689 applies a pitch rotation 693, the orientation of the appliance tool 690 with respect to the target position 701 may change; that is, the pitch rotation 693 may displace the position of the appliance tool 690 with respect to the target position 701. Instead, the example automated oral appliance 689 may be configured to apply a counter-rotation 702 to the appliance tool 690, which may alter the angle of the appliance tool 690 and a tool secured thereby, such as dental floss, in a manner that opposes the displacement of the appliance tool 690 due to the pitch rotation 693. In this manner, the example automated oral appliance 689 may be configured to operate the actuators in a related manner to maintain the target position 700 of the appliance tool 690 with respect to the target position 701.

### C. Calibration

### C1. Establishing Primary Reference Point

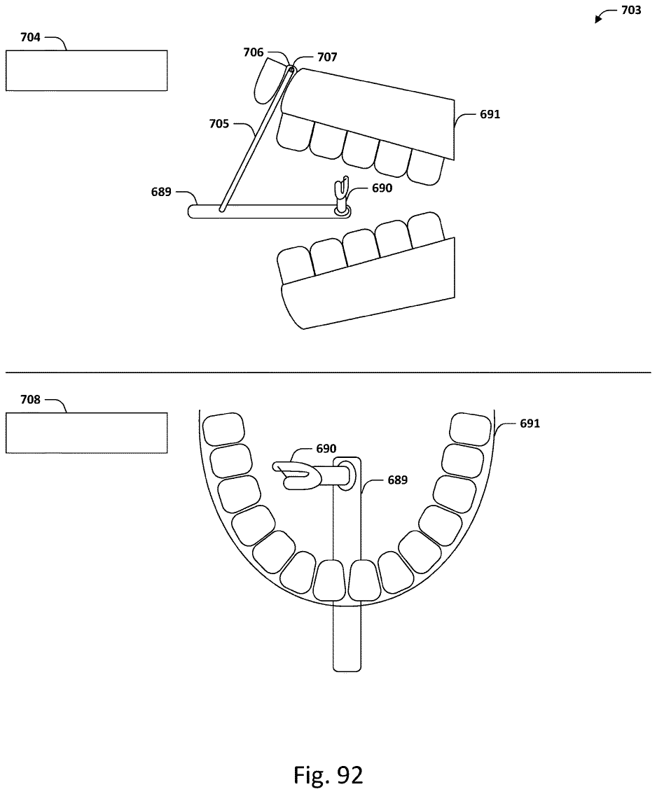

FIG. 92 is a diagram 703 of an example process 704 of establishing a primary reference point 707 within the oral cavity 691 of an individual that may be performed by an automated oral appliance.

As shown in the diagram 703 of FIG. 92, the oral features of the individual may include a fixed position that may serve as a physiological feature 706 that is comparatively stationary, as compared, for example, with the jaw or soft tissue such as the tongue of the individual. An example of such a physiological feature 706 is the pocket between the upper lip and upper gumline of the individual near the superior labial frenulum. As described elsewhere in this specification, an oral mouthpiece may be inserted between the lip and upper gumline near the superior labial frenulum, and may remain comparatively static by the individual during a personal oral operation such as an automated flossing program, even if other portions of the individual's oral cavity move. The oral mouthpiece may include an anchor point to which the automated oral appliance may attach, for example by a positioning member 705 that connects the automated oral appliance to the anchor point of the oral mouthpiece. The oral mouthpiece may be held in place by the individual (e.g., by the upper lip and upper gumline of the individual), and/or may be affixed in other ways, such as a tacky or adhesive substance that may be applied to the oral mouthpiece and/or inside the upper lip. The anchor point and/or the physiological feature 706 for which the anchor point provides a reference may serve as a primary reference point 707, as well as other calibration and oral mapping operations. Examples of such oral mouthpieces and positioning members 705 of example automated oral appliances 689 that may be used to establish the primary reference point 707 are provided elsewhere in this disclosure.

Establishing the primary reference point 707 may involve establishing two or more types of information about a primary reference point 707, such as a position and an orientation. Establishing the primary reference point 707 may involve establishing set of two or more primary reference points 707 within the oral cavity 691 of the individual, such as a first primary reference point 707 based on the superior labial frenulum of the individual and a second primary reference point 707 based on the pocket between the lower lip and lower gumline. Collecting two or more types of information about a primary reference point 707 and/or a set of two or more primary reference points 707 may provide additional information about the position of an automated oral appliance within the oral cavity 691 of the individual, such as a position of the automated oral appliance relative to two or more physiological features 706 of the oral cavity 691 of the individual and/or an orientation of the automated oral appliance and/or an appliance tool 690 of the automated oral appliance with respect to a depth, vertical, lateral, arm rotation, and/or tool rotation axis.

### C2. Calibration

In the diagram 703 of FIG. 92, a calibration 708 may be performed to establish the position of the automated oral appliance and the appliance tool 690 along various linear and/or rotational axes. The processing circuitry 686 may be configured to operate one or more actuators in order to achieve a selected, desired, or target position of the automated oral appliance, such as a home position, neutral position, or zero position. For example, the home position may be a terminal position or midpoint position within a range of motion of a linear actuator or a selected rotational point of a rotational actuator.

The automated oral appliance may operate a depth actuator 679 to move along the reach axis 692 in a first direction until reaching an end point, which may be detectable due to the output of one or more sensors 685. As a first example, depth actuator 679 may be powered by a linear actuator or a rotary actuator or motor turning a leadscrew, ACME screw, ball screw shaft or gear to drive the appliance tool 690 forward or backward. The actuator or motor may have a sensor 685 such as an optical or magnetic encoder mounted to it to measure either the rotation or extension of the motor or actuator and thus the position. The position measured by the encoder may be an absolute position as for example with glass scales, or a relative position, as with quadrature encoders, where the rotation or position is measured in steps in a positive or negative direction or rotation. In order to calibrate the absolute position of the depth actuator 679 using a relative position sensor such as an optical or magnetic quadrature encoder, an absolute position reference must be obtained such as driving the depth actuator with a reduced current that will not harm the actuator until it encounters an endstop which is detected by the encoder(s) reporting a constant position. Alternatively, sensor 685 may be a current sensor and the increased current detected as then actuator encounters the endstop and stalls. The automated oral appliance may also move along the reach axis 692 in a second direction until reaching another end point, which may again be detectable due to a change in actuator current as detected by a current sensor. The detection of one or both end points may indicate to the automated oral appliance (e.g., to the processing circuitry 686) that the automated oral appliance and/or the appliance tool 690 has reached and/or is currently positioned at a particular length, for example, a fully extended length or a fully retracted length. The automated oral appliance may be configured to permit motion along the reach axis 692 only within a limited range, such as a maximum length of a lead screw of a linear actuator. Alternatively or additionally, the automated oral appliance may include a stop mechanism to stop the depth actuator 679 from extending and/or retracting beyond a certain length or position along the reach axis 692, such as a tab or block at a fixed position that engages with a mobile portion of the automated oral appliance when the depth actuator 679 reaches a designated position. The automated oral appliance may be configured to operate the depth actuator 679 via a driver and to detect (e.g., via an encoder) a designated position of the depth actuator 679 as a result of the operation, and the depth actuator 679 may operate in accordance with the encoded position, such as a servomotor that is configured to detect and/or track a current position and to operate in order to achieve a designated position in response to an encoded signal. A depth actuator 679 may include one or more markings along the reach axis 692, and may be configured to determine a current position of the depth actuator 679 along the reach axis 692 by moving the automated oral appliance and determining the detection of a selected marker by a sensor. The automated oral appliance may not monitor or detect the status of the depth actuator 679, but may control the depth actuator 679 in a manner that achieves a desired position (e.g., operating the depth actuator 679 to extend for a period of time, after which the depth actuator 679 is set to a terminal position, such as a fully retracted position, irrespective of the initial position of the depth actuator 679).

The automated oral appliance may be configured to operate the depth actuator 679 to perform a calibration 708 as previously described, and may therefore determine a current position (including orientation) of the automated oral appliance and/or appliance tool 690 along the reach axis 692. For example, the spatial position may be described by three coordinate values and the spatial orientation may be described by three angular values. The automated oral appliance may be configured to determine one or more oral features of the depth actuator 679 (e.g., one or both terminal positions along the reach axis 692) and then to operate the depth actuator 679 in a manner that positions and/or orients the automated oral appliance and/or appliance tool 690 at a designated home position, neutral position, or zero position along the reach axis 692, for example, a center point along the reach axis 692 between the terminal points, or in relation to another point or component of the automated oral appliance (e.g., an indication that the appliance tool 690 is oriented at a particular pivot angle with respect to a body of the automated oral appliance).

The automated oral appliance may be configured to perform the calibration 708 for only one actuator. The automated oral appliance may be configured to perform the calibration 708 for several actuators, such as one or more of the vertical actuator 680, the lateral actuator 681, the arm rotation actuator 682, and/or the tool rotation actuator 683 in a similar self-calibration manner as the depth actuator 679, in order to determine an absolute or relative linear and/or rotational position of each such actuator along a corresponding linear or rotary axis. Such calibration 708 may performed concurrently, sequentially, and/or in an interleaved manner.

Other types of calibration may be used, such as optointerrupters which pass or break a beam of light through a gap, notch or hole in a linear or rotary plate to indicate when a certain linear distance or rotary angle has been reached. Other types of calibration are magnetically-based such as a permanent magnet or electromagnet attached to a portion of the apparatus that moves linearly or rotationally, and a corresponding magnetic sensor such as a Hall-effect sensor. These and other types of calibration sensors are listed elsewhere in this disclosure.

### C3. Calibration Performance

The calibration may be performed in various circumstances.

The calibration 708 may be performed for an automated oral appliance in response to a first activation, such as a first power-on event and/or a first detection of insertion of the automated oral appliance into the oral cavity of an individual.

The calibration 708 may be performed in response to a manual selection by a user, such as a calibration request. The calibration 708 may be performed on demand, for example, before performing another operation such as an instance of an automated flossing program.

The calibration 708 may be performed in response to a detection of a miscalibration, such as the appliance tool 690 unexpectedly encountering a stop position along an axis such as the reach axis 692 that does not correspond to a stored current position of the appliance tool 690.

The calibration 708 may be performed periodically, for example, if more than three days and/or at least five instances of an automated flossing program have occurred since a previous instance of the calibration 708.

The calibration 708 may be performed conditionally, for example, as an abbreviated or verification calibration 708 that verifies whether previously stored oral features are still valid, and as a full calibration 708 that completely recalibrates all actuators and/or axes in the event of a verification failure.

The calibration 708 may be performed incrementally, for example, recalibrating only one or one or some actuators or axes that appear to be miscalibrated while not recalibrating one or some actuators that appear to remain validly calibrated.

### C4. Calibration Results

The calibration may provide a variety of results.

The calibration 708 may enable an automated oral appliance to operate one or more actuators in order to achieve a designed reach, pitch, yaw, roll, and/or pivot position of the automated oral appliance and/or appliance tool 690 with respect to one or more axes, and/or with respect to an oral feature, such as a primary reference point 707. The automated oral appliance may then be configured to begin another process, such as an automated flossing program, on the condition of the automated oral appliance and/or appliance tool 690 beginning in the home position, neutral position, or zero position.

The calibration 708 may enable the automated oral appliance to detect a current position and/or orientation of the actuators, for example, as an initial position of the automated oral appliance and/or appliance tool 690 in which another process, such as an automated flossing program, may begin.

The calibration 708 may enable the processing circuitry 686 to store one or more calibration indicators of the state of one more actuators, such as a position or percentage of the extension of the depth actuator 679 along the reach axis 692 or a rotational angle or position of a rotary actuator such as the arm rotation actuator 682 along a rotary axis. The processing circuitry 686 may be configured to store one or more calibration indicators of a position of the automated oral appliance and/or appliance tool 690, for example, according to a coordinate system, which may be based upon an initial position or upon a reference coordinate (e.g., defining the initial position of the automated oral appliance and/or appliance tool 690 as a home position, neutral position, or zero position) with respect to a position on the automated oral appliance, and/or a physiological feature 706 of the individual. The calibration indicators may be detected, represented, and/or stored, for example, as one or more positions, such as a vector, distance, or offset relative to another calibration indicator, the primary reference point 707, and/or a physiological feature 706 of the individual. The calibration indicators may be detected, represented, and/or stored, for example, as one or more geometric shapes, such as a line, plane, or a two- or three-dimensional surface or polygon such as a sphere or a cube. The calibration 708 may conclude with the automated oral appliance and/or appliance tool 690 being moved to a desired position (including orientation), such as a home position, neutral position, or zero position, and the calibration 708 may include the processing circuitry 686 storing a calibration indicator that the current position of the automated oral appliance and/or appliance tool 690 being in the desired position. The calibration 708 may involve detecting a current position and/or orientation, for example, as a current position and/or initial position of the automated oral appliance and/or appliance tool 690 in the absence of a designated or desired home position, neutral position, or zero position, and the calibration 708 may include the processing circuitry 686 storing a calibration indicator of the detected position of the automated oral appliance or appliance tool 690 as a current position and/or initial position of the automated oral appliance and/or appliance tool 690.

The processing circuitry 686 may be configured to store calibration indicators determined through the calibration 708 in volatile and/or non-volatile memory. Storage in non-volatile memory may enable such calibration indicators to be reloaded after a power reset, for example, as an initial position of the automated oral appliance and/or appliance tool 690. A calibration indicator from an earlier calibration may be retrieved (e.g., from non-volatile memory) and presumptively used as the initial position of the automated oral appliance and/or appliance tool 690, optionally by omitting a second instance of the calibration 708 or by performing an abbreviated version of the calibration 708 to verify that the calibration indicators accurately reflect the initial position and/or current position of the automated oral appliance and/or appliance tool 690.

The processing circuitry 686 may collect and/or store a set of oral features in relation to the primary reference point 707, for example, as an orientation, direction, distance, and/or offset such as a vector with respect to the primary reference point 707, and/or as coordinates within a grid that is established in relation to the primary reference point 707. Respective axes of a coordinate grid may be defined, for example, based on cartesian coordinates and/or polar coordinates. The processing circuitry 686 may establish the primary reference point 707 in order to establish a position of the apparatus in relation to the oral cavity of the individual 751, and the apparatus may otherwise detect the set of oral features not necessarily in relation to the primary reference point 707 but in a different manner, for example, in relation to a home, neutral, and/or zero position of an automated oral appliance, and/or as a set of instructions for controlling the actuators to reach each such oral feature from a current position or from a home, neutral, and/or zero position. The processing circuitry 686 may establish two or more primary reference points 707, for example, a first primary reference point 707 inside the superior labial frenulum inside the upper lip and a second primary reference point 707 inside the lower labial frenulum inside the lower lip.

The foregoing description is but one example calibration of an oral apparatus. Some examples of oral apparatuses may vary from the foregoing description of the example calibration 708 of FIG. 92, for example, by adding operations, omitting operations, performing operations in a different order, combining operations, dividing operations into two or more sub-operations, performing two or more operations in a concurrent and/or interleaved manner, and the like, without departing from the subject matter of the present disclosure. Those of ordinary skill in the art may identify and include many such variations in the calibration techniques in accordance with this disclosure.

### D. Oral Mapping

An oral apparatus (such as the example oral appliance 678 of FIG. 89 and/or the example automated oral appliance 90 of FIG. 90) may be configured to perform an oral mapping.

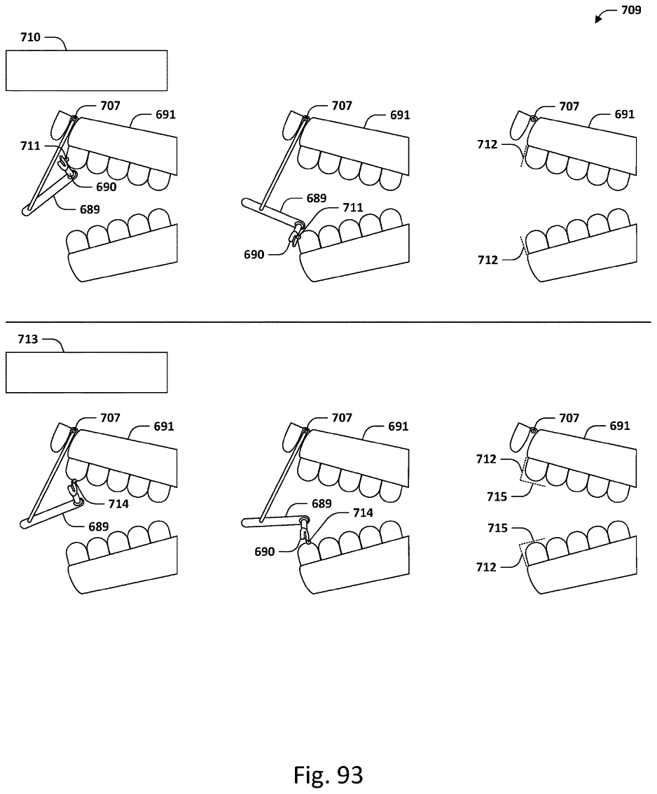

FIGS. 93 through 95, together, present an example oral mapping in accordance with the present disclosure. The illustrations of FIGS. 93 through 95 are but one example, and that many such oral mapping techniques may include at least some of the techniques disclosed by the present disclosure.

### D1. Example Outer Mapping

FIG. 93 is a diagram 709 of an example outer mapping of oral features of an individual by an automated oral appliance.

The example outer mapping of FIG. 93 includes a first outer mapping 710 in which an automated oral appliance (such as the example automated oral appliance 689 of FIG. 90) may map a front or outer portion of the oral features of the individual, for example, a front of the oral cavity and a start (that is, a front starting point) of the upper and lower opposing planes of the oral cavity of the individual.

The first outer mapping 710 may begin with an automated oral appliance in an initial position, such as a home position, neutral position, or a zero position. Alternatively or additionally, the first outer mapping 710 may begin with the position (including orientation) of the automated oral appliance established with respect to a primary reference point 707, such as an anchor point of a positioning member 705.

As shown in the diagram 709 of FIG. 93, the first outer mapping 710 may include an automated oral appliance controlling the actuators to establish contact between the appliance tool 690 and a front surface of at least one upper tooth, and thereby establish at least one upper front reference point 711. As shown in the diagram 709 of FIG. 93, the first outer mapping 710 may include the automated oral appliance controlling the actuators to establish contact between the appliance tool 690 and a front surface of at least one lower tooth, and thereby establish at least one lower front reference point 711. As an example, the automated oral appliance may control the actuators to retract fully along the reach axis 692 (or may set the home position, neutral position, or zero position to a fully retracted position along the reach axis 692), to rotate the appliance tool 690 into a vertically upward and/or vertically downward orientation, and to extend slowly along the reach axis 692 until detecting contact by the appliance tool 690 with a vertical front surface of a tooth. The first outer mapping 710 may involve contact between the appliance tool 690 and the front surfaces of two or more upper and/or lower teeth, such as two or more upper and/or lower incisors, canines, premolars, or molars, and/or the front surfaces of one or more left-hand upper or lower teeth and of one or more corresponding right-hand upper or lower teeth. The detection of at least one upper front reference point 711 and at least one lower front reference point 711 may enable a determination of one or more front planes 712 or front surfaces of the oral cavity of the individual.

The example outer mapping of FIG. 93 includes a second outer mapping 713 in which an automated oral appliance (such as the example automated oral appliance 689 of FIG. 90) may map a start of upper and lower opposing planes of the oral cavity physiology of the individual, for example, the biting surfaces of the front teeth of the individual.

The second outer mapping 713 may begin with an automated oral appliance in an initial position, such as a home position, neutral position, or zero position. For example, the automated oral appliance may reset the position to a home position, neutral position, or zero position after the first outer mapping 710. Alternatively or additionally, the automated oral appliance may adjust the second outer mapping 713 to begin where the first outer mapping 710 concluded. Alternatively or additionally, the second outer mapping 713 may begin with the position (including orientation) of the automated oral appliance established with respect to a primary reference point 707, such as an anchor point of a positioning member 705.

As shown in the diagram 709 of FIG. 93, the second outer mapping 713 may include an automated oral appliance controlling the actuators to establish contact between the appliance tool 690 and an opposing surface (e.g., a downward surface) of at least one upper tooth, and thereby establish at least one upper opposing plane start reference point 714. As shown in the diagram 709 of FIG. 93, the first outer mapping 710 may include the automated oral appliance controlling the actuators to establish contact between the appliance tool 690 and an opposing surface (e.g., an upward surface) of at least one lower tooth, and thereby establish at least one lower opposing plane start reference point 714. As an example, the automated oral appliance may control the actuators to extend a short distance beyond the upper front reference point and/or the lower front reference point, to rotate the appliance tool 690 into a horizontal orientation, and to ascend or descend slowly along a pitch axis (such as by pitch rotation 693) until detecting contact by the appliance tool 690 with a horizontal opposing surface (e.g., a biting surface) of a tooth. The second outer mapping 713 may involve contact between the appliance tool 690 and the opposing surfaces (e.g., biting surfaces) of two or more upper and/or lower teeth, such as two or more upper and/or lower incisors, canines, premolars, or molars, and/or of the opposing surfaces (e.g., biting surfaces) of one or more left-hand upper or lower teeth and one or more corresponding right-hand upper or lower teeth. The detection of at least one upper opposing plane start reference point 714 and at least one lower opposing plane start reference point 714 may enable a determination of an opposing plane start 715 of the surfaces of the upper and lower teeth, and optionally other properties of the oral features of the individual, such as an angle, vertical size, and/or opening width of the oral cavity of the individual.

### D2. Example Inner Mapping

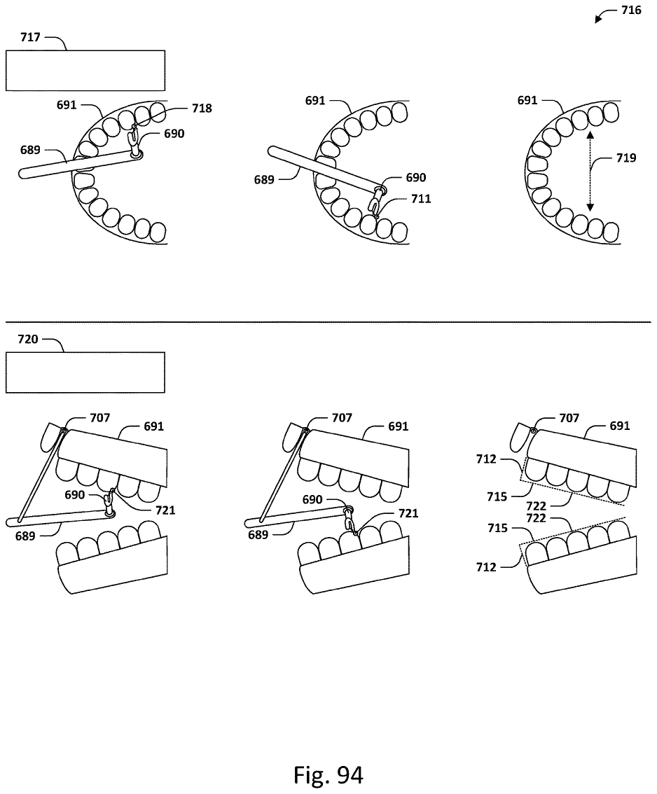

FIG. 94 is a diagram 716 of an example inner mapping of oral features of an individual by an automated oral appliance.

The example inner mapping of FIG. 94 includes a first inner mapping 717 in which an automated oral appliance (such as the example automated oral appliance 689 of FIG. 90) may map an inner portion of the oral features of the individual, for example, the planes that define the inner curvature or surface of the upper and lower teeth and the opposing planes (e.g., biting surface planes) of the inner opposing planes of the oral cavity of the individual.

The first inner mapping 717 may begin with an automated oral appliance in an initial position, such as a home position, neutral position, or zero position. For example, the automated oral appliance may reset the position to a home position, neutral position, or zero position after the second outer mapping 710. Alternatively or additionally, the automated oral appliance may adjust the first inner mapping 717 to begin where the second outer mapping 713 concluded. Alternatively or additionally, the first inner mapping 717 may begin with the position (including orientation) of the automated oral appliance established with respect to a primary reference point 707, such as an anchor point of a positioning member 705.

As shown in the diagram 716 of FIG. 94, the first inner mapping 717 may include an automated oral appliance controlling the actuators to establish contact between the appliance tool 690 and an inner surface of at least one upper tooth, and thereby establish at least one upper inner reference point 718. As shown in the diagram 716 of FIG. 94, the first inner mapping 717 may include the automated oral appliance controlling the actuators to establish contact between the appliance tool 690 and an inner surface of at least one lower tooth, and thereby establish at least one lower inner reference point 718. As an example, the automated oral appliance may control the actuators to extend to a midpoint along the reach axis 692 (or may set the home position, neutral position, or zero position to a fully retracted position along the reach axis 692), to rotate the appliance tool 690 into a vertically upward and/or vertically downward orientation, and to perform a slow yaw rotation 694 until detecting contact by the appliance tool 690 with a vertical inner surface of a tooth. The first inner mapping 717 may involve contact between the appliance tool 690 and the inner surfaces of two or more upper and/or lower teeth, such as two or more upper and/or lower incisors, canines, premolars, and/or molars. The detection of at least one upper inner reference point 718 and at least one lower inner reference point 718 may enable a determination of a width 719 of the oral features of the individual, optionally at one or more points, such as between two or more pairs of opposing upper or lower teeth, and optionally other properties of the oral features of the individual, such as the length and/or curvature of the jaws of the individual and/or the presence of braces along at least part of the inner surfaces of the teeth of the individual.

The example inner mapping of FIG. 94 includes a second inner mapping 720 in which an automated oral appliance (such as the example automated oral appliance 689 of FIG. 90) may further map an opposing plane of the oral features of the individual, for example, the planes that include at least one upper opposing plane start reference point 714 and at least one lower opposing plane start reference point 714, respectively, and that extend backward or deeper into the oral cavity to form the biting planar surfaces of the upper and lower teeth of the individual.

The second inner mapping 720 may begin with an automated oral appliance in an initial position, such as a home position, neutral position, or zero position. For example, the automated oral appliance may reset the position to a home position, neutral position, or zero position after the first inner mapping 717. Alternatively or additionally, the automated oral appliance may adjust the second inner mapping 720 to begin where the first inner mapping 717 concluded. Alternatively or additionally, the second inner mapping 720 may begin with the position (including orientation) of the automated oral appliance established with respect to a primary reference point 707, such as an anchor point of a positioning member 705.

As shown in the diagram 716 of FIG. 94, the second inner mapping 720 may include an automated oral appliance controlling the actuators to establish contact between the appliance tool 690 and a lower surface (e.g., a biting surface) of at least one upper tooth, and thereby establish at least one upper opposing plane reference point 721. As shown in the diagram 716 of FIG. 94, the second inner mapping 717 may include the automated oral appliance controlling the actuators to establish contact between the appliance tool 690 and an upper surface (e.g., a biting surface) of at least one lower tooth, and thereby establish at least one lower opposing plane reference point 721. As an example, the automated oral appliance may control the actuators to extend to a midpoint along the reach axis 692 (or may set the home position, neutral position, or zero position to a fully retracted position along the reach axis 692), to rotate the appliance tool 690 into a horizontal orientation, and to perform a slow pitch rotation 693 until detecting contact by the appliance tool 690 with a horizontal biting surface of a tooth. The second inner mapping 720 may involve contact between the appliance tool 690 and the lower or upper surfaces of two or more upper and/or lower teeth, such as two or more upper and/or lower incisors, canines, premolars, and/or molars. The detection of at least one upper opposing plane reference point 721 and at least one lower opposing plane reference point 721 may enable a determination of an opposing plane 722 of the surfaces of the upper and lower teeth, and optionally other properties of the oral features of the individual, such as an angle, vertical size, and/or opening width of the oral cavity of the individual.

### D3. Example Profile Mapping

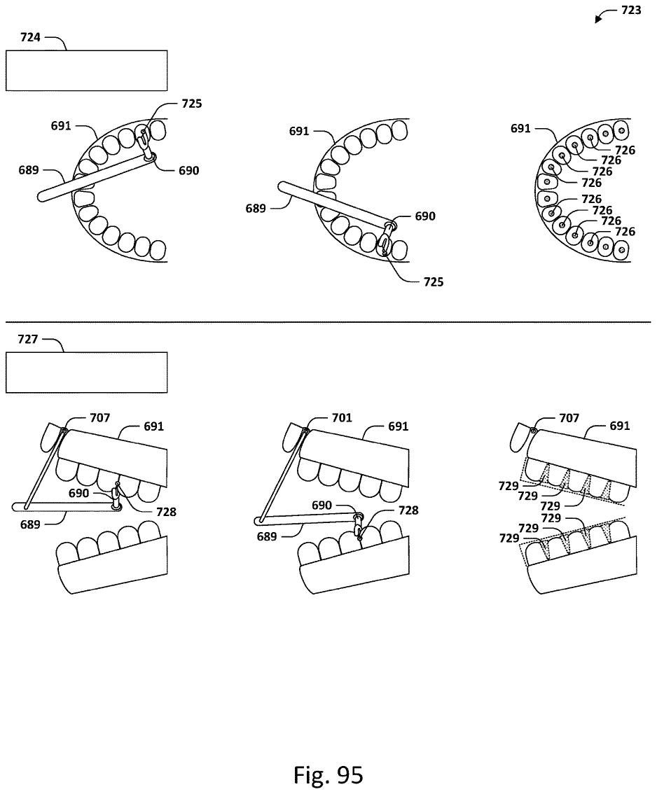

FIG. 95 is a diagram 723 of an example tooth profile mapping and an example pocket profile mapping of oral features of an individual by an automated oral appliance.

The example mapping of FIG. 95 includes a tooth profile mapping 724 in which an automated oral appliance (such as the example automated oral appliance 689 of FIG. 90) may map a touch point 725 for at least one upper tooth and at least one lower tooth of the individual, for example, the individual plane that defines the biting surface of each tooth of the oral cavity of the individual.

The tooth profile mapping 724 may begin with an automated oral appliance in an initial position, such as a home position, neutral position, or zero position. For example, the automated oral appliance may reset the position to a home position, neutral position, or zero position after the second inner mapping 720. Alternatively or additionally, the automated oral appliance may adjust the tooth profile mapping 724 to begin where the second inner mapping 720 concluded. Alternatively or additionally, the tooth profile mapping 724 may begin with the position (including orientation) of the automated oral appliance established with respect to a primary reference point 707, such as an anchor point of a positioning member 705.

As shown in the diagram 723 of FIG. 95, the tooth profile mapping 724 may include an automated oral appliance controlling the actuators to establish contact between the appliance tool 690 and a downward opposing surface (such as a biting surface) of at least one upper tooth (for example, each upper tooth), and thereby detect a touch point 725 that establishes at least one upper tooth opposing surface 726. As shown in the diagram 723 of FIG. 95, the tooth profile mapping 724 may include the automated oral appliance controlling the actuators to establish contact between the appliance tool 690 and an upward opposing surface (such as a biting surface) of at least one lower tooth, and thereby establish at least one lower tooth opposing surface 726. As an example, the automated oral appliance may control the actuators to extend to a midpoint along the reach axis 692 (or may set the home position, neutral position, or zero position to a fully retracted position along the reach axis 692), to rotate the appliance tool 690 into a horizontal orientation, and to perform a slow pitch rotation 693 until detecting contact by the appliance tool 690 with a horizontal surface of a tooth. The tooth profile mapping 724 may involve contact between the appliance tool 690 and the opposing surfaces of two or more upper and/or lower teeth, such as two or more upper and/or lower incisors, canines, premolars, and/or molars. The detection of at least one upper tooth opposing surface 726 and at least one lower tooth opposing surface 726 may enable a determination of a profile map of the teeth of the individual, such as the positions, verticals, shapes, sizes, and/or orientations of each of the individual's teeth, relative to one another and/or to a primary reference point 707, as well as presence or absence of various teeth of the individual, such as wisdom teeth. As one such example, the automated oral appliance may control the appliance tool 690 to sweep side-to-side across the surface of a tooth such as a molar to detect a molar width of each molar of the individual.

In some example variations, the automated oral appliance may be configured to determine various characteristics about each tooth during the tooth profile mapping 724. The automated oral appliance may be configured to measure a presence or absence, vertical, width, length, depth, orientation, shape, composition, and/or color of each tooth. Each such measurement may be based upon a scale or rating, and/or may be relative to one or more other teeth of the individual. As a first example, an automated oral appliance may be configured to move to a position where a tooth is predicted to exist. If the automated oral appliance is unable to determine the presence and/or orientation of the tooth, (for example, due to crooked or overlapping teeth), the automated oral appliance may be configured to move the appliance tool 690 to various positions and/or orientations in the vicinity of the tooth, and upon encountering the tooth, may adjust the oral mapping. As a second example, an automated oral appliance may be configured to measure a molar width, for example, by positioning the appliance tool 690 on a top tooth surface of a lower molar and sweeping the appliance tool 690 side to side until encountering a stop. As a further illustration of a technique for measuring a tooth profile, and thereby determining a tooth width, an automated oral appliance may be configured to position the appliance tool 690 on a side tooth surface facing the center of the mouth and may command the actuator(s) to move the appliance tool 690 in an outward direction from the center of the mouth at a low power, torque or speed which would not cause damage to the tool, appliance or individual. Upon detecting that the tool has been blocked from further movement for example, via position sensors indicating no further movement, force sensors detecting increased force against the tool or current sensors showing an increase in actuator current, one or more vertical actuators may be commanded to raise or lower the tool to clear the tooth surface and thereby permit further movement. Either continuously or at discrete points along the outward movement of the tool, the vertical actuator(s) may be commanded to either raise or lower until vertical contact with the tooth is again established. Either continuously or at discrete points along the outward movement of the tool, the outward position and/or the height of the tool may be recorded in order to construct a profile of the tooth. The profile data may be stored as discrete points, or may be converted into a series of lines and/or curves. The raw points and/or lines may be fitted to one or more curves such as Bezier or polynomial curves and stored in that form to reduce the memory or processing power requirements and to permit additional mathematical operations such as the calculation of continuous slopes or derivatives which may be useful for operations such as trajectory planning.

The example profile mapping of FIG. 95 includes a pocket profile mapping 727 in which an automated oral appliance (such as the example automated oral appliance 689 of FIG. 90) may further map a pocket between one or more pairs of adjacent teeth, for example, a gap or gumline between adjacent pairs of upper and lower teeth of the individual.

The pocket profile mapping 727 may begin with an automated oral appliance in an initial position, such as a home position, neutral position, or zero position. For example, the automated oral appliance may reset the position to a home position, neutral position, or zero position after the tooth profile mapping 724. Alternatively or additionally, the automated oral appliance may adjust the pocket profile mapping 727 to begin where the tooth profile mapping 724 concluded. Alternatively or additionally, the pocket profile mapping 727 may begin with the position (including orientation) of the automated oral appliance established with respect to a primary reference point 707, such as an anchor point of a positioning member 705.

As shown in the diagram 723 of FIG. 95, the pocket profile mapping 727 may include an automated oral appliance that is configured to control a set of actuators to establish contact between a length of floss held by the appliance tool 690 and a pocket between a pair of adjacent upper teeth, and thereby establish at least one upper pocket 728. As shown in the diagram 723 of FIG. 95, the pocket profile mapping 727 may include an automated oral appliance that is configured to control a set of actuators to establish contact between a length of floss held by the appliance tool 690 and a pocket between a pair of adjacent lower teeth, and thereby establish at least one lower pocket 728. As an example, the automated oral appliance may be configured to control the actuators to extend to a midpoint along the reach axis 692 (or may set the home position, neutral position, or zero position to a fully retracted position along the reach axis 692), to rotate the appliance tool 690 into a vertical upward or vertical lower orientation, to pivot the appliance tool 690 (such as by a rotation 696) to orient the appliance tool 690 to coincide with a predicted gap between a pair of adjacent teeth, and to perform a slow pitch rotation 693 until detecting contact by the floss held by the appliance tool 690 and the pocket between the pair of adjacent upper or lower teeth. As another example, the automated oral appliance may be configured to seek and/or detect a feature of a pair of adjacent teeth that indicates a pocket, for example, a “v” grove between two teeth such as the user's front incisors.

The pocket mapping 727 may involve establishing and/or detecting contact between the appliance tool 690 and the pockets between two or more pairs of upper and/or lower teeth. The at least one pocket 728 may enable a determination of the positions of pockets between pairs of teeth, and optionally other properties of the oral features of the individual, such as widths, depths, and/or orientations of the pockets between the pairs of adjacent teeth of the individual.

In some example variations, an automated oral appliance may be configured to determine various characteristics about each pocket during the pocket mapping 727. The automated oral appliance may be configured to measure a presence or absence, vertical, width, length, depth, orientation, shape, composition, and/or color of each pocket between each pair of adjacent teeth. Each such measurement may be based upon a scale or rating, and/or may be relative to one or more other teeth of the individual. As a first example, an automated oral appliance may be configured to oscillate (for example, wiggle back and forth) the appliance tool 690 while ascending and/or descending into a pocket between adjacent teeth, which may reduce the force involved in positioning the floss between adjacent teeth that have tight gaps. As a second such example, the automated oral appliance may be configured to move the appliance tool 690 in a manner to measure the dimensions of the pocket, for example, in a circular and/or corkscrew movement. As a third example, for each tooth gap identified from an oral mapping, an automated oral appliance may be configured to move the appliance tool 690 to the position, and then move the appliance tool 690 to the bottom of the pocket while recording the force involved in positioning the appliance tool 690 and/or the depth of the pocket.

When the appliance tool 690 is positioned at the bottom of a pocket, the automated oral appliance 689 may be configured to move and/or rotate the actuators to a limit (for example, through the range of motion along one or more linear and/or rotational axes until detecting physical resistance and/or contact), and, based upon such range of motion, determine a position and/or orientation of the pocket.

When the automated oral appliance 689 encounters one or more positions where a pocket is predicted to exist, if the automated oral appliance is unable to determine the presence and/or orientation of the pocket (for example, due to crooked or overlapping teeth), the automated oral appliance may be configured to move the appliance tool 690 to various positions and/or orientations in the vicinity of the pocket, and upon encountering the pocket, to adjust the oral mapping.

While the automated oral appliance 689 is positioning the appliance tool 690 within a pocket, the automated oral appliance 689 may be configured to stop moving the appliance tool 690 before encountering the bottom of the pocket, for example, to reduce gum irritation and inflammation.

An oral apparatus may conclude an oral mapping by testing or verifying the oral mapping; by notifying a user of a successful or unsuccessful completion of the oral mapping; by informing the user as to the status of the oral mapping or the oral apparatus; and/or by causing the automated oral appliance or appliance tool 690 to move to a home position, a neutral position, or a zero position, such as a storage configuration.

The foregoing description is but one example oral mapping of an oral apparatus. Some examples of oral apparatuses may vary from the foregoing description of the example oral mapping of FIGS. 93 through 95, for example, by adding operations, omitting operations, performing operations in a different order, combining operations, dividing operations into two or more sub-operations, performing two or more operations in a concurrent and/or interleaved manner, and the like, without departing from the subject matter of the present disclosure. Those of ordinary skill in the art may identify and include many such variations in mapping techniques in accordance with this disclosure.

### D4. Oral Mapping Variations

The oral mapping may include a number of variations. Such variations may provide new or additional features or alternative options and/or may improve, extend, or synergize with other features.

An oral apparatus may be configured to store, receive, and/or execute a set of instructions for operating a set of actuators to move an appliance tool 690 of an oral appliance in a sequence of movements that are expected to contact oral features of the oral cavity 691 of the individual at particular positions in the sequence, for example, a first point in the sequence of instructions where the appliance tool 690 is anticipated to contact a first oral feature such as a tooth surface. A detection of such contact (e.g., resistance against the appliance tool 690, which may be detectable as increased current through an actuator) may verify the contact point and may establish an oral feature as part of an oral mapping of the oral cavity 691 of the individual. The processing circuitry 686 of the oral appliance may be configured to identify sensor input that indicates variance in the detection (e.g., resistance detected at an unexpected point in the sequence, such as before the appliance tool 690 is anticipated to reach the contact point, and/or an absence of resistance at an anticipated contact point). The processing circuitry 686 may be configured to respond to such variance as a fault condition. The processing circuitry 686 may be configured to respond to such variance by adjusting the sequence of instructions, for example, by updating an oral mapping of the oral features of the individual and/or adjusting the sequence of instructions to complete the oral mapping based on the variance.

An oral apparatus may be configured to store, receive, and/or execute a set of instructions for operating a set of actuators to move an appliance tool 690 of an oral appliance to detect a sequence of oral features within the oral cavity 690 of the individual. That is, rather than being programmed to follow a sequence of instructions and to detect contact points at anticipated positions and/or orientations, the oral apparatus may be configured to operate the actuators and sensors to seek out the set of oral features in an exploratory manner, and to generate an oral mapping based upon the detected oral features. The oral apparatus may be configured to detect a first contact point and a second contact point within the oral cavity 691 of the individual, and to fit the positions of the first contact point and the second contact point relative to one another into an anticipated or template oral mapping of the oral features of the individual. The oral apparatus may be configured to continue to collect additional oral features (for example, in an exploratory manner and/or based on the previously detected oral features) and may continue to verify and/or update the oral mapping of the oral cavity 691 and oral features of the individual. Upon reaching a confidence that the detected contact points and oral features adequately match the anticipated or template oral mapping, the oral appliance may be configured to conclude the oral mapping. Upon reaching a confidence that the detected contact points and oral features adequately match the anticipated or template oral mapping, the oral appliance may be configured to continue collecting additional oral features, but may do so in a more programmatic manner, that is, moving an appliance tool 690 to a sequence of positions (including orientations) to collect and/or verify the remaining oral features within the oral mapping. Upon failing to reach a confidence that the detected contact points and oral features adequately match the anticipated or template oral mapping (for example, failing to reach the confidence within a threshold duration and/or based upon a threshold number of unanticipated contacts and/or absence of contacts), the oral appliance may be configured to identify such failing as a fault condition.

An oral apparatus that is unable to detect a particular oral feature may be configured to adapt an oral mapping operation based on variations of the individual's oral features. For example, a misalignment of a user's teeth may result in a tooth or a pocket being displaced from a typical or anticipated position and/or orientation. The oral apparatus may be configured to detect the variation in the oral feature of the individual and to update and/or supplement the oral mapping based thereupon.

An oral apparatus that is unable to detect a particular oral feature may be configured to determine that a tooth or pocket is not in the typical or anticipated position and/or orientation, and to perform a trial-and-error or search operation, for example, by offsetting and re-performing the oral mapping with incremental variations to locate the tooth or pocket. Adaptive processes such as machine learning may be included to facilitate the search process.

An oral apparatus that is unable to detect a particular oral feature may be configured to use other detection processes to evaluate the individual's oral features, such as evaluating the output of a proximity sensor or camera to determine the position and orientation of a tooth or pocket.

An oral apparatus may be configured to skip an oral mapping operation involving a tooth or pocket in case the tooth or pocket that is not accurately detected, and, optionally, to re-attempt the oral mapping operation after performing other oral mapping operations, such as mapping other teeth or pockets and inferring a position and/or orientation of a tooth or pocket that was not accurately detected during a first attempt.

An oral apparatus may be configured to initiate an oral mapping based upon a reference oral mapping, for example, as a prediction, guide, and/or estimate of the oral mapping of the individual. The oral features may include or may be based on, for example, a previous oral mapping of the individual; an oral mapping of another individual who is similar to the individual, such as a family member; a typical oral mapping of individuals who resemble the individual, such as individuals of the same or similar age; and/or a default or typical oral mapping of individuals. The oral apparatus may be configured to perform an oral mapping to verify that the oral mapping of the individual is similar to the reference oral mapping, and/or to adjusting the reference oral mapping to match the oral mapping of the individual.

An oral apparatus may be configured to detect, verify, and/or respond to unusual oral features of the individual, such as substantially misaligned teeth; unusually formed teeth; missing teeth, including extracted wisdom teeth; substantial variation in oral planes, such as a substantial overbite or underbite; unusually formed soft tissue; and the presence or configuration of oral fixtures such as crowns, bridges, braces, retainers, dentures, and the like.

An oral apparatus may be configured to adjust the performance of oral mapping to accommodate unusual oral features or features, for example, by causing an automated oral appliance to navigate differently around an oral feature, to avoid contacting or proximity to an oral feature, to use a different set of sensors to map the oral feature, to capture a different set of data about the oral feature, to produce a different type of oral mapping for the oral feature, to annotate an oral mapping regarding the oral feature, and/or to refrain from mapping the oral feature.

An oral apparatus may be configured to perform a different type of oral mapping based on a presence, absence, or properties of one or more oral features, such as a specialized oral mapping operation for individuals with braces.

An oral apparatus may be configured to communicate with the user to determine or verify a presence, absence, and/or position of a tooth or pocket. The oral apparatus may receive user input about the individual's oral features, such as via an app that allows the individual to indicate the presence, absence, position, orientation, and/or properties of teeth, pockets, and/or oral fixtures, and may adjust the oral mapping based on such features. Individual mapping operations may be verified with the user, such as receiving user input that indicates whether each oral mapping operation was correctly or incorrectly performed, and/or allowing the user to monitor, guide, and/or control individual oral mapping operations such as the oral mapping of individual teeth or pockets. An oral apparatus may be configured to warn a user and/or refrain from performing an oral operation based on a presence, absence, or properties of one or more oral features, such as a specialized oral mapping operation for individuals with braces.

One example of an automated mapping and/or cleaning cycle may be conducted as follows. Upon activation of an oral appliance 813, for example, by pressing a power switch, by application of power by plugging in a power source 825 or by detection of the cessation of charging current due to being picked up from a wireless charging stand, the processing circuitry 824 in oral appliance 813 may execute a self-diagnostic routine. Some examples of self-diagnostics that may be run include verification of the integrity of the volatile and/or non-volatile memory 884 by comparing computed vs. stored checksums of executable programs and/or data structures such as an oral mapping 843. Other examples of self-diagnostics include verifying that the actuators and/or motors are at rest and not drawing current, as may be determined by one or more sensors 821 such as a current sensor configured to measure the current applied to an actuator or motor.

Processing circuitry 824 may then activate one or more actuators or motors to move them to a known calibration position so that relative position sensors such as an optical or magnetic encoder may be calibrated to an absolute position. As one possible implementation, processing circuitry such as an STM32 microcontroller may be connected to an H-bridge chip such as a TI DRV8212. The DRV8212 may be powered by a power source 825 such as, without limitation, batteries or an AC to DC adapter. The output of the DRV8212 H-bridge may be connected to a brushed motor or linear actuator.

A timer peripheral in the STM32 may generate under software control a pulse-width modulated (PWM) waveform varying in duty cycle from 0% to 100%. The output of the timer peripheral may control one or more transistors inside the chip which output a voltage on one or more pins of the chip corresponding to the output of the timer, such as +3.3 volts when the timer output is active and zero volts when the timer is inactive. This pin may be wired to the PWM input (also known as the Enable input or the Speed input) of the DRV8212.

Additionally, a general-purpose input/output (GPIO) pin on the STM32 under software control may be connected to the Direction input (also known as Phase input) of the DRV8212. When the pin is driven high, such as to +3.3 volts, the DRV8212 may output one polarity to the motor, for example, driving it in a forward direction. Conversely, when the pin is driven low, such as to ground (zero volts), the DRV8212 may output the opposite polarity to the motor, for example, driving it in a reverse direction.

By setting the duty cycle of the timer and the output of the Direction pin, the motor may be commanded to move forward or backwards at any speed from full speed forward to stopped (0 RPM) to full speed reverse. By varying the speed and direction of the motor, the motor may be accelerated or braked. For example, if the motor is running at 50% forward speed, reversing the polarity of the Direction pin will result in a rapid slowdown of the motor to stopped, then accelerating to 50% reverse speed.

The brushed motor may turn a leadscrew, ACME screw, ball screw shaft or pinion gear that meshes with a nut, ball screw or rack in order to convert the rotary motion of the motor into linear motion. The linear motion generated by the motor may be coupled, for example, through a tool arm to an oral cavity tool. The oral cavity tool may be or may be attached to an oral hygiene tool such as a constrained length of dental floss or one or more clusters of bristles, thus forming a brush.

The motor may have a sensor 685 such as an optical or magnetic encoder near to or mounted to it to measure the rotation of the motor and thus the position, either angular or linear depending on whether the motor output is used directly or converted to linear motion. The position measured by the encoder may be an absolute position as for example with glass scales or an absolute magnetic encoder, or a relative position, as with quadrature encoders, where the rotation or position is measured in steps in a positive or negative direction or rotation. The output of the quadrature encoder may be output to the microcontroller, where the processor, or a dedicated peripheral such as a timer, may count the number and relative timing of the quadrature pulses in order to determine how far the motor has rotated and in which direction. From the raw pulses, other information may be derived, such as the speed (first derivative), measured either from the number of pulses counted in a given time interval or directly from the time between pulses. Other types of absolute or relative rotation or position sensors may be used, such as resolvers, which may output an analog signal proportional to the angle of rotation. Such an analog signal may be digitized by an analog-to-digital (A/D) converter as a part of the microcontroller and again used to determine the position and/or speed and/or acceleration.

The feedback from sensor 685 allows for closed-loop rotation or position control. Inputs from one or more position and/or rotation sensor(s) may be fed into processing circuitry 686 running an algorithm such as a proportional-integral-derivative (PID) controller (also known as a PID loop). The PID loop computes the difference between the current position or rotation and the commanded position or rotation and outputs a signal, which may be positive or negative, continuous or binary, to command the motor towards the desired position or rotation. As the motor gets closer to the desired position or rotation, the computed difference between the positions or rotations decreases and the motor is commanded to reduce its speed and or brake. The PID loop takes 3 parameters, the proportional, integral and derivative terms, which determine the behavior of the algorithm and how quickly and smoothly it converges to the desired position or rotation and how much overshoot or undershoot occurs as it nears the target position or rotation. A properly tuned PID loop will cause the motor to proceed to the target position or rotation in the minimum possible time, with minimal overshoot and undershoot. Other types of closed-loop feedback algorithms are known and can be used, such as feedforward, sliding mode control, Model Predictive Control (MPC) or linear-quadratic-Gaussian control (LQG), but the basic principle remains the same.

In practice, direct input of target positions into the PID loop is not suitable for many applications because the motor proceeds at high speed towards the target position. For example, plunging a floss tool at full speed into the tooth pocket at the bottom of two adjacent teeth may cause bleeding or injury as the tool hits the gums at the bottom of the pocket. Furthermore, it may be required to have coordinated motion between multiple motors or actuators so that they all arrive at a target position at approximately the same time. If each motor was simply commanded to the target position by the PID loop, all motors would proceed at high speed with the closest motor arriving first, followed by the next closest and so on. This may cause uncoordinated jerks of the tool arm and oral cavity tool that may be harmful or injurious. Finally, it may be advantageous to have controlled acceleration and deceleration of the motors to avoid abrupt movements that may be dangerous or intimidating or put additional wear on the motors or equipment.

To address these needs, a trajectory planning algorithm may be implemented. For a graph with the Y-axis being motor position and the X-axis being time, and several sequential motor target position points plotted, several things can be seen. First, the slope between two adjacent target points determines the required speed of the motor. Points that are closer together in time necessitate a higher speed of the motor in order to reach the target position in time. Secondly, the target points can be connected in a variety of ways. The simplest connection is a straight line between points. However, this has the disadvantage of potentially causing large changes in acceleration as one target point is reached and the motor abruptly changes speed to match the velocity needed to reach the next point in time. A smooth curve connecting the points without cusps or sharp turns results in smooth acceleration and deceleration with minimal jerks. Furthermore, when multiple motors are used together for positioning, the target position for each of the motors can be set at the same temporal location (i.e. the same coordinate on the X-axis). In this way, the motion of all the motors may be coordinated so that they arrive at the target location at roughly the same time. One type of smooth curve suitable for trajectory planning is piecewise cubic Hermite splines. The piecewise cubic Hermite splines are useful for smoothly interpolating between successive data points such as target positions.

A special type of cubic Hermite spline called a centripetal Catmull-Rom spline has some advantageous features compared to other types of curves. First, it will not form cusps, loops or self-intersections, which may cause significant position overshoots or jerky acceleration. Secondly, it follows the target points more closely, as compared to the uniform or chordal Catmull-Rom spline curves.

The centripetal Catmull-Rom spline may be evaluated at every time point where the motor power and direction are set, or may be evaluated less often and the intermediate position points calculated using linear or polynomial interpolation, which may result is less processor loading. The output positions from the centripetal Catmull-Rom spline or the interpolation may be fed into the PID loop to command the motor(s) to the desired intermediate positions. In this way, coordinated and smooth motion of the motors or actuators may be achieved.

The motor may be directly or indirectly coupled, for example, through a driveshaft, to the oral cavity tool such that activation of the motor causes the oral cavity tool to rotate along one or more axes.

As another alternative, the motor may be coupled to the tool arm through a gimbal or ball-and-socket joint such that activation of the motor causes rotation of the tool arm in a horizontal, vertical or oblique direction. Because the rotation of the tool arm in the case of a gimbal or ball-and-socket joint may be through a stationary point, the end of the tool arm (where the oral cavity tool may be located) sweeps out a circular path relative to the stationary point at the center of the gimbal or ball-and-socket joint. Due to the rotation sensor(s) on the motor, the angle traversed is known and the position of the oral cavity tool in rectangular (also known as XYZ or Cartesian coordinates) can be easily computed using the length of the tool arm and sine and cosine equations. Specifying the position in terms of an angle and a length is also known as polar coordinates.

There may be more than one motor and more than one gimbal. In the case of nested gimbals having coincident centers driven by two motors, as seen in FIG. 17 where the common point of rotation for the horizontal and vertical axes is the pivot point 418, conversion from the measured angles of the motors and the length of the tool arm (also known as spherical coordinates) to rectangular coordinates again involves sine and cosine equations. The process of converting known motor positions into the location of a tool or robot end-effector is known as forward kinematics.

Conversely, there may be a set of rectangular coordinates that it is desired to place the end of the tool arm at. In order to compute the required angles, a rectangular to spherical coordinate conversion is required, of which one way to accomplish that utilizes tangent and arccosine equations. The process of converting from a desired location and/or orientation of a tool into motor positions is known as inverse kinematics. Generally speaking, forward kinematics is easier to compute than inverse kinematics.

There may be additional motors and additional degrees of freedom (DoF). For example, the oral appliance illustrated in FIGS. 1 through 16 and schematically shown in FIG. 90 shows 5 actuators, controlling 4 rotary axes and 1 linear axis, thus resulting in 5 degrees-of-freedom.

Normally, computing inverse kinematics for a 5 DoF robot would be computationally intensive. In many cases, there are a multitude of inverse kinematic solutions for a given position and/or orientation and oftentimes solutions must be found using iterative, non-linear or approximate solutions. However, for the oral appliance described in this disclosure, the 5 degrees of freedom are not fully independent. For example, as was shown earlier, all movement of the tool arm passes through pivot point 418, thus allowing the use of much simpler equations with discrete solutions for converting from spherical to rectangular coordinates.

Furthermore, there may be additional kinematic constraints which simplify the equations for computing the actual location of a tool or the motor angles required to place the tool in a defined location and orientation. For example, as shown in FIG. 58B, the oral cavity tool may be located at a defined distance and orientation relative to the tool arm and the rotations of the oral cavity tool in one or two axes may be constrained relative to the tool arm rather than being freely rotatable in any direction. Additional kinematic constraints on the oral cavity tool occur as a result of oral features. For example, a floss tool cannot be angled such that the floss holder would be penetrate adjacent teeth.

For an example forward kinematics case of computing the location of center of the floss in a floss tool based on the measured angles of 5 motors, the solution is simple and leads to a discrete answer. First there is the vector from the pivot point 418 to the intersection of the tool arm axis and the axis of the floss tool perpendicular to the tool arm. The rectangular coordinates of this point can be calculated with angles of rotation of the horizontal and vertical motors and the length from the depth actuator using the spherical to rectangular equations described above. The next vector is from the terminus of the previous vector to the intersection of the floss tool perpendicular to the tool arm and the axis running lengthwise through the floss. Again, this is a spherical to rectangular coordinate transformation utilizing the angle of rotation of the tool arm rotation motor and the distance from the tool axis to the intersection of the two floss axes. Finally, the vector from the terminus of the previous vector to the center of the floss, again a spherical to rectangular coordinate transformation. This vector also yields the orientation of the floss strand. The summation of these three vectors yields the location of the centroid of the floss.

In certain cases, it may be more convenient to do the calculations using spherical and/or polar coordinates and either use the results directly or convert them to rectangular coordinates at the end of the computations. In other cases, it may be advantageous to use numerical analysis methods such as Newton-Raphson approximations instead of discrete solutions.

For the reverse case of solving for the desired motor angles to position an oral cavity tool at a defined location and orientation (inverse kinematics), more than one solution exists. In some cases, this is very valuable. As may be seen in FIG. 91, an oral cavity tool positioned directly vertical inside an oral cavity may take up a great deal of room. For smaller mouths, such as for children and/or animals, there may be insufficient vertical 699 and/or horizontal clearance for proper operation of the oral appliance if the oral cavity tool is kept vertical. In these cases, the tool may be held at an angle by one or more actuators to reduce the vertical 699 clearance requirements.

With the desired position and/or orientation of the oral cavity tool and the kinematic constraints, one or more solutions for the required motor positions may be solved for. In many cases, it may be easier to impose one or more constraint(s) on the solution(s) such as mandating that the oral cavity tool be at a certain angle such as vertical or 30 degrees from vertical. The addition of these constraint(s) may allow for a direct analytical solution requiring less time and/or processing power than numerical solvers. Alternatively, inverse kinematic solution(s) may be found using numerical solvers such as FABRIK or the Jacobian inverse technique with or without Newton-Raphson iteration.

The output from the inverse kinematic solution may then be fed into the trajectory planner algorithm to cause the motors or actuators to move the oral cavity tool to the desired position and orientation.

A mapping or a cleaning cycle may begin in the same way. Self-diagnostics may be performed and proper functionality of the device verified. The user may be prompted to insert part of the oral appliance into his or her mouth through visual or auditory means. Alternatively, if the oral appliance includes an oral positioning apparatus that has one or more sensors that indicate that the user has inserted part of the oral appliance into his or her oral cavity and is ready for the procedure to begin, for example, by biting down or resting his or her jaws on a part of the oral positioning apparatus then the procedure may automatically begin or the user may be prompted to signal that they are ready for the procedure to begin, for example, by pressing a button.

The motors or actuators may be calibrated to known positions such as a home, neutral or zero position as described elsewhere in this disclosure. This step may occur after the user has indicated his or her readiness to proceed or any time before then. Relative position sensors such as quadrature encoders counted by a microprocessor or timer peripheral may have their counts reset to zero at a known position.

A primary reference point 707 or point(s) may be obtained. Primary reference points are points which may be used to establish a positional reference to an oral or facial feature positionally locked to one or both of the user's jaws. Such a point need not be in the oral cavity. For example, the nose is positionally locked to the upper jaw (maxilla) and the chin is positionally locked to the lower jaw (mandible). Any oral or facial feature which is tied to either the upper or lower jaw may function as a primary reference point 707, such as, without limitation, the upper frenulum, the upper and/or lower jaw directly, the nose, cheekbones, ears, hair, mentolabial sulcus and eyesockets.

As shown in FIG. 100, oral or facial feature(s) representing primary reference point(s) 707 may be mechanically constrained, for example, by a robotic hand cupping the lower jaw through the user's skin. More than one oral or facial feature representing a primary reference point may be obtained, for example, a robotic finger may be pressed into the mentolabial sulcus between the chin and the lower lip while simultaneously, having another robotic finger pressed against the nasal base at the intersection of the nasal septum and the philtrum.

The primary reference point 707 need not be physically touching, linked or connected. For example, as shown in FIG. 100, a scanning unit 775 based on, for example, stereo vision, LIDAR, time-of-flight (ToF) cameras or ultrasound may determine the position of a user's chin and use it as a primary reference point 707 for the lower jaw.

The primary reference point 707 or points may come as a byproduct of an oral positioning apparatus. For example, the oral positioning apparatus shown in FIGS. 20 to 35 is configured to hold the jaws apart for access to the oral cavity. It does so by anchoring to the upper and lower gum pockets and surrounds the upper frenulum which is an oral cavity landmark, thus providing primary reference points 707 of the upper frenulum and the lower gum pocket.

Another example of an oral positioning apparatus 923 providing a primary reference point 707 is shown in FIGS. 43 to 45, which provides a primary reference point 707 relative to the upper and lower jaws behind the rear molars.

The location of the primary reference point 707 need not be digitized or otherwise explicitly determined. It may simply provide a relatively fixed position to anchor a connected oral appliance.

A mapping or cleaning cycle may begin with the determination of a positional reference such as the distance to the front surface(s) of the upper and/or lower front teeth. This may be accomplished by slowly advancing the oral cavity tool or probe using the depth actuator 679 at a speed which will not cause injury or discomfort to the user when it contacts the front teeth or gums. A position sensor such as an optical or magnetic encoder mounted to the motor or actuator may continuously or intermittently monitor the position of the depth actuator and by extension, the position of the oral cavity tool or probe. When the position stops, then it is known that the oral cavity tool or probe hit an object. At that point, the distance is recorded as a point in memory. Additional information may be recorded about the collision, for example, any spring back when the actuator is stopped which may indicate that softer tissues such as gums were hit rather than hard teeth.

Consensus oral maps of average adult's and/or children's and/or animal's oral features may be preloaded into computer-readable memory during manufacture of the oral appliance. These oral maps may be highly compressed and/or simplified representations of essential oral landmarks such as locations (with or without orientations) stored as vectors or sets of coordinates such as XYZ (for the three linear dimensions to indicate a position) and/or ABC (for the three angular dimensions to indicate an orientation). During the initial mapping, the factory default map may be loaded, customized and saved, and for cleaning, the customized map created by the mapping algorithm may be loaded.

A very common but not essential oral landmark is the origin. This may be an anchor point which commonly has the XYZ coordinates (0,0,0) for aligning the oral map, to which all other landmarks encoded in the oral map may be referenced. It is commonly chosen to be the center of the groove between upper surfaces of the lower frontmost two teeth due to its easy accessibility and sharply defined position. The origin may also include an orientation, commonly chosen to align with the tooth gap groove between the two frontmost teeth.

Another storage type is a plane, such as simplified representation of the vertical or horizontal surface of a tooth stored as a point corresponding the center of the face of the tooth and a normal vector or ABC orientation to indicate the outward direction that the tooth surface is facing.

Another commonly stored plane, which may be termed the ‘tooth plane’ is defined by the bottom of the tooth gaps of the frontmost two teeth and the bottom of the tooth gaps between two left molars and two right molars, although not necessarily the rearmost ones. These three positions allow for quick and easy realignment, transformation and/or scaling of the map to match the measured landmarks during the calibration phase. Similarly, a plane which may be termed the ‘gumline plane’ may be defined by the bottommost depth of the tooth pocket between of the frontmost two teeth and the bottom of the tooth gaps between two left molars and two right molars, which may be useful during flossing operations.

Because the topmost surfaces of the teeth when connected do not form a 2-dimensional flat plane, for increased accuracy, the ‘tooth plane’ and/or the ‘gumline plane’ may be more accurately modelled as 3-dimensional surfaces instead. The surfaces may be true 3-dimensional freeform surfaces constructed from individual vertices connected with lines to form a mesh, or more commonly may be encoded as ‘extruded surfaces’, which are defined as a 2-dimensional curve extruded (most commonly from the center of the mouth to the left and right sides (to match the left-right symmetry of the oral cavity). The curve may be made up of discrete points connected together with lines or arcs or more commonly may be a polynomial or spline-based curve constructed by curve-fitting discrete points. Such a surface may be compactly stored as a series of curve equation coefficients.

Another storage type may be a line or vector or a localized axis, for example to represent the position and orientation of a tooth gap groove. These objects may be stored in different ways, depending on how they will be used. For example, a line or a vector can be stored as two XYZ points representing the endpoints of the line or vector. Alternatively, a line or vector may be stored as a point, an orientation and a length. A localized axis may be stored as an XYZ point and an orientation to which the axis is parallel to. It may be appreciated the storage types for the plane and the localized axis may be the same, a point and an orientation. The difference is that in the case of a plane, the orientation corresponds to the normal of the plane, whereas with the localized axis, the orientation is parallel to the axis. To indicate how the stored data should be interpreted, it is common to encode the geometrical feature as a structure with a ‘type’ byte which indicates how the stored data should be interpreted. Additional metadata may also be added to the structure, such as a tooth number and the type of oral feature, such as a tooth pocket, large gap, missing tooth

Another storage type may be a cylinder, defined as a localized axis with a diameter. This may be useful to represent the location, orientation and diameter of a tooth pocket at the base of two adjacent teeth.

Another storage type may be a gap, defined as two planes with space between them. The planes may be parallel or not. As the name implies, this may be useful to represent the location, orientation and width of a wide gap between two adjacent teeth.

Another storage type may be a profile, which may be a plane and a curve projected onto it, two perpendicular planes with a different curve projected onto each of them or three perpendicular planes (corresponding to the XYZ directions) with a different curve projected onto each of them. As the name implies, this may be useful to represent the profile of a tooth. The curve may be made up of discrete points connected together with lines or arcs or more commonly may be a polynomial or spline-based curve constructed by curve-fitting discrete points. Such a curve may be efficiently stored as a series of curve equation coefficients.

Another storage type may be a 3-dimension mesh made up of connected vertices. This may be useful for storing scan data from a high or low-resolution 3D scanner. Additionally, if the scanner was camera based, a color may be stored at each vertex and/or the center of the mesh triangles or squares.

Another storage type may be a keep-out zone to indicate areas that should not be entered, such as the location of the tongue. The keep-out zone may be encoded as a distance, such as 1 centimeter below the lower gumline, or as a plane defined by a point and orientation, or as a 3-dimensional surface constructed from individual vertices connected with lines to form a mesh, as an extruded surface or as a 3-dimensional volume, again defined by connected vertices.

Because the distance between the upper jaw and the lower jaw may vary between cleaning runs, it is common to encode the upper oral map (map of the upper oral features such as the upper teeth) and the lower oral map separately, each with their own origin and/or reference frame, so that they may be separately and easily transformed to match the measured landmarks during the calibration phase. For example, the origin of the upper oral map may be the gap between the upper two frontmost teeth and the origin of the lower oral map may be the gap between the lower two frontmost teeth.

Continuing the calibration process, after the frontmost surface of the lower teeth has been located, the bottom of the tooth gap between the frontmost lower two teeth may be located. To do so, the vertical actuator may be activated by processing circuitry to raise the oral cavity tool enough to clear the upper surfaces of the frontmost two lower teeth. The depth actuator may then be activated by processing circuitry to advance the oral cavity tool by half the length of the floss held in the oral cavity tool. The vertical actuator may then be commanded to slowly lower the oral cavity tool until it makes contact with the upper surface(s) of one or both of the frontmost lower two teeth.

Instead of stopping the vertical actuator when contact is made, the vertical position may be recorded in memory and the oral cavity tool swept from side to side using either the horizontal actuator or the tool rotation actuator or both while seeing if the vertical distance increases (the oral cavity tool goes lower). Since the vertical actuator is still (slowly) active, if the oral cavity tool encounters and sinks into the groove of the tooth gap, it will be constrained from left-right movement which may be detected by the position encoders on the horizontal actuator.

It is possible that one or both of the frontmost teeth are crooked and that the tooth gap is not centered left to right. To check for this, the tool rotation actuator may be commanded to slowly rotate clockwise and counterclockwise until the rotation is halted due to the floss being twisted to its limit. The center angle between the clockwise angle limit and the counter-clockwise angle limit is the left-right orientation of the tooth gap groove which may be recorded as an orientation or axis. For some oral cavity tools, the center of the floss is not coincident with the axis of rotation. In these cases, the depth and/or horizontal actuators may be driven such that the effective axis of rotation is coincident with the center of the floss to more accurately find the true orientation of the tooth gap groove.

When the orientation of the frontmost teeth gap has been determined, the depth and/or horizontal and/or vertical actuators may be commanded to drive the oral cavity tool along the tooth gap groove axis in one or both directions until the tool stops due to the floss holder hitting the front or back surfaces of the frontmost teeth. In this way, the width (or thickness) of the frontmost teeth can be measured and the center of the tooth gap determined and recorded.

When the first tooth gap groove has been characterized, the stored oral map may be scaled, transformed and/or rotated using 3D affine transforms and/or quaternions to align the origins of the front tooth gap and the stored oral map.

For cleaning, the oral cavity tool may be commanded to move to and characterize the tooth gap between pairs of left and right side teeth deeper in the oral cavity, such as molars. With three data points (characterized tooth gaps), the stored oral map may be scaled, transformed and/or rotated using 3D affine transforms and/or quaternions to align with the measured data.

For mapping, there are four main possibilities: 1) The next tooth gap on either the left or right side can be characterized. 2) The oral cavity tool can be commanded to move deeper into the oral cavity and measure the width between the interior surfaces of teeth farther back in the oral cavity. 3) The tooth pocket located at the bottom of the gap between the two frontmost lower teeth may be descended to and characterized. 4) The tooth gap between the two frontmost upper teeth may be characterized.

To implement number one, the vertical actuator may be commanded to raise the oral cavity tool to clear the frontmost teeth gap and thereby permit further movement of the oral cavity tool along a curved path towards the rear of the mouth along the centerline of the teeth. Either continuously or at discrete points along the outward movement of the tool, the vertical actuator may be commanded to either raise or lower the oral cavity tool until vertical contact with the tooth is reestablished. The angle of the oral cavity tool may be adjusted continuously or at discrete points along the path to maintain the oral cavity tool perpendicular to the centerline of the teeth along the path.

Upon encountering the tooth gap of the next tooth, the oral cavity tool may descend into the gap due to the vertical actuator maintaining vertical contact with the upper surface of the teeth. Similarly to the tooth gap in the frontmost two teeth, the tool rotation actuator may be commanded to rotate clockwise and counter-clockwise to determine the orientation of the tooth gap.

If the distance between the frontmost tooth gap and the next tooth gap is significantly less than predicted for an adult mouth, then a consensus child map may be loaded instead.

As each tooth gap and/or pocket gap is characterized, the map is refined. When there are more than three features characterized, the oral map may no longer be exactly transformed and aligned to the acquired mapping data. In this case, techniques such as least-squares fitting and Kalman filters may be used to achieve a best fit of the experimental data.

After each tooth gap mapping or after all the teeth gaps in a half of the mouth have been mapped, the pocket(s) may be mapped. After the upper or lower half of the mouth has been mapped, the oral cavity tool can be flipped and moved to the other half of the mouth to be mapped. Other mapping techniques that may be used are described elsewhere in this disclosure.

Although the above description focused on the use of a floss-based oral cavity tool for mapping, other tool variations are possible. For example, a flexible or rigid probe may be used as described in FIGS. 101 to 104 to implement a ‘groove following’ and/or ‘point cloud’ algorithm for mapping. Alternatively, a brushing cartridge as is shown in FIG. 52A may be used for mapping, albeit with reduced ability to probe tooth gaps.

### D5. Oral Mapping Results and Uses

The oral mapping of the oral features of the oral features of the individual that identify planes, teeth profiles, and/or pocket profiles may provide a variety of results and may support a variety of uses.

The oral mapping may enable the processing circuitry 686 to store one or more data points about the oral features of the individual, such as a presence or absence, size, shape, vertical, and/or orientation of a tooth in an absolute manner and/or relative to other teeth of the individual. Each oral feature may be represented, for example, as a point; a line or arc; a vector; a shape, such as a polygon, a circle, and the like; a two-dimensional surface; a three-dimensional surface or volume; a property, such as a color; and an indicator or description of a location or action; or a plurality of any of the above, such as a collection of points, or a point and a shape, etc. The raw points and/or lines may be fitted to one or more curves such as Bezier or polynomial curves and stored in that form. Alternatively, the raw points and/or lines may be fitted to one or more surfaces such as tessellated models, polygon meshes, B-splines, T-splines, subdivision surfaces, NURBS, T-Splines or polynomial curves. The conversions to splines, curves, surfaces or equations may reduce the memory or processing power requirements and permit additional mathematical operations such as the calculation of continuous slopes or derivatives which may be useful for operations such as trajectory planning. The processing circuitry 686 may be configured to store one or more oral features about the oral features of the individual detected during the oral mapping. The oral features may be detected, represented, and/or stored, for example, according to a coordinate system, which may be based upon an initial position or upon a reference coordinate, a position on the automated oral appliance, such as the primary reference point 707, and/or a physiological feature 706 of the individual. The oral features may be detected, represented, and/or stored, for example, as one or more positions, such as a vector, distance, or offset relative to a calibration indicator detected during the calibration, another oral feature, such as the primary reference point 707, and/or a physiological feature 706 of the individual. The oral features may be detected, represented, and/or stored, for example, as one or more geometric shapes, such as a line, plane, or a two- or three-dimensional surface or polygon such as a sphere or a cube.

The oral features or mapping may be processed and/or encoded into alternate forms, such as curves, splines, paths, arrays, matrices, equations, pseudo-code or executable code. For example, a brushing tool path may be created by connecting points on the center of the inner surface of each tooth of the upper or lower teeth, midway between the top surface of the tooth, the gum plane (e.g., as determined by the pocket depth), and the front and rear tooth gaps, with lines or one or more curves, and then offsetting those curves (e.g., by two-thirds of the radius of the brushing tool). The path may then be stored as-is or converted to pseudo-code to be executed by a cleaning algorithm interpreter, or converted to executable code to be “played-back” on the processing circuitry controlling the actuator(s) in order to clean the individual's teeth.

Similarly, the oral features or mapping may be processed into a flossing tool path, for example, by taking the location of the tooth gaps of the upper or lower teeth, offsetting them vertically by sufficient distance (e.g. 2 mm) to clear the top surface of the tooth, connecting each offset tooth gap position to the corresponding tooth pocket position and then back to the offset tooth gap position, then connecting to the next tooth offset gap position, forming a continuous path moving to a tooth, descending into and ascending out of the tooth pocket, and moving to the next tooth. The orientation of the tooth gap may be added to the path so that the floss descends and ascends parallel to the tooth gap. Additional processing and parameters may be included in the path, as described elsewhere in this disclosure, such as reducing the speed of the floss before hitting the bottom of the tooth pocket to reduce inflammation and/or injury of the gums, or gradual acceleration to reduce the strain on the actuators.

The processing circuitry 686 may be configured to store the oral features of the oral mapping in volatile and/or non-volatile memory. Storage in non-volatile memory may enable the oral mapping to be reloaded after a power reset, for example, as a previously determined and stored oral mapping that may be used for personal oral tasks such as brushing, flossing, rinsing, and/or dispensing mouthwash. An oral mapping from an earlier mapping process may be retrieved (e.g., from non-volatile memory) and presumptively used as the initial oral mapping by the automated oral appliance and/or appliance tool 690, optionally by omitting a second instance of the oral mapping or by performing an abbreviated version of the oral mapping to verify that the oral mapping accurately reflects the physiological features 706 of the individual.

An oral mapping may be transmitted, for example, to a server or other device of a healthcare provider such as a dentist, orthodontist, endodontist, and/or dental hygienist. Such transmission may occur, for example, through a device-to-device connection such as Bluetooth, via a local area network, or via a wide-area network such as the Internet. The oral mapping and/or such transmissions that include or refer to the oral mapping may be anonymized, for example, removing personally identifying information of the individual. Such transmission may be accompanied by additional data, such as images and/or video of the oral cavity of the individual, which may be useful in scenarios such as teledentistry. The oral mapping and/or such transmissions that include or refer to the oral mapping may be encrypted, for example, using symmetric encryption with a shared key and/or asymmetric encryption using a public/private key pair. Such anonymization and/or encryption may be applied during transmission; for example, the recipient or receiving device may de-anonymize and/or decrypt received data for review. Such anonymization and/or encryption may be applied during storage of the oral mapping by the recipient or receiving device; for example, a network server, such as a cloud server, may store the data in an anonymized and/or encrypted form. Each oral mapping may be encrypted in a manner that is particular to the oral mapping of the individual, for example, using a unique encryption key that may be used only to encrypt the oral mapping of the individual.

An oral apparatus may be configured to support multiple users, for example, by performing and storing oral mappings of the oral features of different users with different appliance tools 690.

The processing circuitry 686 may be configured to store oral features detected during the oral mapping in volatile and/or non-volatile memory. Storage in non-volatile memory may enable such oral features to be reloaded after a power reset, for example, as a previously determined oral mapping of the oral features of the individual. One or more oral features from an earlier oral mapping may be retrieved (e.g., from non-volatile memory) and used to perform a further operation, for example, such as a dental flossing program. Optionally, the processing circuitry 686 may omit a second instance of the oral mapping or by performing an abbreviated version of the oral mapping to verify that the previous oral mapping reflects the oral features of the individual.

A set of calibration indicators and/or oral features in an oral mapping may be used to perform an oral operation for the individual. For instance, an automated oral appliance may be configured to use the calibration indicators and/or oral features of an oral mapping to perform a brushing operation, a flossing operation, a rinsing operation, an mouthwash dispensing operation, an inspection operation such as evaluating the oral health of the individual, a diagnosis operation such as identifying a cause of oral pain or sensitivity, an imaging operation such as capturing an image of a problem area, and/or a maintenance operation such as maintaining or adjusting braces. Such operations may involve the teeth, pockets, gum line, tongue, cheek, throat, and/or other soft or hard tissue of the individual, and/or oral fixtures of the individual such as crowns, bridges, braces, retainers, dentures, and the like.

A set of calibration indicators and/or oral features in an oral mapping may be used to evaluate a condition of the oral features of the individual, such as the individual's oral health, the condition of various oral features such as teeth and gums, and the availability and/or effectiveness of oral treatment or improvement options. Such evaluation may involve analyzing data gathered by an automated oral appliance, such as the color, shape, size, texture, moisture, temperature, or other properties of the teeth, pockets, or other features of the oral features of the individual. Such evaluation may include analyzing data captured by the oral apparatus to detect, diagnose, rate, and/or track oral conditions. Such evaluation may include, for example, evaluating and/or comparing current, past, or prospective oral fixtures of the individual such as crowns, bridges, braces, retainers, dentures, and the like. Such evaluation may include a detection, determination, or prediction of an incidence, occurrence, or risk of tartar or plaque accumulation, discoloration, cavities, wear, gum disease, damaged oral fixtures, and the like. Such evaluation may include a suitability and/or effectiveness of an oral treatment, such as the effectiveness of a type of toothpaste or mouthwash, a change in oral health in response to a cleaning or flossing regimen, and/or the results of an oral treatment such as braces. Such evaluation may include evaluating a behavior of the individual, such as brushing or flossing habits. Such evaluation may include producing advice and/or recommendations of the availability and/or suitability of oral procedures such as tooth whitening; cleaning of the teeth, gums, and/or tongue; tooth straightening; and/or therapeutic treatment of oral issues such as cavities, gum disease, and the like.

A set of calibration indicators and/or reference points in an oral mapping may be used to render a representation of the oral physiology of the individual, such as a display or rendering of the individual's mouth or teeth. Such displaying or rendering may be via a display on or mounted to the device or via a smartphone, monitor, computer with display or other external device with a wired or wireless connection to the oral hygiene apparatus. Such displaying or rendering may involve a real-time or delayed presentation of the status of the oral hygiene apparatus, such as the current position of the cleaning tool within the mouth with or without a schematic representation of oral structures such as teeth. Such displaying or rendering may involve a presentation of data gathered by an oral apparatus, such as the color, shape, size, texture, moisture, temperature, or other properties of the teeth, pockets, or other features of the oral features of the individual. Such displaying or rendering may include a presentation of data captured by an oral apparatus to detect, diagnose, rate, and/or track oral conditions. Such displaying or rendering may include, for example, a presentation of current, past, or prospective oral fixtures of the individual such as crowns, bridges, braces, retainers, dentures, and the like. Such displaying or rendering may include a presentation of an evaluation, diagnosis, and/or recommendation for a user such as the individual or the individual's parent, guardian, or custodian about conditions such as an incidence, occurrence, or risk of tartar or plaque accumulation, discoloration, cavities, wear, gum disease, damaged oral fixtures, and the like. Such displaying or rendering may include presenting an evaluation, diagnosis, and/or recommendation of the effectiveness of an oral treatment, such as the effectiveness of a type of toothpaste or mouthwash, a change in oral health in response to a cleaning or flossing regimen, and/or the results of an oral treatment such as braces. Such displaying or rendering may include a presentation of a recommendation for the individual, such as brushing or flossing habits or advice or the suitability of oral procedures such as tooth whitening; cleaning of the teeth, gums, and/or tongue; tooth straightening; and/or therapeutic options for various conditions.

A set of calibration indicators and/or oral features in an oral mapping and/or raw oral scan data may be uploaded to a computing device for adjustment or computation of an oral mapping. This may occur when the onboard computing resources are insufficient or incapable of recognizing certain oral features such as impacted or double teeth. The external processing resources may use more advanced techniques such as machine learning trained on libraries of unusual mouth features that were manually classified. Alternatively or additionally, the oral data may be displayed or rendered on a display device such as a monitor. A human may then either adjust the computed oral mapping, or create a new oral mapping from the raw data utilizing one or more human interface devices such as a computer mouse, touchpad, touchscreen or keyboard. After processing the data, a new or revised oral mapping may then be downloaded back to the processing circuitry 686 of the automated oral appliance 689. This uploading and/or downloading may occur via wired or wireless connection, for example, USB, Bluetooth, WiFi, or RS-232 and may be either direct or via a network such as the Internet.

A set of calibration indicators and/or oral features in an oral mapping may be used to facilitate oral procedures, such as the design, manufacture, selection, and/or application of bridges, crowns, braces, retainers, dentures, and the like.

A set of calibration indicators and/or oral features in an oral mapping may be communicated to a user, such as the individual; an individual's parent, guardian, or custodian; an individual's healthcare provider, such as a physician, dentist, orthodontist, endodontist, and/or dental hygienist; and/or a vendor of the oral apparatus, such as oral apparatus manufacturers and/or suppliers of automated dentistry devices or supplies for such devices, including appliance tools 690 or spare floss. In such circumstances, care must be taken to safeguard the privacy of the individual, such as conditioning the release of information upon the informed consent of the individual; refraining from releasing such information in the absence of consent; limiting the scope of released information to the purpose of the third-party disclosure; anonymizing disclosed information that may not be necessary for the disclosure, such as removing personal identifiers or substituting a pseudonym for personally identifying information; and/or revoking or deleting personal information upon withdrawal or cancellation of informed consent. Persons of ordinary skill in the art may devise many such uses of the calibration indicators of a calibration 708 and/or oral features of an oral mapping in accordance with the present disclosure.

### E. Calibration and/or Mapping Sensors and Analysis Techniques

An oral apparatus may include a variety of sensors 685 to perform a calibration 708 and/or oral mapping. Examples of such sensors and mechanisms may include, for example and without limitation: current sensors; voltage sensors; force sensors; light sensors, pressure sensors; strain gauges; capacitive sensors, which may be capable of detecting proximity to a tooth or soft tissue; torque sensors that determine a torque of an actuator; magnetic, electrical, and/or optical encoders and/or etched patterns on linear actuators or rotary actuators; rotary load cells; ranging sensors that determine a position of a first portion of the automated oral appliance through various modalities (e.g., sonic or electromagnetic), and that determine distance through triangulation or distance estimation with respect to a second portion of the automated oral appliance and/or with respect to one or more physiological features 706 of the individual; linear and/or rotary potentiometers that may exhibit a variable resistance and/or reactance in relation to a position of the automated oral appliance or appliance tool 690; two- and three-dimensional cameras; laser detectors; laser line cameras; three-dimensional camera arrays; three-dimensional scanning appliance tools 690 that may scan a shape of an oral feature; sonic or ultrasound sensors; white light emitters to illuminate teeth and/or gums for color detection; LIDAR sensors; image and sound processors; orientation sensors, such as inertial measurement units (IMUs) featuring accelerometers, gyroscopes, magnetometers, and the like; contact sensors, switches, microswitches, and/or stops that may be detected (e.g., mechanically, electrically, and/or magnetically) to indicate the arrival of the automated oral appliance and/or appliance tool 690 at a particular position (including orientation); Hall effect sensors and/or reed switches that detect fluctuation of a magnetic field due to the proximity of a static or movable part to a magnet or electromagnet; optical beams and beam detectors; magnetometers; image sensors, such as cameras, that may visually identify a state of the automated oral appliance; and the like. An oral apparatus may include a magnetic, electrical, contact, and/or optical index sensor (for example, on an actuator rod) and may be configured to detect an actuator home, neutral, and/or zero position without a hard stop. The oral apparatus may include a notch on an actuator end, which may be correlated with the index sensor, and/or a small laser-cut hole on the rod flange. In various examples, one or more of the sensors may be located, for example, in a body of an example automated oral appliance 689, an appliance tool 690 of an example automated oral appliance 689, a tool connected to such an appliance tool 690, a separate component that interoperates with the example automated oral appliance 689 (such as a different device that is in wireless communication with the example automated oral appliance 689), etc., or a collection of such positions.

An oral apparatus may use a variety of analysis techniques for the calibration 708 and/or oral mapping. Examples of such analysis techniques may include, for example and without limitation: image analysis using images captured by visible light, ultraviolet, infrared, or other wavelengths; sound analysis, such as ultrasonic ranging; LIDAR mapping; and medical imaging analysis, such as computed tomography (CT), magnetic resonance imaging (MRI), and optical coherence tomography (OCT). An oral apparatus may be configured to use such analysis techniques in order to detect features directly and/or indirectly. For example, an oral apparatus may include a sensing detection mechanism based on a value or value difference of a current, voltage, resistance, reactance, power, etc. of an actuator such as a motor, or of another component of a circuit that fluctuates in response to the actuator, such as the current output of a power source 687.

An oral apparatus (for example, in an appliance tool 690 of an automated oral appliance) may include one or more sensors, actuators, analysis techniques, and/or control techniques to be used for the calibration 708 and/or mapping before, during, and/or after other oral tasks, such as brushing, flossing, rinsing, and/or dispensing mouthwash. An oral apparatus may include a set of sensors, actuators, analysis techniques, and/or control techniques for both calibration 708 and oral mapping. An oral apparatus may include different sets of sensors, actuators, analysis techniques, and/or control techniques for different tasks. An oral apparatus may include a first set of components (such as sensors, actuators, analysis techniques, and/or control techniques) that are usable for calibration 708 and a second set of components (such as sensors, actuators, analysis techniques, and/or control techniques) that are usable for oral mapping, wherein zero or more components may be usable for one or both of the calibration 708 and oral mapping. An oral apparatus may include a discrete component for calibration 708 and oral mapping, such as a first appliance tool 690 that includes components (such as sensors, actuators, analysis techniques, and/or control techniques) for the calibration 708 and/or oral mapping of the oral cavity 691 of the individual and a second appliance tool 690 that includes another set of components (such as sensors, actuators, analysis techniques, and/or control techniques) for oral tasks such as brushing, flossing, rinsing, and/or dispensing mouthwash. Still other components (such as sensors, actuators, analysis techniques, and/or control techniques) may be provided for use by the oral apparatus for other tasks. As an example, a third appliance tool 690 may include more detailed sensors (e.g., high-resolution cameras or LIDAR sensors) that are usable for particular tasks, such as scanning the oral cavity of the individual for evaluation and/or the design of appliances such as bridges, crowns, braces, retainers, dentures, and the like.

### F. User Interface and User Experience

During and after a calibration 708 and/or oral mapping, an oral apparatus may be configured to communicate with a user, such as the individual, in a variety of ways.

An oral apparatus may be configured to perform a calibration 708 and/or oral mapping based on a detection of a readiness of the individual, such as detecting that the individual has turned on the device, pressed a button on the device, inserted an oral mouthpiece, or gestured such as by nodding the head. The oral apparatus may detect such readiness during operations within the calibration 708 and/or oral mapping, such as verifying that the individual is ready to transition from the calibration 708 to the oral mapping.

An oral apparatus may be configured to instruct a user, such as the individual, about the oral apparatus, the calibration 708, and/or the oral mapping. For example, the oral apparatus may provide verbal instructions or audio cues to the individual that facilitate the calibration 708 and/or the oral mapping, such as opening or closing the oral cavity, keeping the head and oral cavity still, and/or positioning the tongue to reduce interference with an automated oral appliance.

An oral apparatus may be configured to inform the user of the progress of the calibration 708 and/or oral mapping, for example, by visual or other audio cues. For example, an oral apparatus may include a visual progress indicator, such as a continuous or segmented progress bar, clock, or hourglass, which may indicate to the user the progress of the calibration 708 and/or oral mapping toward completion. An oral apparatus may include audio output, and may output a song, a tone, or narrative output that indicates the progress of the calibration 708 and/or oral mapping toward completion.

An oral apparatus may be configured to monitor a state of the oral apparatus, such as a battery level, a cleaning or maintenance status, and/or a fault condition. The oral apparatus may be configured to present visual, audial, haptic, and/or messaging cues to the user regarding the state of the oral apparatus, such as a request to charge the battery of the oral apparatus and/or instructions for a cleaning or maintenance task, such as replacing the appliance tool 690 in the event of a detected breakage of a length of floss. During the calibration 708 and/or oral mapping, the oral apparatus may be configured to occupy the user, such as by playing music or providing verbal information such as trivia or a portion of an audiobook. During the calibration 708 and/or oral mapping, the oral apparatus may be configured to permit the user to customize the music or presented information.

During the calibration 708 and/or oral mapping, the oral apparatus may be configured to receive feedback from a user such as the individual, such as an indication that operations of the calibration 708 and/or oral mapping were performed well or poorly, and/or an indication of sensitivity or pain of some oral features, such as a particular tooth or pocket, or of some operations, such as probing a particular tooth or pocket. Based on such individual feedback, the oral apparatus may adapt the calibration 708 and/or oral mapping (e.g., refraining from mapping or contacting a particular tooth or pocket) and/or may store an instruction for such adapting for future instances of the calibration 708 and/or oral mapping (e.g., an instruction to refrain from mapping or contacting a particular tooth or pocket in the future).

### G. Safety Features

An oral apparatus may include a number of safety features in order to validate the calibration indicators received during a calibration 708 and/or the oral features received during an oral mapping; to detect the occurrence of faults and to perform corrective, compensatory, and/or preventive responsive operations; and/or to maintain safe operation of the oral apparatus for the individual.

An oral apparatus may include multiple sensors, which may be of the same, similar, and/or different types, and which may provide data that may be consistent when the oral apparatus is operating correctly and safety. The oral apparatus may receive and compare the data determined by the multiple sensors to determine that the oral apparatus is operating correctly and safety, or, if the data is not consistent, may invoke one or more fault detection and/or fault recovery processes. Multiple sensors may provide the same or similar measurement (that is, redundant sensors), and the oral apparatus may be configured to compare the data from the multiple sensors to determine whether the data is the same or similar (indicating correct and/or safe operation) or different (indicating a fault condition). Different sensors may provide the same or similar property in different ways (e.g., different forms of position and/or orientation measurement), and the oral apparatus may be configured to compare the data from the different sensors to determine whether the data is the same or similar (indicating correct and/or safe operation) or different (indicating a fault condition). Such determinations and/or comparisons may occur consecutively (e.g., a comparison between first data of a first sensor detected at a first time and second data of a second sensor detected at a second, following time) and/or concurrently (e.g., a comparison between first data of a first sensor and second data of a second sensor, both being detected at one time) As a first such example, an oral apparatus may include a first sensor that is configured to determine a position and/or orientation of the oral apparatus with respect to a first primary reference point 707 (such as the superior labial frenulum) and a second sensor that is configured to determine a position and/or orientation of the oral apparatus with respect to a second primary reference point 707 (such as the lower labial frenulum), and the oral apparatus may be configured to compare the determinations to verify that the different sensors indicate the same or similar position and/or orientation of the oral apparatus, at least within a range of sensor measurement error. As a second such example, an oral apparatus may include a backup time-of-flight sensor that provides another form of position and/or orientation measurement (e.g., an absolute in/out position measurement), and may be configured to compare the backup time-of-flight sensor with data from other sensors that also indicates position and/or orientation.

An oral apparatus may use a second sensor in lieu of a first sensor, for example, in the event that a first sensor becomes unresponsive, fails to provide data, and/or provides data that is inconsistent or unreliable.

An oral apparatus may include additional components that monitor and/or serve as a backup for other components. An oral apparatus may include a second memory, for example, capacitor- or battery-reservoir protected memory, and may be configured to store calibration indicators and/or oral features for recovery in the event of a failure of another component of the oral apparatus, such as a first memory.

An oral apparatus may include a second microcontroller that may be configured to receive, examine, store, and/or transmit to another device (such as cloud storage) the position and/or orientation data of the oral apparatus. In the event of a failure, such as a software fault or power glitch, a first microcontroller may reset and/or lose stored position and/or orientation data. The oral apparatus (e.g., via the second microcontroller) may be configured to detect the failure of the first microcontroller, and, based on detecting the failure, to continue operation using such data, to pause operation, to store the calibration and/or mapping data until the fault is remedied (e.g., the first microcontroller resumes operation and/or is replaced).

An oral apparatus may be configured to verify a readiness of the before performing a calibration 708 and/or oral mapping based on a detection of a readiness of the individual, such as by detecting that the individual has turned on the device, pressed a start button on the device, inserted an oral mouthpiece, closed the oral cavity, or affirmatively gestured such as by nodding the head.

An oral apparatus may be configured to verify an orientation of the oral apparatus and/or the individual before and/or during the calibration 708 and/or oral mapping. For example, an oral apparatus may include an accelerometer that detects the orientation of the oral apparatus as an indicator of the posture of the individual, for example, whether the individual is upright and ready to use the oral apparatus, or whether the individual is prone, supine, lying on one side, or the like, in which the use of the oral apparatus to perform the calibration 708 and/or oral mapping could be inaccurate and/or unsafe. In the latter case, the oral apparatus may delay and/or refrain from performing the calibration 708 and/or oral mapping until the individual is upright. The oral apparatus may provide instructions (for example, verbal instructions) to a user such as the individual regarding the posture of the individual during use of the oral apparatus. Such verbal instructions may include, for example, an explanation that the oral apparatus is only usable while the individual is upright and/or a warning to use the oral apparatus only while the individual is upright.

An oral apparatus may be configured to detect an unreadiness or stop condition before or during a calibration 708 and/or oral mapping, such as by detecting that the individual has turned off the device, pressed a stop button on the device, removed an oral mouthpiece, opened the oral cavity, or negatively gestured such as by shaking the head. The oral apparatus may respond to such unreadiness or stop conditions by stopping or refraining from initiating a calibration 708 or oral mapping. An oral apparatus may include sensors that determine when the oral cavity of an individual is open, for example, electrical contacts that are in contact only when the oral cavity is sufficiently closed and/or that are in contact only when the oral cavity is not sufficiently closed. Based upon a detection of electrical continuity or absence of electrical continuity between the contacts, the oral apparatus may be configured to determine that the oral cavity of the individual is closed and that the calibration 708 and/or oral mapping may be performed, or that the oral cavity of the individual is open, based upon which the oral apparatus may stop, pause, and/or refrain from performing the calibration 708 and/or oral mapping.

During and/or after a calibration 708, an oral apparatus may be configured to validate the results of the calibration 708, for example, based on matching or mismatching calibration indicators detected during the calibration 708 to verify correspondence with other calibration indicators and/or device specifications. As a first such example, a depth actuator 679 may detect a premature stop during a traversal of the reach axis 692. As a second such example, a linear actuator such as a depth actuator 679 may fail to detect an expected stop, such as a current draw for a period that is longer than the period of a full range traversal of the reach axis 692. As a third such example, the oral apparatus may be configured to detect an inconsistency or mismatch between sensor readings that is not physically valid and/or that does not match expected values. As a fourth such example, the oral apparatus may be configured to detect an inconsistency or mismatch between sensors that determine similar properties of an oral apparatus (such as the example oral appliance 678 of FIG. 89), such a first sensor and a second sensor that report different positions of an automated oral appliance along a reach axis 692. As a fifth such example, an oral apparatus may be configured to detect a mismatch between a first set of calibration indicators and a second set of calibration indicators, for example, a current instance of the calibration 708 and a previous instance of the calibration 708. As a sixth such example, the oral apparatus may be configured to receive an indication of a fault condition from a user such as the individual during the calibration 708, such as a detection of a stop button or a user action such as shaking the head, opening the oral cavity, and/or withdrawing the oral apparatus from the oral cavity. These and other fault conditions may indicate, for example, a blockage along an axis, mechanical damage, an overpower condition such as a short, an underpower condition such as a battery failure, a faulty actuator or sensor, memory corruption, undue movement of the oral apparatus or the oral features of the individual during the calibration 708, individual discomfort, and the like.

An oral apparatus may include contacts (for example, spring finger electrical contacts) and may be configured to detect when a mating between the spring jaws and a leadscrew is overpowered (for example, due to a fall or damage resulting therefrom) and/or pushed apart (for example, due to physical misuse). Based on such detection, the oral apparatus may be configured to shut down and/or to perform a second instance of the calibration 708 at a later time, for example, after removal and/or reinsertion into the oral cavity of an individual.

An oral apparatus may include an appliance tool 690 including a flag and/or flap, which may provide an index position as a calibration oral feature, for example, in relation to a stop.

During and/or after an oral mapping, an oral apparatus may be configured to validate the results of the oral mapping. As a first such example, the oral apparatus may be configured to evaluate the oral features of the oral mapping for internal consistency, for example, ensuring that the tooth profile oral features for different teeth do not overlap in a manner suggesting that such teeth occupy the same physical space. As a second such example, the oral apparatus may be configured to evaluate the oral features of a first mapping for consistency with the oral features of a second mapping, for example, to ensure that the oral features of a current mapping for an individual is not substantially and implausibly different than the oral features of a previous mapping for the same individual. As a third such example, the oral apparatus may be configured to evaluate the oral features of an oral mapping with a reference set of oral features, such as an oral mapping of an average individual or of another individual whose oral features is likely to be similar to that of the individual. As a fourth such example, the oral apparatus may be configured to receive an indication of a fault condition from a user such as the individual during the oral mapping, such as a detection of a stop button or a user action such as shaking the head, opening the oral cavity, and/or withdrawing the oral apparatus from the oral cavity. These and other fault conditions may indicate, for example, a faulty actuator or sensor, memory corruption, undue movement of the oral apparatus or the oral features of the individual during the oral mapping, user discomfort, and the like.

An oral apparatus may diagnostically test various components, such as actuators, sensors, memory, power sources 687, and processing circuitry 686, in order to detect and respond to faults in a proactive manner, such as before an individual begins the calibration 708, an oral mapping, or an oral operation such as an automated flossing program. For example, the oral apparatus may run one or more self-test diagnostics upon being powered on, during moments when one or more such components are idle, periodically, upon request of a user, and/or in response to various conditions, such as detecting unexpected behavior of a component or unexpected data.

The processing circuitry 686 of an oral apparatus may be configured to evaluate and verify the integrity of the oral apparatus. The oral apparatus may be configured to determine, using internal light sensors and/or moisture sensors, the integrity of the sealed device against infiltration of fluids or contaminants, such as water, saliva, dirt, food, and/or lubricants. Upon detecting the presence of such moisture or contamination and/or the failure of a seal, the processing circuitry 686 of the oral apparatus may be configured to refrain from performing a calibration 708 and/or oral mapping, to stop a calibration 708 and/or oral mapping that is in progress, and/or to inform a user of a corrective measure to be taken.

The processing circuitry 686 of an oral apparatus may be configured to determine that an appliance tool 690 is present and/or intact, for example, that a length of floss is present and unbroken. As a first such example, the processing circuitry 686 may be configured to detect whether an appliance tool 690 is connected to an example automated oral apparatus 689, for example, based on a button depressed by the appliance tool 690, a detection of a magnet present in the appliance tool 690, and/or an electrical contact between the appliance tool 690 and the example automated oral apparatus 689. The processing circuitry 686 may be configured to determine a failure to detect the appliance tool 690 as a fault condition. As a second such example, an appliance tool 690 may include a strain gauge that detects and provides an output based on a strain of a length of floss that is held taut in the appliance tool 690, and the processing circuitry 686 may be configured to determine that the floss is absent and/or broken if the detected strain is not adequate (for example, below a threshold) as a fault condition. As a third such example, an automated oral appliance may be configured to position the appliance tool 690 at a point at which contact is predicted between the length of floss held by the appliance tool 690 and a surface of a tooth or another physiological feature 706, and to determine that the floss is absent and/or broken if a sensor 685 (such as a pressure sensor or a current sensor of an actuator) fails to detect resistance at the contact point. The processing circuitry 686 of the oral apparatus may be configured to identify the determination that a component such as dental floss is not present and/or is broken as a fault condition.

The processing circuitry 686 of an oral apparatus may be configured to determine that the components of the oral apparatus are authentic, for example, that an appliance tool 690 and/or a length of floss secured thereby are provided by a manufacturer and/or supplier of the oral apparatus, rather than being differently manufactured, provided, and/or modified, for example, by holding a length of floss of a different material such as metal. Such detection may involve, for example, evaluating a tension of the actuators during use of the oral apparatus, such as the tension of the actuators while the floss is pressed against a tooth of the individual, which may indicate the material and/or tension of the floss secured by the appliance tool 690. The processing circuitry 686 of the oral apparatus may be configured to identify the presence of an unauthentic component as a fault condition.

The processing circuitry 686 of an oral apparatus may be configured to determine a liquid level of a liquid in a container of the oral apparatus, such as mouthwash and/or rinsing fluid in a compartment or tank of the oral apparatus. The processing circuitry 686 may be configured to identify an insufficient liquid level (for example, below a threshold level) as a fault condition.

The processing circuitry 686 of an oral apparatus may be configured to determine a power level of a power source of the oral apparatus, such as a battery, a capacitor, a solar panel, and/or a wall source. The processing circuitry 686 may be configured to identify an insufficient power level (for example, below a threshold level) as a fault condition.

The processing circuitry 686 of an oral apparatus may be configured to evaluate and verify calibration indicators, oral features, and/or components before, during, and/or after a calibration 708, mapping, or other operation. In some such examples, a separate safety coprocessor may be included in an oral apparatus with a dedicated task of evaluating the calibration indicators, oral features, and/or component behavior, such as ensuring that actuator voltages or currents remain within an acceptable range and/or that the physical position of an automated oral appliance or appliance tool 690 does not enter unsafe places inside the oral cavity of the individual, such as the back of the throat. In case the processing circuitry 686 detects such a condition, the processing circuitry 686 may cancel an operation, apply a compensatory operation (such as retracting the automated oral appliance along the reach axis 692), enter a fault state, and/or stop the oral apparatus until the condition is resolved. In case a safety coprocessor detects such a condition, the safety coprocessor may cancel or override an operation of other processing circuitry 686, apply a compensatory operation, cause the automated oral appliance to enter a fault state, and/or stop the oral apparatus until the condition is resolved.

Based upon passing verification of the calibration indicators of a calibration 708 and/or the oral features of an oral mapping, the oral apparatus may be configured to proceed with a next operation, such as an automated flossing program. Based upon failing verification of the calibration indicators and/or oral features, the oral apparatus may respond in various ways.

In response to detecting a fault condition of a calibration 708 and/or oral mapping, the oral apparatus may be configured to refrain from performing a calibration 708 and/or oral mapping; to pause or stop a calibration 708 and/or oral mapping that is in progress; to restart, reinitiate, and/or re-attempt the calibration 708 and/or the oral mapping; and/or to enter a fault state, for example, moving an appliance tool 690 to a home, neutral, and/or zero position. An oral apparatus may be configured to inform a user of a corrective measure to be taken to address the fault condition; to initiate an interactive process with the user to address the fault condition; to monitor a condition of the oral apparatus to detect resolution of the fault condition; and/or to inform the user of the resolution of the fault condition.

In response to detecting a fault condition of a calibration 708 and/or oral mapping, the oral apparatus may be configured to invoke a fault recovery algorithm. For example, the oral apparatus may be configured to check battery-backed up SRAM for calibration indicators and/or oral features of an oral mapping; to ask a coprocessor for a status and/or coordinates; to test limit sensors; to test actuators along various axes, such as pivoting the appliance tool 690; and/or to interact with a user, for example, to ask the user to position the oral apparatus in a particular manner and/or to indicate its position and/or orientation.

In response to detected fault conditions, the oral apparatus may be configured to attempt to perform the calibration 708 and/or mapping in a different manner, such as more slowly or as a more complete version of the calibration 708 and/or mapping. The oral apparatus may perform the calibration 708 and/or mapping in an incremental manner, such as performing individual calibration and/or mapping operations (such as mapping one tooth or one pair of teeth), and may validate the results of each individual operation. The oral apparatus may communicate with a user such as the individual while performing the calibration and/or mapping, or individual calibration and/or mapping operations, and may receive, respond to, and/or incorporate responses from the user in the completion of such operations. An automated oral appliance may map each tooth and/or pocket and may verify with the user such as the individual that the oral mapping is accurate before proceeding to a next mapping. For example, if an oral mapping does not successfully complete, the oral apparatus may provide to the user an option to execute the oral mapping one tooth at a time and to press one button (indicating “good”) or another button (indicating “bad”) to provide feedback to the oral apparatus about the accuracy of the oral mapping. For teeth that are identified as “bad,” the oral apparatus may apply different variations of the oral mapping of the tooth (for example, different positions and/or rotations of the appliance tool 690) in order to determine the oral mapping of the tooth.

In response to detecting such fault conditions, the oral apparatus may be configured to log the fault condition and/or notify the individual or a user such as a parent, healthcare provider, and/or vendor of an oral apparatus.

In response to detecting such fault conditions, the oral apparatus may be configured to compensate for the fault condition, for example, by operating the actuators at a lower power level, by circumventing a faulty actuator by using a substitute set of actuator controls that achieve the same or similar movements by using only the other actuators, or by circumventing a faulty sensor and using other sensors to retrieve similar calibration indicators and/or oral features.

In response to detecting such fault conditions, the oral apparatus may be configured to interact with the individual to identify, diagnose, resolve, and/or address the cause of the fault, such as by asking the individual to clean, lubricate, or service the oral apparatus and to request recalibration and/or mapping after cleaning the oral apparatus. Upon completion of the oral mapping, the oral apparatus may provide instructions to a user such as the individual to remove, clean, and/or store the oral apparatus.

Different fault conditions may prompt different responses. For example, a first fault condition, such as a physical miscalibration that may indicate a blockage, may result in an emergency stop mechanism or an urgent alert, in case continuing calibration might damage the oral apparatus and/or injure the individual. A second fault condition, such as an undervoltage detection, may indicate a low-battery condition that results in a notification to the individual, continuing the calibration 708, or pausing the calibration 708 until the low-battery condition is addressed. In response to detecting a low-priority fault condition, the oral apparatus may disregard the fault condition.

### H. Some Example Embodiments

The following description presents some examples in which the subject matter of the present disclosure may be embodied. However, the following description is intended to be only some examples. Those of ordinary skill in the part will appreciate that various aspects of the disclosure may be embodied in many different forms, and all such forms are contemplated to be within the scope of the disclosure.

### H1. First Example Method

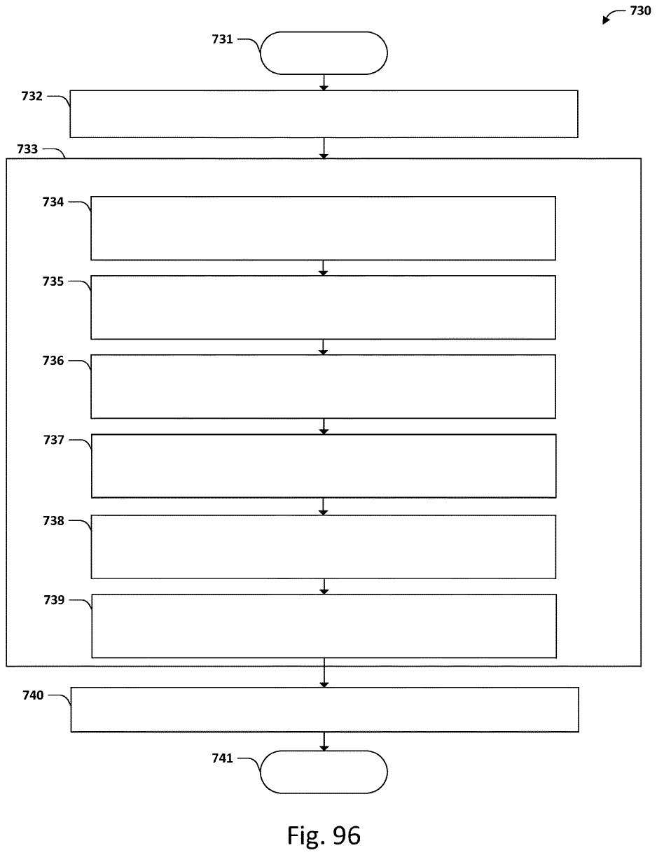

FIG. 96 is a flowchart diagram of a first example method 730 of mapping an oral cavity of an individual using an apparatus positioned inside the oral cavity,

The first example method 730 may be implemented, for example, as a set of instructions that, when executed by processing circuitry of an apparatus, cause the apparatus to perform each of the elements of the first example method 730.

The first example method 730 begins at 731 and includes establishing 732 a primary reference point.

The first example method 730 includes collecting 733 a set of oral features by one or more of the following operations: Detecting 734 at least one upper front reference point and at least one lower front reference point; detecting 735 at least one upper opposing plane start reference point and at least one lower opposing plane start reference point; detecting 736 at least one upper inner reference point and at least one lower inner reference point; detecting 737 at least one upper opposing plane reference point and at least one lower opposing plane reference point; detecting 738 at least one tooth opposing surface of at least one tooth; and detecting 739 at least one pocket between at least one pair of adjacent teeth.

The first example method 730 includes storing 740 the set of oral features as an oral mapping of the oral cavity of the individual.

In this manner, the operations included in the first example method 730 may produce an oral mapping, and so the example method 730 ends at 741.

### H2. Second Example Method

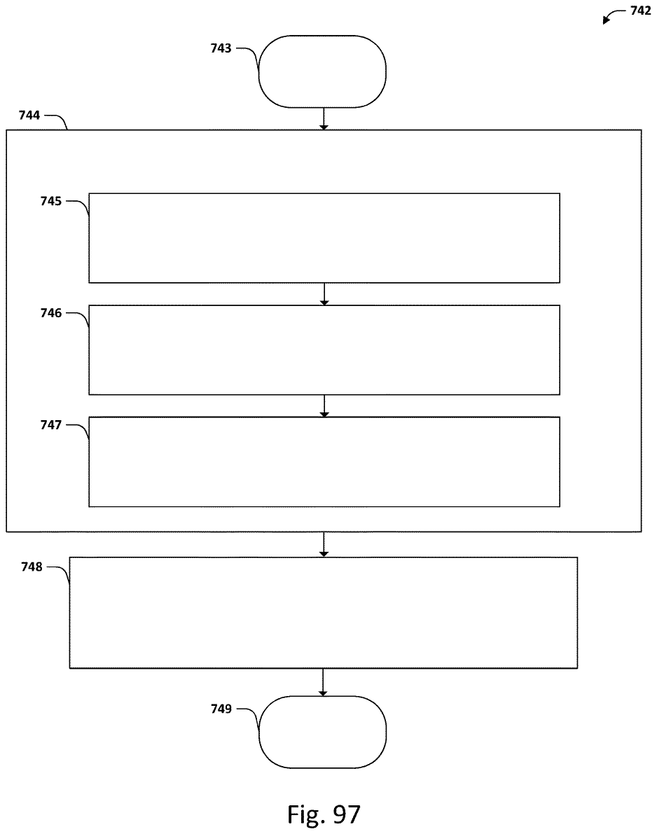

FIG. 97 is a flowchart diagram of a second example method 742 of mapping an oral cavity of an individual using an apparatus positioned inside the oral cavity.

The second example method 742 may be implemented, for example, as a set of instructions that, when executed by processing circuitry of an apparatus, cause the apparatus to perform each of the elements of the second example method 742.

The second example method 742 begins at 743 and includes collecting 744 a set of oral features by one or more of the following operations: Detecting 745 a set of oral cavity structures; detecting 746 at least one tooth surface of at least one tooth; and detecting 747 at least one pocket between at least one pair of adjacent teeth.

The second example method 742 includes storing 748 an oral mapping as a set of oral features.

In this manner, the operations included in the second example method 742 may produce an oral mapping, and so the example method 742 ends at 749.

### H3. Example Apparatus

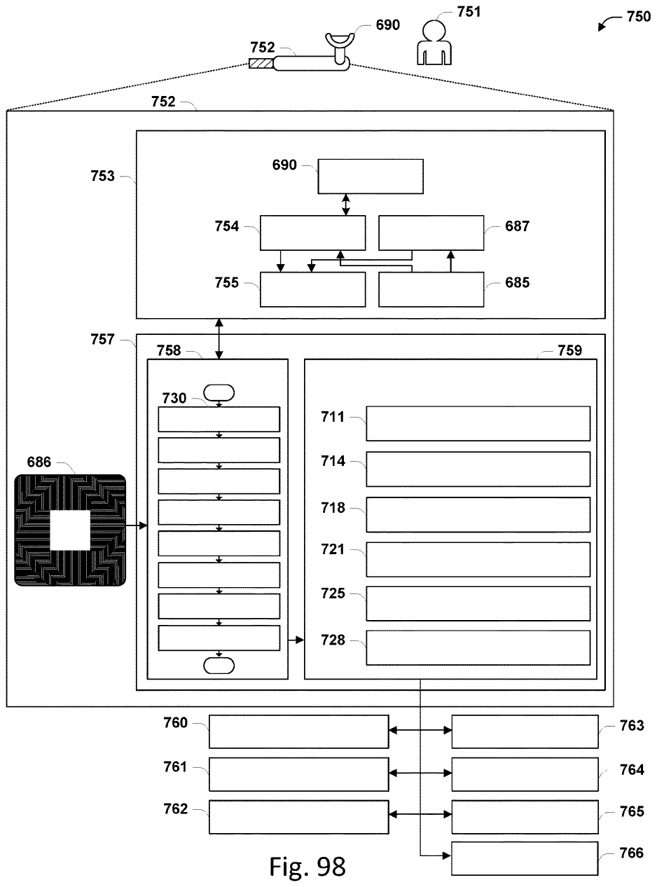

FIG. 98 is a component block diagram 750 of an example oral appliance 752 configured to map an oral cavity of an individual 751.

As shown in FIG. 98, an example oral appliance 752 may include a set of hardware 753, such as an appliance tool 690 and at least one actuator 755. The hardware 753 may include an actuator set including one or more of a depth actuator 679 including a linear actuator configured to move the appliance tool 690 along a reach axis 692, a vertical actuator 680 including a rotary actuator configured to provide a pitch rotation 693 to the appliance tool 690, a lateral actuator 681 including a rotary actuator configured to provide a yaw rotation 694 to the appliance tool 690, an arm rotation actuator 682 including a rotary actuator configured to provide a roll rotation 695 to the appliance tool 690, and a tool rotation actuator 683 including a rotary actuator configured to provide a rotation 696 to the appliance tool 690.

The oral appliance 752 may include at least one sensor 685, such as a current sensor.

The oral appliance 752 may include a power source 687 and input/output hardware 754, such as a bus.

The oral appliance 752 may include processing circuitry 686 and memory 757 storing a set of instructions 758 that, when executed by the processing circuitry 686, cause the oral appliance 752 to map the oral cavity of an individual 751 by operating the actuators 755 and monitoring the sensors 756 to generate an oral mapping 759, such as in the example calibration of FIG. 92 and/or the example oral mapping of FIGS. 93 through 95.

The oral appliance 752 may include memory 757, for example, random-access memory (RAM), read-only memory (ROM), an erasable programmable read-only memory (EPROM), an electrically erasable programmable read-only memory (EEPROM), and the like. The memory 757 may be volatile, such as system memory, and/or nonvolatile, such as a hard disk drive, a solid-state storage device, flash memory, or magnetic tape. The instructions 758 stored in the memory 757 may be specified according to a native instruction set architecture of a processor, such as a variant of the IA-32 instruction set architecture or a variant of the ARM instruction set architecture, as assembly and/or machine-language (e.g., binary) instructions; instructions of a high-level imperative and/or declarative language that is compilable and/or interpretable to be executed on a processor; and/or instructions that are compilable and/or interpretable to be executed by a virtual processor of a virtual machine, such as a web browser. Such instructions 758 may also include instructions for a library, resource, platform, application programming interface (API), and the like that is utilized in the generation of an archive package.

The oral mapping 759 may be stored in the memory 757 and may include one or more of, for example, at least one upper and/or lower front reference point 711; at least one upper and/or lower opposing plane start reference point 714; at least one upper and/or lower inner reference point 718; at least one upper and/or lower opposing plane reference point 721; at least one upper and/or lower tooth opposing surface 726; and/or at least one upper and/or lower pocket 728. The oral mapping 759 may include at least one tooth surface of at least one tooth, at least one pocket between at least one pair of adjacent teeth, and an oral mapping as a set of oral features.

An oral appliance 752 that is configured to generate and/or store an oral mapping 759 as disclosed herein may be further configured to use the oral mapping 759 in a variety of ways. The oral appliance 752 may be configured to present the oral mapping 759 on a display device 760 of the oral appliance 752 and/or of another device, such as an LCD, LED, OLED, and/or projector display. The oral appliance 752 may be configured to transmit the oral mapping 759 to an oral analysis device 761, such as a device that evaluates the oral mapping 759 to design one or more bridges, crowns, braces, retainers, dentures, and the like. The oral appliance 752 may be configured to transmit the oral mapping 759 to an oral cleaning device 762, such as a device that performs one or more personal oral tasks such as brushing, flossing, rinsing, mouthwash dispensing, and the like. The oral appliance 752 may include and/or be included by an oral analysis device 761 and/or oral cleaning device 762, while in some other examples, the oral appliance 752 and the oral analysis device 761 and/or oral cleaning device 762 may be different devices. The oral appliance 752 may be configured to present and/or transmit the oral mapping 759 to a user 763, such as the individual 751, a parent or guardian of the individual 751, and the like. The oral appliance 752 may be configured to present and/or transmit the oral mapping 759 to a healthcare provider 764 of the individual 751, such as a dentist, orthodontist, endodontist, dental hygienist, and the like. The oral appliance 752 may be configured to present and/or transmit the oral mapping 759 to an oral apparatus manufacturer 765 and/or consumables vendor 766 of the oral appliance 752 and/or accessories such as appliance tools 690 or spare floss. Many such uses of the oral mapping 759 may be devised and included in the oral appliance 752.

Components of an apparatus such as the oral appliance 752 may be organized in a particular manner, for example, to allocate some functionality to each component of a system. Some examples may implement each such component in various ways, such as software, hardware (e.g., processing circuitry), or a combination thereof. The organization of the system may vary as compared with some other examples. Examples may include a system featuring a different organization of components, such as renaming, rearranging, adding, partitioning, duplicating, merging, and/or removing components, sets of components, and interrelationships, without departing from the scope of the present disclosure. All such variations that are reasonably technically and logically possible, and that are not contradictory with other statements, are intended to be included in this disclosure, the scope of which is to be understood as being limited only by the claims.

Many aspects of the disclosure are described in terms of sequences of actions to be performed by elements of a computer system or other hardware capable of executing programmed instructions, for example, a general-purpose computer, special purpose computer, workstation, or other programmable data process apparatus. An apparatus may include processing circuitry that is capable of executing instructions. The processing circuitry may include, for example, logic circuits; a hardware/software combination, such as a processor executing software; or a combination thereof. For example, a processor may include, but is not limited to, a central processing unit (CPU), a graphics processing unit (GPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. Some examples may include a combination of components of the same and/or different types, such as a plurality of processors and/or processing cores in a uni-processor or multi-processor computer; two or more processors operating in tandem, such as a CPU and a GPU; a CPU utilizing an ASIC; and/or software executed by processing circuitry. Some examples may include components of a single device, such a computer comprising one or more CPUs. Some examples may include components of multiple devices, such as two or more devices having CPUs that communicate. Some examples may include one or more components that are included in a server computing device, a server computer, a series of server computers, server farm, a cloud computer, a content platform, a mobile computing device, a smartphone, a tablet, or a set-top box. Some examples may include components that communicate directly (e.g., two or more cores of a multi-core processor) and/or indirectly (e.g., via a bus, via over a wired or wireless channel or network, and/or via an intermediate component such as a microcontroller or arbiter). Some examples may include multiple instances of systems or instances that are respectively performed by a device or component, where such systems instances may execute concurrently, consecutively, and/or in an interleaved manner. Some examples may feature a distribution of an instance or system over two or more devices or components.

An apparatus may include input device(s) such as keyboard, mouse, pen, voice input device, touch input device, infrared cameras, video input devices, and the like. An apparatus may include output device(s) such as one or more displays, speakers, printers, and the like. Input device(s) and/or output device(s) may be connected to an apparatus via a wired connection, wireless connection, or any combination thereof. An input device or an output device from another computing device may be used as input device(s) or output device(s) for an apparatus.

An apparatus may include one or more communication device(s) by which the apparatus may communicate with other devices. Communication device(s) may include, for example, a modem, a Network Interface Card (NIC), an integrated network interface, a radio frequency transmitter/receiver, an infrared port, a USB connection, or other interfaces for connecting the apparatus to other computing devices, including remote devices. Communication device(s) may include a wired connection or a wireless connection. Communication device(s) may be configured to transmit and/or receive communication media.

An apparatus may include one or more storage devices that are configured to store computer-readable instructions, and that may be distributed across a network. For example, an apparatus may communicate with a remote device via a network to store and/or retrieve computer-readable instructions to implement one or more examples provided herein. An apparatus may be configured to access a remote device to download a part or all of the computer-readable instructions for execution. Alternatively, an apparatus may be configured to download portions of the computer-readable instructions as needed, wherein some instructions may be executed at or by the apparatus and some other instructions may be executed at and/or by the remote device.

Components of an apparatus may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In other examples, components of an apparatus may be interconnected by a network. For example, memory may be comprised of multiple physical memory units located in different physical positions interconnected by a network.

The interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the Bluetooth wireless networking standard (including Core Specification versions 3.0, 4.0, 4.1, 4.2, 5.0, and 5.1 from the Bluetooth SIG).

### H4. Example Computer-Readable Medium

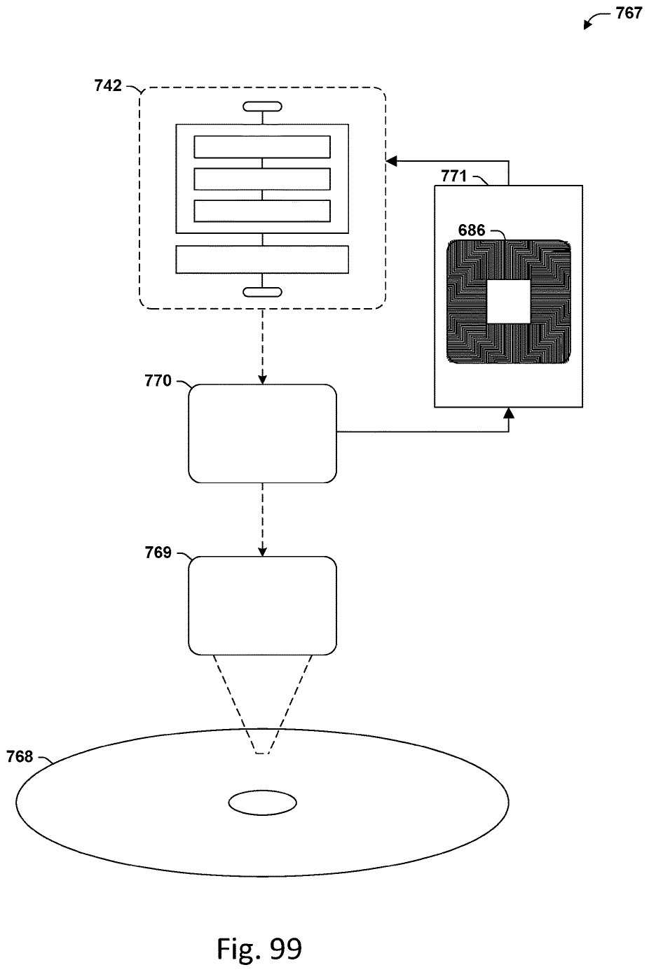

FIG. 99 is a diagram 767 of an example computer-readable medium 768 storing instructions that, when executed by an oral apparatus, may cause the oral apparatus to map an oral cavity of an individual.

As shown in FIG. 99, the example computer-readable medium 768 may store binary data 769 encoding a set of instructions 770 that, when executed by processing circuitry 686 of an apparatus 771 such as an oral apparatus or an automated oral appliance, cause the apparatus 771 to perform an oral mapping in accordance with some examples. As a first such example, the instructions 770 may encode the elements of the first example method, such as the example method 730 of FIG. 96. As a second such example, the instructions 406 may encode the elements of the second example method 742 of FIG. 97. As a third such example, the instructions 770 may encode the elements of the instructions 758 of the oral appliance 752 of FIG. 98.

As used herein, the term “computer-readable medium” may include any tangible form of computer readable carrier, such as solid-state memory, magnetic disk, and optical disk containing an appropriate set of computer instructions, such as program modules, and data structures that would cause a processor to carry out the techniques described herein. Non-limiting examples of “computer-readable media” include nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc), an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (such as EPROM, EEPROM, or Flash memory), or any other tangible medium capable of storing information. As used herein, the term “computer-readable media” excludes transitory electrical or electromagnetic signals propagating through a medium (such as on a carrier wave); the term “computer-readable media” as used thus refers only to considered tangible and/or non-transitory storage devices.

### H5. Other Example Embodiments

An oral apparatus may include at least one actuator; at least one sensor; processing circuitry; and a computer-readable memory storing instructions that, when executed by the processing circuitry, cause the oral apparatus to establish a primary reference point; collect a set of oral features by one or more of, detecting at least one upper front reference point and at least one lower front reference point, detecting at least one upper opposing plane start reference point and at least one lower opposing plane start reference point, detecting at least one upper inner reference point and at least one lower inner reference point, detecting at least one upper opposing plane reference point and at least one lower opposing plane reference point, detecting at least one tooth opposing surface of at least one tooth, and detecting at least one pocket between at least one pair of adjacent teeth; and store the set of oral features as an oral mapping of the oral cavity of the individual.

An automated oral appliance may include an appliance tool; an actuator set including one or more of: a depth actuator including a linear actuator configured to move the appliance tool along a reach axis, a vertical actuator including a rotary actuator configured to provide a pitch rotation 693 to the appliance tool, a lateral actuator including a rotary actuator configured to provide a yaw rotation to the appliance tool, an arm rotation actuator including a rotary actuator configured to provide a roll rotation to the appliance tool, and a tool rotation actuator including a rotary actuator configured to provide a rotation to the appliance tool; processing circuitry; and a memory storing instructions that, when executed by the processing circuitry, cause the oral apparatus to control the actuator set to establish a primary reference point; collect a set of oral features by detecting one or more of: at least one upper front reference point and at least one lower front reference point, detecting at least one upper opposing plane start reference point and at least one lower opposing plane start reference point, detecting at least one upper inner reference point and at least one lower inner reference point, detecting at least one upper opposing plane reference point and at least one lower opposing plane reference point, detecting at least one tooth opposing surface of at least one tooth, and detecting at least one pocket between at least one pair of adjacent teeth; and store the set of oral features as an oral mapping of the oral cavity of the individual.

A controller may be provided to control an oral apparatus featuring a set of actuators in order to map an oral cavity of an individual, where the controller includes processing circuitry and a memory storing instructions that cause the oral apparatus to control the set of actuators to collect a set of oral features by one or more of: detecting a set of oral cavity structures; detecting at least one tooth surface of at least one tooth, and detecting at least one pocket between at least one pair of adjacent teeth, and where the instructions further cause the controller to store the set of oral features as an oral mapping of the oral cavity of the individual.

An apparatus may be provided to map an oral cavity of an individual, where the apparatus includes collecting means for collecting a set of oral features of an oral cavity of an individual, by one or more of: detecting a set of oral cavity structures; detecting at least one tooth surface of at least one tooth, and detecting at least one pocket between at least one pair of adjacent teeth, and storing means for storing the set of oral features as an oral mapping of the oral cavity of the individual. The collecting means may be or may include an automated oral appliance and/or a wired or wireless communication interface for communicating with an automated oral appliance, such as a controller, a network adapter, a Bluetooth adapter, and the like. The storing means may be or may include memory (which may be volatile and/or nonvolatile storage); a memory interface, such as a storage driver or storage layer that communicates with memory; and/or a network interface that communicates with a storage device, such as a memory of another device such as an oral apparatus, a network storage device including a cloud storage device, or the like.

### H6. Other Example Embodiments

FIG. 100 is an illustration of an example robotic dental workstation configured to map the oral cavity of a human or animal subject. A left effector 774 may establish one or more primary reference points 707 by grasping or constraining one or more physiological features of the subject. This could be a single-point reference, for example the chin of the subject, or a multi-point reference, for example, using the palm and fingers of the effector to grasp the subject's chin, while placing the thumb of the effector under the subject's nose in order to obtain a second primary reference point 707 correlated to the degree that the subject's mouth is open.

Alternatively or additionally, one or more of the primary reference points 707 may be determined virtually, without physical contact. For example, LIDAR or 3D stereo computer vision in a scanning unit 775 with the appropriate algorithms (such as neural networks trained on facial features) may identify landmarks on the face, such as the tip of the nose or a chin divot which may be tracked in real-time and serve the purpose of primary reference points.

A right effector 773 is transiently or permanently connected to a probe 772. In this illustration the probe is an elongated member with a semi-rigid elastomeric pick, but other variations are known to those with ordinary skill in the art, such as a simple rod, ordinary toothbrush, floss wand or other tools, which may provide lesser or greater information when used to probe the oral cavity of the subject.

The probe 772 is shown in FIG. 100 extending into the oral cavity of the person. The oral cavity is defined by its surfaces which include the surfaces of the person's lips, gums, palate, tongue, palate, teeth, and cheek inner surfaces. These surfaces define a lower gum pocket between the lower gum and lower lip, in the region below the front lower teeth, and an upper gum pocket between the upper gum and upper lip, in the region above the front upper teeth.

### H7. Third Example Method

FIG. 101 is a flowchart diagram of a third example method of mapping an oral cavity of a subject using an apparatus positioned inside the oral cavity. Said third method utilizes a ‘groove following’ approach to minimize the time required to map said oral cavity.

The third example method may be implemented, for example, as a set of instructions that, when executed by processing circuitry of an apparatus, cause the apparatus to perform each of the elements of the third example method.

The third example method begins by verifying that the subject's mouth is open. This task may be accomplished by various methods such as verbal instruction with or without verbal acknowledgment from the subject, or automated sensing of the position of the subject's lips via means such as 3D stereo computer vision or LIDAR combined with feature detection and classification algorithms.

The third example method includes obtaining one or more primary reference points of the subject's mouth area, as outlined elsewhere in this disclosure, or in the case of FIG. 100, by utilizing the onboard sensors, algorithms and effectors used to detect, classify and manipulate objects, for example those present in the Robot Operating System (ROS) ecosystem.

The third example method includes moving and orienting a probe for general entry into mouth, based on the primary reference points previously obtained, or via other sensing means such as 3D stereo computer vision or LIDAR.

The third example method includes probing the extents of two or more teeth in order to determine the general dimensions of the subject's mouth. In one example implementation, this may be accomplished by orienting the probe downward at a level where it is expected to intersect the front teeth, then slowly moving it forward until position sensors such as optical or magnetic encoders have detected that it has hit an obstruction, or via force sensors which detect the force of the front teeth stopping the probe from moving forward. One of ordinary skill in the art may contemplate other types of sensors to accomplish the same detection feature, such as capacitive touch sensors. In a similar way, the probe may be moved to the estimated center of the mouth (based on a consensus dental model), and then swept left and right to detect the positions of the inner surfaces of the back teeth.

Alternatively or additionally, one or more of the teeth extents may be determined virtually, without physical probing contact. For example, LIDAR or 3D stereo computer vision with the appropriate algorithms (such as neural networks trained on facial features) may identify the subject's teeth and determine basic parameters such as the distance between the left rear molars and the right rear molars. These parameters may be used to adjust a dental model to match the subject's physiognomy.

The third example method includes utilizing the data collected in the previous steps to scale and/or rotate and/or translate a dental model (which may be as simple as a list of relative coordinates of oral features, or as complex as a full point cloud mesh) to best fit measured the measured dimensions and coordinates, as determined by an algorithm such as least squares.

Alternatively or additionally, if the aforementioned probing and fitting steps have previously been performed and a customized dental model of the subject was created and saved, it may be reloaded to improve the speed and quality of the cleaning run by skipping some calibration steps. However, even if a customized dental model is available, some probing of oral surfaces may be required in order to orient the model in 3D space to match the subject's oral cavity positioning.

The third example method includes selecting an initial target pocket at the base of a tooth based on the fitted dental model.

Due to the pocket entrance at the base of a tooth having three walls (formed by the tooth surface descending into the pocket, the surface of the adjacent tooth descending into the pocket, and the surface of the gums descending into the pocket), there is a pocket axis 792 which points towards the center of the pocket, as shown in FIG. 102. FIG. 102 shows a plurality of teeth 790 and the corresponding gums 791. This axis is at the center of the lines which are formed by the intersection of these surfaces, the tooth-tooth line 793, and the two tooth-gum lines 794. If the probe is oriented along this axis and at the bottom of the pocket, then lateral force applied to the probe will not result in any movement. In this way, the center of the pocket may be determined.

The third example method includes orienting the probe along the estimated pocket axis based on the fitted dental model.

The third example method includes moving the probe towards the predicted location of the pocket until contact.

The third example method includes moving the probe laterally while maintaining force in the direction of the pocket axis in order to determine the nadir of the pocket. The applied force should be sufficient to ensure contact with oral cavity surfaces, but not so great as to induce discomfort in the subject. The movement may be at right angles, or random directions or any other scheme, such as first moving laterally at 120 degree angles, then 120 degree angles offset by 60 degrees, then 120 degree angles offset by 30 degrees, and so on. As the probe moves laterally, if the distance along the axis keeps increasing (towards the nadir of the pocket) then the search is continued.

FIG. 102 shows an example groove axis 796 perpendicular to the groove, formed at the center of the intersection of the groove-tooth surface and the groove-gum surfaces. Groove-tooth line 795 is tangent to the tooth surface where it meets the groove and groove-gum line 797 is tangent to the gum surface where it meets the groove. The center of these lines gives groove axis 796 which is the optimal orientation for a probe following the groove, as a deviation from the groove in either direction perpendicular to the direction of travel produces the maximal restoring force.

The third example method includes moving the probe 799 along calculated grooves 798 utilizing the fitted dental model, as shown in FIG. 103, maintaining contact against the oral surface and attempting to keep the probe axis oriented along the groove axis 796, (while avoiding collision with mouth structures and other uncomfortable situations such as excessive cheek stretching). The applied force should be sufficient to ensure contact with oral cavity surfaces, but not so great as to induce discomfort in the subject.

The third example method includes wiggling the probe laterally as the probe is travelling along the predicted groove path, either continuously or periodically. If there is a reduction in resistance when the probe is moved perpendicularly to the groove path, for example as detected by a force sensor directly or via a distance sensor such as an encoder when a constant lateral force is applied to the probe, then this indicates that the probe is no longer in the center of the groove. The processing circuitry may then continue the lateral motion of the probe until the resistance increases again. In this way, the processing circuitry may maintain the probe's motion along the center of the groove. Other variations to maintain the probe's path along the center of the groove path can be envisioned by those of ordinary skill in the art, such as capacitive distance or touch sensors, presence-detecting microswitches, or cameras with image processing capabilities such as OpenCV.

Optionally, during the tracing run, the fitted dental model may be updated with data from the tracing. For example, as each tooth pocket is found, the initial fitting of the dental model may be refined, thereby increasing the accuracy of the predicted grooves. This may either happen in real-time if sufficient computing power is available, or alternatively, the tracing may be paused and the new model recomputed periodically.

Some oral conditions, for example, a missing tooth may cause the tracing to fail or prematurely stop. In these cases, an alternate starting tooth pocket, for example, on the other side of the missing tooth may be chosen by the software and the tracing resumed from that point. The data from the separate tracings may be merged into a unified dental model.

If, after several tries, a complete dental tracing cannot be accomplished, the processing unit may abort the tracing process. The incomplete dental model may be either discarded or saved for manual processing or diagnostic purposes.

The third example method includes storing the customized dental model.

### H8. Fourth Example Method

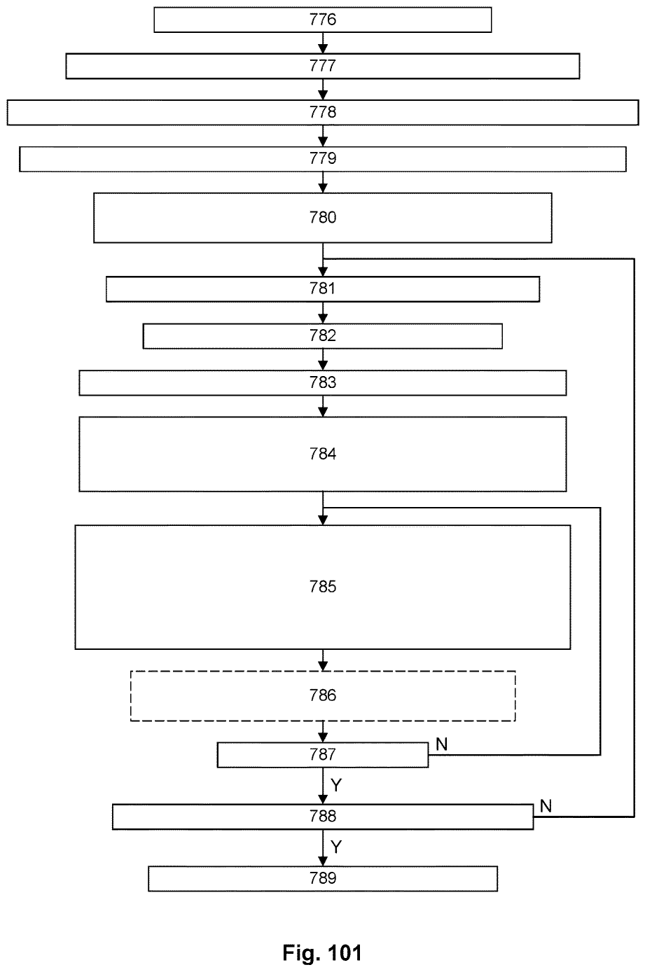

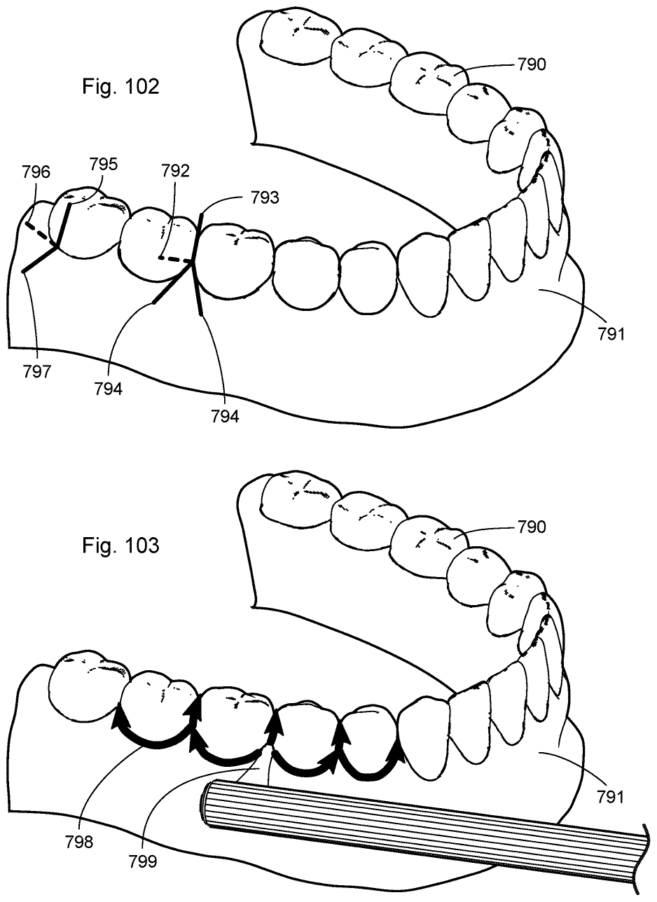

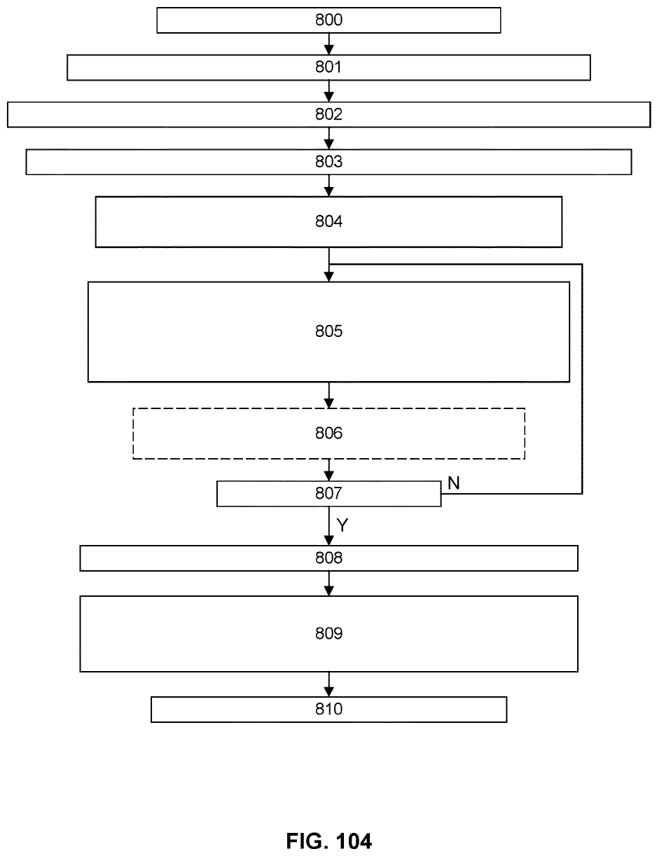

FIG. 104 is a flowchart diagram of a fourth example method of mapping an oral cavity of a subject using an apparatus positioned inside the oral cavity. Said fourth method utilizes a ‘point cloud’ approach to map said oral cavity.

The fourth example method may be implemented, for example, as a set of instructions that, when executed by processing circuitry of an apparatus, cause the apparatus to perform each of the elements of the fourth example method.

The fourth example method begins by verifying that the subject's mouth is open. This task may be accomplished by various methods such as verbal instruction with or without verbal acknowledgment from the subject, or automated sensing of the position of the subject's lips via means such as 3D stereo computer vision or LIDAR combined with feature detection and classification algorithms.

The fourth example method includes obtaining one or more primary reference points of the subject's mouth area, as outlined elsewhere in this disclosure, or in the case of FIG. 100, by utilizing the onboard sensors, algorithms and effectors used to detect, classify and manipulate objects, for example those present in the Robot Operating System (ROS) ecosystem.

The fourth example method includes moving and orienting a probe for general entry into mouth, based on the primary reference points previously obtained, or via other sensing means such as 3D stereo computer vision or LIDAR.

The fourth example method includes probing the extents of two or more teeth in order to determine the general dimensions of the subject's mouth. In one example implementation, this may be accomplished by orienting the probe downward at a level where it is expected to intersect the front teeth, then slowly moving it forward until position sensors such as optical or magnetic encoders have detected that it has hit an obstruction, or via force sensors which detect the force of the front teeth stopping the probe from moving forward. One of ordinary skill in the art may contemplate other types of sensors to accomplish the same detection feature, such as capacitive touch sensors. In a similar way, the probe may be moved to the estimated center of the mouth (based on a consensus dental model), and then swept left and right to detect the positions of the inner surfaces of the back teeth.

Alternatively or additionally, one or more of the teeth extents may be determined virtually, without physical probing contact. For example, LIDAR or 3D stereo computer vision with the appropriate algorithms (such as neural networks trained on facial features) may identify the subject's teeth and determine basic parameters such as the distance between the left rear molars and the right rear molars. These parameters may be used to adjust a dental model to match the subject's physiognomy.

The fourth example method includes utilizing the data collected in the previous steps to scale and/or rotate and/or translate a dental model (which may be as simple as a list of relative coordinates of oral features, or as complex as a full point cloud mesh) to best fit measured the measured dimensions and coordinates, as determined by an algorithm such as least squares.

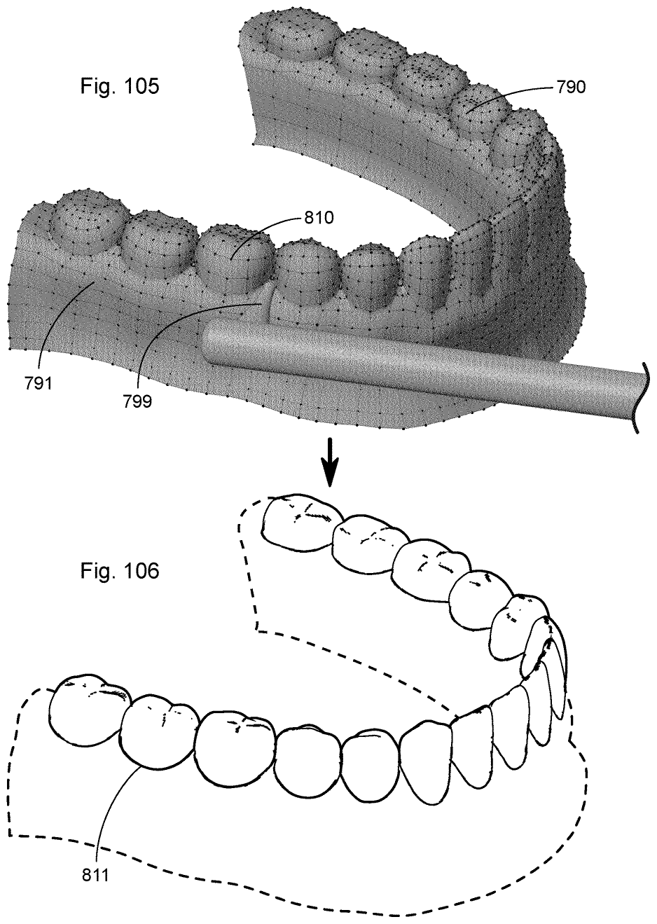

The fourth example method includes raster scanning oral structures using the fitted dental model as a guide to generate a point cloud as shown in FIG. 105. Probe 799 rotation and orientation may be adjusted in order to have maximum accuracy of the digitized points 810 while avoiding collisions with mouth structures and other uncomfortable situations such as excessive cheek stretching. The raster scans may include all teeth 790 and enough of the corresponding gums 791 to generate sufficient surface data to be able to determine the teeth boundaries. The raster scans may either be continuous, with the probe continuously following the curvature of the oral surfaces via force feedback, capacitive touch or other sensing means, or discrete, whereby the probe moves to the next location then descends toward the oral surface until contact is detected, then moves onto the next calculated location. The raster paths may either be Euclidian, proceeding along X, Y and Z axes, or curved paths to reduce the amount of probe 799 travel and scanning time. The raster paths may have equal spacing between digitized points 810 or variable spacing to increase the density of digitized points 810 in areas where it will help to delineate the boundaries between oral features.

Optionally, during the scanning run, the fitted dental model may be updated with data from the scanning. For example, as each digitized point 810 is obtained, the initial fitting of the dental model may be refined, thereby increasing the accuracy of the model relative to the subject's oral cavity. This may either happen in real-time if sufficient computing power is available, or alternatively, the scanning may be paused and the new model recomputed periodically.

If, after several tries, a complete dental scan cannot be accomplished, the processing unit may abort the scanning process. The incomplete scan data may be either discarded or saved for manual processing or diagnostic purposes.

The fourth example method may include processing the generated point cloud into surfaces such as tessellated models, polygon meshes, B-splines, T-splines, subdivision surfaces, NURBS, T-Splines or polynomial curves using algorithms known to those of ordinary skill in the art. Alternatively or additionally, the raw point cloud data may be used in some boundary-finding algorithms without being first converted into meshes or surfaces or curves.

The fourth example method includes processing the point cloud data, whether previously transformed or used raw, by algorithms such as “Novel algorithms for 3D surface point cloud boundary detection and edge reconstruction” (https://doi.org/10.1016/j.jcde.2018.02.001) to determine the boundaries between oral features. Further processing of the detected boundaries to identify gumlines, individual teeth and teeth pockets may be performed to create a dental model useful for various oral health functions. FIG. 106 illustrates an example end result of said processing, showing the computed teeth boundaries 811.

The third example method includes storing the customized dental model after the point cloud processing is complete.

TABLE 4
Labels for FIGS. 89 to 106

| # | Label |
|---|---|
| 678 | Oral Appliance |
| 679 | Actuator 1: Depth (Linear) |
| 680 | Actuator 2: Vertical (Rotary) |
| 681 | Actuator 3: Lateral (Rotary) |
| 682 | Actuator 4: Arm Rotation (Rotary) |
| 683 | Actuator 5: Tool Rotation (Rotary) |
| 684 | Driver |
| 685 | Sensor |
| 686 | Processing Circuitry |
| 687 | Power Source |
| 690 | Probe Head |
| 698 | Angular Orientation |
| 700 | Maintaining Target Position |
| 704 | Establishing Reference Point |
| 708 | Calibration: Neutral Position |
| 710 | Oral Mapping: Front |
| 711 | Upper/Lower Front Reference Points |
| 713 | Oral Mapping: Opposing Plane Start |
| 714 | Upper/Lower Opposing Plane Start Reference Points |
| 717 | Oral Mapping: Inner Surface Or Width |
| 718 | Upper/Lower Inner Reference Points |
| 720 | Oral Mapping: Opposing Plane |
| 721 | Upper/Lower Opposing Plane Reference Points |
| 724 | Oral Mapping: Tooth Profile |
| 725 | Tooth Opposing Surface Reference Points |
| 727 | Oral Mapping: Pocket Profile |
| 728 | Pocket Reference Points |
| 731 | Start |
| 732 | Establish Primary Reference Point |
| 733 | Collect Set Of Oral Features By One Or More Of, |
| 734 | Detecting At Least One Upper Front Reference Point And At |
| | Least One Lower Front Reference Point |
| 735 | Detecting At Least One Upper Opposing Plane Start Reference |
| | Point And At Least One Lower Opposing Plane Start Reference |
| | Point |
| 736 | Detecting At Least One Upper Inner Reference Point And At |
| | Least One Lower Inner Reference Point |
| 737 | Detecting At Least One Upper Opposing Plane Reference Point |
| | And At Least One Lower Opposing Plane Reference Point |
| 738 | Detecting At Least One Tooth Opposing Surface Reference Point |
| | Of At Least One Tooth |
| 739 | Detecting At Least One Pocket Reference Point Between At Least |
| | One Pair Of Adjacent Teeth |
| 740 | Store Set Of Oral Features As Oral Mapping Of Mouth Of |
| | Individual |
| 741 | End |
| 743 | Start |
| 744 | Collect Set Of Oral Features By One Or More Of, |
| 745 | Detecting Set Of Mouth Structures |
| 746 | Detecting At Least One Tooth Surface Of At Least One Tooth |
| 747 | Detecting At Least One Pocket Between At Least One Pair Of |
| | Adjacent Teeth |
| 748 | Store Set Of Oral Features As Oral Mapping Of Mouth Of |
| | Individual |
| 749 | End |
| 752 | Oral Appliance |
| 753 | Hardware |
| 754 | I/O |
| 755 | Actuator |
| 757 | Memory |
| 758 | Instructions |
| 759 | Oral Mapping |
| 760 | Display Device |
| 761 | Oral Analysis Device |
| 762 | Oral Cleaning Device |
| 763 | User (Individual, Parent) |
| 764 | Dentist/Hygienist/Orthodontist |
| 765 | Oral Appliance Manufacturer |
| 766 | Consumables Vendor |
| 768 | Computer-Readable Medium |
| 769 | 0101101000101010101011010101101101011100 . . . |
| 770 | Computer Instructions |
| 771 | Apparatus |

### Cleaning Detailed Description

### A. Introduction

In the field of dentistry, a variety of oral hygiene tasks may be performed within the mouth of an individual, such as brushing of the teeth, gums, and/or tongue; flossing between adjacent teeth; and dispensing mouthwash and/or whitening solutions. Such tasks may involve electrical devices such as electric toothbrushes, dental floss and flossing picks, and oral irrigators that dispense pressurized water, and may be performed by users such as the individual, by a caregiver of the individual such as a parent or guardian, and/or by a healthcare provider such as a dentist, orthodontist, endodontist, and/or dental hygienist.

Presented herein are oral hygiene apparatuses that automatically perform oral hygiene tasks within the mouth of an individual, such as brushing, flossing, and dispensing mouthwash. Some examples may involve an automated probe that is equipped with a tool, such as a brush head, a length of dental floss, and/or a mouthwash dispenser. The automated probe may include a mapping of the oral physiology of the individual, such as reference points that indicate the presence, locations, and/or shapes of each tooth and/or each pocket between a pair of adjacent teeth. The automated probe may be configured to move to locations and/or orientations within the mouth of the individual where such tasks are to be performed, such as moving and orienting a probe head to position a length of floss within a pocket between a pair of adjacent teeth, and may operate the tool to perform the task, such as scraping the length of floss against the side surfaces of each of the teeth within the pocket. An oral hygiene apparatus may use a variety of sensors to determine the reference points within the mouth; to establish and/or verify the position and/or orientation of the oral hygiene apparatus within the mouth of the individual; and/or to perform and/or verify the performance of the task involving the tool of the oral hygiene apparatus. Such an oral hygiene apparatus may perform the oral hygiene tasks within the mouth of the individual in a manner that does not rely upon the manual techniques of a user, and may therefore perform such as tasks in a manner that is more accurate, comfortable, fast, and/or efficient as compared with other such oral hygiene apparatuses.

### B. Example Oral Hygiene Apparatus

### B1. Component Block Diagram

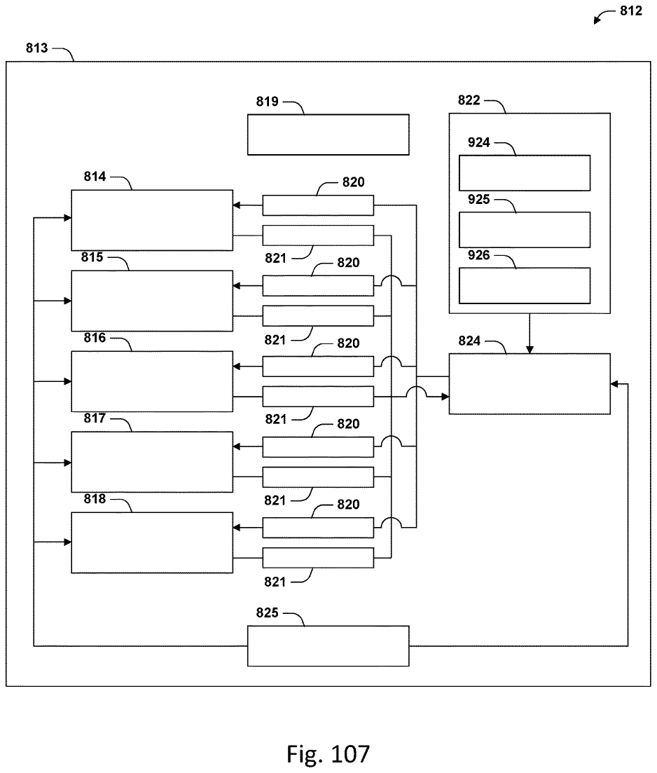

FIG. 107 is a component block diagram 812 of an example oral hygiene apparatus 813.

The example oral hygiene apparatus 813 of FIG. 107 is a simplified representation featuring a subset of components that may relate to some examples of oral hygiene apparatuses that may perform oral hygiene tasks, and that more sophisticated devices may include different numbers, types, organizations, and/or interrelationships of components. Some more detailed and complete representations of such oral probes that may be usable for performing oral hygiene tasks are provided elsewhere in this disclosure. Further, the example oral hygiene apparatus 813 of FIG. 107 is but one example of many oral hygiene apparatuses that may include at least a portion of the oral hygiene apparatuses that are disclosed by the present disclosure.

The example oral hygiene apparatus 813 of FIG. 107 may include a set of actuators that move or control parts of the oral probe. Such actuators may include, for example, linear actuators that create linear motion and/or rotary actuators that create rotational motion. Each actuator may receive power from a power source 825, for example, alternating-current or direct-current power from a power source, and/or a signal. Power and signal may be provided in one input, such as direct-current power provided on a duty cycle that provides a selectable motor speed or pulse-width modulation that encodes a position of a servomotor. The example oral apparatus 813 of FIG. 107 includes a set of five actuators: one linear actuator (a depth actuator 814) and four rotary actuators (a vertical actuator 815, a lateral actuator 816, an arm rotation actuator 817, and a tool rotation actuator 818), each having an encoder which provides feedback on a position or rotation, from which other details such as linear or angular speed, velocity, acceleration, and the like may be determined.

The example oral hygiene apparatus 813 of FIG. 107 may include an oral hygiene tool 819, such as a brush; a length of dental floss; a container and/or dispenser (such as a pump, conduit, and nozzle) configured to store and/or dispense a substance such as toothpaste, mouthwash, or a tooth whitening composition. The oral hygiene tool 819 may be mechanical, electrical, electromechanical, or the like; for example, a brush of the oral hygiene tool 819 may include a conventional brush comprising a set of bristles and/or an electric brush with a rotating head. The oral hygiene tool 819 may use and/or share some of the other components of the example oral hygiene apparatus 813, such as a shared power source 825 that supplies power to both the actuators and the oral hygiene tool 819. The oral hygiene tool 819 may include discrete components that are separate from the other components of the example oral hygiene apparatus 813, such as a separate battery. The oral hygiene tool 819 may be integrated with the example oral hygiene apparatus 813, such as an integrated brush; in some other examples, the oral hygiene tool 819 may be a separable apparatus, such as a separate toothbrush or floss holder that may be inserted into and used by the oral hygiene device 813.

The example oral hygiene apparatus 813 of FIG. 107 includes processing circuitry 824 that receives power from the power source 825 and that is interconnected with the actuators through a variety of connections. As a first such example, the processing circuitry 824 communicates signals to the respective actuators via a driver 820, for example, a timer or other digital pulse train generating peripheral generates a pulse-width modulation (PWM) signal, which may control transistors that drive the actuators forward or backward. Each driver 820 may provide a discrete control signal to one (or more) of the actuators; alternatively, each driver 820 may alter a power source to encode a signal, for example, an H-bridge which converts the digital signals from the processing circuitry into forward, backward or stopped polarity voltage applied to the actuators. Alternatively, a voltage-to-current converter can control a current supplied to the actuator so as to vary its speed, direction and torque. As a second such example, the processing circuitry 824 may receive, from each actuator, a signal indicating a performance of the actuator, such as current through the actuator as determined by a sensor 821 such as a current sensor. The processing circuitry 824 may be configured to detect or monitor a current level and/or current fluctuation by the current sensor. For example, increasing power may indicate that the actuator has encountered a physical barrier or obstacle, or has reached a limit, such as a maximum extension of the depth actuator 814. In the example oral hygiene apparatus 813 of FIG. 107, each actuator may be coupled with a sensor 821 such as a current sensor by which the processing circuitry 824 may determine the current conducted by the actuator in response to the signal of the driver 820 and may adjust the example oral hygiene apparatus 813 to alter the signals applied to the driver 820 in response thereto, e.g., by signaling an actuator to move more slowly, to stop, or to reverse direction in the event that the current flow of an actuator indicates that the example oral hygiene apparatus 813 has encountered a blockage.

More particularly, the processing circuitry 824 of the example oral hygiene apparatus 813 may be configured to operate the actuators to move and/or orient the oral hygiene tool 819 with respect to a set of locations such as a first location 924, a second location 925 and a third location 926 within the mouth of the individual where one or more oral hygiene tasks are to be performed. As a first such example, the example oral hygiene apparatus 813 may store a location set 822 of locations where the oral hygiene tool 819 is to be moved and/or oriented in order to apply a brushing motion to a brush, such as a first location 924 indicating a brushing surface of a right first molar and a second location 925 indicating a brushing surface of a left second molar. As a second such example, the example oral hygiene apparatus 813 may store a location set 822 of locations where the oral hygiene tool 819 is to be moved and/or oriented in order to apply a flossing motion to a length of floss held by the oral hygiene tool 819, such as a location 926 of a first pocket between a pair of adjacent teeth. Accordingly, the processing circuitry 824 may be configured to operate the actuators to position the oral hygiene tool 819 in the set of locations 823, for example in series, and to cause the oral hygiene tool 819 to perform the oral hygiene task when the oral hygiene tool 819 is in each of the locations of location set 822, such as operating a pump to dispense mouthwash through a nozzle when a nozzle of the oral hygiene tool 819 is positioned at a location and/or orientation to cause the dispensed mouthwash to contact a particular location within the mouth of the individual.

### B2. Example Actuator Set

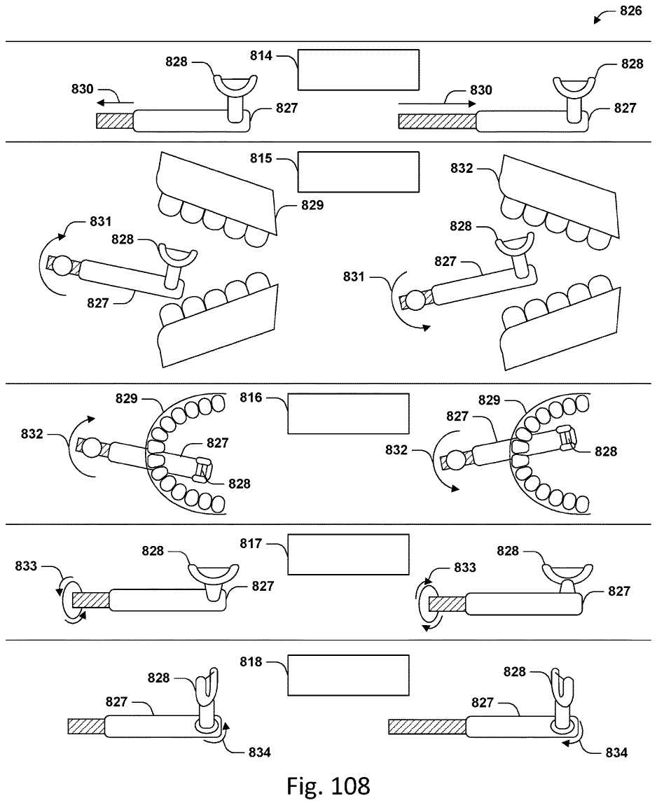

FIG. 108 is a diagram of example set of actuators that may be included in an automated oral appliance 827.

The examples shown in the diagram 826 of FIG. 108 involve an example automated oral appliance 827 including an appliance tool 828 that may be usable in the oral cavity 829 of an individual. In the example shown in FIG. 108 and in other figures, the example automated oral appliance 827 may be a consumer-grade personal oral hygiene apparatus featuring an automated flossing program that is performed using a length of dental floss held by the appliance tool 828, but it is to be understood that at least some of the concepts illustrated in FIG. 108 may be included in other devices that may have different features. The example automated oral appliance 827 may be or may include an automated oral hygiene apparatus 813 such as shown in the component block diagram 812 of FIG. 107.

As a first example shown in FIG. 108, the example automated oral appliance 827 may include a depth actuator 814, which may be configured to extend and/or retract the length of the example automated oral appliance 827 along a reach axis 830 (e.g., a depth or length axis). The example automated oral appliance 827 may be configured to operate the depth actuator 814 to exhibit movement along the reach axis 830 in order to position and/or move the example automated oral appliance 827 into and out of the oral cavity 829 of the individual, for example, during an automated dental flossing program. The depth actuator 814 may include one or more linear actuators, which may be mechanical, electromechanical, hydraulic, pneumatic, and the like.

As a second example shown in FIG. 108, the example automated oral appliance 827 may include a vertical actuator 815, which may be configured to move the example automated oral appliance 827 in a manner that creates pitch rotation 831 (e.g., rotation that raises or lowers the example automated oral appliance 827). The example automated oral appliance 827 may be configured to operate the vertical actuator 815 to exhibit pitch rotation 831 in order to move the example automated oral appliance 827 to a selected vertical position within the oral cavity 829 of the individual to reach the upper teeth or lower teeth, for example, during an automated dental flossing program. The vertical actuator 815 may include one or more rotary actuators, which may be mechanical, electromechanical, hydraulic, pneumatic, and the like.

As a third example shown in FIG. 108, the example automated oral appliance 827 may include a lateral actuator 816, which may be configured to move the example automated oral appliance 827 in a manner that creates yaw rotation 832 (e.g., rotation around a vertical axis). The example automated oral appliance 827 may be configured to operate the lateral actuator 816 to exhibit yaw rotation 832 in order to move the example automated oral appliance 827 to a selected horizontal position within the oral cavity 829 of the individual to reach the left-hand teeth or the right-hand teeth, for example, during an automated dental flossing program. The lateral actuator 816 may include one or more rotary actuators, which may be mechanical, electromechanical, hydraulic, pneumatic, and the like.

As a fourth example shown in FIG. 108, the example automated oral appliance 827 may include an arm rotation actuator 817, which may be configured to rotate the example automated oral appliance 827 to exhibit a roll rotation 833 (e.g., rotation around the reach axis 830). The example automated oral appliance 827 may be configured to operate the arm rotation actuator 817 to exhibit roll rotation 833 in order to move the example automated oral appliance 827 to orient the appliance tool 828 toward the left-hand side or the right-hand side of the oral cavity 829 of the individual, and/or the upper side or the lower side of the oral cavity 829 of the individual, for example, during an automated dental flossing program. The arm rotation actuator 817 may include one or more rotary actuators, which may be mechanical, electromechanical, hydraulic, pneumatic, and the like.

As a fifth example shown in FIG. 108, the example automated oral appliance 827 may include a tool rotation actuator 818, which may be configured to rotate the appliance tool 828 of the example automated oral appliance 827 around a tool rotation axis (e.g., an axis that is orthogonal to the reach axis 830). The example automated oral appliance 827 may be configured to operate the tool rotation actuator 818 to exhibit rotation with respect to a tool rotation axis in order to orient a length of floss that is held by the appliance tool 828 to align with a pocket between two teeth in the oral cavity 829 of the individual, for example, during an automated dental flossing program. The tool rotation actuator 818 may include one or more rotary actuators, which may be mechanical, electromechanical, hydraulic, pneumatic, and the like.

As a fifth example shown in FIG. 108, the example automated oral appliance 827 may include a tool rotation actuator 818, which may be configured to rotate the appliance tool 828 of the example automated oral appliance 827 around a tool rotation axis (e.g., an axis that is orthogonal to the reach axis 830). The example automated oral appliance 827 may be configured to operate the tool rotation actuator 818 to exhibit pivot rotation with respect to a tool rotation axis in order to orient a length of floss that is held by the appliance tool 828 to align with a pocket between two teeth in the oral cavity 829 of the individual, for example, during an automated dental flossing program. The tool rotation actuator 818 may include one or more rotary actuators, which may be mechanical, electromechanical, hydraulic, pneumatic, and the like.

The processing circuitry 824 may be configured to operate each actuator concurrently, sequentially, and/or in an interleaved manner. The processing circuitry 824 may be configured to operate one or more of the actuators independently of the other actuators, that is, irrespective of the operation of the other actuators. Alternatively or additionally, the processing circuitry may be configured to operate one or more of the actuators in a correlated manner with respect to other actuators. For example, some forms of motion of the example automated oral appliance 827 and/or appliance tool 828 due to the activation of some actuators may affect the position and/or motion of the example automated oral appliance 827 and/or appliance tool 828 along the same or other axes; for example, moving the example automated oral appliance 827 to achieve a desired yaw rotation 832 may also alter the orientation of the appliance tool 828. The processing circuitry 824 may be configured to operate the actuators in a compensatory manner, for example, applying a counteractive pivot rotation 834 with respect to a tool rotation axis of the appliance tool 828 based on operating the lateral actuator 816 in order to maintain the orientation of the appliance tool 828. Such compensatory operation may occur in a concurrent manner (e.g., operating the tool rotation actuator 818 counter-rotating the appliance tool 828 to create pivot rotation 834 concurrently with operating lateral actuator 816 to create yaw rotation 832) and/or sequentially (e.g., operating the tool rotation actuator 818 counter-rotating the appliance tool 828 to create pivot rotation 834 before or after operating lateral actuator 816 to create yaw rotation 832). The example automated oral appliance 827 may be configured to coordinate such motion in a corresponding or proportional manner; in other examples, the example automated oral appliance 827 may be configured to translate or otherwise adjust the motion of one actuator relative to the motion of another actuator (e.g., activating the tool rotation actuator 818 to create a larger pivot rotation 834 in response to a first pitch rotation 831 than in response to a second pitch rotation 831).

The processing circuitry 824 may be configured to coordinate the control of two or more actuators based upon the physiological features 838 of the individual. Some examples, such as automated oral probes, may be configured to reduce an operating height, for example, to reduce the range of motion of the individual's mouth during operation of the automated oral probe. One technique for reducing such operating height may involve orienting and/or maintaining an orientation of an appliance tool 828 at an angle with respect to a physiological feature of an individual, rather than at an angle with respect to the automated oral probe. Such orientation may be achieved or maintained, for example, by altering the pivot rotation 834 of the appliance tool 828 with respect to a tool rotation axis based on a roll rotation 833 with respect to an arm rotation axis.

### C. Calibration

### C1. Establishing Primary Reference Point

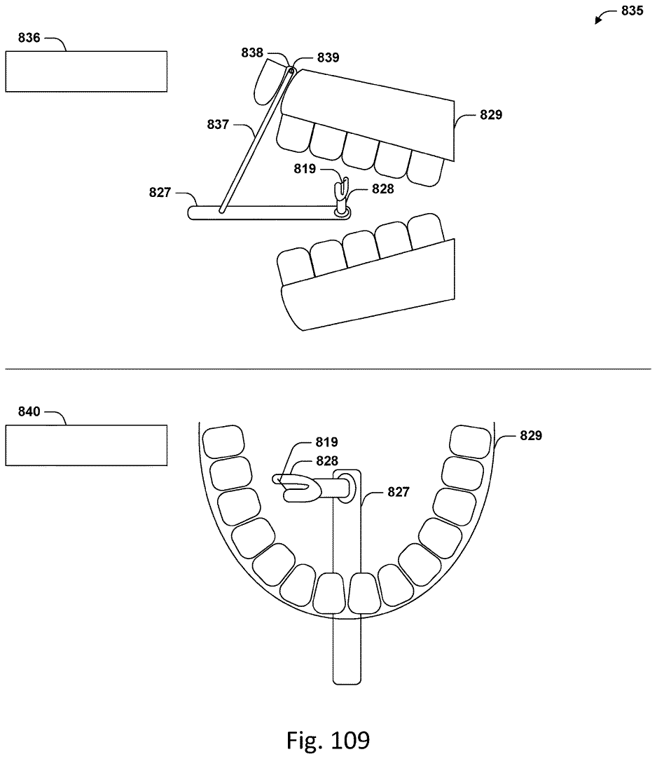

FIG. 109 is a diagram of an example calibration process that may be performed by an automated oral appliance 827.

As shown in the diagram 835 of FIG. 109, the oral physiology of the individual may include a fixed location that may serve as a physiological feature 838 that is comparatively stationary, as compared, for example, with the jaw or soft tissue such as the tongue of the individual. An example of such a physiological feature 838 is the pocket between the upper lip and upper gumline of the individual near the labial frenulum. As described elsewhere in this specification, a mouthpiece may be inserted between the lip and upper gumline near the labial frenulum, and may remain comparatively static by the individual during a personal oral operation such as an automated flossing program, even if other portions of the individual's mouth move. The mouthpiece may include an anchor point to which the automated oral probe may attach, for example by a positioning member 837 that connects the automated oral probe to the anchor point of the mouthpiece. The mouthpiece may be held in place by the individual (e.g., by the upper lip and upper gumline of the individual), and/or may be affixed in other ways, such as a tacky or adhesive substance that may be applied to the mouthpiece and/or inside the upper lip. The anchor point and/or the physiological feature 838 for which the anchor point provides a reference may serve as a primary reference point 839, as well as other calibration and oral mapping operations. Examples of such mouthpieces and positioning members 837 of example automated oral probes 827 that may be used to establish the primary reference point 839 are provided elsewhere in this disclosure. Establishing the primary reference point 839 may involve establishing two or more types of information about a primary reference point 839, such as a position and an orientation. Establishing the primary reference point 839 may involve establishing set of two or more primary reference points 839 within the oral cavity 829 of the individual, such as a first primary reference point 839 based on the upper labial frenulum of the individual and a second primary reference point 839 based on the lower labial frenulum or gum pocket. Collecting two or more types of information about a primary reference point 839 and/or a set of two or more primary reference points 839 may provide additional information about the position of an automated oral probe within the oral cavity 829 of the individual, such as a position of the automated oral probe relative to two or more physiological features 838 of the oral cavity 829 of the individual and/or an orientation of the automated oral probe and/or an appliance tool 828 of the automated oral probe with respect to a depth, vertical, lateral, arm rotation, and/or tool rotation axis.

### C2. Calibration

In the diagram 835 of FIG. 109, a calibration 840 may be performed to establish the position of the automated oral probe and the appliance tool 828 along various linear and/or rotational axes. The processing circuitry 824 may be configured to operate one or more actuators in order to achieve a selected, desired, or target position of the automated oral probe, such as a home position, neutral position, or zero position. For example, the home position may be a terminal position or midpoint position within a range of motion of a linear actuator or a selected rotational point of a rotational actuator.

The automated oral probe may operate a depth actuator 814 to move along the reach axis 830 in a first direction until reaching an end point, which may be detectable due to a change in actuator current as detected by a current sensor. The automated oral probe may also move along the reach axis 830 in a second direction until reaching another end point, which may again be detectable due to a change in actuator current as detected by a current sensor. Other types of sensors 821 may be utilized for end point detect as is described elsewhere in this disclosure. The detection of one or both end points may indicate to the automated oral probe (e.g., to the processing circuitry 824) that the automated oral probe and/or the appliance tool 828 has reached and/or is currently positioned at a particular length, for example, a fully extended length or a fully retracted length. The automated oral probe may be configured to permit motion along the reach axis 830 only within a limited range, such as a maximum length of a lead screw of a linear actuator. Alternatively or additionally, the automated oral probe may include a stop mechanism to stop the depth actuator 814 from extending and/or retracting beyond a certain length or position along the reach axis 830, such as a tab or block at a fixed position that engages with a mobile portion of the automated oral probe when the depth actuator 814 reaches a designated position. The automated oral probe may be configured to encode (e.g., via a driver 820) a designated position of the depth actuator 814, and the depth actuator 814 may operate in accordance with the encoded position, such as a servomotor that is configured to detect and/or track a current position and to operate in order to achieve a designated position in response to an encoded signal. A depth actuator 814 may include one or more markings along the reach axis 830, and may be configured to determine a current position of the depth actuator 814 along the reach axis 830 by moving the automated oral probe and determining the detection of a selected marker by a sensor. The automated oral probe may not monitor or detect the status of the depth actuator 814, but may control the depth actuator 814 in a manner that achieves a desired position (e.g., operating the depth actuator 814 to extend for a period of time, after which the depth actuator 814 is set to a terminal position, such as a fully retracted position, irrespective of the initial position of the depth actuator 814).

The automated oral probe may be configured to operate the depth actuator 814 to perform a calibration 840 as previously described, and may therefore determine a current position (including orientation) of the automated oral probe and/or appliance tool 828 along the reach axis 830. The automated oral probe may be configured to determine one or more reference points of the depth actuator 814 (e.g., one or both terminal positions along the reach axis 830) and then to operate the depth actuator 814 in a manner that positions and/or orients the automated oral probe and/or appliance tool 828 at a designated home position, neutral position, or zero position along the reach axis 830, for example, a center point along the reach axis 830 between the terminal points, or in relation to another point or component of the automated oral probe (e.g., an indication that the appliance tool 828 is oriented at a particular pivot angle with respect to a body of the automated oral probe).

The automated oral probe may be configured to perform the calibration 840 for only one actuator. The automated oral probe may be configured to perform the calibration 840 for several actuators, such as one or more of the vertical actuator 815, the lateral actuator 816, the arm rotation actuator 817, and/or the tool rotation actuator 818 in a similar self-calibration manner as the depth actuator 814, in order to determine an absolute or relative linear and/or rotational position of each such actuator along a corresponding linear or rotary axis. Such calibration 840 may performed concurrently, sequentially, and/or in an interleaved manner.

### C3. Calibration Performance

The calibration may be performed in various circumstances.

The calibration 840 may be performed for an automated oral probe in response to a first activation, such as a first power-on event and/or a first detection of insertion of the automated oral probe into the mouth of an individual.

The calibration 840 may be performed in response to a manual selection by a user, such as a calibration request. The calibration 840 may be performed on demand, for example, before performing another operation such as an instance of an automated flossing program.

The calibration 840 may be performed in response to a detection of a miscalibration, such as the appliance tool 828 unexpectedly encountering a stop position along an axis such as the reach axis 830 that does not correspond to a stored current position of the appliance tool 828.

The calibration 840 may be performed periodically, for example, if more than three days and/or at least five instances of an automated flossing program have occurred since a previous instance of the calibration 840.

The calibration 840 may be performed conditionally, for example, as an abbreviated or verification calibration 840 that verifies whether previously stored reference points are still valid, and as a full calibration 840 that completely recalibrates all actuators and/or axes in the event of a verification failure.

The calibration 840 may be performed incrementally, for example, recalibrating only one or one or some actuators or axes that appear to be miscalibrated while not recalibrating one or some actuators that appear to remain validly calibrated.

### C4. Calibration Results

The calibration may provide a variety of results.

The calibration 840 may enable an automated oral probe to operate one or more actuators in order to achieve a designed reach, pitch, yaw, roll, and/or pivot position of the automated oral probe and/or appliance tool 828 with respect to one or more axes, and/or with respect to a reference point, such as a primary reference point 839. The automated oral probe may then be configured to begin another process, such as an automated flossing program, on the condition of the automated oral probe and/or appliance tool 828 beginning in the home position, neutral position, or zero position.

The calibration 840 may enable the automated oral probe to detect a current position and/or orientation of the actuators, for example, as an initial position of the automated oral probe and/or appliance tool 828 in which another process, such as an automated flossing program, may begin.

The calibration 840 may enable the processing circuitry 824 to store one or more calibration indicators of the state of one more actuators, such as a position or percentage of the extension of the depth actuator 814 along the reach axis 830 or a rotational angle or position of a rotary actuator such as the arm rotation actuator 817 along a rotary axis. The processing circuitry 824 may be configured to store one or more calibration indicators of a position of the automated oral probe and/or appliance tool 828, for example, according to a coordinate system, which may be based upon an initial position or upon a reference coordinate (e.g., defining the initial position of the automated oral probe and/or appliance tool 828 as a home position, neutral position, or zero position) with respect to a location on the automated oral probe, and/or a physiological feature 838 of the individual. The calibration indicators may be detected, represented, and/or stored, for example, as one or more locations, such as a vector, distance, or offset relative to another calibration indicator, the primary reference point 839, and/or a physiological feature 838 of the individual. The calibration indicators may be detected, represented, and/or stored, for example, as one or more geometric shapes, such as a line, plane, or a two- or three-dimensional surface or polygon such as a sphere or a cube. The calibration 840 may conclude with the automated oral probe and/or appliance tool 828 being moved to a desired position (including orientation), such as a home position, neutral position, or zero position, and the calibration 840 may include the processing circuitry 824 storing a calibration indicator that the current position of the automated oral probe and/or appliance tool 828 being in the desired position. The calibration 840 may involve detecting a current position and/or orientation, for example, as a current position and/or initial position of the automated oral probe and/or appliance tool 828 in the absence of a designated or desired home position, neutral position, or zero position, and the calibration 840 may include the processing circuitry 824 storing a calibration indicator of the detected position of the automated oral probe or appliance tool 828 as a current position and/or initial position of the automated oral probe and/or appliance tool 828.

The processing circuitry 824 may be configured to store calibration indicators determined through the calibration 840 in volatile and/or non-volatile memory. Storage in non-volatile memory may enable such calibration indicators to be reloaded after a power reset, for example, as an initial position of the automated oral probe and/or appliance tool 828. A calibration indicator from an earlier calibration may be retrieved (e.g., from non-volatile memory) and presumptively used as the initial position of the automated oral probe and/or appliance tool 828, optionally by omitting a second instance of the calibration 840 or by performing an abbreviated version of the calibration 840 to verify that the calibration indicators accurately reflect the initial position and/or current position of the automated oral probe and/or appliance tool 828.

The processing circuitry 824 may collect and/or store a set of reference points in relation to the primary reference point 839, for example, as an orientation, direction, distance, and/or offset such as a vector with respect to the primary reference point 839, and/or as coordinates within a grid that is established in relation to the primary reference point 839. Respective axes of a coordinate grid may be defined, for example, based on cartesian coordinates and/or polar coordinates. The processing circuitry 824 may establish the primary reference point 839 in order to establish a location of the apparatus in relation to the mouth of the individual 878, and the apparatus may otherwise detect the set of reference points not necessarily in relation to the primary reference point 839 but in a different manner, for example, in relation to a home, neutral, and/or zero position of an automated oral probe, and/or as a set of instructions for controlling the actuators to reach each such reference point from a current position or from a home, neutral, and/or zero position. The processing circuitry 824 may establish two or more primary reference points 839, for example, a first primary reference point 839 inside the upper labial frenulum inside the upper lip and a second primary reference point 839 inside the lower labial frenulum inside the lower lip.

It is to be understood that the foregoing description is but one example calibration of an oral hygiene apparatus. Some examples of oral hygiene apparatuses may vary from the foregoing description of the example calibration 840 of FIG. 109, for example, by adding operations, omitting operations, performing operations in a different order, combining operations, dividing operations into two or more sub-operations, performing two or more operations in a concurrent and/or interleaved manner, and the like, without departing from the subject matter of the present disclosure. Those of ordinary skill in the art may identify and include many such variations in the calibration techniques in accordance with this disclosure.

### D. Oral Hygiene Task

An oral hygiene apparatus (such as the example oral hygiene apparatus 813 of FIG. 107 and/or an automated oral probe) may be configured to perform an oral hygiene task.

### D1. First Example Oral Hygiene Task

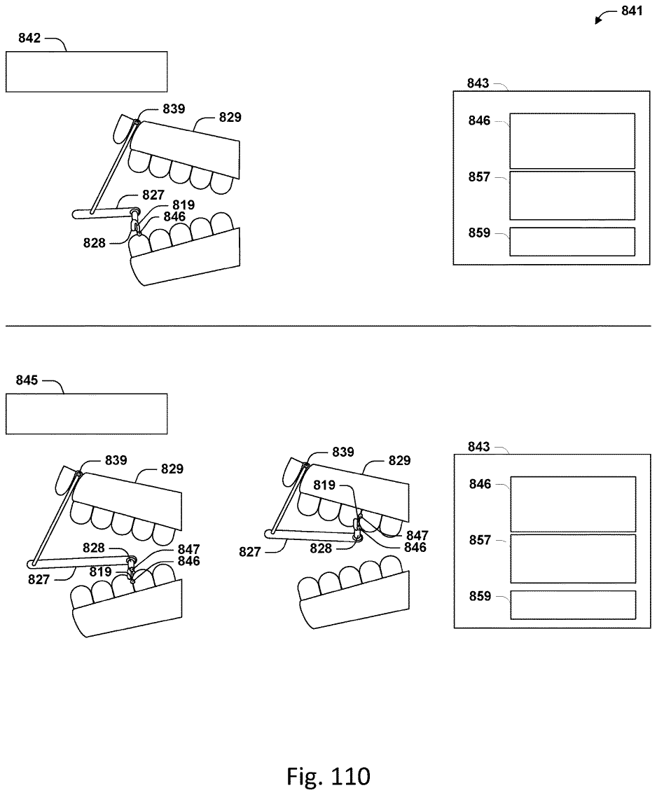

FIG. 110 is a diagram of performing a first oral hygiene task in the mouth of an individual by an automated oral appliance 827.

As shown in the diagram 841 of FIG. 110, an automated oral appliance 827 may be configured to verify an oral mapping 842 before beginning an oral hygiene task. This may be accomplished by obtaining a primary reference point 839 and then probing one or more of a list of reference points contained in an oral mapping 843 such as upper/lower opposing plane reference points 846, tooth opposing surface reference points 857 and/or pocket reference points 859 and compare the measured values to the values stored in oral mapping 843. If the values match within a specified tolerance, then it is relatively certain that the individual who generated the stored oral mapping 843 is the same individual currently using the oral appliance 827.

The calibration may be the same as described elsewhere in this disclosure. In brief, oral appliance 827 may move oral hygiene tool 819 and/or appliance tool 828 to touch off or probe various surfaces and oral features inside oral cavity 829 and to measure one or more parameters of the contact such as a relative distance and/or orientation to a primary reference point 839.

As shown in the diagram 841 of FIG. 110, an automated oral appliance 827 may be configured to verify an oral mapping 842 before beginning an oral hygiene task. This may be accomplished by obtaining a primary reference point 839 and then probing one or more of a list of reference points contained in an oral mapping 843 such as upper/lower opposing plane reference points 846, tooth opposing surface reference points 857 and/or pocket reference points 859 and compare the measured values to the values stored in oral mapping 843. If the values match within a specified tolerance, then it is relatively certain that the individual who generated the stored oral mapping 843 is the same individual currently using the oral appliance 827.

As shown in the diagram 841 of FIG. 110, an automated oral appliance 827 may be configured to perform a flossing task 845. This may be accomplished by obtaining a primary reference point 839 wherein processing circuitry of an automated oral appliance 827 loads an oral mapping 843 from memory. Oral mapping 843 may contain upper/lower opposing plane reference points 846, tooth opposing surface reference points 857 and/or pocket reference points 859. Processing circuitry may then command one or more actuators to move an oral hygiene tool 819 and/or an appliance tool 828 holding a length of floss into the oral cavity 829 vertically above a pocket reference point 859 at or above the level of opposing plane start 847. The location and/or orientation of opposing plane start 847 may be defined by upper/lower opposing plane reference points 846. As the data structure of pocket reference point 859 includes the orientation of the teeth gap that leads to the pocket, processing circuitry may command actuators to orient an oral hygiene tool 819 and/or an appliance tool 828 parallel to the teeth gap.

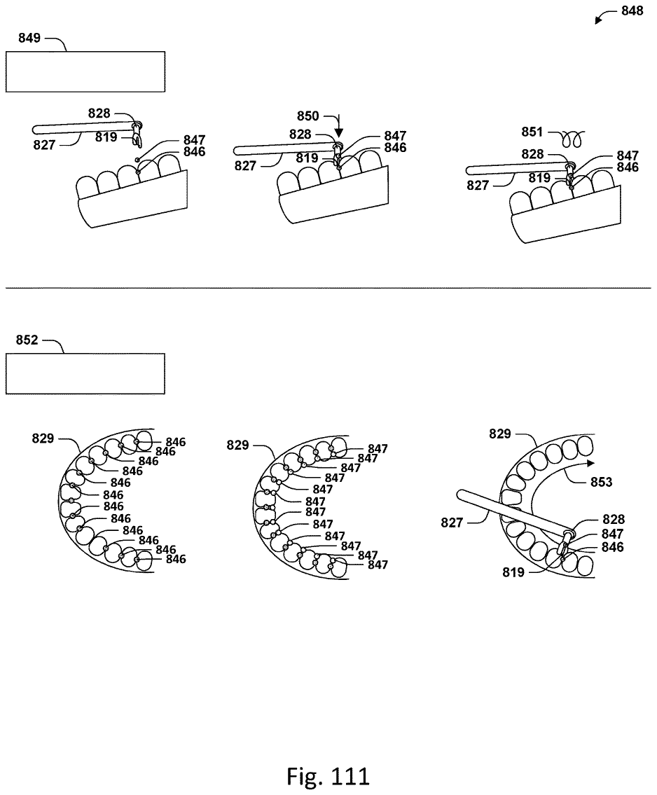

As shown in the diagram 848 of FIG. 111, an automated oral appliance 827 may be configured to perform a flossing routine 849. Processing circuitry may command oral hygiene tool 819 and/or an appliance tool 828 to descend 850 down to a pocket reference point 859. The tool may descend straight down or follow a zig-zag or other complex path 851 described elsewhere in this disclosure to reduce the required force to descend or to perform other functions such as scraping the walls of the tooth pocket. Similarly, the oral hygiene tool 819 and/or an appliance tool 828 may ascend straight vertically or may take a complex path.

As shown in the diagram 852 of FIG. 111, an automated oral appliance 827 may be configured to floss a series of pockets by repeating the process of proceeding to an opposing plane start 847 above a tooth pocket, executing a routine to descend then ascend from the tooth pocket to a clearance level above the tops of the teeth, then proceeding 853 to the next tooth pocket location.

Although the preceding example used the example of flossing, analogous techniques are applicable to brushing. For example, a trajectory path may be computed by fitting a spline or curve to the normals to the interior and exterior facing surfaces of the teeth, and then offsetting it by half the diameter of the bristles that make up a brushing oral cavity tool. Processing circuitry may command actuators to maintain the bristles normal to the teeth surfaces as can be seen in FIG. 17.

### H. Some Example Embodiments

The following description presents some examples in which the subject matter of the present disclosure may be embodied. However, the following description is intended to be only some examples. Those of ordinary skill in the part will understand that various aspects of the disclosure may be embodied in many different forms, and all such forms are contemplated to be within the scope of the disclosure.

### H1. First Example Method

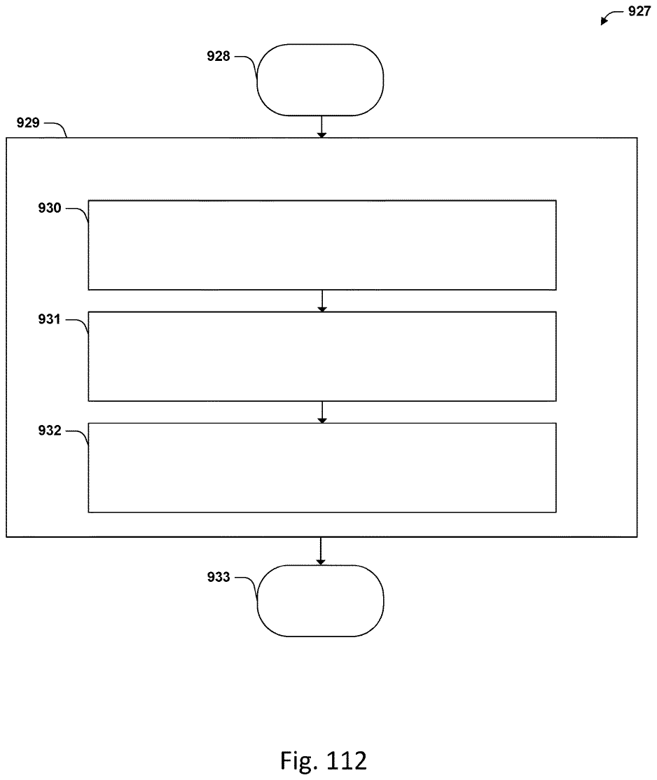

FIG. 112 is a flowchart diagram of a first example method of performing an oral hygiene task in a mouth of an individual.

The first example method 927 may be implemented, for example, as a set of instructions that, when executed 929 by processing circuitry of an apparatus, cause the apparatus to perform each of the elements of the first example method 927.

The first example method 927 begins at 928 and includes identifying 930 a location set 822 of locations in the mouth to position the oral hygiene tool to perform the oral hygiene task.

The first example method 927 includes operating 931 the motion generator to position the oral hygiene tool at each location of location set 822.

The first example method 927 includes operating 932 the oral hygiene tool to perform the oral hygiene task while the oral hygiene tool is positioned at one of the locations of the location set 822.

In this manner, the operations included in the first example method 927 may perform an oral hygiene task, and so the example method 927 ends at 933.

### H1. Second Example Method

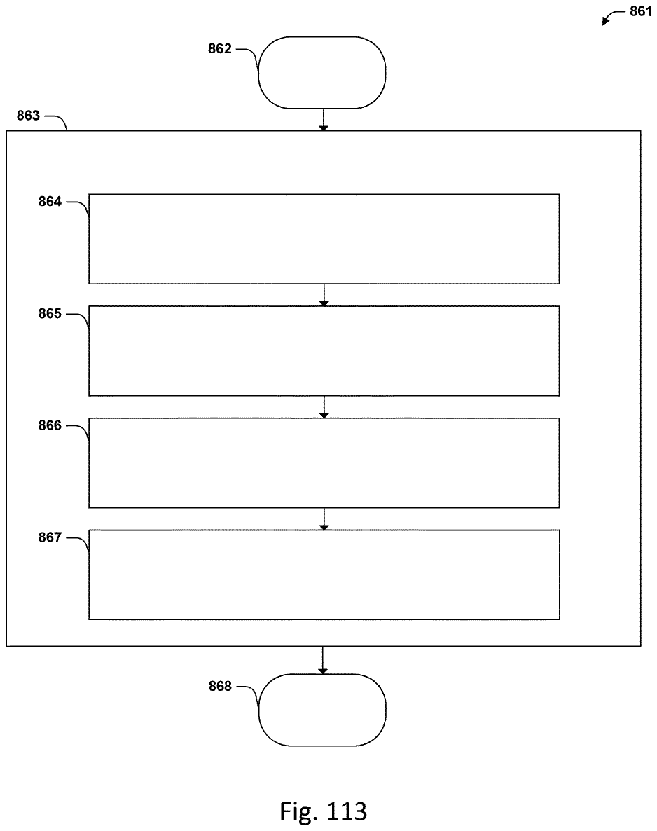

FIG. 113 is a flowchart diagram of a second example method of performing an oral hygiene task in a mouth of an individual.

The second example method 861 may be implemented, for example, as a set of instructions that, when executed 863 by processing circuitry of an apparatus, cause the apparatus to perform each of the elements of the second example method 861.

The second example method 861 begins at 862 and includes storing 864 an oral mapping as a set of reference points within the mouth of the individual.

The second example method 861 includes identifying 865 a location set 822 of locations in the mouth to perform the oral hygiene task based on the oral mapping.

The second example method 861 includes positioning 866 the oral hygiene tool at each location of location set.

The second example method 861 includes operating 867 the oral hygiene tool to perform the oral hygiene task based on the reference point while the oral hygiene tool is positioned at a location of the location set 822 that corresponds to a reference point of the oral mapping.

In this manner, the operations included in the second example method 861 may produce an oral mapping, and so the example method 861 ends at 868.

### H2. Third Example Method

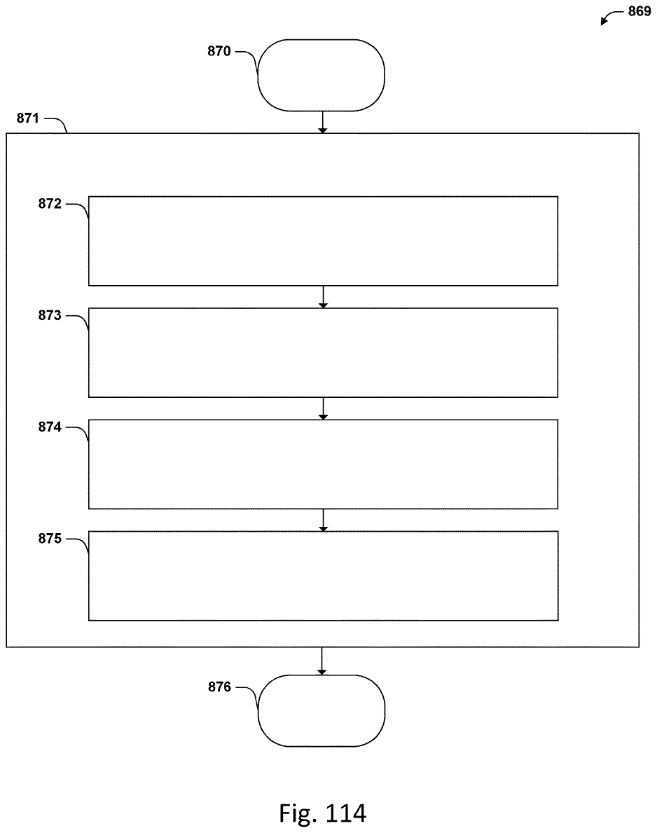

FIG. 114 is a flowchart diagram of a third example method of performing an oral hygiene task in a mouth of an individual.

The third example method 869 may be implemented, for example, as a set of instructions that, when executed by processing circuitry of an apparatus, cause the apparatus to perform each of the elements of the second example method 869.

The third example method 869 begins at 870 and includes collecting 871 a set of reference points by the following operations: Detecting 872 a set of mouth structure reference points; detecting 873 at least one tooth surface reference point of at least one tooth; and detecting 874 at least one pocket reference point between at least one pair of adjacent teeth.

The third example method 869 includes storing 875 an oral mapping as a set of reference points.

In this manner, the operations included in the third example method 869 may produce an oral mapping, and so the example method 869 ends at 876.

### H3. Fourth Example Method

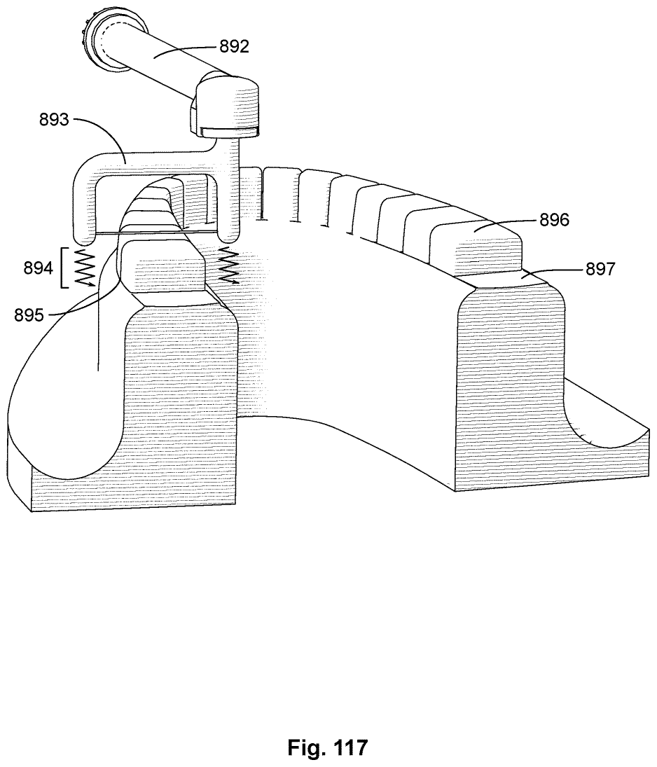

FIG. 117 is a diagram of a fourth example method, a zig-zag maneuver to reduce the force required to penetrate the space between tightly packed teeth.

In certain individuals, due to genetic or environmental factors, certain teeth may be tightly packed together. In an automated dental flossing apparatus, the force required to directly move the floss between the teeth may exceed the available torque or may necessitate using larger and more expensive actuators.

To reduce the required force, the third example method may be implemented, for example, as a set of instructions that, when executed by processing circuitry of an apparatus, may cause an actuator arm 892 to move a floss cartridge 893 laterally back and forth in a zig-zag path 894 while moving to or from a tooth pocket 895 located at a junction of two teeth 896 and gums 897, or alternatively, between any other adjacent objects in the oral cavity, such as a natural tooth and a dental implant.

To further reduce the surface area of contact between the floss and the tooth surfaces and thereby reduce the amount of force required, said zig-zag path 894 may be implemented with the floss at an angle relative to the tooth pocket 895 rather than parallel to it. With the floss at an angle, one side of the floss will reach the tooth pocket 895 before the other side of the floss. Upon one side of the floss reaching the tooth pocket 895 the processing circuitry may then command actuator arm 892 to rotate floss cartridge 893 such that the floss occupies and becomes parallel to the tooth pocket 895.

Alternatively or additionally, the processing circuitry may adjust the angle of the floss during the stroke, for example, such that the floss finishes the descent parallel to the tooth pocket. As another example, as the floss is leaving the tooth pocket, the angle may gradually be increased so as to avoid placing excessive tension on the floss which might lead to breakage.

### H4. Fifth Example Method

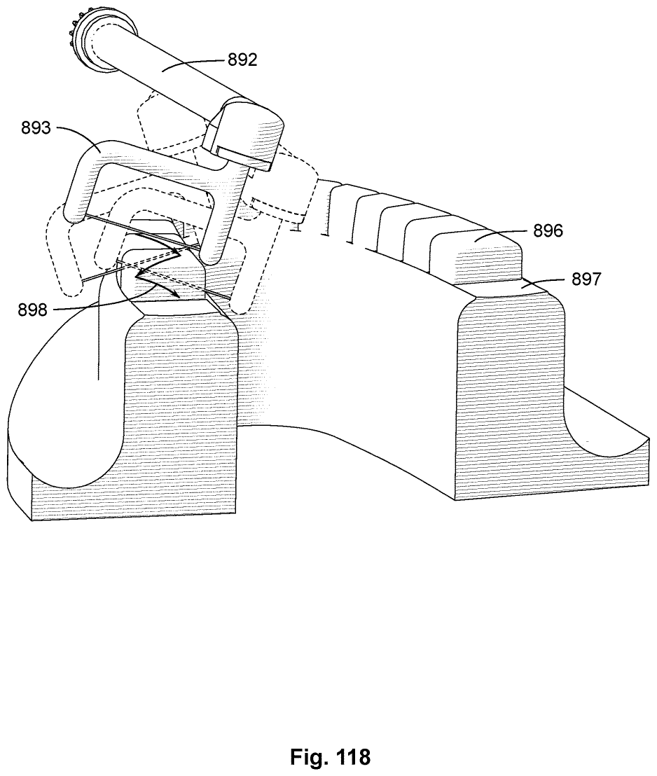

FIG. 118 is a diagram of a fifth example method, a sawing maneuver to reduce the force required to penetrate the space between tightly packed teeth.

In certain individuals, due to genetic or environmental factors, certain teeth may be tightly packed together. In an automated dental flossing apparatus, the force required to directly move the floss between the teeth may exceed the available torque or may necessitate using larger and more expensive actuators.

To reduce the required force, the fourth example method may be implemented, for example, as a set of instructions that, when executed by processing circuitry of an apparatus, may cause an actuator arm 892 to move a floss cartridge 893 at alternating angles while descending or ascending in a sawing path 898 while moving to or from a tooth pocket located at a junction of two teeth 896 and gums 897, or alternatively, between any other adjacent objects in the oral cavity, such as a natural tooth and a dental implant.

Said sawing path may be implemented as a linear path with a fixed angle of the floss until the end of the stroke when the angle is reversed, or may be a complex curved path to increase or decrease the angle of the floss during the stroke in order to minimize the amount of force required to penetrate the gap. The alternating angles of the floss need not need to be the same angle, but rather can be varied according to need, such as tapering the angle of the floss as it approaches a tooth pocket.

With the floss at an angle, one side of the floss will reach the tooth pocket before the other side of the floss. Upon one side of the floss reaching the tooth pocket the processing circuitry may then command actuator arm 892 to rotate floss cartridge 893 such that the floss occupies and becomes parallel to the tooth pocket.

Alternatively or additionally, the processing circuitry may adjust the angle of the floss during the stroke, for example, such that the floss finishes the descent parallel to the tooth pocket. As another example, as the floss is leaving the tooth pocket, the angle may gradually be increased so as to avoid placing excessive tension on the floss which might lead to breakage.

### H5. Sixth Example Method

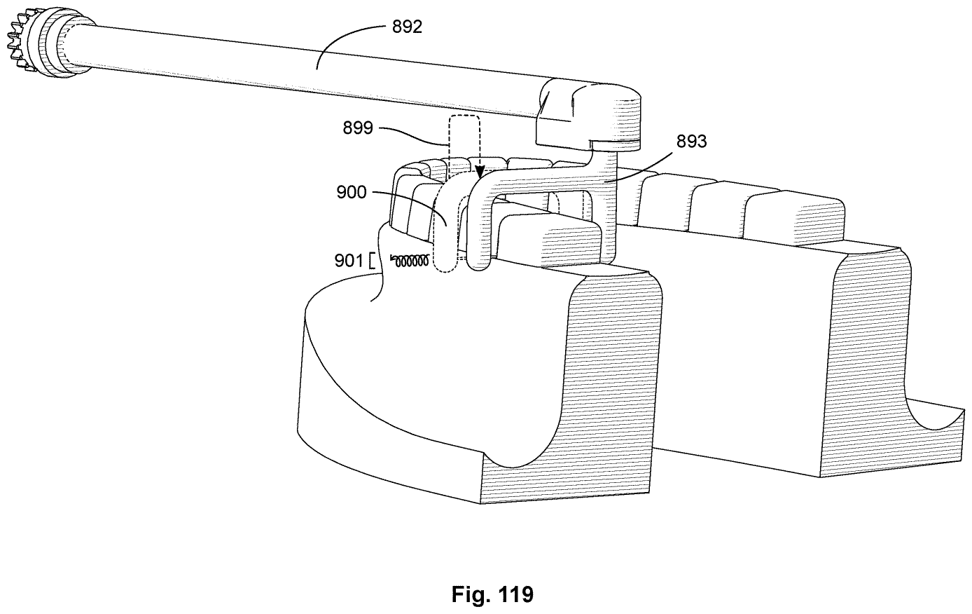

FIG. 119 is a diagram of a sixth example method, a repeatable corkscrew maneuver to sweep food debris out of a tooth pocket.

An automated dental flossing apparatus allows for advanced cleaning techniques which would be laborious if performed manually. As an example, the amount of food debris removed from a tooth pocket can be increased if floss is fed through the tooth pocket in a corkscrew motion. Fresh floss is introduced into the pocket, dislodges food debris as the walls of the tooth pocket are scraped by the corkscrew motion, some of which sticks to the floss and is transported out of the tooth pocket.

If the floss in a floss cartridge 893 is sufficiently wide compared to the tooth pocket width, then the entire pocket can be swept with a single corkscrew path 901. However, to clear the tooth pocket of wider teeth such as molars in a single pass would require a long length of floss, more than double the width of the tooth pocket of the largest molar, with a corresponding large floss cartridge 893 to hold it. Such a large cartridge may cause interference problems with oral cavity structures, especially with individuals with small mouths or children.

In order to improve the tooth pocket cleaning ability with a smaller floss cartridge 893 when the tooth pocket width does not permit cleaning the entire tooth pocket in a single pass, the corkscrew path 901 may be repeated. Each pass of the corkscrew path 901 will push food debris further along the tooth pocket until it is eventually transported out of the tooth pocket.

The fifth example method may be implemented, for example, as a set of instructions that, when executed by processing circuitry of an apparatus, cause an actuator arm 892 to move a floss cartridge 893 in a corkscrew path 901 to an end position 900. If the tooth pocket is too wide to permit clearance in a single pass or alternatively, if the user desires to increase the cleaning efficacy by performing multiple passes, floss cartridge 893 is lifted out of the tooth pocket on a return path 899 and returned to the start position. This sequence can be repeated as many times as is desired or necessary to achieve the required degree of cleaning.

If the automated dental flossing apparatus has a means or method of cleaning the floss, for example, via a cleaning and/or disinfecting fluid jet pointed at the floss, or via a wiping action, then the floss cleaning can be performed during the return path 899 so that food debris gathered on the floss during the corkscrew path 901 will not be returned to the start position where it could be transported into the tooth pocket upon the execution of the repeated corkscrew path 901.

Although FIG. 119 shows the floss cartridge 893 proceeding along a corkscrew path 901 from the interior of the mouth towards the exterior and return path 899 shows straight line segments to return to the start point, those of ordinary skill in the art may identify other variations and combinations of features of any other examples, even if that combination is not explicitly described. For example, the corkscrew path 901 may proceed in a direction toward the interior of the mouth. Alternatively or additionally, return path 899 may take a circuitous route allowing for cleaning of the floss along the way by wiping it on a structure such as a wiper bar or the user's tongue. Alternatively or additionally, return path 899 may use a zig-zag or sawing path as described elsewhere in this disclosure to reduce the amount of force required to extricate it from the tooth pocket.

### H6. Example Apparatus

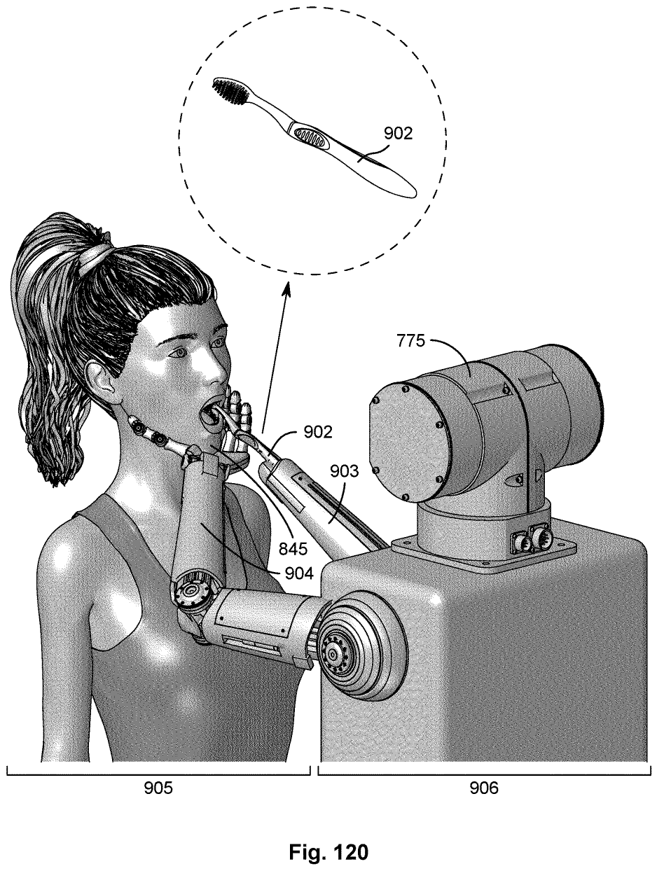

FIG. 120 is an illustration of an example robotic dental workstation configured to clean the oral cavity of a human or animal subject. A left effector 904 may establish one or more primary reference points 845 by grasping or constraining one or more physiological features of the subject. This could be a single-point reference, for example the chin of the subject, or a multi-point reference, for example, using the palm and fingers of the effector to grasp the subject's chin, while placing the thumb of the effector under the subject's nose in order to obtain a second primary reference point 845 correlated to the degree that the subject's mouth is open.

Alternatively or additionally, one or more of the primary reference points 845 may be determined virtually, without physical contact. For example, LIDAR or 3D stereo computer vision in a scanning unit 775 with the appropriate algorithms (such as neural networks trained on facial features) may identify landmarks on the face, such as the tip of the nose or a chin divot which may be tracked in real-time and serve the purpose of primary reference points.

Left effector 904 may also provide a counterforce to minimize the movement of subject 905 caused by forces imposed by right effector 903 transmitted via cleaning tool 902 (in this example, a toothbrush).

### H7. Seventh Example Method

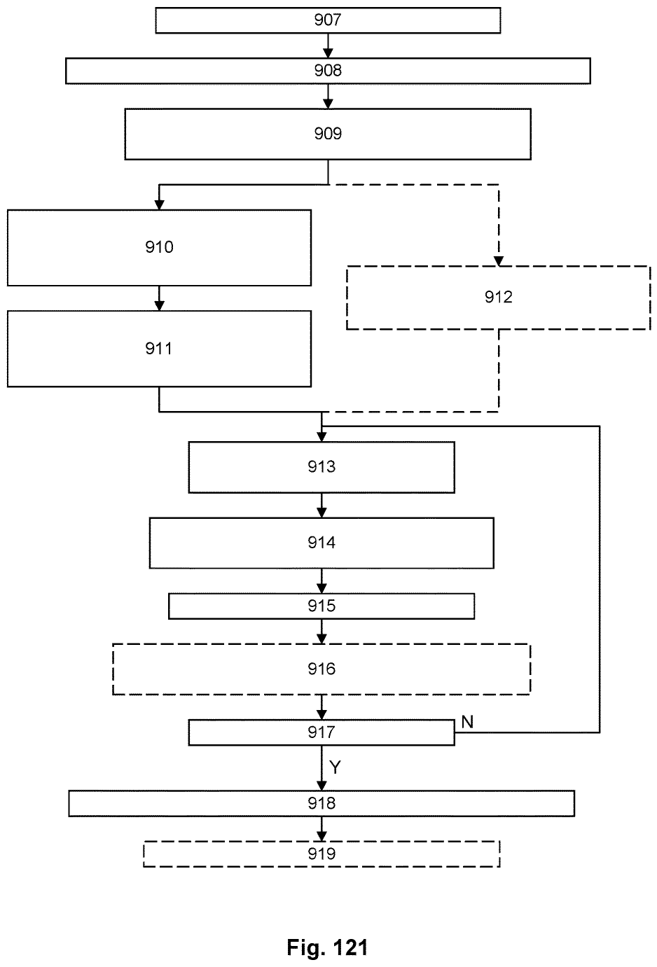

FIG. 121 is a flowchart diagram of a seventh example method of cleaning an oral cavity of an individual.

The sixth example method may be implemented, for example, as a set of instructions that, when executed by processing circuitry of an apparatus, cause the apparatus to perform each of the elements of the sixth example method.

The sixth example method begins with step 907 by verifying that the subject's mouth is open. This task may be accomplished by various methods such as verbal instruction with or without verbal acknowledgment from the subject, or automated sensing of the position of the subject's lips via means such as 3D stereo computer vision or LIDAR combined with feature detection and classification algorithms.

The sixth example method includes step 908, obtaining one or more primary reference points of the subject's mouth area, as outlined elsewhere in this disclosure, or in the case of FIG. 120, by utilizing the onboard sensors, algorithms and effectors used to detect, classify and manipulate objects, for example those present in the Robot Operating System (ROS) ecosystem.

The sixth example method includes step 909, moving and orienting a cleaning tool for general entry into mouth, based on the primary reference points previously obtained, or via other sensing means such as 3D stereo computer vision or LIDAR.

The sixth example method includes step 910, probing the extents of two or more teeth in order to determine the general dimensions of the subject's mouth. In one example implementation, this may be accomplished by positioning the cleaning tool inside the mouth to where it clears the front teeth (based on a consensus dental model), then lowering the cleaning tool downward at a speed not expected to cause discomfort when it contacts the top of the front teeth, until position sensors like optical or magnetic encoders have detected that it has hit an obstruction, or via force sensors which detect the force of the front teeth stopping the cleaning tool from moving downward. One of ordinary skill in the art can contemplate other types of sensors to accomplish the same detection feature, such as capacitive touch sensors. In a similar way, the cleaning tool may then be raised, moved to the estimated center of the mouth, lowered and then swept left and right to detect the positions of the inner surfaces of the back teeth.

Alternatively or additionally, one or more of the teeth extents may be determined virtually, without physical probing contact. For example, LIDAR or 3D stereo computer vision with the appropriate algorithms (such as neural networks trained on facial features) may identify the subject's teeth and determine basic parameters such as the distance between the left rear molars and the right rear molars. These parameters may be used to adjust a dental model to match the subject's physiognomy.

The sixth example method includes step 911, utilizing the data collected in the previous steps to scale and/or rotate and/or translate a dental model (which may be as simple as a list of relative coordinates of oral features, or as complex as a full point cloud mesh) to best fit measured the measured dimensions and coordinates, as determined by an algorithm such as least squares.

Alternatively or additionally, if the aforementioned probing and fitting steps have previously been performed and a customized dental model of the subject was created and saved, it may be reloaded to improve the speed and quality of the cleaning run by skipping some calibration steps (step 912). However, even if a customized dental model is available, some probing of oral surfaces may be required in order to orient the model in 3D space to match the subject's oral cavity positioning.

The sixth example method includes step 913, moving the cleaning tool to an oral feature to be cleaned. For brushing, this could be a tooth surface. For flossing, this could be a gap between two teeth. Other variations are possible and contemplated in this disclosure, such as the application of fluoride liquid to teeth, the scraping of biofilms from the tongue or the removal of debris from orthodontic appliances via waterjet.

The sixth example method includes step 914, executing a cleaning routine associated with the cleaning tool. For brushing, this may involve activating a motor to oscillate the bristles on the cleaning tool to sweep the tooth surface of debris and plaque, while simultaneously activating an actuator to apply force to keep the bristles in contact with the tooth surface. For flossing, this may involve activating actuators to drive the floss through the gap between teeth down to the tooth pocket at the root of the tooth, then driving the floss out from between the teeth. This cleaning routine may be either intermittent or continuous. For example, in the brushing example, the bristle oscillation may be continuous even while the cleaning tool is being moved from one oral feature to the next. Whereas with the flossing example, the flossing routine is started and completed before moving to the next flossing location.

Optionally, during the cleaning run, the fitted dental model can be updated with data from the cleaning (step 916). For example, if the measured position of the oral feature differs from the dental model, the fitting of the dental model can be refined, thereby increasing the accuracy of the model relative to the subject's oral cavity. This can either happen in real-time if sufficient computing power is available, or alternatively, the cleaning can be paused and the new model recomputed periodically.

The sixth example method includes step 915, selecting the next oral feature and moving the cleaning tool to that location. When all oral features in the cleaning set have been completed (step 917), the cleaning tool is then retracted from the subject's mouth (step 918).

If, after several tries, a complete cleaning cannot be accomplished, the processing unit may abort the cleaning process.

Optionally, the customized dental model may be saved so that future cleaning runs can be performed quicker, with better accuracy and a reduced calibration burden (step 919).

### H8. Example Apparatus

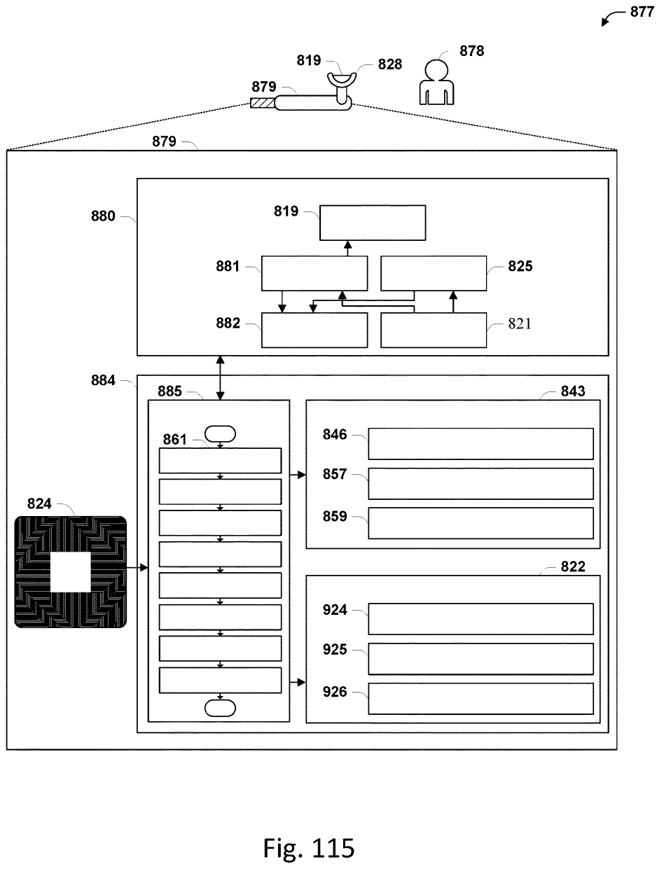

FIG. 115 is a component block diagram 877 of an oral appliance 879 configured to perform an oral hygiene task in a mouth of an individual 878 using an oral hygiene tool 819.

As shown in FIG. 115, an oral appliance 879 may include a set of hardware 880, such as an appliance tool 828 and at least one actuator 882. The oral appliance 879 may include at least one sensor 821, such as a current sensor. The oral appliance 879 may include a power source 825 and input/output hardware 881, such as a bus.

The oral appliance 879 may include processing circuitry 824 and memory 884 storing a set of instructions 885 that, when executed by the processing circuitry 824, cause the oral appliance 879 to perform an oral hygiene task in the oral cavity of an individual 878 by operating the actuators 882 according to an oral mapping 843 and monitoring the sensors 821, such as in the examples of FIGS. 110 and 111. As a first such example, the instructions 885 may encode the elements of the first example method, such as the example method 861 of FIG. 113.

The oral mapping 843 may be stored in the memory 884 and may include, for example, at least one upper/lower opposing plane reference points 846, tooth opposing surface reference points 857 and/or pocket reference points 859. Memory 884 may also contain one or more location sets 822 which may consist of a first location 924, a second location 925 and a third location.

### H9. Example Computer-Readable Medium

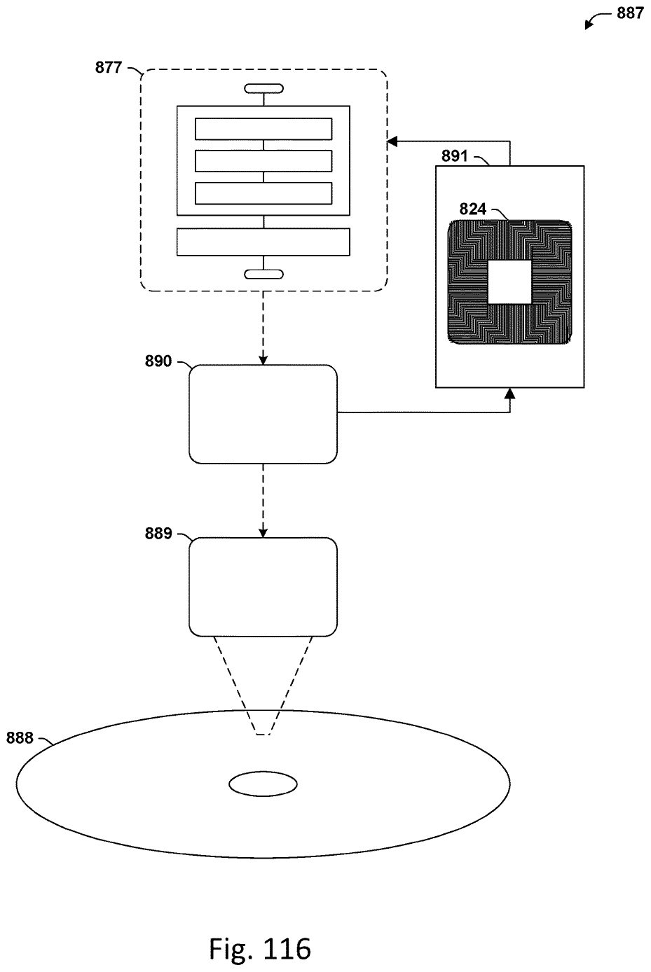

FIG. 116 is a diagram 887 of an example computer-readable medium 888 storing instructions that, when executed by an oral hygiene apparatus, may cause the oral hygiene apparatus to map a mouth of an individual.

As shown in FIG. 116, the example computer-readable medium 888 may store binary data 889 encoding a set of instructions 890 that, when executed by processing circuitry 824 of an apparatus 891 such as an oral hygiene apparatus or an automated oral probe, cause the apparatus 891 to perform an oral mapping in accordance with some examples. As a first such example, the instructions 890 may encode the elements of the first example method, such as the example method 861 of FIG. 113. As a second such example, the instructions 406 may encode the elements of the second example method 869 of FIG. 114. As a third such example, the instructions 890 may encode the elements of the instructions 885 of the oral appliance 879 of FIG. 115.

As used herein, the term “computer-readable medium” may include any tangible form of computer readable carrier, such as solid-state memory, magnetic disk, and optical disk containing an appropriate set of computer instructions, such as program modules, and data structures that would cause a processor to carry out the techniques described herein. Non-limiting examples of “computer-readable media” include nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc), an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (such as EPROM, EEPROM, or Flash memory), or any other tangible medium capable of storing information. As used herein, the term “computer-readable media” excludes transitory electrical or electromagnetic signals propagating through a medium (such as on a carrier wave); the term “computer-readable media” as used thus refers only to considered tangible and/or non-transitory storage devices.

### H10. Other Example Embodiments

An oral hygiene apparatus may include at least one actuator; at least one sensor; processing circuitry; and a memory storing instructions that, when executed by the processing circuitry, cause the oral hygiene apparatus to establish a primary reference point; collect a set of reference points by, detecting at least one upper front reference point and at least one lower front reference point, detecting at least one upper opposing plane start reference point and at least one lower opposing plane start reference point, detecting at least one upper inner reference point and at least one lower inner reference point, detecting at least one upper opposing plane reference point and at least one lower opposing plane reference point, detecting at least one tooth opposing surface reference point of at least one tooth, and detecting at least one pocket reference point between at least one pair of adjacent teeth; and store the set of reference points as an oral mapping of the mouth of the individual.

An automated oral probe may include a probe head; an actuator set including a reach actuator including a linear actuator configured to move the probe head along a reach axis, a pitch actuator including a rotary actuator configured to provide a pitch rotation 831 to the probe head, a yaw actuator including a rotary actuator configured to provide a yaw rotation to the probe head, a roll actuator including a rotary actuator configured to provide a roll rotation to the probe head, and a pivot actuator including a rotary actuator configured to provide a pivot rotation to the probe head; processing circuitry; and a memory storing instructions that, when executed by the processing circuitry, cause the oral hygiene apparatus to control the actuator set to establish a primary reference point; collect a set of reference points by detecting at least one upper front reference point and at least one lower front reference point, detecting at least one upper opposing plane start reference point and at least one lower opposing plane start reference point, detecting at least one upper inner reference point and at least one lower inner reference point, detecting at least one upper opposing plane reference point and at least one lower opposing plane reference point, detecting at least one tooth opposing surface reference point of at least one tooth, and detecting at least one pocket reference point between at least one pair of adjacent teeth; and store the set of reference points as an oral mapping of the mouth of the individual.

A controller may be provided to control an oral hygiene apparatus featuring a set of actuators in order to map a mouth of an individual, where the controller includes processing circuitry and a memory storing instructions that cause the oral hygiene apparatus to control the set of actuators to collect a set of reference points by detecting a set of mouth structure reference points; detecting at least one tooth surface reference point of at least one tooth, and detecting at least one pocket reference point between at least one pair of adjacent teeth, and where the instructions further cause the controller to store the set of reference points as an oral mapping of the mouth of the individual.

An apparatus may be provided to map a mouth of an individual, where the apparatus includes collecting means for collecting a set of reference points by detecting a set of mouth structure reference points; detecting at least one tooth surface reference point of at least one tooth, and detecting at least one pocket reference point between at least one pair of adjacent teeth, and storing means for storing the set of reference points as an oral mapping of the mouth of the individual. The collecting means may be or may include an automated oral probe and/or a wired or wireless communication interface for communicating with an automated oral probe, such as a controller, a network adapter, a Bluetooth adapter, and the like. The storing means may be or may include memory (which may be volatile and/or nonvolatile storage); a memory interface, such as a storage driver or storage layer that communicates with memory; and/or a network interface that communicates with a storage device, such as a memory of another device such as an oral hygiene apparatus, a network storage device including a cloud storage device, or the like.

TABLE 5
Labels for FIGS. 107 to 121

| # | Label |
|---|---|
| 776 | Verify Subject's Mouth Is Open |
| 777 | Obtain Primary Reference Point(s) For Subject |
| 778 | Translate And Orient Probe For General Entry Into Mouth |
| 779 | Probe Several Teeth For General Dimensions Of Mouth |
| 780 | Scale, Rotate And/Or Translate Dental Model To Fit Measured |
| | Dimensions |
| 781 | Select Target Pocket At Base Of Tooth |
| 782 | Orient Probe Along Pocket Axis |
| 783 | Move Probe Towards Pocket Until Contact |
| 784 | Translate Probe Laterally While Maintaining Force In Direction |
| | Of Axis In Order To Find Nadir Of Pocket |
| 785 | Using Fitted Dental Model, Translate And Rotate Probe Along |
| | Calculated Grooves, Maintaining Force Against Oral Surface. |
| | Wiggle Probe Along Groove Path To Maintain Probe Along |
| | Center Of Groove. |
| 786 | Adjust Fitted Dental Model With Data From Actual Mouth |
| | Tracing |
| 787 | Finished Tracing? |
| 788 | Successful Trace Of Mouth Grooves? |
| 789 | Save Customized Dental Model |
| 800 | Verify Subject's Mouth Is Open |
| 801 | Obtain Primary Reference Point(S) For Subject |
| 802 | Translate And Orient Probe For General Entry Into Mouth |
| 803 | Probe Several Teeth For General Dimensions Of Mouth |
| 804 | Scale, Rotate And/Or Translate Dental Model To Fit Measured |
| | Dimensions |
| 805 | Using Fitted Dental Model, Raster Scan Teeth Areas To Generate |
| | Point Cloud. Adjust Probe Rotation And Orientation To Avoid |
| | Collisions With Mouth Structures. |
| 806 | Adjust Fitted Dental Model With Data From Actual Mouth |
| | Scanning |
| 807 | Finished Scanning? |
| 808 | Process Point Cloud To Generate Surfaces |
| 809 | Use Surface Discontinuities To Determine Object Boundaries |
| | Between Teeth And Adjacent Teeth And Gums |
| 810 | Save Customized Dental Model |
| 813 | Oral Appliance |
| 814 | Actuator 1: Depth (Linear) |
| 815 | Actuator 2: Vertical (Rotary) |
| 816 | Actuator 3: Lateral (Rotary) |
| 817 | Actuator 4: Arm Rotation (Rotary) |
| 818 | Actuator 5: Tool Rotation (Rotary) |
| 819 | Oral Hygiene Tool |
| 820 | Driver |
| 821 | Sensor |
| 822 | Location Set |
| 823 | Location |
| 824 | Processing Circuitry |
| 825 | Power Source |
| 836 | Establishing Reference Point |
| 840 | Calibration: Neutral Position |
| 842 | Flossing: Verify Oral Mapping |
| 843 | Oral Mapping |
| 845 | Flossing: Flossing Task |
| 846 | Upper/Lower Opposing Plane Reference Points |
| 849 | Flossing: Flossing Routine |
| 852 | Flossing: Pocket Series |
| 857 | Tooth Opposing Surface Reference Points |
| 859 | Pocket Reference Points |
| 862 | Start |
| 863 | Execute, By Processing Circuitry, Instructions That Cause |
| | Apparatus To: |
| 864 | Store An Oral Mapping As A Set Of Reference Points Within The |
| | Mouth Of The Individual |
| 865 | Identify A Location Set Of Locations In The Mouth To Perform |
| | The Oral Hygiene Task Based On The Oral Mapping |
| 866 | Position The Oral Hygiene Tool At Each Location Of Location |
| | Set |
| 867 | While The Oral Hygiene Tool Is Positioned At A Location Of The |
| | Location Set That Corresponds To A Reference Point Of The Oral |
| | Mapping, Operate The Oral Hygiene Tool To Perform The Oral |
| | Hygiene Task Based On The Reference Point |
| 868 | End |
| 870 | Start |
| 871 | Execute, By Processing Circuitry, Instructions That Cause |
| | Apparatus To: |
| 872 | Identify A Location Set In The Mouth To Position The Oral |
| | Hygiene Tool To Perform The Oral Hygiene Task |
| 873 | Identify Current Position Of The Oral Hygiene Tool Within |
| | Mouth Of Individual Based On A Sensor |
| 874 | Operate A Motion Generator To Move The Oral Hygiene Tool |
| | From The Current Position To The Location |
| 875 | While The Oral Hygiene Tool Is Positioned At The Location, |
| | Operate The Oral Hygiene Tool To Perform The Oral |
| | Hygiene Task |
| 876 | End |
| 879 | Oral Appliance |
| 880 | Hardware |
| 881 | I/O |
| 882 | Actuators |
| 883 | Sensors |
| 884 | Memory |
| 885 | Instructions |
| 886 | Location Set |
| 888 | Computer-Readable Medium |
| 889 | 0101101000101010101011010101101101011100 . . . |
| 890 | Computer Instructions |
| 891 | Apparatus |
| 907 | Verify Subject'S Mouth Is Open |
| 908 | Obtain Primary Reference Point(S) For Subject |
| 909 | Translate And Orient Cleaning Tool For General Entry Into |
| | Mouth |
| 910 | Probe Several Teeth For General Dimensions Of Mouth |
| 911 | Scale, Rotate And/Or Translate Dental Model To Fit Measured |
| | Dimensions |
| 912 | Load Customized Dental Model |
| 913 | Move Cleaning Tool To Selected Oral Feature |
| 914 | Execute Cleaning Routine For Selected Oral Feature |
| 915 | Select Next Oral Feature |
| 916 | Adjust Fitted Dental Model With Data From Mouth Cleaning |
| | Feedback |
| 917 | All Features Cleaned? |
| 918 | Retract Cleaning Tool From Subject's Mouth |
| 919 | Save Customized Dental Model |
| 924 | First Location: Pocket Between Left Molars |
| 925 | Second Location: Pocket Between Right Molars |
| 926 | Third Location: Pocket Between Front Incisors |
| 928 | Start |
| 929 | Execute, By Processing Circuitry, Instructions That Cause |
| | Apparatus To: |
| 930 | Identify A Location Set Of Locations In The Mouth To Position |
| | The Oral Hygiene Tool To Perform The Oral Hygiene Task |
| 931 | Operate The Motion Generator To Position The Oral Hygiene |
| | Tool At Each Location Of Location Set |
| 932 | While The Oral Hygiene Tool Is Positioned At One Of The |
| | Locations Of The Location Set, Operate The Oral Hygiene Tool |
| | To Perform The Oral Hygiene Task |
| 933 | End |

### Use of Terms

For the convenience of the reader, the above description has focused representative samples of all embodiments contemplated by the inventor. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

Although the disclosure has been shown and described with respect to some examples, alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated examples of the disclosure. In addition, while a particular feature of the disclosure may have been disclosed with respect to only one of several implementations, such feature may be combined with one or more other features of the other implementations as may be desired and advantageous for any given or particular application.

The descriptions provided in the present disclosure are merely illustrative in nature and are in no way intended to limit the disclosure, its application, or uses. The broad teachings of the disclosure may be implemented in a variety of forms. Therefore, while this disclosure includes particular examples, the true scope of the disclosure is not limited to such examples, and other modifications will be apparent to a person of ordinary skill in the art upon a study of the drawings, the specification, and the following claims. Although each of the examples is described above as having certain features, any one or more of those features described with respect to any example of the disclosure may be implemented in and/or combined with features of any other examples, even if that combination is not explicitly described. In other words, the described examples may not be not mutually exclusive, and permutations of one or more examples with one another remain within the scope of this disclosure.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

Various operations of some examples are provided herein. One or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be understood by persons of ordinary skill in the art as being within the scope of the present disclosure. Further, it will be understood that not all operations are necessarily present in each example provided herein. Some examples may vary from the example methods disclosed herein, such as by adding operations, omitting operations, performing operations in a different order, combining operations, dividing operations into two or more sub-operations, performing two or more operations in a concurrent and/or interleaved manner, and the like, without departing from the subject matter of the present disclosure.

Some examples may include methods, apparatuses, and/or articles of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

Terms such as “processing circuitry” may be appropriate computer hardware with appropriate software. Each of these devices typically has a microprocessor and one or more nontransitory, machine-readable memories for storing programs for execution by the microprocessor, scripts, and data. Various processes described herein may be implemented by, e.g., appropriately programmed general purpose computers, special purpose computers and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, or one or more scripts. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hard-wired circuitry or custom hardware may be used in place of, or in combination with, some or all of the software instructions that may implement the processes. Algorithms other than those described may be used.

As used herein, terms such as “module” and “controller” may be replaceable with the term “circuit.” The term “module” may refer to, be part of, or include processing circuitry (e.g., shared, dedicated, or group) that executes code and memory hardware (e.g., shared, dedicated, or group) that stores code executed by the processing circuitry. A module may include one or more interface circuits. A module may be configured to communicate with other modules using the interface circuit(s). Although some example modules may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. In various implementations, the functionality of a module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. modules and units are merely described based on their function for clarity purposes, and do not necessarily represent specific hardware or software. In this regard, modules, units, and other components may be hardware and/or software implemented to substantially perform their particular functions explained herein. The various functions of the different components may be combined or segregated as hardware and/or software modules in any manner, and may be useful separately or in combination. Input/output or I/O devices or user interfaces including, but not limited to, keyboards, displays, pointing devices, and the like may be coupled to the system either directly or through intervening I/O controllers.

As used herein, the term “code” may refer to software, firmware, and/or microcode, and may refer, for example, to programs, routines, functions, classes, data structures, and/or objects. “Code” may include, without limitation: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java, Fortran, Perl, Pascal, Curl, OCaml, JavaScript, HTML5, Ada, ASP, PHP, Scala, Eiffel, Smalltalk, Erlang, Ruby, Flash, Visual Basic, Lua, MATLAB, SIMULINK, and Python. Code may include or represent a procedure, a function, a subprogram, a program, a routine, a subroutine, a module, a software package, a class, or any combination of instructions, data structures, or program statements. Code may be coupled with other code or hardware by passing and/or receiving information, data, arguments, parameters, or memory contents.

Spatial and functional relationships between elements (for example, between modules) may be described herein using terms such as “connected,” “engaged,” “interfaced,” and “coupled.” Unless explicitly described as being “direct,” when a relationship between first and second elements is described in the above disclosure, each such relationship is intended to encompass a direct relationship where no other intervening elements are present between the first and second elements, and also an indirect relationship where one or more intervening elements are present (either spatially or functionally) between the first and second elements.

As used herein, the terms “component,” “module,” “system,” “interface.” and the like are generally intended to refer to a computer-related entity, either hardware, a combination of hardware and software, software, or software in execution. For example, a component may be, but is not limited to being, processing circuitry, a process running on processing circuitry, an object, an executable, a thread of execution, a program, and/or a computer. By way of illustration, both an application running on a controller and the controller may be a component. One or more components may reside within a process and/or thread of execution and a component may be localized on one computer and/or distributed between two or more computers.

As used herein, the terms “at least one of A, B, and C” should be construed to mean a selection of one or more among elements A, B, and C (A OR B OR C), using a non-exclusive logical OR, and should not be construed to mean “at least one of A, at least one of B, and at least one of C.”

As used herein, the term “or” is intended to mean an inclusive “or,” that is, “and/or,” rather than an exclusive “or.” That is, unless specified otherwise, or clear from context, “X employs A or B” is intended to mean any of the natural inclusive permutations.

As used herein, the articles “a” and “an” as used herein and in the appended claims may generally be construed to mean “one or more” unless specified otherwise or clear from context to be directed to a singular form.

As used herein, the terms “includes,” “having,” “has,” “with,” or variants thereof are used in either the detailed description or the claims, such terms are intended to be inclusive in a manner similar to the term “comprising.”

1. An oral appliance, comprising:
a motion generator comprising a tool arm having a distal end, and an assembly;
wherein the assembly comprises a mechanism to rotate the tool arm and structure allowing the tool arm to move linearly;
wherein a distal end of the tool arm is configured to mechanically attach to an oral cavity tool;
at least one sensor configured to output a signal indicating locations of surfaces of an oral cavity;
machine-readable and/or readable and writable memory;
non-human processing circuitry which is coupled to the memory and the at least one sensor;
wherein the processing circuitry is configured to read from and/or write to the memory;
wherein the processing circuitry is configured to receive signals from the at least one sensor; and
wherein the processing circuitry is configured to automatically generate control signals to control the motion generator to move the tool arm.

2. The oral appliance of claim 1, wherein the assembly is a gimbal assembly that comprises at least one gimbal and a bore through which the tool arm extends.

3. The oral appliance of claim 1, wherein the processing circuitry utilizes the output of one or more sensors to store in the memory a map of oral cavity locations.

4. The oral appliance of claim 1, utilizes a locations of a map stored in the memory to control the motion generator to move the tool art to locations in the oral cavity.

5. The oral appliance of claim 1, further comprising a oral cavity tool attached to the tool arm.

6. The oral appliance of claim 5, wherein the processing circuitry uses a map stored in the memory to control the motion generator to move the tool within the oral cavity so that the tool performs at least brushing or flossing of teeth within the oral cavity.

7. The oral appliance of claim 5 wherein the oral cavity tool includes a length of dental floss or plurality of bristles.

8. The oral appliance of claim 5, wherein the oral cavity tool includes one or more cameras.

9. The oral appliance of claim 5, wherein the oral cavity tool includes one or more 2D or 3D scanners.

10. The oral appliance of claim 5, wherein the oral appliance includes a tool holder for the oral cavity tool.

11. The oral appliance of claim 5, wherein the oral cavity tool includes a groove to retain the tool in the tool holder while permitting rotation of the tool.

12. The oral appliance of claim 5, wherein the oral cavity tool includes a flange to retain the tool in the tool holder while permitting rotation of the tool.

13. The oral appliance of claim 5, wherein a portion of the oral cavity tool that mates with the tool holder has an asymmetric shape so that it may be attached in only one orientation relative to the tool holder.

14. The oral appliance of claim 1, wherein the oral appliance includes a clamp to removably attach the oral cavity tool.

15. The oral appliance of claim 1, wherein the motion generator includes one or more motors.

16. The oral appliance claim 1, wherein the motion generator includes one or more linear actuators.

17. The oral appliance claim 1, wherein the motion generator includes one or more rotary actuators.

18. The oral appliance of claim 1, wherein the motion generator includes a motor or linear or rotary actuator for rotating the oral cavity tool around a first axis.

19. The oral appliance claim 1, wherein the motion generator includes a motor or linear or rotary actuator for rotating the oral cavity tool around a second axis.

20. The oral appliance of claim 1, wherein the motion generator includes five motors: one for left-right motion, one for up-down motion, one for in-out motion, one for oral cavity tool rotation along a first axis, and one for oral cavity tool rotation along a second axis.

21. The oral appliance of claim 1, wherein at least a portion of the tool arm has an exterior surface of constant geometry such that it can mate with a seal to reduce ingress of debris or fluids into the oral appliance.

22. The oral appliance of claim 1, wherein the oral appliance includes a seal which mates with the tool arm to reduce ingress of debris or fluids into the oral appliance.

23. The oral appliance of claim 1, wherein the motion generator includes a linear bearing or bushing to permit the tool arm to extend and retract.

24. The oral appliance of claim 1, wherein the motion generator is coupled to the oral cavity tool via a tool arm and one or more gimbals.

25. The oral appliance of claim 1, wherein the motion generator is coupled to the oral cavity tool via nested gimbals.

26. The oral appliance of claim 1, wherein the motion generator is coupled to the oral cavity tool via a tool arm and a ball-and-socket joint.

27. The oral appliance of claim 1, wherein the oral appliance includes a hemispherical shield which mates with a seal to reduce ingress of debris or fluids into the oral appliance.

28. The oral appliance of claim 1, wherein at least one of the sensors comprises either an optical encoder or a magnetic encoder.

29. The oral appliance of claim 1, wherein at least one of the sensors comprises one of a current sensor, a linear potentiometer, a rotary potentiometer, a linear variable-displacement transformer (LVDT), a force-sensitive resistor (FSR), a strain gauge, a magnetometer, and a gyroscope.

30. The oral appliance of claim 1, wherein at least one of the sensors comprises, an accelerometer.

31. The oral appliance of claim 30, wherein the sensor comprising the accelerometer provides detection of a hazardous or damaging orientation in order to stop or prevent the operation of the device and/or communicate a warning.

32. The oral appliance of claim 1, wherein at least one of the sensors comprises one of an ultrasonic transceiver or ranger, a camera, a 2D or 3D scanner, and a capacitive sensor.

33. The oral appliance of claim 1, further comprising:
one or more members configured to constrain one or more oral or facial features of an individual to provide one or more position references.

34. The oral appliance of claim 1, further comprising:
one or more members configured to contact one or more oral or facial features of an individual to constrain the lower jaw relative to the upper jaw of an oral cavity to maintain an opening to the oral cavity.

35. The oral appliance of claim 1, further comprising one or more members configured to anchor the oral appliance's position relative to the oral cavity.

36. The oral appliance of claim 34, wherein at least a part of the members fit into the upper and/or lower gum pockets between the front gums and the inner surface of the lip.

37. The oral appliance of claim 34, wherein at least one of the members has a notch which surrounds the upper frenulum.

38. The oral appliance of claim 34, wherein at least part of the members fit between the maxilla and mandible behind the rear molars.

39. The oral appliance of claim 34, wherein the members are configured to constrain at least one facial feature via at least one member external to the oral cavity.

40. The oral appliance of claim 39, wherein at least one facial feature constrained is the mandible.

41. The oral appliance of claim 39, wherein at least one facial feature constrained is the chin.

42. The oral appliance of claim 39, wherein at least one facial feature constrained is the nose.

43. The oral appliance of claim 39, wherein at least one facial feature is the intersection of the nasal septum and the philtrum.

44. The oral appliance of claim 45, wherein at least one facial feature is the mentolabial sulcus.

45. The oral appliance of claim 1, wherein the oral cavity tool includes a cleaning and/or dispensing orifice.

46. The oral appliance of claim 1, wherein the oral appliance includes a cleaning member or cleaning and/or dispensing mechanism for an oral cavity tool.

47. The oral appliance of claim 5, wherein the oral cavity tool comprises an oral cavity tool cleaning mechanism that comprises one or more stationary brushes which the oral cavity tool may be moved to brush against, using the motion generator.

48. The oral appliance of claim 47, wherein the oral cavity tool comprises an oral cavity tool cleaning mechanism that comprises one or more moving or rotating brushes.

49. The oral appliance of claim 47, wherein the oral cavity tool comprises an oral cavity tool cleaning mechanism that comprises one or more stationary or moving wipers.

50. The oral appliance of claim 47, wherein the oral cavity tool comprises an oral cavity tool cleaning mechanism that comprises of one or more stationary or moving sponges.

51. The oral appliance of claim 5, wherein the oral cavity tool comprises an oral cavity tool dispensing mechanism that comprises one or more orifices fed from one or more substance pumps from one or more substance reservoirs.

52. The oral appliance of claim 5, wherein the oral cavity tool comprises an oral cavity tool cleaning mechanism that comprises one or more jets.

53. The oral appliance of claim 52, wherein the one or more jets are configured to use water pressure supplied by the water mains.

54. The oral appliance of claim 52, wherein the one or more jets are configured to be fed from one or more substance pumps from one or more substance reservoirs.

55. The oral appliance of claim 52, wherein the one or more jets are configured as part of the oral cavity tool.

56. The oral appliance of claim 52, wherein the one or more jets are part of the oral appliance, and not part of the oral cavity tool.

57. The oral appliance of claim 1, wherein the memory stores a map that defines a set of coordinates and/or orientations of locations in the oral cavity.

58. The oral appliance of claim 1, wherein the memory stores a map represented by a set of points and/or vectors and/or curves and/or surfaces.

59. A method of using an oral appliance, comprising:
using a tool while the tool is at least partially within the oral cavity of a living creature;
moving the tool, with a motion generator comprised of at least one linear and/or rotary motion-producing device; and
retrieving a map from machine-readable memory; and
processing, with non-human processing circuitry, the map to generate control signals for controlling movement of the motion generator; and
the processing circuitry using the map to control the motion generator to move the tool within the oral cavity so that the tool performs one of the functions of: cleaning, inspecting, scanning, imaging, dispensing, repairing, and surgery of anatomical features of the oral cavity.

60. A method for automatically generating an oral map of features within an oral cavity of a living animal, comprising:
moving a tool relative to a reference point that is fixed relative to oral cavity;
detecting, using a sensor, positions of the tool, indicating that either the tool or an object mechanically connected to the tool, has hit an obstruction; and
storing oral mapping data, in computer writable memory, based upon the detected positions.

61. The method of claim 60 wherein processing circuitry computes the mapping data based upon the detected positions, and stores mapping data in the computer writeable memory.

62. The method of claim 60 wherein processing circuitry generates control signals to control a motion generator to cause the moving of the tool relative to the reference point.

63. An oral hygiene apparatus comprising:
an oral hygiene tool;
a member connected to the oral hygiene tool;
a connector configured to connect to an actuator;
wherein the connector is mechanically coupled to the member so that motion of the connector causes the member to move; and
a retention feature which is configured to retain the connector to an actuator and enable the actuator to rotate the connector.

64. The cartridge of claim 63, wherein said retention feature is an integral part of said connector.

65. The cartridge of claim 63, wherein said retention feature is not an integral part of said connector.

66. A cartridge, comprising:
an oral hygiene tool;
a member connected to the oral hygiene tool;
a connector configured to connect to an actuator;
wherein the connector is mechanically coupled to the member so that motion of the connector causes the member to move; and
a retention feature which is configured to retain the connector to an actuator and enable the actuator to rotate the connector.

67. An oral positioning apparatus, comprising:
one or more members configured so that the one or more members hold an upper jaw spaced from a lower jaw of a vertebrate, when the one or more members are positioned relative to anatomical features of the vertebrate;
a cam follower connected to one or more of said locating members either directly or through intermediate members; and
a cam having a plurality of positions which constrain the motion of said cam follower.

68. An automated oral hygiene apparatus, for automatically performing an oral hygiene task within a mouth of an individual, comprising:
a probe;
wherein the probe comprises a tool;
wherein the oral hygiene apparatus is configured to automatically move and orient the probe within the mouth; and
wherein the oral hygiene apparatus is configured to automatically operate the tool to perform an oral hygiene task.

69. The apparatus of claim 68, further comprising:
a set of actuators configured to automatically move parts of the oral probe.

70. The apparatus of claim 69, wherein the set of actuators comprises one linear actuator and four rotary actuators.

71. The apparatus of claim 69, wherein each one of the set of actuators comprises a corresponding encoder that provides feedback on position or rotation of the corresponding actuator.

72. The apparatus of claim 68, wherein the tool comprises a brush.

73. The apparatus of claim 68, wherein the tool comprises dental floss.

74. The apparatus of claim 68, further comprising:
computer memory storing data defining a set of locations where the tool is to be moved and/or oriented to perform the oral hygiene task.

75. The apparatus of claim 68, further comprising:
processing circuitry configured to generate signals to control operation of the set of actuators to move and orient the oral hygiene tool to specified locations within the mouth of the individual where one or more oral hygiene tasks are to be performed.

76. The apparatus of claim 75, further comprising computer memory storing a set of locations where the tool is to be moved and/or oriented to perform the oral hygiene task; and
wherein the processing circuitry is configured to read the set of locations from the computer memory and use those locations to the generate signals to control the operation of the set of actuators to move and orient the oral hygiene tool to the specified locations within the mouth of the individual where one or more oral hygiene tasks are to be performed.

77. The apparatus of claim 68, wherein the tool comprises dental floss, and the oral hygiene apparatus is configured to automatically move the dental floss through a pocket between opposing surface of adjacent teeth in a corkscrew motion.

78. The apparatus of claim 77, wherein the tool comprises a floss cartridge forming an “U” shape which constrains the dental floss to extend between tips of the “U”.

79. A method for automatically performing an oral hygiene task within a mouth of an individual, comprising:
providing an automated oral hygiene apparatus comprising probe, wherein the probe comprises a tool;
the automated oral hygiene apparatus automatically moving and orienting the probe within the mouth; and
the oral hygiene apparatus automatically operating the tool to perform an oral hygiene task.
